(19) United States
(12) Patent Application Publication
(10) Pub. No.: US 2026/0279148 A1
(43) Pub. Date: Sep. 17, 2026

(54) METHODS, SYSTEMS, AND APPARATUSES FOR COLLECTION, RECEIVING AND UTILIZING DATA AND ENABLING GAMEPLAY

(71) Applicant: AdrenalineIP, Washington, DC (US)

(72) Inventors: Casey Alexander HUKE, Washington, DC (US); John CRONIN, Jericho, VT (US); Joseph W. BEYERS, Saratoga, CA (US); Michael D'ANDREA, Burlington, VT (US)

(73) Assignee: AdrenalineIP, Washington, DC (US)

(21) Appl. No.: 19/675,870

(22) Filed: May 13, 2026

Related U.S. Application Data
(63) Continuation of application No. 18/716,678, filed on Dec. 9, 2022.
(60) Provisional application No. 63/288,145, filed on Dec. 10, 2021.

(51) Int. Cl. G07F 17/32; G06Q 50/34

(52) U.S. Cl. CPC G07F 17/323; G06Q 50/34; G07F 17/3211; G07F 17/3288

(57) ABSTRACT

The embodiments include various methods, systems, and apparatuses for enabling, providing, transmitting and displaying data. In some embodiments, the methods, systems, and apparatuses may be further related to the collection of data from one or more sources or sensors and transmission and manipulation of that data. The data can be sourced from a variety of sources, including sporting events, and may be processed, manipulated and transmitted in substantially real time depending on the embodiment.

### CROSS-REFERENCE TO RELATED APPLICATION

This application is a Continuation of U.S. patent application Ser. No. 18/716,678, filed on Jun. 5, 2024, which is the National Stage Entry of PCT/US2022/052350, filed on Dec. 9, 2022, which claims priority to U.S. Provisional Patent Application Ser. No. 63/288,145, filed Dec. 10, 2021, the contents of which are hereby incorporated by reference in their entirety.

### FIELD

The present disclosures are generally related to points based gaming and wagering on sporting events.

### BACKGROUND

In order to offer accurate odds on a sub-event of a live sporting event, such as an individual play, odds must be calculated quickly. A set of baseline odds may be generated from a set of data known in advance, then adjusted as new data is available to calculate odds quickly.

These odds adjustments may be made by recalculating the odds as new data is available. But this process is time-consuming and not practical when some of the most critical data, such as player formation, is only available seconds before the start of the play.

These problems become compounded when offering parlay wagers which are combinations of wagers which may be concurrent or sequential. Parlay wagers are a tool for sportsbooks to entice users, balance books, increase profit, etc. Quickly generating accurate odds is important to offering parlay wagers on events close in time, such as the current and next play in a football game.

In order to offer accurate odds on a micro-event of a live sporting event, such as an individual play, odds must be calculated quickly. To facilitate this, a set of baseline odds may be generated from a set of data that is known in advance, then adjusted as new data is available.

Alternatively, individual adjustments may be made to the already calculated odds for each newly available parameter. But this method does not consider how parameters might interact or counteract and instead treats each parameter as a completely independent variable.

Thus, there is a need in the prior art to adjust wager odds based on multiple parameters.

It is customary for people to wager on games and other sporting events. However, the complexity of placing wagers makes it difficult for users to place wagers on certain aspects of the game outside of its outcome or score.

Another problem is that programs that would allow users to place wagers on game events are currently unable to accurately calculate the odds of the next game event.

Yet another problem is that inaccurate odds lead to inherent unfairness in wagering, negatively affecting user retention.

Thus, there is a need in the prior art to provide users with a wagering platform that provides accurate odds that are fair to every user.

Many parlay wagers could be generated from any combination of wagers but would be ineffective if users were unlikely to place those parlay wagers. Given the limited amount of time available during a live sporting event, it is critical to provide users with parlay options that are attractive to them without requiring them to spend time searching for those options.

Currently, wagering platforms and wagering applications use similar metrics and statistics to determine wager odds but are limited in the capabilities of utilizing artificial intelligence and machine learning to adjust the wager odds.

Also, the wagering platforms and wagering applications do not use artificial intelligence and machine learning to find highly correlated data points that can be used for individual wager markets.

Lastly, the wagering platforms and wagering applications do not utilize artificial intelligence and machine learning to assist in adjusting wager odds for individual wager markets once the wager odds are created for a play-by-play wagering application.

Thus, there is a need in the prior art to utilize artificial intelligence and machine learning to select a common parameter to adjust wager odds.

Currently, wagering platforms and wagering applications create wagering odds for users to place wagers on specific wager markets, but there are limited artificial intelligence and machine learning methods to create wagering odds.

Also, there are limited methods to create and use training data that the wagering platforms and wagering applications could use to train an artificial intelligence and machine learning system.

Lastly, there are few methods that include wager odds created by an artificial intelligence system to be used as the training data for an artificial intelligence and machine learning system to create and adjust wagering odds.

Thus, there is a need in the prior art to provide training for an artificial intelligence and machine learning system to adjust odds.

Currently, wagering platforms and applications do not use algorithms and artificial intelligence to adjust wager odds on wagering platforms.

Also, wagering platforms and applications do not combine various parameters to create new data points to be used in an artificial intelligence system to adjust wager odds.

Lastly, wagering platforms and applications do not fully utilize common parameters and data points to create new metrics to adjust current wager odds.

Thus, there is a need in the prior art to use algorithms that utilize multiple parameters to create new parameters that can be used in an artificial intelligence system to adjust wager odds.

Currently, wagering platforms and wagering applications do not store wager odd data for individual situations to be used for future similar situations

Also, it is difficult for wagering platforms and wagering applications to use previous wager odds again in similar situations since the event situations are constantly changing.

Lastly, wagering platforms and applications do not fully utilize the data created and collected when creating and adjusting wagering odds for a wagering application.

Thus, there is a need in the prior art to store the wager odds adjustments to be extracted in future similar situations.

### BRIEF DESCRIPTIONS OF THE DRAWINGS

The accompanying drawings illustrate various embodiments of systems, methods, and various other aspects of the embodiments. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a system for parlay wager odds calculation, according to an embodiment.

FIG. 2 illustrates an odds calculation module, according to an embodiment.

FIG. 3 illustrates a wager module, according to an embodiment.

FIG. 4 illustrates a parlay database, according to an embodiment.

FIG. 5 illustrates a recommendations database, according to an embodiment.

FIG. 6 illustrates an adjustment database, according to an embodiment.

FIGS. 7A-7B illustrate example correlations, according to an embodiment.

FIG. 8 illustrates a system for using data to determine wager odds at a live event, according to an embodiment.

FIG. 9 illustrates a base module, according to an embodiment.

FIG. 10 illustrates an odds calculation module, according to an embodiment.

FIG. 11 illustrates a recommendations database, according to an embodiment.

FIG. 12 illustrates an adjustment database, according to an embodiment.

FIGS. 13A-13B illustrate an example of OCM, according to an embodiment.

FIGS. 14A-14B illustrate an example 2 of OCM, according to an embodiment.

FIG. 15 illustrates a system for odds adjustment using machine learning, according to an embodiment.

FIG. 16 illustrates a base module, according to an embodiment.

FIG. 17 illustrates a machine learning module, according to an embodiment.

FIG. 18 illustrates an odds calculation module, according to an embodiment.

FIG. 19 illustrates a recommendations database, according to an embodiment.

FIG. 20 illustrates an adjustment database, according to an embodiment.

FIG. 21 illustrates a system for parlay wager odds calculation, according to an embodiment.

FIG. 22 illustrates an odds calculation module, according to an embodiment.

FIG. 23 illustrates a wager module, according to an embodiment.

FIG. 24 illustrates a parlay database, according to an embodiment.

FIG. 25 illustrates a recommendations database, according to an embodiment.

FIG. 26 illustrates an adjustment database, according to an embodiment.

FIGS. 27A-27B illustrate correlated data for the historical data, according to an embodiment.

FIG. 28 illustrates an AI parlay module, according to an embodiment.

FIG. 29 illustrates an AI training module, according to an embodiment.

FIG. 30 illustrates a method for odds adjustment using artificial intelligence and machine learning, according to an embodiment.

FIG. 31 illustrates a base module, according to an embodiment.

FIG. 32 illustrates a machine learning module, according to an embodiment.

FIG. 33 illustrates a parameter module, according to an embodiment.

FIG. 34 illustrates an odds calculation module, according to an embodiment.

FIG. 35 illustrates a recommendation fdatabase, according to an embodiment.

FIG. 36 illustrates an adjustment database, according to an embodiment.

FIG. 37 illustrates an MILE database, according to an embodiment.

FIG. 38 illustrates a method for machine learning training for an odds adjustor, according to an embodiment.

FIG. 39 illustrates a base module, according to an embodiment.

FIG. 40 illustrates an odds calculation module, according to an embodiment.

FIG. 41 illustrates a machine learning module, according to an embodiment.

FIG. 42 illustrates a recommendations database, according to an embodiment.

FIG. 43 illustrates an adjustment database, according to an embodiment.

FIG. 44 illustrates a system for adjusting wager odds using an algorithm, according to an embodiment.

FIG. 45 illustrates a base module, according to an embodiment.

FIG. 46 illustrates an odds calculation module, according to an embodiment.

FIG. 47 illustrates a recommendations database, according to an embodiment.

FIG. 48 illustrates an adjustment database, according to an embodiment.

FIG. 49 illustrates an algorithm database, according to an embodiment.

FIG. 50 illustrates a system for adjusting a wager directly from a database using a parameter, according to an embodiment.

FIG. 51 illustrates a base module, according to an embodiment.

FIG. 52 illustrates an odds calculation module, according to an embodiment.

FIG. 53 illustrates a recommendations database, according to an embodiment.

FIG. 54 illustrates an adjustment database, according to an embodiment.

FIG. 55 illustrates a parameter odds database, according to an embodiment.

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention

As used herein, the word exemplary means serving as an example, instance, or illustration. The embodiments described herein are not limiting but rather are exemplary only. It should be understood that the described embodiments are not necessarily to be construed as preferred or advantageous over other embodiments. Moreover, the terms embodiments of the invention, embodiments, or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that specific circuits can perform the various sequence of actions described herein (e.g., application-specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

A “bet” or “wager” is to risk something, usually a sum of money, against someone else's or an entity based on the outcome of a future event, such as the results of a game or event. It may be understood that non-monetary items may be the subject of a “bet” or “wager” as well, such as points or anything else that can be quantified for a “wager” or “bet.” A bettor refers to a person who bets or wagers. A bettor may also be referred to as a user, client, or participant throughout the present invention. A “bet” or “wager” could be made for obtaining or risking a coupon or some enhancements to the sporting event, such as better seats, VIP treatment, etc. A “bet” or “wager” can be made for a certain amount or for a future time. A “bet” or “wager” can be made for being able to answer a question correctly. A “bet” or “wager” can be made within a certain period of time. A “bet” or “wager” can be integrated into the embodiments in a variety of manners.

A “book” or “sportsbook” refers to a physical establishment that accepts bets on the outcome of sporting events. A “book” or “sportsbook” system enables a human working with a computer to interact, according to a set of both implicit and explicit rules, in an electronically powered domain to place bets on the outcome of a sporting event. An added game refers to an event not part of the typical menu of wagering offerings, often posted as an accommodation to patrons. A “book” or “sportsbook” can be integrated into the embodiments in a variety of manners.

To “buy points” means a player pays an additional price (more money) to receive a half-point or more in the player's favor on a point spread game. Buying points means you can move a point spread, for example, up to two points in your favor. “Buy points” can be integrated into the embodiments in a variety of manners.

The “price” refers to the odds or point spread of an event. To “take the price” means betting the underdog and receiving its advantage in the point spread. “Price” can be integrated into the embodiments in a variety of manners.

“No action” means a wager in which no money is lost or won, and the original bet amount is refunded. “No action” can be integrated into the embodiments in a variety of manners.

The “sides” are the two teams or individuals participating in an event: the underdog and the favorite. The term “favorite” refers to the team considered most likely to win an event or game. The “chalk” refers to a favorite, usually a heavy favorite. Bettors who like to bet big favorites are referred to as “chalk eaters” (often a derogatory term). An event or game in which the sportsbook has reduced its betting limits, usually because of weather or the uncertain status of injured players, is referred to as a “circled game.” “Laying the points or price” means betting the favorite by giving up points. The term “dog” or “underdog” refers to the team perceived to be most likely to lose an event or game. A “longshot” also refers to a team perceived to be unlikely to win an event or game. “Sides,” “favorite,” “chalk,” “circled game,” “laying the points price,” “dog,” and “underdog” can be integrated into the embodiments in a variety of manners.

The “money line” refers to the odds expressed in terms of money. With money odds, whenever there is a minus (−), the player “lays” or is “laying” that amount to win (for example, $100); where there is a plus (+), the player wins that amount for every $100 wagered. A “straight bet” refers to an individual wager on a game or event that will be determined by a point spread or money line. The term “straight-up” means winning the game without any regard to the “point spread”; a “money-line” bet. “Money line,” “straight bet,” “straight-up” can be integrated into the embodiments in a variety of manners.

The “line” refers to the current odds or point spread on a particular event or game. The “point spread” refers to the margin of points by which the favored team must win an event to “cover the spread.” To “cover” means winning by more than the “point spread.” A handicap of the “point spread” value is given to the favorite team so bettors can choose sides at equal odds. “Cover the spread” means that a favorite wins an event with the handicap considered, or the underdog wins with additional points. To “push” refers to when the event or game ends with no winner or loser for wagering purposes, a tie for wagering purposes. A “tie” is a wager in which no money is lost or won because the teams' scores were equal to the number of points in the given “point spread.” The “opening line” means the earliest line posted for a particular sporting event or game. The term “pick” or “pick 'em” refers to a game when neither team is favored in an event or game. “Line,” “cover the spread,” “cover,” “tie,” “pick,” and “pick-em” can be integrated into the embodiments in a variety of manners.

To “middle” means to win both sides of a game, wagering on the “underdog” at one point spread and the favorite at a different point spread and winning both sides. For example, if the player bets the underdog +4½ and the favorite −3½ and the favorite wins by 4, the player has middled the book and won both bets. “Middle” can be integrated into the embodiments in a variety of manners.

Digital gaming refers to any type of electronic environment that can be controlled or manipulated by a human user for entertainment purposes. A system that enables a human and a computer to interact according to a set of both implicit and explicit rules in an electronically powered domain for the purpose of recreation or instruction. “eSports” refers to a form of sports competition using video games or a multiplayer video game played competitively for spectators, typically by professional gamers. Digital gaming and “eSports” can be integrated into the embodiments in a variety of manners.

The term event refers to a form of play, sport, contest, or game, especially one played according to rules and decided by skill, strength, or luck. In some embodiments, an event may be football, hockey, basketball, baseball, golf, tennis, soccer, cricket, rugby, MMA, boxing, swimming, skiing, snowboarding, horse racing, car racing, boat racing, cycling, wrestling, Olympic sport, etc. The event can be integrated into the embodiments in a variety of manners.

The “total” is the combined number of runs, points, or goals scored by both teams during the game, including overtime. The “over” refers to a sports bet in which the player wagers that the combined point total of two teams will be more than a specified total. The “under” refers to bets that the total points scored by two teams will be less than a certain figure. “Total,” “over,” and “under” can be integrated into the embodiments in a variety of manners.

A “parlay” is a single bet that links together two or more wagers; to win the bet, the player must win all the wagers in the “parlay.” If the player loses one wager, the player loses the entire bet. However, if he wins all the wagers in the “parlay,” the player wins a higher payoff than if the player had placed the bets separately. A “round robin” is a series of parlays. A “teaser” is a type of parlay in which the point spread or total of each individual play is adjusted. The price of moving the point spread (teasing) is lower payoff odds on winning wagers. “Parlay,” “round-robin,” “teaser” can be integrated into the embodiments in a variety of manners.

A “prop bet” or “proposition bet” means a bet that focuses on the outcome of events within a given game. Props are often offered on marquee games of great interest. These include Sunday and Monday night pro football games, various high-profile college football games, major college bowl games, and playoff and championship games. An example of a prop bet is “Which team will score the first touchdown?” “Prop bet” or “proposition bet” can be integrated into the embodiments in a variety of manners.

A “first-half bet” refers to a bet placed on the score in the first half of the event only and only considers the first half of the game or event. The process in which you go about placing this bet is the same process that you would use to place a full game bet, but as previously mentioned, only the first half is important to a first-half bet type of wager. A “half-time bet” refers to a bet placed on scoring in the second half of a game or event only. “First-half-bet” and “half-time-bet” can be integrated into the embodiments in a variety of manners.

A “futures bet” or “future” refers to the odds that are posted well in advance on the winner of major events. Typical future bets are the Pro Football Championship, Collegiate Football Championship, the Pro Basketball Championship, the Collegiate Basketball Championship, and the Pro Baseball Championship. “Futures bet” or “future” can be integrated into the embodiments in a variety of manners.

The “listed pitchers” is specific to a baseball bet placed only if both of the pitchers are scheduled to start a game start. If they don't, the bet is deemed “no action” and refunded. The “run line” in baseball refers to a spread used instead of the money line. “Listed pitchers” and “no action” and “run line” can be integrated into the embodiments in a variety of manners.

The term “handle” refers to the total amount of bets taken. The term “hold” refers to the percentage of the house wins. The term “juice” refers to the bookmaker's commission, most commonly the 11 to 10 bettors lay on a straight point spread wagers: also known as “vigorish” or “vig.” The “limit” refers to the maximum amount accepted by the house before the odds and/or point spread are changed. “Off the board” refers to a game in which no bets are being accepted. “Handle,” “juice,” vigorish,” “vig,” and “off the board” can be integrated into the embodiments in a variety of manners.

“Casinos” are public rooms or buildings where gambling games are played. “Racino” is a building complex or grounds having a racetrack and gambling facilities for playing slot machines, blackjack, roulette, etc. “Casino” and “Racino” can be integrated into the embodiments in a variety of manners.

Customers are companies, organizations, or individuals that would deploy, for fees, and may be part of, or perform, various system elements or method steps in the embodiments.

Managed service user interface service is a service that can help customers (1) manage third parties, (2) develop the web, (3) do data analytics, (4) connect thru application program interfaces and (4) track and report on player behaviors. A managed service user interface can be integrated into the embodiments in a variety of manners.

Managed service risk management services are a service that assists customers with (1) very important person management, (2) business intelligence, and (3) reporting. These managed service risk management services can be integrated into the embodiments in a variety of manners.

Managed service compliance service is a service that helps customers manage (1) integrity monitoring, (2) play safety, (3) responsible gambling, and (4) customer service assistance. These managed service compliance services can be integrated into the embodiments in a variety of manners.

Managed service pricing and trading service is a service that helps customers with (1) official data feeds, (2) data visualization, and (3) land-based, on-property digital signage. These managed service pricing and trading services can be integrated into the embodiments in a variety of manners.

Managed service and technology platforms are services that help customers with (1) web hosting, (2) IT support, and (3) player account platform support. These managed service and technology platform services can be integrated into the embodiments in a variety of manners.

Managed service and marketing support services are services that help customers (1) acquire and retain clients and users, (2) provide for bonusing options, and (3) develop press release content generation. These managed service and marketing support services can be integrated into the embodiments in a variety of manners.

Payment processing services are those services that help customers that allow for (1) account auditing and (2) withdrawal processing to meet standards for speed and accuracy. Further, these services can provide for the integration of global and local payment methods. These payment processing services can be integrated into the embodiments in a variety of manners.

Engaging promotions allow customers to treat your players to free bets, odds boosts, enhanced access, and flexible cashback to boost lifetime value. Engaging promotions can be integrated into the embodiments in a variety of manners.

“Cash out” or “pay out” or “payout” allow customers to make available, on singles bets or accumulated bets with a partial cash-out where each operator can control payouts by managing commission and availability at all times. The “cash-out” or “payout” or “payout” can be integrated into the embodiments in a variety of manners, including both monetary and non-monetary payouts, such as points, prizes, promotional or discount codes, and the like.

“Customized betting” allows customers to have tailored personalized betting experiences with sophisticated tracking and analysis of players' behavior. “Customized betting” can be integrated into the embodiments in a variety of manners.

Kiosks are devices that offer interactions with customers, clients, and users with a wide range of modular solutions for both retail and online sports gaming. Kiosks can be integrated into the embodiments in a variety of manners.

Business Applications are an integrated suite of tools for customers to manage the everyday activities that drive sales, profit, and growth, from creating and delivering actionable insights on performance to help customers to manage sports gaming. Business Applications can be integrated into the embodiments in a variety of manners.

State-based integration allows for a given sports gambling game to be modified by states in the United States or countries, based upon the state the player is in, based upon mobile phone or other geolocation identification means. State-based integration can be integrated into the embodiments in a variety of manners.

Game Configurator allows for the configuration of customer operators to have the opportunity to apply various chosen or newly created business rules on the game and to parametrize risk management. The game configurator can be integrated into the embodiments in a variety of manners.

“Fantasy sports connectors” are software connectors between method steps or system elements in the embodiments that can integrate fantasy sports. Fantasy sports allow a competition in which participants select imaginary teams from among the players in a league and score points according to the actual performance of their players. For example, if a player in fantasy sports is playing at a given real-time sport, odds could be changed in the real-time sports for that player.

Software as a service (or SaaS) is a software delivery method and licensing in which software is accessed online via a subscription rather than bought and installed on individual computers. Software as a service can be integrated into the embodiments in a variety of manners.

Synchronization of screens means synchronizing bets and results between devices, such as TV and mobile, PC, and wearables. Synchronization of screens can be integrated into the embodiments in a variety of manners.

Automatic content recognition (ACR) is an identification technology to recognize content played on a media device or present in a media file. Devices containing ACR support enable users to quickly obtain additional information about the content they see without user-based input or search efforts. A short media clip (audio, video, or both) is selected to start the recognition. This clip could be selected from within a media file or recorded by a device. Through algorithms such as fingerprinting, information from the actual perceptual content is taken and compared to a reference fingerprint database, each reference fingerprint corresponding to a known recorded work. A database may contain metadata about the work and associated information, including complementary media. If the media clip's fingerprint is matched, the identification software returns the corresponding metadata to the client application. For example, a “fumble” could be recognized during an in-play sports game, and at the time stamp of the event, metadata such as “fumble” could be displayed. Automatic content recognition (ACR) can be integrated into the embodiments in a variety of manners.

Joining social media means connecting an in-play sports game bet or result to a social media connection, such as FACEBOOK® chat interaction. Joining social media can be integrated into the embodiments in a variety of manners.

Augmented reality means a technology that superimposes a computer-generated image on a user's view of the real world, thus providing a composite view. In an example of this invention, a real-time view of the game can be seen, and a “bet,” a computer-generated data point, is placed above the player bet on. Augmented reality can be integrated into the embodiments in a variety of manners.

A betting exchange system is a platform that matches up users who wish to take opposite sides in a bet. Users may “back” or “lay” wagers on the outcome of a sporting event or a portion of the event. Each wager on a betting exchange involves two bets, one backing and one laying. Back betting, or “backing” a selection, is to wager that the outcome will occur. Lay betting, or “laying” a selection, is to wager that the outcome will not occur. Users may then trade those positions up until the point that the wagering market closes and the wagers are paid out. The value of a wager may increase or decrease based as a sporting event progresses. Exchanges allow users to cash out of their position before the market for a wager closes by selling that wager at the current price to another user on the exchange.

Betting exchange systems allow users to wager on what is not going to happen with “lay” wagers. More often than not, users are more likely to win money by betting on what's not going to happen. Take the correct score markets in soccer, for example. Picking the exact score in a game is impossible to do consistently. One might get it right now and then, but it just comes down to luck. There are so many possible options to choose from. There are nine potential score outcomes even if we could rule out either team scoring more than two goals.

Betting exchange systems may allow wagers involving more than two users as exchange betting allows for one lay bet to be backed by multiple users, each backing a portion of the lay bet. Those wagers may be at different odds. For example, a first user may want to back Team A to win for $20. There may be a second user, or users, who want to lay $10 on Team A not to win at 2 to 1 odds. There may also be a third user, or users, who want to lay $10 on Team A not to win at 3 to 1 odds. The first user may back team A to win for $10 at the best available odds, in this case, 2 to 1. If the first user wants to back team A to win for $20, they will need to back ten dollars at 2 to 1 against the second user and back the other ten dollars against the third user at 3 to 1. This combination of wagers is the equivalent backing Team A to win for $20 at 2.5 to 1 odds.

Betting exchange systems do not take on the risk of any given wager as a traditional sportsbook would as the exchange users set the odds. Removing the risk to the wagering platform allows users to get more value out of a wager as they are paying less to the exchange that does not have to take on the risk that a sportsbook must price into each wager. There is no inherent limit to the stakes or odds that a user of a betting exchange can propose. Betting exchange systems derive revenue from wagers differently than traditional sportsbooks. Revenue is based on the volume of wagers and trades on their platform, removing the results of the wager immaterial to the betting exchange system operation. Betting exchange systems do not lay bets themselves but instead rely on users to offer up their wagers, and the betting exchange system's role is to facilitate the exchange of wager terms, trades of wagers, and settlement of wagers.

Betting exchange systems do not tend to limit or ban successful users the way traditional sportsbooks do. Betting exchange systems do not limit or ban successful users because there is no impact to the betting exchange system from a user's success. A successful user needs only to find someone to take the other side of their wager. A betting exchange system benefits from the increased liquidity brought to markets by successful gamblers.

Betting exchange systems are not limited in the wagers they can offer. A traditional sportsbook will only offer wagers on which they have calculated odds to offer. Users of a betting exchange system may create their own markets for any outcome and odds that have at least one user to back and at least one user to lay a given outcome. Users may also be able to wager at a different price than the market price. For example, if a user is confident the price on a team they want to back is going to drift to a bigger price due to team news, they can put a request up and set a higher price than is currently available, and another user may think they are wrong about their estimation and be prepared to match their bet at the bigger price.

Betting exchange systems may present information related to the exchange and potential wagers to back or lay in several different ways. Some betting exchange systems use a standard or grid interface that puts the back and lay options laid out left to right, with the prices getting higher as you move away from the center. The amount of money or action at a given back or lay price is often displayed. Some betting exchange systems offer an option to back all or lay all. This option allows a user to back or lay an outcome at multiple different prices. A user may not need to back all or lay all to wager at multiple prices on a given outcome.

A “ladder” interface is a view in which that the full market depth of a market on a betting exchange system is shown, along with all the values associated with that price (volume already traded, amounts available, etc.). This type of interface enables a user to see where the market has been and helps them evaluate where it might be heading in the short term. Users may define a default “stake” or wager amount that, once defined, will allow the user to place orders immediately with a single click on the back or lay option at the price the user wants to enter the market at. Users may remove their stake in the same fashion if another user has not yet accepted the stake. Ladder interfaces allow users to place a large number of trades in a short time. This trading volume allows users to win, not only if their selection is successful but by hedging their position across all possible outcomes. Each tick (price increment) on the ladder would display to the user their financial position if they closed at this point. Some betting exchange systems show a graphical representation of where the selection has been matched. Some show the user where they are in the queue of contracts to be met. Third-party software providers receive data from the betting exchange system through an API to allow users to customize their interface and functionality. These third-party software programs may also allow users to incorporate additional data feeds, such as a news feed related to the live sporting event, into the user's wagering interface.

A betting exchange system offers users multiple ways to win. Users may be able to use automated bots to manage their betting activity. Users who lack the expertise to create bots may set up betting triggers that automate certain betting behaviors when specific market prices are met. Users may engage in “position trading” in which bets may be placed with the intent to sell them off, seeking to find opportunities in market swings. Betting exchanges allow users many “hedging” options that may incorporate one or more of these strategies to mitigate risk. Liquidity in betting exchange systems may be limited by regulations that restrict participants in an exchange bet. Therefore, a betting exchange system should take steps to maximize the amount of liquidity on their platform to ensure the most markets are available.

A betting exchange system relies on liquidity to ensure market availability. Markets will only be available if there is someone to both back and lay that market. There will be fewer markets available on a betting exchange if fewer people offer odds, and fewer people offer odds if fewer people accept them. If the people are not offering odds and there is no traditional bookmaker to do it, their markets cannot be created, and wagers cannot be placed.

A machine learning betting system is a system that incorporates machine learning into at least one step in the odds makings, market creation, user interface, or personalization of a sports wagering platform. Machine learning leverages artificial intelligence to allow a computer algorithm to improve itself automatically over time without being explicitly programmed. Machine learning and AI are often discussed together, and the terms are sometimes used interchangeably, but they don't mean the same thing. An important distinction is that although all machine learning is AI, not all AI is machine learning. Machine learning algorithms can develop their framework for analyzing a data set through experience in using that data. Machine learning helps create models that can process and analyze large amounts of complex data to deliver accurate results. Machine learning uses models or mathematical representations of real-world processes. It achieves this through examining features, measurable properties, and parameters of a data set. It may utilize a feature vector, or a set of multiple numeric features, as a training input for prediction purposes. An algorithm takes a set of data known as “training data” as input. The learning algorithm finds patterns in the input data and trains the model for expected results (target). The output of the training process is the machine learning model. A model may then make a prediction when fed input data. The value that the machine learning model has to predict is called the target or label. When excessively large amounts of data are fed to a machine learning algorithm, it may experience overfitting, a situation in which the algorithm learns from noise and inaccurate data entries. Overfitting may result in data being labeled incorrectly or in predictions being inaccurate. An algorithm may experience underfitting when it fails to decipher the underlying trend in the input data set as it does not fit the data well enough.

A machine learning betting system will measure error once the model is trained. New data will be fed to the model, and the outcome will be checked and categorized into one of four types of results: true positive, true negative false positive, and false negative. A true positive result is when the model predicts a condition when the condition is present. A true negative result is when the model does not predict a condition when it is absent. A false-positive result is when the model predicts a condition when it is absent. A false negative is when the model does not predict a condition when it is absent. The sum of false positives and false negatives is the total error in the model. While an algorithm or hypothesis can fit well to a training set, it might fail when applied to another data set outside the training set. It must therefore be determined if the algorithm is fit for new data. Testing it with a set of new data is the way to judge this. Generalization refers to how well the model predicts outcomes for a new set of data. Noise must also be managed and data parameters tested. A machine learning betting system may go through several cycles of training, validation, and testing until the error in the model is brought within an acceptable range.

A machine learning betting system may use one or more types of machine learning. Supervised machine learning algorithms can use data that has already been analyzed, by a person or another algorithm, to classify new data. Analyzing a known training dataset allows a supervised machine learning algorithm to produce an inferred function to predict output values in the new data. As input data is fed into the model, it changes the weighting of characteristics until the model is fitted appropriately. This supervised learning is part of a process to ensure that the model avoids overfitting or underfitting called cross-validation. Supervised learning helps organizations solve various real-world problems at scale, such as classifying spam in a separate email folder.

Supervised machine learning algorithms are adept at dividing data into two categories, or binary classification, choosing between more than two types of answers, or multi-class classification, predicting continuous values, or regression modeling, or combining the predictions of multiple machine learning models to produce an accurate prediction, also known as ensembling. Some methods used in supervised learning include neural networks, naïve Bayes, linear regression, logistic regression, random forest, support vector machine (SVM), and more. A supervised machine learning betting system may be provided a dataset of historical sporting events, the odds of various outcomes of those sporting events, and the action waged on those outcomes, and use that data to predict the action on future outcomes by identifying similar historical outcomes. A machine learning betting system may utilize recommendation algorithms to learn user preferences are for teams, players, sports, wagers, etc.

Unsupervised machine learning analyzes and clusters data that has not been analyzed yet to discover hidden patterns or groupings within the data without the need for a human to define what the patterns or groupings should look like. The ability of unsupervised machine learning algorithms to discover similarities and differences in information makes it the ideal solution for exploratory data analysis, cross-selling strategies, customer segmentation, image, and pattern recognition. Most types of deep learning, including neural networks, are unsupervised algorithms.

Unsupervised machine learning may be utilized in dimensionality reduction or the process of reducing the number of random variables under consideration by identifying a set of principal variables. Unsupervised machine learning may split datasets into groups based on similarity, also known as clustering. It may also engage in anomaly detection by identifying unusual data points in a data set. It may also identify items in a data set that frequently occur together, also known as association mining. Principal component analysis and singular value decomposition are two methods of dimensionality reduction that may be employed. Other algorithms used in unsupervised learning include neural networks, k-means clustering, probabilistic clustering methods, and more.

A machine learning betting system may fall between a supervised machine learning algorithm and an unsupervised one. In these systems, an algorithm used training on a smaller labeled dataset to identify features and classify a larger, unlabeled dataset. These types of algorithms perform better when provided with labeled data sets. However, labeling can be time-consuming and expensive, which is where unsupervised learning can provide efficiency benefits. For example, a sportsbook may identify a cohort of users in a dataset who exhibit desirable behavior. A semi-supervised machine learning betting system may use that to identify other users in the cohort who are desirable.

Reinforcement learning is when data scientists teach a machine learning algorithm to complete a multi-step process with clearly defined rules. The algorithm is programmed to complete a task and is given positive and negative feedback or cues as it works out how to complete the task it has been given. The prescribed set of rules for accomplishing a distinct goal will allow the algorithm will learn and decide which steps to take along the way. This combination of rules along with positive and negative feedback would allow a reinforcement learning machine learning betting system to optimize the task over time. A machine learning betting system may utilize reinforcement learning to identify potential cheaters by recognizing a series of behaviors associated with undesirable player conduct, cheating, or fraud.

Some embodiments of this disclosure, illustrating all its features, will now be discussed in detail. It can be understood that the embodiments are intended to be open-ended in that an item or items used in the embodiments is not meant to be an exhaustive listing of such items or items or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

FIG. 1 is a system for parlay wager odds calculation. This system may include a live event 102, for example, a sporting event such as a football, basketball, baseball, or hockey game, tennis match, golf tournament, eSports or digital game, etc. The live event 102 may include some number of actions or plays upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 102, such as the score of an American football game or the run line in a baseball game, or a series of actions in the live event 102. Sportsbooks have several bets they can handle, which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers, which can be done at kiosks at the live event 102 or at another location.

Further, embodiments may include a plurality of sensors 104 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 104 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 106 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 106 may be communicatively coupled to a peer-to-peer wagering network 114, which may perform real-time analysis on the type of play and the result of the play. The cloud 106 may also be synchronized with game situational data such as the time of the game, the score, location on the field, weather conditions, and the like, which may affect the choice of play utilized. For example, in an exemplary embodiment, the cloud 106 may not receive data gathered from the sensors 104 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 108 such as a computing device, laptop, smartphone, tablet, computer, smart speaker, or I/O devices. I/O devices may be present in the computing device. Input devices may include but are not limited to keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide-semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include but are not limited to video displays, graphical displays, speakers, headphones, inkjet printers, laser printers, or 3D printers. Devices may include but are not limited to a combination of multiple input or output devices such as Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs, including, but not limited to, Microsoft KINECT, SIRI for iPhone by Apple, Google Now, or Google Voice Search. Additional user devices have both input and output capabilities, including, but not limited to, haptic feedback devices, touchscreen displays, or multi-touch displays. Touchscreen, multi-touch displays, touchpads, touch mice, or other touch sensing devices may use different technologies to sense touch, including but not limited to capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 108 could be an optional component and would be utilized in a situation where a paired wearable device employs the mobile device 108 for additional memory or computing power or connection to the internet.

Further, embodiments may include a wagering software application or a wagering app 110, which is a program that enables the user to place bets on individual plays in the live event 102, streams audio and video from the live event 102, and features the available wagers from the live event 102 on the mobile device 108. The wagering app 110 allows users to interact with the wagering network 114 to place bets and provide payment/receive funds based on wager outcomes.

Further, embodiments may include a mobile device database 112 that may store some or all the user's data, the live event 102, or the user's interaction with the wagering network 114.

Further, embodiments may include the wagering network 114, which may perform real-time analysis on the type of play and the result of a play or action. The wagering network 114 (or the cloud 106) may also be synchronized with game situational data, such as the time of the game, the score, location on the field, weather conditions, and the like, which may affect the choice of play utilized. For example, in an exemplary embodiment, the wagering network 114 may not receive data gathered from the sensors 104 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 114 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 116, which may contain data relevant to all users of the wagering network 114 and may include, but is not limited to, a user ID, a device identifier, a paired device identifier, wagering history, or wallet information for the user. The user database 116 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 116 may contain betting lines and search queries. The user database 116 may be searched based on a search criterion received from the user. Each betting line may include, but is not limited to, a plurality of betting attributes such as at least one of the live event 102, a team, a player, an amount of wager, etc. The user database 116 may include but is not limited to information related to all the users involved in the live event 102. In one exemplary embodiment, the user database 116 may include information for generating a user authenticity report and a wagering verification report. Further, the user database 116 may be used to store user statistics like, but not limited to, the retention period for a particular user, frequency of wagers placed by a particular user, the average amount of wager placed by each user, etc.

Further, embodiments may include a historical plays database 118 that may contain play data for the type of sport being played in the live event 102. For example, in American Football, for optimal odds calculation, the historical play data may include metadata about the historical plays, such as time, location, weather, previous plays, opponent, physiological data, etc.

Further, embodiments may utilize an odds database 120—that contains the odds calculated by an odds calculation module 122—to display the odds on the user's mobile device 108 and take bets from the user through the mobile device wagering app 110.

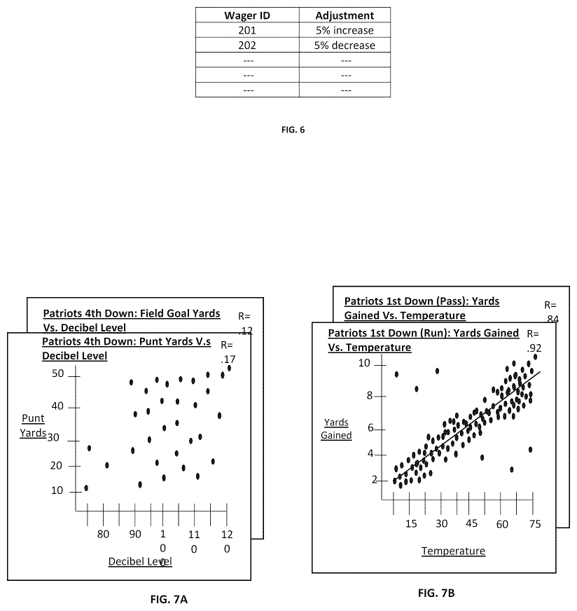

Further, embodiments may include the odds calculation module 122, which utilizes historical play data to calculate odds for in-play wagers. For example, the odds calculation module 122 may be continuously polling for the data from the live event 102. The odds calculation module 122 may receive the data from the live event 102. The odds calculation module 122 may store the results data, or the results of the last action, in the historical play database 118, which may contain historical data of all previous actions. The odds calculation module 122 filters the historical play database 118 on the team and down from the situational data. The first parameter of the historical plays database 118 is selected, for example, the event. Then the odds calculation module 122 performs correlations on the data. For example, the historical action database 130 is filtered on the team, the players, the quarter, the down, and the distance to be gained. The first parameter is selected, which in this example is the event, which may either be a pass or a run, and the historical action database 130 is filtered on the event being a pass. Then, correlations are performed on the rest of the parameters, which are yards gained, temperature, decibel level, etc. In FIG. 7B, the graph shows the correlated data for the historical data involving the Patriots in the second quarter on second down with five yards to go and the action being a pass, which has a correlation coefficient of 0.81. The correlations are also performed with the same filters and the next event, which is the action being a run which is also shown in FIG. 7B and has a correlation coefficient of 0.79. It is determined if the correlation coefficient is above a predetermined threshold, for example, 0.75, in order to determine if the data is highly correlated and deemed a relevant correlation. If the correlation is deemed highly relevant, then the correlation coefficient is extracted from the date. For example, the two correlation coefficients of 0.81 for a pass and 0.79 for a run are both extracted. If it is determined that the correlations are not highly relevant, then then it is determined if any parameters are remaining. Also, if the correlations were determined to be highly relevant, it is also determined if any parameters are remaining to perform correlations on. If there are additional parameters to have correlations performed, then the odds calculation module 122 selects the next parameter in the historic action database and returns to performing correlations on the data. Once there are no remaining parameters to perform correlations on, the odds calculation module 122 determines the difference between each of the extracted correlations. For example, the correlation coefficient for a pass is 0.81, and the correlation coefficient for a run is 0.79. The difference between the two correlation coefficients (0.81-0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendations database 128 to compare the two correlation coefficient based on statistical significance as opposed to the difference of the two correlation coefficients. The difference between the two correlation coefficients, 0.02, is then compared to the recommendations database 128. The recommendations database 128 contains various ranges of differences in correlations as well as the corresponding odds adjustment for those ranges. For example, the 0.02 difference of the two correlation coefficients falls into the range +0-2 difference in correlations which, according to the recommendations database 128, should have an odds adjustment of 5% increase. The odds calculation module 122 then extracts the odds adjustment from the recommendations database 128. The extracted odds adjustment is stored in an adjustment database 130. The odds calculation module 122 compares the odds database 120 to the adjustment database 130. It is determined whether or not there is a match in any of the wager IDs in the odds database 120 and the adjustment database 130. For example, the odds database 120 contains a list of all the current bet options for a user. The odds database 120 contains a wager ID, event, time, quarter, wager, and odds for each bet option. The adjustment database 130 contains the wager ID and the percentage, either as an increase or decrease, that the odds should be adjusted. If there is a match between the odds database 120 and the adjustment database 130, then the odds in the odds database 120 are adjusted by the percentage increase or decrease in the adjustment database 130, and the odds in the odds database 120 are updated. For example, if the odds in the odds database 120 are −105 and the matched wager ID in the adjustment database 130 is a 5% increase, then the updated odds in the odds database 120 should be −110. If there is a match, the odds are adjusted based on the data stored in the adjustment database 130 and the new data stored in the odds database 120 over the old entry. If there are no matches, or once the odds database 120 has been adjusted if there are matches, the odds calculation module 122 offers the odds database 120 to the wagering app 110, allowing users to place bets on the wagers stored in the odds database 120. In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 122. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1−b2/Sb1−b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 122 may then extract an odds adjustment from the recommendations database. The extracted odds adjustment is then stored in the adjustment database 130. In some embodiments, the recommendations database may be used in the odds calculation module 122 to determine how the wager odds should be adjusted depending on the difference between the correlation coefficients of the correlated data points. The recommendations database 128 may contain the difference in correlations and the odds adjustment. For example, in FIG. 3B there is a correlation coefficient for a Patriots 2nd down pass of 0.81 and a correlation coefficient for a Patriots 2nd run of 0.79, the difference between the two would be +0.02 when compared to the recommendations database 128 the odds adjustment would be a 5% increase for a Patriots pass or otherwise identified as wager 201 in the adjustment database. In some embodiments, the difference in correlations may be the statistical significance of comparing the two correlation coefficients in order to determine how the odds should be adjusted. In some embodiments, the adjustment database 130 may be used to adjust the wager odds of the odds database 120 if it is determined that a wager should be adjusted. The adjustment database 130 contains the wager ID, which is used to match with the odds database 120 to adjust the odds of the correct wager.

Further, embodiments may include a wager module 124, which may determine the odds of each next possible event of the live event 102. Then, the wager module 124 may prompt the odds calculation module 122 to calculate the odds of each outcome of those next possible events. The wager module 124 may offer users to place a parlay wager, which is a wager on multiple outcomes, the odds of which may be more favorable than betting on each outcome separately.

Further, embodiments may include a parlay database 126, which may contain the odds for the outcomes of possible future events.

Further, embodiments may include a recommendations database 128 that may be used by the odds calculation module 124 to determine how the wager odds should be adjusted depending on the difference between the correlation coefficients of the correlated data points. The recommendations database 128 may contain the difference in correlations and the odds adjustment. For example, if there is a correlation coefficient for a Red Sox second inning with a runner on base with one out and a stolen base of 0.81 and a correlation coefficient for a Red Sox second inning with a runner on base with one out and the runner caught stealing of 0.79, the difference between the two would be +0.02 when compared to the recommendations database 128 the odds adjustment would be a 5% increase for a Red Sox stolen base or otherwise identified as wager 201 in the adjustment database 130. In some embodiments, the difference in correlations may be the statistical significance of comparing the two correlation coefficients in order to determine how the odds should be adjusted.

Further, embodiments may include an adjustment database 130 that may be used to adjust the wager odds of the odds database 120 if it is determined that a wager should be adjusted. The adjustment database 130 contains the wager ID, which is used to match with the odds database 120 to adjust the odds of the correct wager.

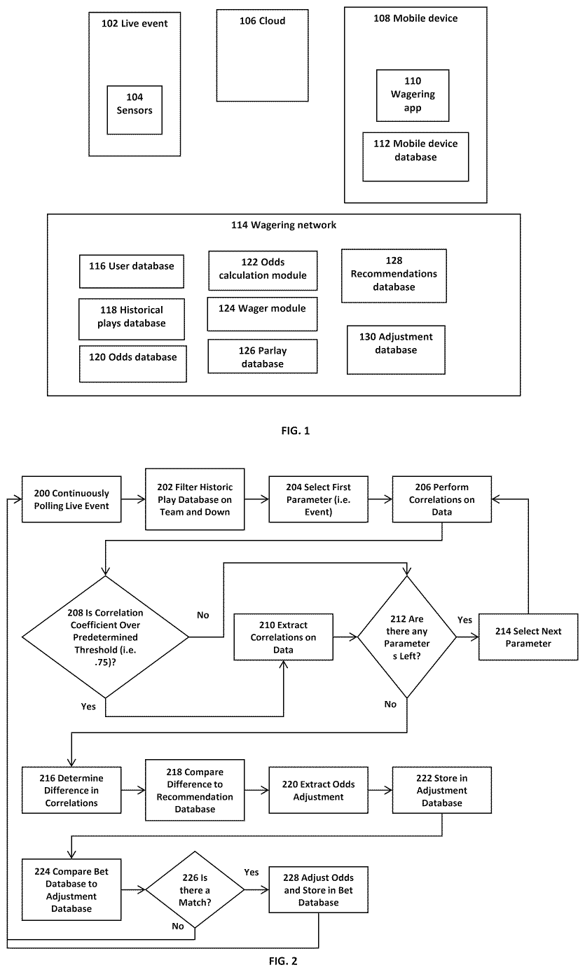

FIG. 2 illustrates the odds calculation module 122. The process may begin with the odds calculation module 124 continuously polling for the data from the live event 102 at step 200. In some embodiments, the odds calculation module 124 may receive the data from the live event 102. In some embodiments, the odds calculation module 124 may store the results data, or the results of the last action, in the historical play database 118, which may contain historical data of all previous actions. The odds calculation module 124 filters, at step 202, the historical play database 118 on the live event 102 status, such as team on offense, down and distance, position on the field, etc., from the situational data. The odds calculation module 124 selects, at step 204, the first parameter of the historical plays database 118, for example, the event. Then the odds calculation module 124 performs, at step 206, correlations on the data. For example, the historical play database 118 is filtered on the team, the players, the inning, and the number of outs. The first parameter is selected, which in this example is the event, which may be a stolen base, and the historical play database 118 is filtered on the event being a stolen base. Then, correlations are performed on the rest of the parameters, which are how far away the baserunner is from first base, how far away is the first baseman from first base, and how far away is the second baseman from second base, etc. In an example of correlated data, the correlated data for the historical data involving the Red Sox in the second inning with one out recorded and the action being a stolen base, which has a correlation coefficient of 0.81. The correlations are also performed with the same filters, and the next event, which is the action being the runner is caught stealing, has a correlation coefficient of 0.79. Then the odds calculation module 124 determines, at step 208, if the correlation coefficient is above a predetermined threshold, for example, 0.75, in order to determine if the data is highly correlated and deemed a relevant correlation. If the correlation is deemed highly relevant, then the odds calculation module 124 extracts, at step 210, the correlation coefficient from the data. For example, the two correlation coefficients of 0.81 for a stolen base and 0.79 for a runner caught stealing are both extracted. If it is determined that the correlations are not highly relevant, then the odds calculation module 124 determines, at step 212, if any parameters are remaining. Also, if the correlations were determined to be highly relevant and therefore extracted, it is also determined if any parameters are remaining to perform correlations on. If there are additional parameters to have correlations performed, then the odds calculation module 124 selects, at step 214, the next parameter in the historical plays database 118, and the process returns to performing correlations on the data. Once there are no remaining parameters to perform correlations on, the odds calculation module 124 then determines, at step 216, the difference between each of the extracted correlations. For example, the correlation coefficient for a stolen base is 0.81, and the correlation coefficient for a runner caught stealing is 0.79. The difference between the two correlation coefficients (0.81−0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendations database 128 to compare the two correlation coefficient based on statistical significance as opposed to the difference of the two correlation coefficients. Then the odds calculation module compares, at step 218, the difference between the two correlation coefficients, for example, 0.02, to the recommendations database 128. The recommendations database 128 contains various ranges of differences in correlations as well as the corresponding odds adjustment for those ranges. For example, the 0.02 difference of the two correlation coefficients falls into the range +0-2 difference in correlations which, according to the recommendations database 128, should have an odds adjustment of 5% increase. The odds calculation module 124 then extracts, at step 320, the odds adjustment from the recommendations database 128. The odds calculation module 124 then stores, at step 222, the extracted odds adjustment in the adjustment database 130. The odds calculation module 124 compares, at step 224, the odds database 120 to the adjustment database 130. The odds calculation module 124 then determines, at step 226, whether or not there is a match in any of the wager IDs in the odds database 120 and the adjustment database 130. For example, the odds database 120 contains a list of all the current bet options for a user. The odds database 120 contains a wager ID, event, time, inning, wager, and odds for each bet option. The adjustment database 130 contains the wager ID and the percentage, either as an increase or decrease, that the odds should be adjusted. If it is determined there is a match between the odds database 120 and the adjustment database 130, then the odds calculation module 124 adjust, at step 228, the odds in the odds database 120 by the percentage increase or decrease in the adjustment database 130 and the odds in the odds database 120 are updated. For example, if the odds in the odds database 120 are −105 and the matched wager ID in the adjustment database 130 is a 5% increase, then the updated odds in the odds database 120 should be −110. If there is a match, the odds are adjusted based on the data stored in the adjustment database 130 and the new data stored in the odds database 120 over the old entry. If there are no matches, or once the odds database 120 has been adjusted if there are matches, the odds calculation module 124 returns to step 200. In some embodiments, the odds calculation module 124 may offer the odds database 120 to the wagering app 110, allowing users to place bets on the wagers stored in the odds database 120. In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 124. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1−b2/Sb1−b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 124 may then extract an odds adjustment from the recommendations database 128. The extracted odds adjustment is then stored in the adjustment database 130. In some embodiments, the recommendations database 128 may be used in the odds calculation module 124 to determine how the wager odds should be adjusted depending on the difference between the correlation coefficients of the correlated data points. The recommendations database 128 may contain the difference in correlations and the odds adjustment. For example, if there is a correlation coefficient for a Red Sox second inning with a runner on base with one out and a stolen base of 0.81 and a correlation coefficient for a Red Sox second inning with a runner on base with one out and the runner caught stealing of 0.79, the difference between the two would be +0.02 when compared to the recommendations database 128 the odds adjustment would be a 5% increase for a Red Sox stolen base or otherwise identified as wager 201 in the adjustment database 130. In some embodiments, the difference in correlations may be the statistical significance of comparing the two correlation coefficients in order to determine how the odds should be adjusted. In some embodiments, the adjustment database 130 may be used to adjust the wager odds of the odds database 120 if it is determined that a wager should be adjusted. The adjustment database 130 contains the wager ID, which is used to match with the odds database 120 to adjust the odds of the correct wager. Odds from the odds database 120 may be provided as starting indicators of odds movement on a betting exchange system.

FIG. 3 illustrates the wager module 124. The process begins with the wagering module 124 continuously polling for a user wager selection at step 300. When a user selects a wager, the odds database 120 may be queried at step 302 for the most likely outcomes of the wager. For example, a user may wager $10 at +150 odds that the Patriots will pass on 1st down and 10 from their 30-yard line. The odds database 120 may indicate there is a 30% chance of an incomplete pass, a 10% chance of a short completed pass, a 10% chance of a run for no gain, a 10% chance of a short run, a 10% chance of a pass for 10-20 yards. In this example, the three most likely outcomes of the current play are examined, but more outcomes may be examined. The threshold for the number of outcomes to be examined may be static and defined by an administrator. It may also be based on the likelihood of the potential outcomes, for example, selecting all outcomes with a greater than 10% chance of being true. In other embodiments, the number of potential outcomes to examine may be dynamically determined by an algorithm. The parameters of the live event 102 after the retrieved likely outcomes may be identified at step 304. The odds database 120 may indicate that there is a 40% chance the next play will be 2nd down and 10 from the same 30-yard line, based on the combination of an incomplete pass probability (30%) and the run for no gain probability (10%), as both of those outcomes result in the same parameters of the live event 102. It is also determined that there is a 20% chance the next play will be 2nd down and between 3 and 7, and a 10% chance it will be 1st and 10 between the 40-yard line and midfield. The odds calculation module 122 may be prompted, at step 306, to determine the odds that could be offered on one or more outcomes for the live event 102 in the identified parameters. For example, the odds calculation module 122 may calculate −150 odds the Patriots will pass on 2nd down and 10 from their 40-yard line. The odds calculated may be written to the parlay database 126, at step 308. Odds from the parlay database 126 may be provided as starting indicators of odds movement on a betting exchange system. It may then be determined, at step 310, if there are more outcomes to test. For example, the second and third most likely situations in the live event 102. If more outcomes are to be tested, the process returns to step 306. A parlay is a single bet that links together two or more individual wagers for a high payout. A two-wager parlay might pay 13/5 (+260), a three-wager parlay might pay 6/1 (+600), a four-wager parlay might pay 10/1(+1000), and so forth, with the payouts getting higher with more wagers or totals selected. Once the odds calculation module 122 has calculated the odds on at least one outcome of the potential future state of the live event 102, the odds of parlaying that wager with the original wager selected by the user may be calculated at step 312. The wager module 124 may present, at step 314, one or more parlay wager options and odds to the user. For example, the user's current wager is for the Patriots to pass at +150. The odds of the Patriots passing on 2nd and 10 (the most likely future state of the live event 102 with a 40% probability of occurring) are −150. Those two wagers may be combined into a single parlay with odds of +317. This combination of the two individual wager odds, plus the extra payout for a parlay. Sportsbooks may vary the amount of extra payout given on a parlay. In one embodiment, the amount of extra payout offered on a parlay may be customized to the user based on their likely response to the offer. In one embodiment, the odds of an outcome on the next play may be blended across multiple potential outcomes of the current play. For example, the odds for the Patriots to pass on the next play may be 60% if it is 2nd and 10, 37% if it is 2nd and 3-7, and 40% if it is 1st and 10. The odds of those situations being 40%, 20%, and 10%, respectively. The other 30% of possible next states of the game may have odds of a pass that are too difficult or not significant enough to calculate individually. These states may be given a general or default value for the likelihood of a pass, for example, the average percentage of times the Patriots pass overall, which in 2019 was about 58%. Then the total odds of the next play being a pass are 60%×40% plus 37%×20% plus 40%×10% plus 58%×30% which is equal to 52.8%. The combined odds of the current play resulting pass and the next play being a pass are 60%×52.8%, equal to 31.68% or about +214. Parlay wagers generally pay a premium over betting and winning the constituent wagers, so actual odds offered to the user may be adjusted up to, for example, +215 or +220 to make the parlay wager more enticing to users. This calculation may be used to calculate the odds for parlay wagers made from more than two wagers. The three odds of the same event happening could be blended and weighted based on the likelihood of each situation and the likelihood of a pass in that situation. For example, a parlay wager option may be that the three next plays are all passes or that over the next 4 downs, there will never be an interception. The wager module 124 may use machine learning or AI to optimize profit, revenue, user engagement, new user recruitment, etc., by selecting which parlay options are shown to the user and how the odds of those parlay options are adjusted. The wager module 124 may receive, at step 316, a parley selection from the user. The wager module 124 may monitor, at step 318, the live event 102 for the outcome of the events wagered on. This may require the wager module 124 to continue to monitor multiple events until all events wagered on by one parlay wager are concluded or until at least one outcome would cause the user to lose the wager. The wager module 124 may compare, at step 320, the outcome of an event wagered on to the wager. For example, a wager is placed by a user that the next play would be a run. The outcome of the next play is a pass. Therefore the wager is lost. The wager module 124 may adjust, at step 322, the account balance of the user based on whether the wager was won or lost. The wager module 124 may then return to step 300.

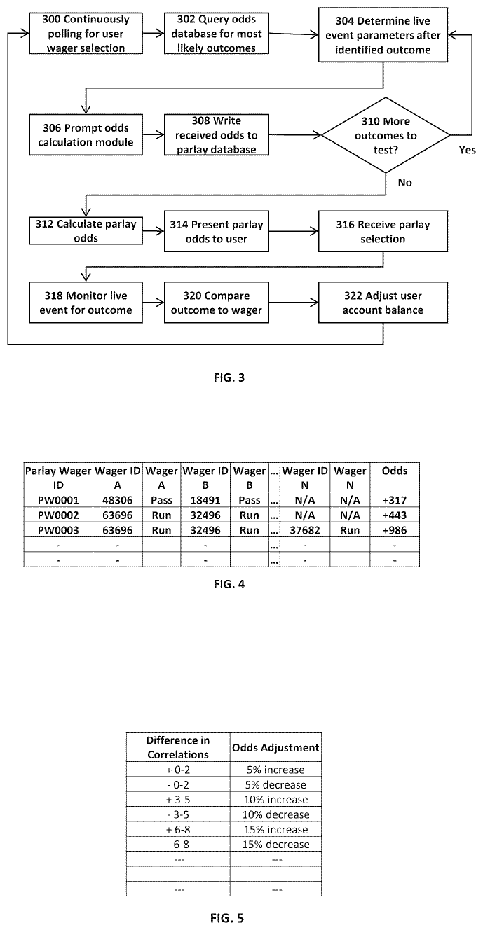

FIG. 4 provides an illustration of the parlay database 126 that may contain parlay wagers and odds. Each parlay wager is made of two or more wagers. The details of these wagers may be stored in the parlay database 126 or another database such as a wager database or bet database. The parlay database 126 may contain wager IDs for these wagers such that they can be referenced if they are stored in a separate database.

FIG. 5 provides an illustration of the recommendations database 128 that may be used in the odds calculation module 124 to determine how the wager odds should be adjusted depending on the difference between the correlation coefficients of the correlated data points. The recommendations database 128 may contain the difference in correlations and the odds adjustment. For example, if there is a correlation coefficient for a Red Sox second inning with a runner on base with one out and a stolen base of 0.81 and a correlation coefficient for a Red Sox second inning with a runner on base with one out and the runner caught stealing of 0.79, the difference between the two would be +0.02 when compared to the recommendations database 128 the odds adjustment would be a 5% increase for a Red Sox stolen base or otherwise identified as wager 201 in the adjustment database 130. In some embodiments, the difference in correlations may be the statistical significance of comparing the two correlation coefficients in order to determine how the odds should be adjusted.

FIG. 6 provides an illustration of the adjustment database 130 that may be used to adjust the wager odds of the odds database 120 if it is determined that a wager should be adjusted. The adjustment database 130 contains the wager ID, which is used to match with the odds database 120 to adjust the odds of the correct wager.

FIG. 7A provides an illustration for another example of the odds calculation module 122 and the resulting correlations. In FIG. 7A, the data that is filtered by the team, down and quarter and finding the various correlations with the team, down and quarter and the various parameters such as the decibel level in the stadium, punt yardage, field goal yardage, etc. An example of non-correlated parameters with the team, down, and quarter and the decibel level in the stadium and punt yardage with a 17% (which is below the 75% threshold), therefore there is no correlation and the next parameters should be correlated, unless there are no more parameters remaining.

FIG. 7B provides an illustration for another example of the odds calculation module 122 and the resulting correlations. In FIG. 7B, the data that is filtered by the team, down and quarter and finding the various correlations with the team, down and quarter and the various parameters such as the event, temperature, yards gained, etc. An example of correlated parameters is with the event being a run and the team, down, and quarter with a 92%, therefore there is a correlation (since it is above the 75% threshold). The correlation coefficient needs to be extracted and compared with the other extracted correlation coefficient, which in this example is the event data where the event is a pass, which is correlated at 84%. The difference between the two correlations is compared to the recommendations database to determine if there is a need to adjust the odds. In this example, there is a 0.08 difference between the event being a run and the event being a pass, which means on first down in the first quarter the New England Patriots are more likely to throw a run than to pass the ball, and the odds are adjusted 15% decrease in order to match the correlated data. Conversely, if the correlated data of run, 0.84, is compared to the correlated data of a pass, 0.92, the difference would be −0.08, and the odds would be adjusted by a 15% increase.

Another embodiment may relate to a method of using combined parameters to determine wager odds at a live event.

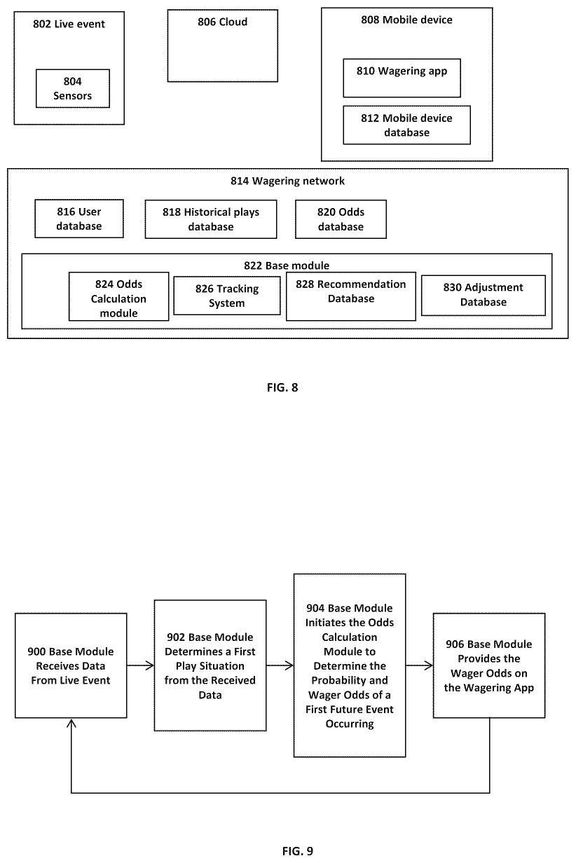

FIG. 8 is a system for using data to determine wager odds at a live event. This method comprises a live event 802, such as a sporting event such as a football, basketball, baseball, or hockey game, tennis match, golf tournament, eSports or digital game, etc. The live event 802 may include some number of actions or plays upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 802, such as the score of an American football game or the run line in a baseball game, or a series of actions in the live event 802. Sportsbooks have several bets they can handle, which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers, which can be done at kiosks at the live event 802 or at another location.

Further, embodiments may include a plurality of sensors 804 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 804 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball. In some embodiments, telemetry data that an array of anchors may receive from one or more tracking devices which may include positional telemetry data. The positional telemetry data provides location data for a respective tracking device, which describes the location of the tracking device within a spatial region. In some embodiments, this positional telemetry data is provided as one or more Cartesian coordinates (e.g., an X coordinate, a Y coordinate, and/or Z a coordinate) that describe the position of each respective tracking device. However, any coordinate system (e.g., polar coordinates, etc.) that describes the position of each respective tracking device is used in alternative embodiments. The telemetry data received by the array of anchors from the one or more tracking devices includes kinetic telemetry data. The kinetic telemetry data provides data related to various kinematics of the respective tracking device. In some embodiments, this kinetic telemetry data is provided as a velocity of the respective tracking device, an acceleration of the respective tracking device, and/or a jerk of the respective tracking device. Further, in some embodiments, one or more of the above values is determined from an accelerometer of the respective tracking device and/or derived from the positional telemetry data of the respective tracking device. Further, in some embodiments, the telemetry data that is received by the array of anchors from the one or more tracking devices includes biometric telemetry data. The biometric telemetry data provides biometric information related to each subject associated with the respective tracking device. In some embodiments, this biometric information includes a heart rate of the subject, temperature, for example, a skin temperature, a temporal temperature, etc. In some embodiments, the array of anchors communicates the above-described telemetry data, for example, positional telemetry, kinetic telemetry, and/or biometric telemetry, to a telemetry parsing system. Accordingly, in some embodiments, the telemetry parsing system communicates the telemetry data to an odds calculation module 824. In some embodiments, an array of anchor devices may receive telemetry data from one or more tracking devices. In order to minimize error in receiving the telemetry from one or more tracking devices, the array of anchor devices preferably includes at least three anchor devices. The inclusion of at least three anchor devices within the array of anchor devices allows for each ping, for example, telemetry data received from a respective tracking device, to be triangulated using the combined data from the at least three anchors that receive the respective ping.

Further, embodiments may include a cloud 806 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 806 may be communicatively coupled to a peer-to-peer wagering network 814, which may perform real-time analysis on the type of play and the result of the play. The cloud 806 may also be synchronized with game situational data such as the time of the game, the score, location on the field, weather conditions, and the like, which may affect the choice of play utilized. For example, in an exemplary embodiment, the cloud 806 may not receive data gathered from the sensors 804 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 808 such as a computing device, laptop, smartphone, tablet, computer, smart speaker, or I/O devices. I/O devices may be present in the computing device. Input devices may include but are not limited to keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide-semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include but are not limited to video displays, graphical displays, speakers, headphones, inkjet printers, laser printers, or 3D printers. Devices may include but are not limited to a combination of multiple input or output devices such as Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs, including, but not limited to, Microsoft KINECT, SIRI for iPhone by Apple, Google Now, or Google Voice Search. Additional user devices have both input and output capabilities, including, but not limited to, haptic feedback devices, touchscreen displays, or multi-touch displays. Touchscreen, multi-touch displays, touchpads, touch mice, or other touch sensing devices may use different technologies to sense touch, including but not limited to capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 808 could be an optional component and would be utilized in a situation where a paired wearable device employs the mobile device 808 for additional memory or computing power or connection to the internet.

Further, embodiments may include a wagering software application or a wagering app 810, which is a program that enables the user to place bets on individual plays in the live event 802, streams audio and video from the live event 802, and features the available wagers from the live event 802 on the mobile device 808. The wagering app 810 allows users to interact with the wagering network 814 to place bets and provide payment/receive funds based on wager outcomes.

Further, embodiments may include a mobile device database 812 that may store some or all the user's data, the live event 802, or the user's interaction with the wagering network 814.

Further, embodiments may include the wagering network 814, which may perform real-time analysis on the type of play and the result of a play or action. The wagering network 814 (or the cloud 806) may also be synchronized with game situational data, such as the time of the game, the score, location on the field, weather conditions, and the like, which may affect the choice of play utilized. For example, in an exemplary embodiment, the wagering network 814 may not receive data gathered from the sensors 804 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 814 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 816, which may contain data relevant to all users of the wagering network 814 and may include, but is not limited to, a user ID, a device identifier, a paired device identifier, wagering history, or wallet information for the user. The user database 816 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 816 may contain betting lines and search queries. The user database 816 may be searched based on a search criterion received from the user. Each betting line may include, but is not limited to, a plurality of betting attributes such as at least one of the live event 802, a team, a player, an amount of wager, etc. The user database 816 may include but is not limited to information related to all the users involved in the live event 802. In one exemplary embodiment, the user database 816 may include information for generating a user authenticity report and a wagering verification report. Further, the user database 816 may be used to store user statistics like, but not limited to, the retention period for a particular user, frequency of wagers placed by a particular user, the average amount of wager placed by each user, etc.

Further, embodiments may include a historical plays database 818 that may contain play data for the type of sport being played in the live event 802. For example, in American Football, for optimal odds calculation, the historical play data may include metadata about the historical plays, such as time, location, weather, previous plays, opponent, physiological data, etc.

Further, embodiments may utilize an odds database 820—that contains the odds calculated by an odds calculation module 822—to display the odds on the user's mobile device 808 and take bets from the user through the mobile device wagering app 810.

Further, embodiments may include a base module 822, which receives the sensor data from the live event 802. Then the base module 822 determines a first play situation from the received sensor data. The base module 822 determines the probability and wager odds of a first future event occurring at the present competition based on at least the first play situation and playing data associated with at least a subset of one or both of the first set of one or more participants and the second set of one or more participant. The base module 822 provides the wager odds on the wagering app 810.

Further, embodiments may include the odds calculation module 824, which utilizes historical play data to calculate odds for in-play wagers. For example, the odds calculation module 824 may be continuously polling for the data from the live event 802. The odds calculation module 824 may receive the data from the live event 802. The odds calculation module 824 may store the results data, or the results of the last action, in the historical play database 818, which may contain historical data of all previous actions. The odds calculation module 824 filters the historical play database 818 on the team and inning from the situational data. The first parameter of the historical plays database 818 is selected, for example, the event. Then the odds calculation module 824 performs correlations on the data. For example, the historical play database 818 is filtered on the team, the players, the inning, and the number of outs. The first parameter is selected, which in this example is the event, which may be a stolen base, and the historical play database 818 is filtered on the event being a stolen base. Then, correlations are performed on the rest of the parameters, which are how far away the baserunner is from first base, how far away is the first baseman from first base, and how far away is the second baseman from second base, etc. In an example of correlated data, the correlated data for the historical data involving the Red Sox in the second inning with one out recorded and the action being a stolen base, which has a correlation coefficient of 0.81. The correlations are also performed with the same filters, and the next event, which is the action being the runner is caught stealing, has a correlation coefficient of 0.79. It is determined if the correlation coefficient is above a predetermined threshold, for example, 0.75, in order to determine if the data is highly correlated and deemed a relevant correlation. If the correlation is deemed highly relevant, then the correlation coefficient is extracted from the date. For example, the two correlation coefficients of 0.81 for a stolen base and 0.79 for a runner caught stealing are both extracted. If it is determined that the correlations are not highly relevant, then then it is determined if any parameters are remaining. Also, if the correlations were determined to be highly relevant and therefore extracted, it is also determined if any parameters are remaining to perform correlations on. If there are additional parameters to have correlations performed, then the odds calculation module 824 selects the next parameter in the historic action database and returns to performing correlations on the data. Once there are no remaining parameters to perform correlations on, the odds calculation module 824 determines the difference between each of the extracted correlations. For example, the correlation coefficient for a stolen base is 0.81, and the correlation coefficient for a runner caught stealing is 0.79. The difference between the two correlation coefficients (0.81−0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendations database 828 to compare the two correlation coefficient based on statistical significance as opposed to the difference of the two correlation coefficients. The difference between the two correlation coefficients, 0.02, is then compared to the recommendations database 828. The recommendations database 828 contains various ranges of differences in correlations as well as the corresponding odds adjustment for those ranges. For example, the 0.02 difference of the two correlation coefficients falls into the range+0-2 difference in correlations which, according to the recommendations database 828, should have an odds adjustment of 5% increase. The odds calculation module 824 then extracts the odds adjustment from the recommendations database 828. The extracted odds adjustment is stored in an adjustment database 830. The odds calculation module 824 compares the odds database 820 to the adjustment database 830. It is determined whether or not there is a match in any of the wager IDs in the odds database 820 and the adjustment database 830. For example, the odds database 820 contains a list of all the current bet options for a user. The odds database 820 contains a wager ID, event, time, inning, wager, and odds for each bet option. The adjustment database 830 contains the wager ID and the percentage, either as an increase or decrease, that the odds should be adjusted. If there is a match between the odds database 820 and the adjustment database 830, then the odds in the odds database 820 are adjusted by the percentage increase or decrease in the adjustment database 830, and the odds in the odds database 820 are updated. For example, if the odds in the odds database 820 are −105 and the matched wager ID in the adjustment database 830 is a 5% increase, then the updated odds in the odds database 820 should be −110. If there is a match, then the odds are adjusted based on the data stored in the adjustment database 830, and the new data is stored in the odds database 820 over the old entry. If there are no matches, or once the odds database 820 has been adjusted if there are matches, the odds calculation module 824 offers the odds database 820 to the wagering app 810, allowing users to place bets on the wagers stored in the odds database 820. In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 824. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1−b2/Sb1−b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 824 may then extract an odds adjustment from the recommendations database 828. The extracted odds adjustment is then stored in the adjustment database 830. In some embodiments, the recommendations database 828 may be used in the odds calculation module 824 to determine how the wager odds should be adjusted depending on the difference between the correlation coefficients of the correlated data points. The recommendations database 828 may contain the difference in correlations and the odds adjustment. For example, if there is a correlation coefficient for a Red Sox second inning with a runner on base with one out and a stolen base of 0.81 and a correlation coefficient for a Red Sox second inning with a runner on base with one out and the runner caught stealing of 0.79, the difference between the two would be +0.02 when compared to the recommendations database 828 the odds adjustment would be a 5% increase for a Red Sox stolen base or otherwise identified as wager 201 in the adjustment database 830. In some embodiments, the difference in correlations may be the statistical significance of comparing the two correlation coefficients in order to determine how the odds should be adjusted. In some embodiments, the adjustment database 830 may be used to adjust the wager odds of the odds database 820 if it is determined that a wager should be adjusted. The adjustment database 830 contains the wager ID, which is used to match with the odds database 820 to adjust the odds of the correct wager.

Further, embodiments may include a tracking system 826, which is associated with one or more tracking devices and anchors. The tracking system 826 may include one or more processing units (CPUs), a peripherals interface, a memory controller, a network or other communications interface, a memory, for example, a random access memory, a user interface, the user interface including a display and an input, such as a keyboard, a keypad, a touch screen, etc., an input/output (I/O) subsystem, one or more communication busses for interconnecting the components mentioned above, and a power supply system for powering the components mentioned above. In some embodiments, the input is a touch-sensitive display, such as a touch-sensitive surface. In some embodiments, the user interface includes one or more soft keyboard embodiments. The soft keyboard embodiments may include standard (QWERTY) and/or non-standard configurations of symbols on the displayed icons. It should be appreciated that the tracking system 826 is only one example of a system that may be used in engaging with various tracking devices and that the tracking system 826 optionally has more or fewer components than described, optionally combines two or more components, or optionally has a different configuration or arrangement of the components. The various components described are implemented in hardware, software, firmware, or a combination thereof, including one or more signal processing and/or application-specific integrated circuits. Memory optionally includes high-speed random access memory, and optionally also includes non-volatile memory, such as one or more magnetic disk storage devices, flash memory devices, or other non-volatile solid-state memory devices. Access to memory by other tracking system components, such as CPU(s), is, optionally, controlled by a memory controller. Peripherals interface can be used to couple input and output peripherals of the tracking system 826 to CPU(s) and memory. One or more processors run or execute various software programs and/or sets of instructions stored in memory to perform various functions for the tracking system 826 and to process data. In some embodiments, peripherals interface, CPU(s), and memory controller are, optionally, implemented on a single chip. In some other embodiments, they are, optionally, implemented on separate chips. In some embodiments, power system optionally includes a power management system, one or more power sources (e.g., battery, alternating current (AC)), a recharging system, a power failure detection circuit, a power converter or inverter, a power status indicator (e.g., a light-emitting diode (LED), etc.) and any other components associated with the generation, management and distribution of power in portable devices. In some embodiments, the tracking system 826 may include a tracking device manager module for facilitating management of one or more tracking devices, the tracking device manager module may include a tracking device identifier store for storing pertinent information related to each respective tracking device, including a tracking device identifier and a tracking device ping rate, and a tracking device grouping store for facilitating management of or more tracking device groups. The tracking device identifier store includes information related to each respective tracking device, including the tracking device identifier (ID) for each respective tracking device as well as a tracking device group to which the respective tracking device is associated. In some embodiments, a first tracking device group is associated with the left shoulder of each respective subject, and a second tracking device group is associated with a right shoulder of each respective subject. In some embodiments, a third tracking device group is associated with a first position, for example, first baseman, second baseman, shortstop, baserunner, pitcher, etc., of each respective subject, and a fourth tracking device group is associated with a second position. Grouping the tracking devices allows for a particular group to be designated with a particular ping rate, for example, a faster ping rate for baserunners. Grouping the tracking devices also allows for a particular group to be isolated from other tracking devices that are not associated with the respective group, which is useful in viewing representations of the telemetry data provided by the tracking devices of the group.

Further, embodiments may include a recommendations database 828 that may be used in the odds calculation module 824 to determine how the wager odds should be adjusted depending on the difference between the correlation coefficients of the correlated data points. The recommendations database 828 may contain the difference in correlations and the odds adjustment. For example, if there is a correlation coefficient for a Red Sox second inning with a runner on base with one out and a stolen base of 0.81 and a correlation coefficient for a Red Sox second inning with a runner on base with one out and the runner caught stealing of 0.79, the difference between the two would be +0.02 when compared to the recommendations database 828 the odds adjustment would be a 5% increase for a Red Sox stolen base or otherwise identified as wager 201 in the adjustment database 830. In some embodiments, the difference in correlations may be the statistical significance of comparing the two correlation coefficients in order to determine how the odds should be adjusted.

Further, embodiments may include an adjustment database 830 that may be used to adjust the wager odds of the odds database 820 if it is determined that a wager should be adjusted. The adjustment database 830 contains the wager ID, which is used to match with the odds database 820 to adjust the odds of the correct wager.

FIG. 9 Illustrates the base module 822. The base module 822 receives, at step 900, data from the live event 802. For example, the base module 822 receives time-stamped position information of one or more participants of one or both of the first set of participant(s) and the second set of participant(s) in the present competition is received, the time-stamped position information captured by the sensors 804 at a live event 802 during the present competition. For example, the sensor data may be collected by a system including the tracking system 826, the tracking devices, the anchor devices, etc. The time-stamped position information may include an XY- or XYZ-position of each participant of a first subset and a second subset of players with respect to a predefined space, for example, a game field, such as a football field, etc.

The first subset and the second subset can include any number of participants such as each subset including one participant, each subset including two or more participants, or each subset including all the participants of the first competitor and the second competitor, respectively, that are on the field during the first time point. 200. Then the base module 822 determines, at step 902, a first play situation based on the received data. For example, the base module 822 receives weather information which is used to determine a first play situation of the present competition, such as a current play situation. The base module 822 may receive data from multiple sources to determine the first play situation. For example, data already stored in the system, data input manually by a person at the live event 802, data from a third party, data from sensors 804, etc.

In various embodiments, determining the play situation uses a set of parameters, including a current team, inning, outs recorded, baserunners, and defensive positions describing the play situation at the given time. In some embodiments, the data describing the play situation of the live sports event further includes motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 804 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball. In some embodiments, telemetry data that an array of anchors may receive from one or more tracking devices which may include positional telemetry data. The positional telemetry data provides location data for a respective tracking device, which describes the location of the tracking device within a spatial region. In some embodiments, this positional telemetry data is provided as one or more Cartesian coordinates (e.g., an X coordinate, a Y coordinate, and/or Z a coordinate) that describe the position of each respective tracking device. However, any coordinate system (e.g., polar coordinates, etc.) that describes the position of each respective tracking device is used in alternative embodiments. The telemetry data that is received by the array of anchors from the one or more tracking devices includes kinetic telemetry data. The kinetic telemetry data provides data related to various kinematics of the respective tracking device. In some embodiments, this kinetic telemetry data is provided as a velocity of the respective tracking device, an acceleration of the respective tracking device, and/or a jerk of the respective tracking device. Further, in some embodiments, one or more of the above values is determined from an accelerometer of the respective tracking device and/or derived from the positional telemetry data of the respective tracking device. Further, in some embodiments, the telemetry data that is received by the array of anchors from the one or more tracking devices includes biometric telemetry data. The biometric telemetry data provides biometric information related to each subject associated with the respective tracking device. In some embodiments, this biometric information includes a heart rate of the subject, temperature, for example, a skin temperature, a temporal temperature, etc. In some embodiments, the array of anchors communicates the above-described telemetry data, for example, positional telemetry, kinetic telemetry, and/or biometric telemetry, to a telemetry parsing system. Accordingly, in some embodiments, the telemetry parsing system communicates the telemetry data to an odds calculation module 822. In some embodiments, an array of anchor devices may receive telemetry data from one or more tracking devices. In order to minimize error in receiving the telemetry from the one or more tracking devices, the array of anchor devices preferably includes at least three anchor devices. The inclusion of at least three anchor devices within the array of anchor devices allows for each ping, for example, telemetry data received from a respective tracking device, to be triangulated using the combined data from the at least three anchors that receive the respective ping.

The position may be defined as an XY- or XYZ-coordinate for each player with respect to a predefined space, such as a field where the sporting event occurs, such as pitcher's location, catcher's location, baserunner's location, first base location, first baseman location, etc. The player configuration includes positions of the player with respect to each other, as well as with respect to the bases, pitcher's mound, home plate, foul lines, etc. Such positional data is used for recognizing patterns for deriving player configurations in play situations as well as for tracking next events, for example, a baserunner's lead, the position of the first baseman, second baseman, shortstop, etc.,

In various embodiments, determining a prediction of the probability of a first future event includes using historical playing data of one or more participants in one or both of the first set of participant(s) and the second set of participant(s). That is, the process determines a prediction of the probability of a first future event occurring at a live sports event based upon at least (I) the playing data, (ii) the play situation, and (iii) the historical playing data. Historical data refers to play-by-play data that specifies data describing play situations and next play events that have occurred after each play situation. The historical play-by-play data includes historical outcomes of next plays from given player configurations. For example, the historical play-by-play data includes a plurality of next play events that have occurred after a given play situation. For baseball, the given play situation includes the player's configuration in the field, a current inning, a number of outs recorded, a number of baserunners, a number of pitches thrown, a number of pitches called strikes, a number of pitches called balls, etc.

In some embodiments, such historical data also includes data collected so far during a live sports event. In some embodiments, the historical data further includes play-by-play data recorded and published by a league, such as the MLB, NBA, NHL, NFL, etc.

In some embodiments, historical playing data is stored at historical plays database 818 for each participant of at least the first and second subset of participants in a plurality of historical games in the league. In some embodiments, the historical data is used to identify historical play situations corresponding to the play situation at the first time point and provide a prediction of the next event based on the historical play events that have occurred after similar play situations. In some embodiments, the historical playing data includes player telemetry data for each player of at least the first and second subset of players in the plurality of historical games in the league. In some embodiments, the historical playing data includes historical states for player configurations. The current play situation with the present player configuration is compared with the historical states for player configurations to predict the next event in the present game. In some embodiments, the historical states for each player configuration of the player configurations include player types included in the respective player configuration or a subset of the player types included in the respective player configuration. In some embodiments, the plurality of historical games spans a plurality of seasons over a plurality of years. The historical playing data may be for the same type of sport or competition involving the first and second competitors. The first and second competitors may have different team members compared with the current configuration of the team or may have some of the same team members. The base module 822 initiates, at step 904, the odds calculation module 824 to determine the probability and wager odds of a first future event occurring at the present competition based on at least the first play situation and playing data associated with at least a subset of one or both of the first set of one or more participants and the second set of one or more participant. The base module 822 provides, at step 906, the wager odds on the wagering app 810. In various embodiments, the wager odds are transmitted to the wagering app 810 through the wager network 814 to be displayed on a mobile device 808. In some embodiments, the wagering app 810, which is a program that enables the user to place bets on individual plays in the live event 802, streams audio and video from the live event 802, and features the available wagers from the live event 802 on the mobile device 808. The wagering app 810 allows users to interact with the wagering network 814 to place bets and provide payment/receive funds based on wager outcomes. The base module 822 may provide the wager odds as starting indicators of odds movement on a betting exchange system.

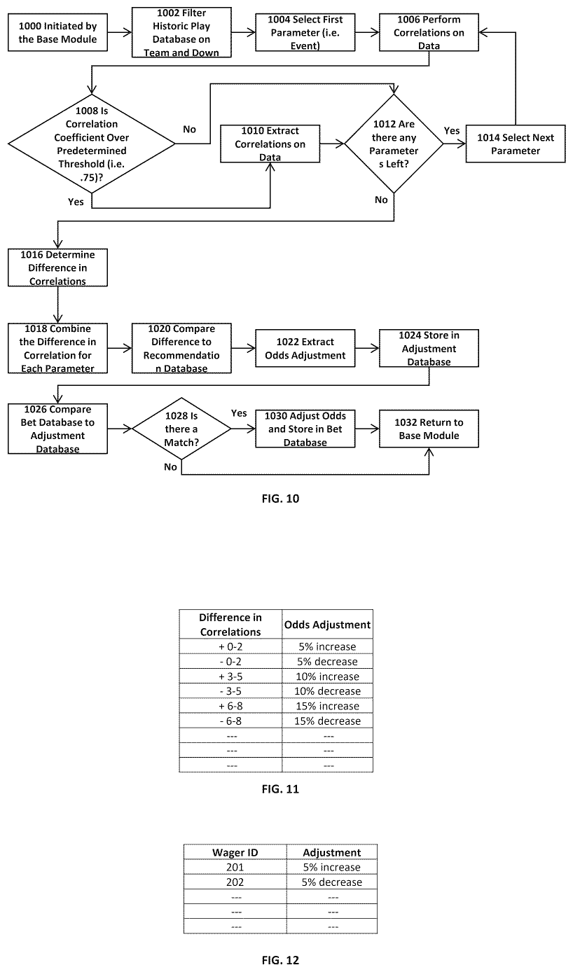

FIG. 10 illustrates the odds calculation module 824. The odds calculation module 824 being initiated, at step 1000, by the base module 822. In some embodiments, the odds calculation module 824 may be continuously polling for the data from the live event 802. In some embodiments, the odds calculation module 824 may receive the data from the live event 802. In some embodiments, the odds calculation module 824 may store the results data, or the results of the last action, in the historical play database 818, which may contain historical data of all previous actions. The odds calculation module 824 filters, at step 1002, the historical play database 818 on the team and down, or inning, from the situational data. For example, if the live event 802 is a football game, the Patriots are on offense, and it is 4th down, then only historical plays where the patriots were on offense during a 4th down would not be filtered out. The odds calculation module 824 selects, at step 1004, the first parameter of the historical plays database 818, for example, the event. Examples of parameters are temperature, humidity, rain, team formation, user behavior, team matchup, decibel level, number of downs, number of yards, time in-game, how far away is the baserunner from first base, how far away is the first baseman from first base and how far away is the second baseman from second base, yards gained, field goal yards, punt yards, etc. Then the odds calculation module 824 performs, at step 1006, correlations on the data. For example, the historical play database 818 is filtered on the team, the players, the inning, and the number of outs. The first parameter is selected, which in this example is the event, which may be a stolen base, and the historical play database 818 is filtered on the event being a stolen base. Then, correlations are performed on the rest of the parameters: temperature, how far away the baserunner is from the first base, how far away is the first baseman from the first base, and how far away is the second baseman from second base, etc. In an example of correlated data, the correlated data for the historical data involving the Red Sox in the second inning with one out recorded and the action being a stolen base, which has a correlation coefficient of 0.81 with temperature. The correlations are also performed with the same filters, and the next event, which is the action being the runner is caught stealing, has a correlation coefficient of 0.79 with temperature. Correlation may be additionally determined with each parameter and the betting behavior of users. For example, proximity to Boston may have a correlation coefficient of 0.86 with betting on the Red Sox to steal a base and 0.61 with betting on the Red Sox to get caught stealing. Betting behavior correlation may not be relevant to the outcome of the play but may still be used to adjust the odds to maximize profit. Then the odds calculation module 824 determines, at step 1008, if the correlation coefficient is above a predetermined threshold, for example, 0.75, in order to determine if the data is highly correlated and deemed a relevant correlation. If the correlation is deemed highly relevant, then the odds calculation module 824 extracts, at step 1010, the correlation coefficient from the data. For example, the two correlation coefficients of 0.81 for a stolen base and 0.79 for a runner caught stealing are both extracted. If it is determined that the correlations are not highly relevant, then the odds calculation module 824 determines, at step 1012, if any parameters are remaining. Also, if the correlations were determined to be highly relevant and therefore extracted, it is also determined if any parameters are remaining to perform correlations on. If there are additional parameters to have correlations performed, then the odds calculation module 824 selects, at step 1014, the next parameter in the historical plays database 818, and the process returns to performing correlations on the data. Once there are no remaining parameters to perform correlations on, the odds calculation module 824 then determines, at step 1016, the difference between each of the extracted correlations. For example, for the temperature parameter, the correlation coefficient for a stolen base is 0.81, and the correlation coefficient for a runner caught stealing is 0.79. The difference between the two correlation coefficients (0.81−0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendations database 828 to compare the two correlation coefficient based on statistical significance as opposed to the difference of the two correlation coefficients. The odds calculation module 824 combines, at step 1018, the difference in correlations for each parameter. For example, the difference between the two correlation coefficients for the parameter of temperature is 0.02. The difference between the two correlation coefficients for how far away the first baseman is from the first base is 0.05. These differences can be combined using statistics, for example, by averaging the two values to 0.035. This average may be weighted based on how correlated the parameter is. Alternatively, before step 1016 occurs, the odds calculation module 824 may calculate the coefficient of multiple correlations for each outcome using all of the correlation coefficients over the predetermined threshold. The coefficient of multiple correlations is the maximum degree of the linear relation between multiple independent variables and the dependent variable or outcome. The coefficient of multiple correlations can be computed using an n-dimensional vector c, wherein each component of c is equal to the correlation coefficient of each independent variable and the outcome and a matrix of correlation coefficients between each combination of two independent variables. Once computed for each outcome, the difference of the coefficients of multiple correlations may be calculated by basic subtraction. The odds calculation module 824 may use machine learning to select, combine, or weight the parameters relevant to the odds. Then the odds calculation module compares, at step 1020, the combined difference between the correlation coefficients, for example, 0.02, to the recommendations database 828. The recommendations database 828 contains various ranges of differences in correlations as well as the corresponding odds adjustment for those ranges. For example, the 0.02 difference of the correlation coefficients falls into the range +0-2 difference in correlations which, according to the recommendations database 828, should have an odds adjustment of 5% increase. The odds calculation module 824 then extracts, at step 1022, the odds adjustment from the recommendations database 828. The odds calculation module then stores, at step 1024, the extracted odds adjustment in the adjustment database 830. The odds calculation module 824 compares, at step 1026, the odds database 820 to the adjustment database 830. The odds calculation module 824 then determines, at step 1028, whether or not there is a match in any of the wager IDs in the odds database 820 and the adjustment database 830. For example, the odds database 820 contains a list of all the current bet options for a user. The odds database 820 contains a wager ID, event, time, inning, wager, and odds for each bet option. The adjustment database 830 contains the wager ID and the percentage, either as an increase or decrease, that the odds should be adjusted. If it is determined there is a match between the odds database 820 and the adjustment database 830, then the odds calculation module 824 adjust, at step 1030, the odds in the odds database 820 by the percentage increase or decrease in the adjustment database 830 and the odds in the odds database 820 are updated. For example, if the odds in the odds database 820 are −105 and the matched wager ID in the adjustment database 830 is a 5% increase, then the updated odds in the odds database 820 should be −110. If there is a match, then the odds are adjusted based on the data stored in the adjustment database 830, and the new data is stored in the odds database 820 over the old entry. If there are no matches, or, once the odds database 820 has been adjusted if there are matches, the odds calculation module 824 returns, at step 1032, to the base module 822. In some embodiments, the odds calculation module 824 may offer the odds database 820 to the wagering app 810, allowing users to place bets on the wagers stored in the odds database 820. In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 824. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1−b2/Sb1−b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 824 may then extract an odds adjustment from the recommendations database 828. The extracted odds adjustment is then stored in the adjustment database 830. In some embodiments, the recommendations database 828 may be used in the odds calculation module 824 to determine how the wager odds should be adjusted depending on the difference between the correlation coefficients of the correlated data points. The recommendations database 828 may contain the difference in correlations and the odds adjustment. For example, if there is a correlation coefficient for a Red Sox second inning with a runner on base with one out and a stolen base of 0.81 and a correlation coefficient for a Red Sox second inning with a runner on base with one out and the runner caught stealing of 0.79, the difference between the two would be +0.02 when compared to the recommendations database 828 the odds adjustment would be a 5% increase for a Red Sox stolen base or otherwise identified as wager 201 in the adjustment database 830. In some embodiments, the difference in correlations may be the statistical significance of comparing the two correlation coefficients in order to determine how the odds should be adjusted. In some embodiments, the adjustment database 830 may be used to adjust the wager odds of the odds database 820 if it is determined that a wager should be adjusted. The adjustment database 830 contains the wager ID, which is used to match with the odds database 820 to adjust the odds of the correct wager.

FIG. 11 illustrates the recommendations database 828. The recommendations database 828 may be used in the odds calculation module 824 to determine how the wager odds should be adjusted depending on the difference between the correlation coefficients of the correlated data points. The recommendations database 828 may contain the difference in correlations and the odds adjustment. For example, if there is a correlation coefficient for a Red Sox second inning with a runner on base with one out and a stolen base of 0.81 and a correlation coefficient for a Red Sox second inning with a runner on base with one out and the runner caught stealing of 0.79, the difference between the two would be +0.02 when compared to the recommendations database 828 the odds adjustment would be a 5% increase for a Red Sox stolen base or otherwise identified as wager 201 in the adjustment database 830. In some embodiments, the difference in correlations may be the statistical significance of comparing the two correlation coefficients in order to determine how the odds should be adjusted.

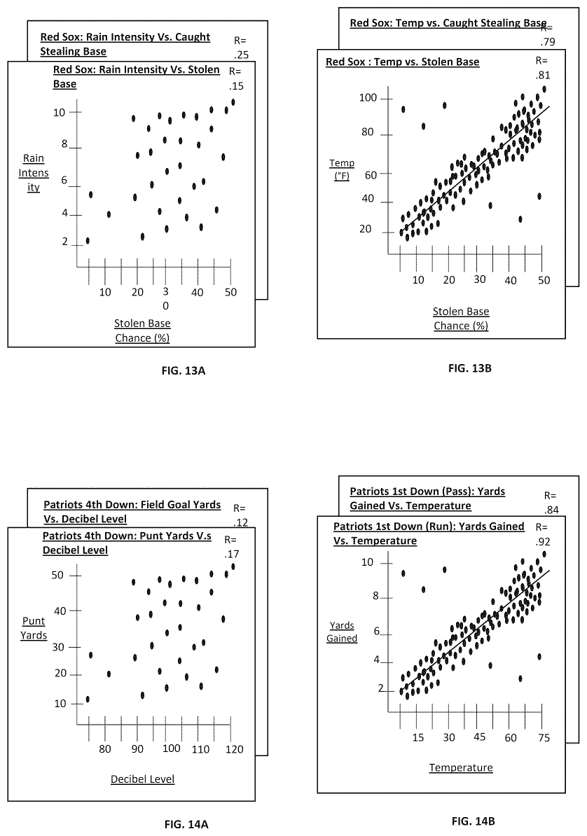

FIG. 12 illustrates the adjustment database 830. The adjustment database 830 may be used to adjust the wager odds of the odds database 820 if it is determined that a wager should be adjusted. The adjustment database 830 contains the wager ID, which is used to match with the odds database 820 to adjust the odds of the correct wager.

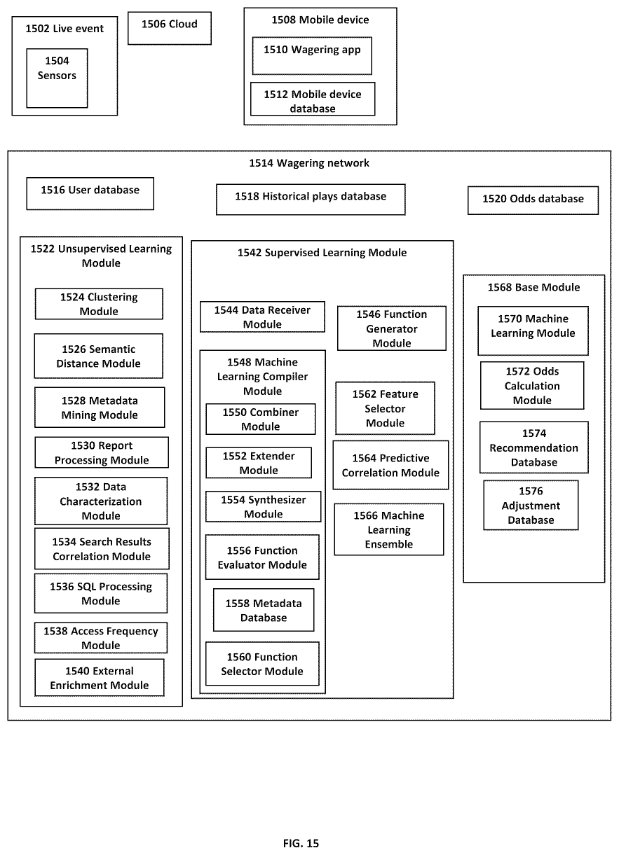

FIG. 13A provides an illustration of an example of the odds calculation module 822 and the resulting correlations. In FIG. 13A, the data is filtered by the team, the various outcomes such as a stolen base, and various parameters such as rain intensity. An example of non-correlated parameters with the team is rain intensity and stolen bases, which have a correlation coefficient of 0.15 (below the 0.75 threshold). Therefore, there is no correlation, and the next parameters should be correlated unless no more parameters remain.

FIG. 13B provides an illustration of an example of the odds calculation module 822 and the resulting correlations. In FIG. 13B, the data is filtered by the team, the various outcomes such as stolen base, and various parameters such as temperature. An example of correlated parameters with the team is rain intensity and stolen bases, which have a correlation coefficient of 0.81. Therefore there is a correlation (since it is above the 0.81 threshold).

FIG. 14A provides an illustration for another example of the odds calculation module 822 and the resulting correlations. In FIG. 14A, the data that is filtered by the team, down and quarter and finding the various correlations with the team, down and quarter and the various parameters such as the decibel level in the stadium, punt yardage, field goal yardage, etc. An example of non-correlated parameters with the team, down, and quarter and the decibel level in the stadium and punt yardage with a 17% (which is below the 75% threshold), therefore there is no correlation and the next parameters should be correlated, unless there are no more parameters remaining.

FIG. 14B provides an illustration for another example of the odds calculation module 822 and the resulting correlations. In FIG. 14B, the data that is filtered by the team, down and quarter and finding the various correlations with the team, down and quarter and the various parameters such as the event, temperature, yards gained, etc. An example of correlated parameters is with the event being a run and the team, down, and quarter with a 92%, therefore there is a correlation (since it is above the 75% threshold). The correlation coefficient needs to be extracted and compared with the other extracted correlation coefficient, which in this example is the event data where the event is a pass, which is correlated at 84%. The difference between the two correlations is compared to the recommendations database to determine if there is a need to adjust the odds. In this example, there is a 0.08 difference between the event being a run and the event being a pass, which means on first down in the first quarter the New England Patriots are more likely to throw a run than to pass the ball, and the odds are adjusted 15% decrease in order to match the correlated data. Conversely, if the correlated data of run, 0.84, is compared to the correlated data of a pass, 0.92, the difference would be −0.08, and the odds would be adjusted by a 15% increase.

In another embodiment, machine learning (ML) and/or artificial intelligence (AI) method and systems for adjusting odds may be shown and described.

FIG. 15 is a system for odds adjustment using machine learning. This system may include a live event 1502, for example, a sporting event such as a football, basketball, baseball, or hockey game, tennis match, golf tournament, eSports, or digital game, etc. The live event 1502 may include some number of actions or plays upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the bet price, sometimes by increasing the juice, vig, or hold that the sportsbook takes. Another type of wager the bettor can make is an over/under, in which the user bets over or under a total for the live event 1502, such as the score of an American football game or the run line in a baseball game, or a series of actions in the live event 1502. Sportsbooks have several bets they can handle, limiting the number of wagers they can take on either side of a bet before moving the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer future bets on live events in the future. Sportsbooks need to offer payment processing services to cash out customers, which can be done at kiosks at the live event 1502 or at another location.

Further, embodiments may include a plurality of sensors 1504 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 1504 may include but are not limited to, tracking devices, such as RFID tags, GPS chips, or other such devices embedded on uniforms, in equipment, in the field of play and boundaries of the field of play, or on other markers in the field of play. In addition, imaging devices may also be used as tracking devices, such as player tracking, which provide statistical information through real-time X, Y positioning of players and X, Y, Z positioning of the ball.

Further, embodiments may include a cloud 1506 or a communication network that may be a wired or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 1506 may be communicatively coupled to a peer-to-peer wagering network 1514, which may perform real-time analysis on the type of play and the result of the play. The cloud 1506 may also be synchronized with game situational data such as the time of the game, the score, location on the field, weather conditions, and the like, which may affect the choice of play utilized. For example, in an exemplary embodiment, the cloud 1506 may not receive data gathered from the sensors 1504 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 1508 such as a computing device, laptop, smartphone, tablet, computer, smart speaker, or I/O devices. I/O devices may be present in the computing device. Input devices may include but are not limited to keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide-semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include but are not limited to video displays, graphical displays, speakers, headphones, inkjet printers, laser printers, or 3D printers. Devices may include but are not limited to a combination of multiple input or output devices such as Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs, including, but not limited to, Microsoft KINECT, SIRI for iPhone by Apple, Google Now, or Google Voice Search. Additional user devices have both input and output capabilities, including, but not limited to, haptic feedback devices, touchscreen displays, or multi-touch displays. Touchscreen, multi-touch displays, touchpads, touch mice, or other touch sensing devices may use different technologies to sense touch, including but not limited to capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 1508 could be an optional component. It would be utilized in a situation where a paired wearable device employs the mobile device 1508 for additional memory or computing power or connection to the internet.

Further, embodiments may include a wagering software application or a wagering app 1510, which is a program that enables the user to place bets on individual plays in the live event 1502, streams audio and video from the live event 1502, and features the available wagers from the live event 1502 on the mobile device 1508. The wagering app 1510 allows users to interact with the wagering network 1514 to place bets and provide payment/receive funds based on wager outcomes. 110. Further, embodiments may include a mobile device database 1512 that may store some or all the user's data, the live event 1502, or the user's interaction with the wagering network 1514.

Further, embodiments may include the wagering network 1514, which may perform real-time analysis on the type of play and the result of a play or action. The wagering network 1514 (or the cloud 1506) may also be synchronized with game situational data, such as the time of the game, the score, location on the field, weather conditions, and the like, which may affect the choice of play utilized. For example, in an exemplary embodiment, the wagering network 1514 may not receive data gathered from the sensors 1504 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 1514 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 1516, which may contain data relevant to all users of the wagering network 1514 and may include, but is not limited to, a user ID, a device identifier, a paired device identifier, wagering history, or wallet information for the user. The user database 1516 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 1516 may contain betting lines and search queries. The user database 1516 may be searched based on a search criterion received from the user. Each betting line may include, but is not limited to, a plurality of betting attributes such as at least one of the live event 1502, a team, a player, an amount of wager, etc. The user database 1516 may include but is not limited to information related to all the users involved in the live event 1502. In one exemplary embodiment, the user database 1516 may include information for generating a user authenticity report and a wagering verification report. Further, the user database 1516 may be used to store user statistics like, but not limited to, the retention period for a particular user, frequency of wagers placed by a particular user, the average amount of wager placed by each user, etc.

Further, embodiments may include a historical plays database 1518 that may contain play data for the type of sport being played in the live event 1502. For example, in American Football, for optimal odds calculation, the historical play data may include metadata about the historical plays, such as time, location, weather, previous plays, opponent, physiological data, etc.

Further, embodiments may utilize an odds database 1520—that contains the odds calculated by an odds calculation module 1522—to display the odds on the user's mobile device 1508 and take bets from the user through the mobile device wagering app 1510.

Further, embodiments may include an unsupervised learning module 1522. Embodiments of the unsupervised learning module 1522 may include multiple sub-modules, including a clustering module 1524, a semantic distance module 1526, a metadata mining module 1528, a report processing module 1530, a data characterization module 1532, a search results correlation module 1534, a SQL query processing module, an access frequency module 1538, and an external enrichment module 1540. Each of these modules is configured to perform at least one unsupervised learning technique.

Unsupervised learning techniques generally seek to summarize and explain key features of a data set. Non-limiting examples of unsupervised techniques include hidden Markov models, blind signal separation using feature extraction techniques for dimensionality reduction, and each of the techniques performed by the modules of the unsupervised learning module 1522 (cluster analysis, mining metadata from the data in the unstructured data set, identifying relationships in data of the unstructured data set based on one or more of analyzing process reports and analyzing process SQL queries, identifying relationships in data of the unstructured data set by identifying semantic distances between data in the unstructured data set, using statistical data to determine a relationship between data in the unstructured data set, identifying relationships in data of the unstructured data set based on analyzing the access frequency of data of the unstructured data set, querying external data sources to determine a relationship between data in the unstructured data set, and text search results correlation).

As mentioned, generally, the unsupervised learning module 1522 can determine relationships between data loaded by a load module into an unstructured data set. For example, the unsupervised learning module 1522 can connect data based on confidence intervals, confidence metrics, distances, or the like indicating the proximity measures and metrics inherent in the unstructured data set, such as schema and Entity Relationship Descriptions (ERD), integrity constraints, foreign key, and primary key relationships, parsing SQL queries, reports, spreadsheets, data warehouse information, or the like. For example, the unsupervised learning module 1522 may derive one or more relationships across heterogeneous data sets based on probabilistic relationships derived from machine learning, such as the unsupervised learning module 1522. The unsupervised learning module 1522 may determine, at a feature level or the like, the distance between data points based on one or more probabilistic relationships derived from machine learning, such as the unsupervised learning module 1522. In addition to identifying simple relationships between data elements, the unsupervised learning module 1522 may also determine a chain or tree comprising multiple relationships between different data elements.

In some embodiments, as part of one or more unstructured learning techniques, the unsupervised learning module 1522 may establish a confidence value, a confidence metric, a distance, or the like (collectively “confidence metric”) through clustering or other machine learning techniques (e.g., the unsupervised learning module 1522, the supervised learning module) that a certain field belongs to a feature, is associated, or related to other data, or the like.

In some unsupervised learning techniques, the unsupervised learning module 1522 may determine a confidence that data of an instance belongs together, is related, or the like. For example, the unsupervised learning module 1522 may determine that a player and an outcome with certain wager odds belong together, thus joining these instances or rows together and providing a confidence metric behind the join. In addition, the load module, or the unsupervised learning module 1522, may store a confidence metric representing a likelihood that a field belongs to an instance or a different confidence value that the field belongs to in a feature. Finally, the load module and/or the supervised learning module may use the confidence values, confidence metrics, or distances to determine an intersection between the row and the column, indicating where to put the field with confidence so that the field may be fed to and processed by the supervised learning module.

In this manner, the unsupervised learning module 1522 and/or the supervised learning module may eliminate a transformation step in data warehousing and replace the precision and deterministic behavior with an imprecise, probabilistic behavior (e.g., store the data in an unstructured or semi-structured manner). Maintaining data in an unstructured or semi-structured format without transforming the data may allow the load module and/or the supervised learning module to identify a signal that a manual transformation would have otherwise eliminated, may eliminate the effort of performing the manual transformation, or the like. Thus, the unsupervised learning module 1522 and/or the supervised learning module may automate and make wager adjustments more efficient and more effective due to the signal component that may have been erased through a manual transformation.

In some unsupervised learning techniques, the unsupervised module may make a first pass of the data to identify the first set of relationships, distances, and/or confidences that satisfy a simplicity threshold. For example, unique data, such as players, positions, teams, or the like, may be relatively easy to connect without exhaustive processing. The unsupervised learning module 1522, in a further embodiment, may make a second pass of data that is unable to be processed by the unsupervised learning module 1522 in the first pass (e.g., data that fails to satisfy the simplicity threshold is more difficult to connect, or the like).

The unsupervised learning module 1522 may perform an exhaustive analysis for the remaining data in the second pass, analyzing each potential connection or relationship between different data elements. For example, the unsupervised learning module 1522 may perform additional unsupervised learning techniques (e.g., cross product, a Cartesian joinder, or the like) for the remaining data in the second pass (e.g., analyzing each possible data connection or combination for the remaining data), thereby identifying probabilities or confidences of which connections or combinations are valid, should be maintained, or the like. In this manner, the unsupervised learning module 1522 may overcome computational complexity by approaching a logarithmic problem in a linear manner. In some embodiments, the unsupervised learning module 1522 and the supervised learning module, using the techniques described herein, may repeatedly, substantially continuously, and/or indefinitely process data over time, continuously refining the accuracy of connections and combinations.

Further, embodiments may include a clustering module 1524. The clustering module 1524 can be configured to perform one or more clustering analyses on the unstructured data loaded by the load module. Clustering involves grouping a set of objects so that objects in the same group (cluster) are more similar, in at least one sense, to each other than those in other clusters. Non-limiting examples of clustering algorithms include hierarchical clustering, k-means algorithm, kernel-based clustering algorithms, density-based clustering algorithms, spectral clustering algorithms. In one embodiment, the clustering module 1524 utilizes decision tree clustering with pseudo labels.

The clustering module 1524 may use focal points, clusters, or the like to determine relationships between, distances between, and/or confidences for data. By using focal points, clustering, or the like to break up large amounts of data, the unsupervised learning module 1522 may efficiently determine relationships, distances, and/or confidences for the data.

As mentioned, the unsupervised learning module 1522 may utilize multiple unsupervised learning techniques to assemble an organized data set. In one embodiment, the unsupervised learning module 1522 uses at least one clustering technique to assemble each organized data set. In other embodiments, some organized data sets may be assembled without using a clustering technique.

Further, embodiments may include a semantic distance module 1526. The semantic distance module 1526 is configured to identify the meaning in language and words using the unstructured data of the unstructured data set and use that meaning to identify relationships between data elements.

Further, embodiments may include a metadata mining module 1528. The metadata mining module 1528 is configured to data-mine declared metadata to identify relationships between metadata and data described by the metadata. For example, the metadata mining module 1528 may identify the table, row, and column names and draw relationships between them.

Further, embodiments may include a report processing module 1530. The report processing module 1530 is configured to analyze and/or read reports and other documents. The report processing module 1530 can identify associations and patterns in these documents that indicate how the unstructured data set is organized. These associations and patterns can be used to identify relationships between data elements in the unstructured data set.

Further, embodiments may include a data characterization module 1532. The data characterization module 1532 is configured to use statistical data to ascertain the likelihood of similarities across a column/row family. For example, the data characterization module 1532 can calculate the maximum and minimum values in a column/row, the average column length, and the number of distinct values in a column. These statistics can assist the unsupervised learning module 1522 in identifying the likelihood that two or more columns/rows are related. For instance, two data sets with a maximum value of 10 and 10,000, respectively, may be less likely to be related than two data sets with identical maximum values.

Further, embodiments may include a search results correlation module 1534. The search results correlation module 1534 is configured to correlate data based on common text search results. These search results may include minor text and spelling variations for each word. Accordingly, the search results correlation module 1534 may identify words that may be a variant, abbreviation, misspelling, conjugation, or derivation of other words. These identifications may be used by other unsupervised learning techniques.

Further, embodiments may include a SQL processing module 1536. The search results correlation module 1534 is configured to harvest queries in a live database, including SQL queries. These queries and the results can be utilized to determine or define a distance between relationships within a data set. Similarly, the unsupervised learning module 1522 or SQL processing module 1536 may harvest SQL statements or other data in real-time from a running database, database manager, or other data source. The SQL processing module 1536 may parse and/or analyze SQL queries to determine relationships. For example, a WHERE statement, a JOIN statement, or the like may relate to certain data features. In a further embodiment, the load module may use data definition metadata (e.g., primary keys, foreign keys, feature names, or the like) to determine relationships.

Further, embodiments may include an access frequency module 1538. The access frequency module 1538 is configured to identify correlations between data based on the frequency at which data is accessed, accessed simultaneously, access count, time of day data is accessed, and the like. For example, the access frequency module 1538 can target highly accessed data first and use access patterns to determine possible relationships. More specifically, the access frequency module 1538 can poll a database system's buffer cache metrics for highly accessed database blocks and store that access pattern information in the data set to be used to identify relationships between the highly accessed data.

Further, embodiments may include an external enrichment module 1540. The external enrichment module 1540 is configured to access external sources if the confidence metric between features of a data set is below a threshold. Non-limiting examples of external sources include the Internet, an Internet search engine, an online encyclopedia or reference site, or the like. For example, suppose the geolocation of an event column is not related to other columns. In that case, it may be queried to an external source to establish relationships between the geolocation of an event and weather reports or forecasts.

While not an unsupervised learning technique, the unsupervised learning module 1522 can be configured to query the user (ask a human) for lacking information or for assistance in determining relationships between features of the unstructured data set.

In addition to the use of unsupervised learning techniques, the unsupervised learning module 1522 can be aided in determining relationships between data elements of the unstructured data set and assembling organized data sets by the supervised learning module. As mentioned, the organized data set(s) assembled by the unsupervised learning module 1522 can be evaluated by the supervised learning module. The unsupervised learning module 1522 can use these evaluations to identify which relationships are more likely and less likely. The unsupervised learning module 1522 can use that information to improve the accuracy of its processes.

Furthermore, in some embodiments, the unsupervised learning module 1522 may use a machine learning ensemble, such as predictive program code, as an input to unsupervised learning to determine probabilistic relationships between data points. The unsupervised learning module 1522 may use relevant influence factors from supervised learning (e.g., a machine learning ensemble or other predictive program code) to enhance unsupervised mining activities in defining the distance between data points in a data set. The unsupervised learning module 1522 may define the confidence that a data element is associated with a specific instance, a specific feature, or the like.

Further, embodiments may include a supervised learning module 1542. The supervised learning module 1542 is configured to generate one or more machine learning ensemble 166s of learned functions based on the organized data set(s) assembled by the unsupervised learning module 1522. In the depicted embodiment, the supervised learning module 1542 includes a data receiver module 1544, a function generator module 1546, a machine learning compiler module 1548, a feature selector module 1562, a predictive correlation module 1564, and a machine learning ensemble 1566. The machine learning compiler module 1548 may include a combiner module 1550, an extender module 1552, a synthesizer module 1554, a function evaluator module 1556, a metadata database 1558, and a function selector module 1560. The machine learning ensemble 1566 may include an orchestration module, a synthesized metadata rule set, and synthesized learned functions.

Further, embodiments may include a data receiver module 1544 configured to receive data from the organized data set, including training data, test data, workload data, or the like, from the load module, or the unsupervised learning module 1522, either directly or indirectly. The data receiver module 1544, in various embodiments, may receive data over a local channel such as an API, a shared library, a hardware command interface, or the like; over a data network such as wired or wireless LAN, WAN, the Internet, a serial connection, a parallel connection, or the like. In certain embodiments, the data receiver module 1544 may receive data indirectly from a live event 1502, from the load module, the unsupervised learning module 1522, or the like, through an intermediate module that may pre-process, reformat, or otherwise prepare the data for the supervised learning module 1542. The data receiver module 1544 may support structured data, unstructured data, semi-structured data, or the like.

One type of data that the data receiver module 1544 may receive, as part of a new ensemble request or the like, is initialization data. The supervised learning module 1542, in certain embodiments, may use initialization data to train and test learned functions from which the supervised learning module 1542 may build a machine learning ensemble 1566. Initialization data may comprise the trial data set, the organized data set, historical data, statistics, Big Data, customer data, marketing data, computer system logs, computer application logs, data networking logs, or other data that the wagering network 1514 provides to the data receiver module 1544 with which to build, initialize, train, and/or test a machine learning ensemble 1566.

Another type of data that the data receiver module 1544 may receive, as part of an analysis request or the like, is workload data. The supervised learning module 1542, in certain embodiments, may process workload data using a machine learning ensemble 1566 to obtain a result, such as classification, a confidence metric, an inferred function, a regression function, an answer, a prediction, a recognized pattern, a rule, a recommendation, an evaluation, or the like. Workload data for a specific machine learning ensemble 1566, in one embodiment, has substantially the same format as the initialization data used to train and/or evaluate the machine learning ensemble 1566. For example, initialization data and/or workload data may include one or more features. As used herein, a feature may comprise a column, category, data type, attribute, characteristic, label, or other groupings of data. For example, in embodiments where initialization data and/or workload data is organized in a table format, a column of data may be a feature. Initialization data and/or workload data may include one or more instances of the associated features. In a table format, where columns of data are associated with features, a row of data is an instance.

In some embodiments, the data receiver module 1544 may maintain data stored on the wagering network 1514 (including the organized data set), such as initialization data and/or workload data, historical data, etc., where the function generator module 1546, the machine learning compiler module 1548, or the like may access the data. In certain embodiments, as described below, the function generator module 1546 and/or the machine learning compiler module 1548 may divide initialization data into subsets, using certain subsets of data as training data for generating and training learned functions and using certain subsets of data as test data for evaluating generated learned functions.

Further, embodiments may include a function generator module 1546 configured to generate a plurality of learned functions based on training data from the data receiver module 1544. A learned function comprises a computer-readable code that accepts an input and provides a result. A learned function may comprise a compiled code, a script, text, a data structure, a file, a function, or the like. In some embodiments, a learned function may accept instances of one or more features as input and provide a result, such as classification, a confidence metric, an inferred function, a regression function, an answer, a prediction, a recognized pattern, a rule, a recommendation, an evaluation, or the like. In another embodiment, certain learned functions may accept instances of one or more features as input and provide a subset of the instances, a subset of the one or more features, or the like as an output. In a further embodiment, certain learned functions may receive the output or result of one or more other learned functions as input, such as a Bayes classifier, a Boltzmann machine, or the like.

The function generator module 1546 may generate learned functions from multiple machine learning classes, models, or algorithms. For example, the function generator module 1546 may generate decision trees; decision forests; kernel classifiers and regression machines with a plurality of reproducing kernels; non-kernel regression and classification machines such as logistic, CART, multi-layer neural nets with various topologies; Bayesian-type classifiers such as Nave Bayes and Boltzmann machines; logistic regression; multinomial logistic regression; probit regression; AR; MA; ARMA; ARCH; GARCH; VAR; survival or duration analysis; MARS; radial basis functions; support vector machines; k-nearest neighbors; geospatial predictive modeling; and/or other classes of learned functions.

In one embodiment, the function generator module 1546 generates learned functions pseudo-randomly, without regard to the effectiveness of the generated learned functions, without prior knowledge regarding the suitability of the generated learned functions for the associated training data or the like. For example, the function generator module 1546 may generate a total number of learned functions that is large enough that at least a subset of the generated learned functions are statistically likely to be effective. As used herein, pseudo-randomly indicates that the function generator module 1546 is configured to generate learned functions in an automated manner, without input or selection of learned functions, machine learning classes or models for the learned functions, or the like by a Data Scientist, expert, or other users.

The function generator module 1546 may generate as many learned functions as possible for a requested machine learning ensemble 1566, given one or more parameters or limitations. The wagering network 1514 may provide a parameter or limitation for learned function generation as part of a new ensemble request or the like, such as an amount of time; an allocation of system resources such as some processor nodes or cores, or an amount of volatile memory; some learned functions; runtime constraints on the requested ensemble such as an indicator of whether or not the requested ensemble should provide results in real-time; and/or another parameter or limitation from the wagering network 1514.

The number of learned functions that the function generator module 1546 may generate for building a machine learning ensemble 1566 may also be limited by capabilities of the system, such as the number of available processors or processor cores, a current load on the system, a price of remote processing resources over the data network, or other hardware capabilities of the system available to the function generator module 1546. The function generator module 1546 may balance the system's hardware capabilities with the time available for generating learned functions and building a machine learning ensemble 1566 to determine how many learned functions to generate for the machine learning ensemble 1566.

In a further embodiment, the function generator module 1546 may generate hundreds, thousands, or millions of learned functions, or more, for a machine learning ensemble 1566. By generating an unusually large number of learned functions from different classes without regard to the suitability or effectiveness of the generated learned functions for training data, in certain embodiments, the function generator module 1546 ensures that at least a subset of the generated learned functions, either individually or in combination, are useful, suitable, and/or effective for the training data without careful curation and fine-tuning by a Data Scientist or other expert.

Similarly, by generating learned functions from different machine learning classes without regard to the effectiveness or the suitability of the different machine learning classes for training data, the function generator module 1546, in certain embodiments, may generate learned functions that are useful, suitable, and/or effective for the training data due to the sheer number of learned functions generated from the different machine learning classes. This brute force, trial-and-error approach to generating learned functions, in certain embodiments, eliminates or minimizes the role of a Data Scientist or other expert in the generation of a machine learning ensemble 1566.

The function generator module 1546, in certain embodiments, divides initialization data from the data receiver module 1544 into various subsets of training data and may use different training data subsets, different combinations of multiple training data subsets, or the like to generate different learned functions. The function generator module 1546 may divide the initialization data into training data subsets by feature, instance, or both. For example, a training data subset may comprise a subset of features of initialization data, a subset of features of initialization data, a subset of both features and instances of initialization data, or the like. Varying the features and/or instances used to train different learned functions in certain embodiments may further increase the likelihood that at least a subset of the generated learned functions is useful, suitable, and/or effective. In a further embodiment, the function generator module 1546 ensures that the available initialization data is not used in its entirety as training data for any one learned function so that at least a portion of the initialization data is available for each learned function as test data.

In one embodiment, the function generator module 1546 may also generate additional learned functions in cooperation with the machine learning compiler module 1548. The function generator module 1546 may provide a learned function request interface, allowing the machine learning compiler module 1548 or another module, wagering network 1514, or the like to send a learned function request to the function generator module 1546 requesting that the function generator module 1546 generate one or more additional learned functions. In one embodiment, a learned function request may include one or more attributes for the requested one or more learned functions. For example, a learned function request, in various embodiments, may include a machine learning class for a requested learned function, one or more features for a requested learned function, instances from initialization data to use as training data for a requested learned function, runtime constraints on a requested learned function or the like. In another embodiment, a learned function request may identify initialization data, training data, or the like for one or more requested learned functions. The function generator module 1546 may generate one or more learned functions pseudo-randomly, as described above, based on the identified data.

Further, embodiments may include a machine learning compiler module 1548 configured to form a machine learning ensemble 1566 using learned functions from the function generator module 1546. As used herein, a machine learning ensemble 1566 comprises an organized set of a plurality of learned functions. Providing a classification, a confidence metric, an inferred function, a regression function, an answer, a prediction, a recognized pattern, a rule, a recommendation, or another result using a machine learning ensemble 1566, in certain embodiments, may be more accurate than using a single learned function.

In some embodiments, the machine learning compiler module 1548 may combine and/or extend learned functions to form new learned functions, request additional learned functions from the function generator module 1546, or the like for inclusion in a machine learning ensemble 1566. In one embodiment, the machine learning compiler module 1548 evaluates learned functions from the function generator module 1546 using test data to generate evaluation metadata. The machine learning compiler module 1548, in a further embodiment, may evaluate combined learned functions, extended learned functions, combined-extended learned functions, additional learned functions, or the like using test data to generate evaluation metadata.

The machine learning compiler module 1548, in certain embodiments, maintains evaluation metadata in a metadata database 1558. The machine learning compiler module 1548 may select learned functions (e.g., learned functions from the function generator module 1546, combined learned functions, extended learned functions, learned functions from different machine learning classes, and/or combined-extended learned functions) for inclusion in a machine learning ensemble 1566 based on the evaluation metadata. In a further embodiment, the machine learning compiler module 1548 may synthesize the selected learned functions into a final, synthesized function or function set for a machine learning ensemble 1566 based on evaluation metadata. The machine learning compiler module 1548, in another embodiment, may include synthesized evaluation metadata in a machine learning ensemble 1566 for directing data through the machine learning ensemble 1566 or the like.

Further, embodiments may include a combiner module 1550. The combiner module 1550 combines learned functions, forming sets, strings, groups, trees, or clusters of combined learned functions. In certain embodiments, the combiner module 1550 combines learned functions into a prescribed order, and different orders of learned functions may have different inputs, produce different results, or the like. In addition, the combiner module 1550 may combine learned functions in different combinations. For example, the combiner module 1550 may combine certain learned functions horizontally or in parallel, joined at the inputs and outputs or the like, and may combine certain learned functions vertically or in series, feeding the output of one learned function into the input of another learned function.

The combiner module 1550 may determine which learned functions to combine, how to combine learned functions, or the like based on evaluation metadata for the learned functions from the metadata database 1558, generated based on an evaluation of the learned functions using test data, as described below regarding the function evaluator module 1556. The combiner module 1550 may request additional learned functions from the function generator module 1546 for combining with other learned functions. For example, the combiner module 1550 may request a new learned function with a particular input and/or output to combine with an existing learned function or the like.

While the combining of learned functions may be informed by evaluation metadata for the learned functions, in certain embodiments, the combiner module 1550 combines a large number of learned functions pseudo-randomly, forming a large number of combined functions. For example, the combiner module 1550, in one embodiment, may determine each possible combination of generated learned functions, as many combinations of generated learned functions as possible given one or more limitations or constraints, a selected subset of combinations of generated learned functions, or the like, for evaluation by the function evaluator module 1556. In certain embodiments, by generating a large number of combined learned functions, the combiner module 1550 is statistically likely to form one or more combined learned functions that are useful and/or effective for the training data.

Further, embodiments may include a combiner module 1550. The combiner module 1550 combines learned functions, forming sets, strings, groups, trees, or clusters of combined learned functions. In certain embodiments, the combiner module 1550 combines learned functions into a prescribed order, and different orders of learned functions may have different inputs, produce different results, or the like. The combiner module 1550 may combine learned functions in different combinations. For example, the combiner module 1550 may combine certain learned functions horizontally or in parallel, joined at the inputs and outputs or the like, and may combine certain learned functions vertically or in series, feeding the output of one learned function into the input of another learned function.

The combiner module 1550 may determine which learned functions to combine, how to combine learned functions, or the like based on evaluation metadata for the learned functions from the metadata database 1558, generated based on an evaluation of the learned functions using test data, as described below regarding the function evaluator module 1556. The combiner module 1550 may request additional learned functions from the function generator module 1546 for combining with other learned functions. For example, the combiner module 1550 may request a new learned function with a particular input and/or output to combine with an existing learned function or the like.

While the combining of learned functions may be informed by evaluation metadata for the learned functions, in certain embodiments, the combiner module 1550 combines a large number of learned functions pseudo-randomly, forming a large number of combined functions. For example, the combiner module 1550, in one embodiment, may determine each possible combination of generated learned functions, as many combinations of generated learned functions as possible given one or more limitations or constraints, a selected subset of combinations of generated learned functions, or the like, for evaluation by the function evaluator module 1556. Thus, in certain embodiments, by generating many combined learned functions, the combiner module 1550 is statistically likely to form one or more combined learned functions that are useful and/or effective for the training data.

Further, embodiments may include an extender module 1552. The extender module 1552, in certain embodiments, is configured to add one or more layers to a learned function. For example, the extender module 1552 may extend a learned function or combined learned function by adding a probabilistic model layer, such as a Bayesian belief network layer, a Bayes classifier layer, a Boltzmann layer, or the like.

Certain classes of learned functions, such as probabilistic models, may be configured to receive either instance of one or more features as input or the output results of other learned functions, such as a classification and a confidence metric, an inferred function, a regression function, an answer, a prediction, a recognized pattern, a rule, a recommendation, an evaluation, or the like. The extender module 1552 may use these types of learned functions to extend other learned functions. For example, the extender module 1552 may extend learned functions generated by the function generator module 1546 directly, may extend combined learned functions from the combiner module 1550, may extend other extended learned functions, may extend synthesized learned functions from the synthesizer module 1554, or the like.

In one embodiment, the extender module 1552 determines which learned functions to extend, how to extend learned functions, or the like based on evaluation metadata from the metadata database 1558. The extender module 1552, in certain embodiments, may request one or more additional learned functions from the function generator module 1546 and/or one or more additional combined learned functions from the combiner module 1550 for the extender module 1552 to extend.

While the extending of learned functions may be informed by evaluation metadata for the learned functions, in certain embodiments, the extender module 1552 generates a large number of extended learned functions pseudo-randomly. For example, the extender module 1552, in one embodiment, may extend each possible learned function and/or combination of learned functions, may extend a selected subset of learned functions, may extend as many learned functions as possible given one or more limitations or constraints, or the like, for evaluation by the function evaluator module 1556. Thus, in certain embodiments, by generating many extended learned functions, the extender module 1552 is statistically likely to form one or more extended learned functions and/or combined extended learned functions that are useful and/or effective for the training data.

Further, embodiments may include a synthesizer module 1554. The synthesizer module 1554, in certain embodiments, is configured to organize a subset of learned functions into the machine learning ensemble 1566, as synthesized learned functions. In a further embodiment, the synthesizer module 1554 includes evaluation metadata from the metadata database 1558 of the function evaluator module 1556 in the machine learning ensemble 1566 as a synthesized metadata rule set, so that the machine learning ensemble 1566 includes synthesized learned functions and evaluation metadata, the synthesized metadata rule set, for the synthesized learned functions.

The learned functions that the synthesizer module 1554 synthesizes or organizes into the synthesized learned functions of the machine learning ensemble 1566 may include learned functions directly from the function generator module 1546 combined learned functions from the combiner module 1550, extended learned functions from the extender module 1552, combined extended learned functions, or the like. As described below, in one embodiment, the function selector module 1560 selects the learned functions for the synthesizer module 1554 to include in the machine learning ensemble 1566. In certain embodiments, the synthesizer module 1554 organizes learned functions by preparing the learned functions and the associated evaluation metadata for processing workload data to reach a result. For example, as described below, the synthesizer module 1554 may organize and/or synthesize the synthesized learned functions, and the synthesized metadata rule set for the orchestration module is used to direct workload data through the synthesized learned functions to produce a result.

In one embodiment, the function evaluator module 1556 evaluates the synthesized learned functions that the synthesizer module 1554 organizes, and the synthesizer module 1554 synthesizes and/or organizes the synthesized metadata rule set based on evaluation metadata that the function evaluation module generates during the evaluation of the synthesized learned functions, from the metadata database 1558 or the like.

Further, embodiments may include a function evaluator module 1556. The function evaluator module 1556 is configured to evaluate learned functions using test data or the like. For example, the function evaluator module 1556 may evaluate learned functions generated by the function generator module 1546, learned functions combined by the combiner module 1550 described above, learned functions extended by the extender module 1552 described above, combined extended learned functions, synthesized learned functions organized into the machine learning ensemble 1566 by the synthesizer module 1554 described above, or the like.

Test data for a learned function, in certain embodiments, comprises a different subset of the initialization data for the learned function than the function generator module 1546 used as training data. For example, the function evaluator module 1556, in one embodiment, evaluates a learned function by inputting the test data into the learned function to produce a result, such as classification, a confidence metric, an inferred function, a regression function, an answer, a prediction, a recognized pattern, a rule, a recommendation, an evaluation, or another result.

Test data, in certain embodiments, comprises a subset of initialization data, with a feature associated with the requested result removed, so that the function evaluator module 1556 may compare the result from the learned function to the instances of the removed feature to determine the accuracy and/or effectiveness of the learned function for each test instance. For example, if a client has requested a machine learning ensemble 1566 to predict whether a customer will be a repeat customer and provided historical customer information as initialization data, the function evaluator module 1556 may input a test data set comprising one or more features of the initialization data other than whether the customer was a repeat customer into the learned function, and compare the resulting predictions to the initialization data to determine the accuracy and/or effectiveness of the learned function.

The function evaluator module 1556, in one embodiment, is configured to maintain evaluation metadata for an evaluated learned function in the metadata database 1558. The evaluation metadata, in certain embodiments, comprises log data generated by the function generator module 1546 while generating learned functions, the function evaluator module 1556 while evaluating learned functions, or the like.

In one embodiment, the evaluation metadata includes indicators of one or more training data sets that the function generator module 1546 used to generate a learned function. The evaluation metadata, in another embodiment, includes indicators of one or more test data sets that the function evaluator module 1556 used to evaluate a learned function. In a further embodiment, the evaluation metadata includes indicators of one or more decisions made by and/or branches taken by a learned function during an evaluation by the function evaluator module 1556. The evaluation metadata, in another embodiment, includes the results determined by a learned function during an evaluation by the function evaluator module 1556. In one embodiment, the evaluation metadata may include evaluation metrics, learning metrics, effectiveness metrics, convergence metrics, or the like for a learned function based on an evaluation of the learned function. An evaluation metric, learning metrics, effectiveness metric, convergence metric, or the like may be based on a comparison of the results from a learned function to actual values from initialization data and may be represented by a correctness indicator for each evaluated instance, a percentage, a ratio, or the like. Different classes of learned functions in certain embodiments may have different types of evaluation metadata.

Further, embodiments may include a metadata database 1558 that provides evaluation metadata for learned functions to the feature selector module 1562, the predictive correlation module 1564, the combiner module 1550, the extender module 1552, and/or the synthesizer module 1554. The metadata database 1558 may provide an API, a shared library, one or more function calls, or the like providing access to evaluation metadata. The metadata database 1558, in various embodiments, may store or maintain evaluation metadata in a database format, as one or more flat files, as one or more lookup tables, as a sequential log or log file, or as one or more other data structures. In one embodiment, the metadata database 1558 may index evaluation metadata by learned function, by feature, by instance, by training data, by test data, by effectiveness, and/or by another category or attribute and may provide query access to the indexed evaluation metadata. The function evaluator module 1556 may update the metadata database 1558 in response to each evaluation of a learned function, adding evaluation metadata to the metadata database 1558 or the like.

Further, embodiments may include a function selector module 1560 that may use evaluation metadata from the metadata database 1558 to select learned functions for the combiner module 1550 to combine, for the extender module 1552 to extend, for the synthesizer module 1554 to include in the machine learning ensemble 1566, or the like. For example, in one embodiment, the function selector module 1560 may select learned functions based on evaluation metrics, learning metrics, effectiveness metrics, convergence metrics, or the like. In another embodiment, the function selector module 1560 may select learned functions for the combiner module 1550 to combine and/or for the extender module 1552 to extend based on training data features used to generate the learned functions or the like.

Further, embodiments may include a feature selector module 1562 that determines which features of initialization data to use in the machine learning ensemble 1566, and in the associated learned functions, and/or which features of the initialization data to exclude from the machine learning ensemble 1566, and from the associated learned functions. As described above, initialization data and the training data and test data derived from the initialization data may include one or more features. Learned functions and the machine learning ensemble 1566s that they form are configured to receive and process instances of one or more features. Certain features may be more predictive than others, and the more features that the machine learning compiler module 1548 processes and includes in the generated machine learning ensemble 1566, the more processing overhead used by the machine learning compiler module 1548, and the more complex the generated machine learning ensemble 1566 becomes. Additionally, certain features may not contribute to the effectiveness or accuracy of the results from a machine learning ensemble 1566 but may simply add noise to the results.

The feature selector module 1562, in one embodiment, cooperates with the function generator module 1546 and the machine learning compiler module 1548 to evaluate the effectiveness of various features, based on evaluation metadata from the metadata database 1558. For example, the function generator module 1546 may generate a plurality of learned functions for various combinations of features, and the machine learning compiler module 1548 may evaluate the learned functions and generate evaluation metadata. Based on the evaluation metadata, the feature selector module 1562 may select a subset of features that are most accurate or effective, and the machine learning compiler module 1548 may use learned functions that utilize the selected features to build the machine learning ensemble 1566. The feature selector module 1562 may select features for use in the machine learning ensemble 1566 based on evaluation metadata for learned functions from the function generator module 1546, combined learned functions from the combiner module 1550, extended learned functions from the extender module 1552, combined extended functions, synthesized learned functions from the synthesizer module 1554, or the like.

In a further embodiment, the feature selector module 1562 may cooperate with the machine learning compiler module 1548 to build a plurality of different machine learning ensemble 1566 for the same initialization data or training data, each different machine learning ensemble 1566 utilizing different features of the initialization data or training data. The machine learning compiler module 1548 may evaluate each different machine learning ensemble 1566, using the function evaluator module 1556 described below, and the feature selector module 1562 may select the machine learning ensemble 1566 and the associated features which are most accurate or effective based on the evaluation metadata for the different machine learning ensemble 1566s. In certain embodiments, the machine learning compiler module 1548 may generate tens, hundreds, thousands, millions, or more different machine learning ensemble 1566s so that the feature selector module 1562 may select an optimal set of features (e.g., the most accurate, most effective, or the like) with little or no input from a Data Scientist, expert, or other users in the selection process.

In one embodiment, the machine learning compiler module 1548 may generate a machine learning ensemble 1566 for each possible combination of features from which the feature selector module 1562 may select. In a further embodiment, the machine learning compiler module 1548 may begin generating machine learning ensemble 1566s with a minimal number of features and may iteratively increase the number of features used to generate machine learning ensemble 1566s until an increase in effectiveness or usefulness of the results of the generated machine learning ensemble 1566s fails to satisfy a feature effectiveness threshold. By increasing the number of features until the increases stop being effective, in certain embodiments, the machine learning compiler module 1548 may determine a minimum effective set of features for use in a machine learning ensemble 1566 so that generation and use of the machine learning ensemble 1566 is both effective and efficient. The feature effectiveness threshold may be predetermined or hardcoded, may be selected by a client 1504 as part of a new ensemble request or the like, may be based on one or more parameters or limitations, or the like.

During the iterative process, in certain embodiments, once the feature selector module 1562 determines that a feature is merely introducing noise, the machine learning compiler module 1548 excludes the feature from future iterations and the machine learning ensemble 1566. For example, in one embodiment, a client 1504 may identify one or more features as required for the machine learning ensemble 1566 in a new ensemble request or the like. The feature selector module 1562 may include the required features in the machine learning ensemble 1566 and select one or more of the remaining optional features for inclusion in the machine learning ensemble 1566 with the required features.

In a further embodiment, based on evaluation metadata from the metadata database 1558, the feature selector module 1562 determines which features from initialization data and/or training data are adding noise, are not predictive, are the least effective, or the like, and excludes the features from the machine learning ensemble 1566. In other embodiments, the feature selector module 1562 may determine which features enhance the quality of results, increase effectiveness, or the like, and selects the features for the machine learning ensemble 1566.

In one embodiment, the feature selector module 1562 causes the machine learning compiler module 1548 to repeat generating, combining, extending, and/or evaluating learned functions while iterating through permutations of feature sets. At each iteration, the function evaluator module 1556 may determine the overall effectiveness of the learned functions in aggregate for the current iteration's selected combination of features. For example, once the feature selector module 1562 identifies a feature as noise introducing, the feature selector module 1562 may exclude the noisy feature, and the machine learning compiler module 1548 may generate a machine learning ensemble 1566 without the excluded feature. In one embodiment, the predictive correlation module 1564 determines one or more features, instances of features, or the like that correlate with higher confidence metrics (e.g., that are most effective in predicting results with high confidence). The predictive correlation module 1564 may cooperate with, be integrated with, or otherwise, work in concert with the feature selector module 1562 to determine one or more features, instances of features, or the like that correlate with higher confidence metrics. For example, as the feature selector module 1562 causes the machine learning compiler module 1548 to generate and evaluate learned functions with different sets of features, the predictive correlation module 1564 may determine which features and/or instances of features correlate with higher confidence metrics, are most effective, or the like based on metadata from the metadata database 1558.

Further, embodiments may include a predictive correlation module 1564 configured to harvest metadata regarding which features correlate to higher confidence metrics, to determine which feature was predictive of which outcome or result, or the like. In one embodiment, the predictive correlation module 1564 determines the relationship of a feature's predictive qualities for a specific outcome or result based on each instance of a particular feature. In other embodiments, the predictive correlation module 1564 may determine the relationship of a feature's predictive qualities based on a subset of instances of a particular feature. For example, the predictive correlation module 1564 may discover a correlation between one or more features and the confidence metric of a predicted result by attempting different combinations of features and subsets of instances within an individual feature's dataset and measuring an overall impact on predictive quality, accuracy, confidence, or the like. The predictive correlation module 1564 may determine predictive features at various granularities, such as per feature, per subset of features, per instance, or the like.

In one embodiment, the predictive correlation module 1564 determines one or more features with the greatest contribution to a predicted result or confidence metric as the machine learning compiler module 1548 forms the machine learning ensemble 1566, based on evaluation metadata from the metadata database 1558, or the like. For example, the machine learning compiler module 1548 may build one or more synthesized learned functions that are configured to provide one or more features with the greatest contribution as part of a result. In another embodiment, the predictive correlation module 1564 may determine one or more features with the greatest contribution to a predicted result or confidence metric dynamically at runtime as the machine learning ensemble 1566 determines the predicted result or confidence metric. In such embodiments, the predictive correlation module 1564 may be part of, integrated with, or in communication with the machine learning ensemble 1566. The predictive correlation module 1564 may cooperate with the machine learning ensemble 1566, such that the machine learning ensemble 1566 provides a listing of one or more features that provided the greatest contribution to a predicted result or confidence metric as part of a response to an analysis request.

In determining features that are predictive or that have the greatest contribution to a predicted result or confidence metric, the predictive correlation module 1564 may balance a frequency of the contribution of a feature and/or an impact of the contribution of the feature. For example, a certain feature or set of features may contribute to the predicted result or confidence metric frequently, for each instance or the like, but have a low impact. Another feature or set of features may contribute relatively infrequently but has a very high impact on the predicted result or confidence metric (e.g., provides at or near 100% confidence or the like). Thus, while the predictive correlation module 1564 is described herein as determining features that are predictive or that have the greatest contribution, in other embodiments, the predictive correlation module 1564 may determine one or more specific instances of a feature that are predictive, have the greatest contribution to a predicted result or confidence metric, or the like.

Further, embodiments may include machine learning ensemble 1566 that provides machine learning results for an analysis request by processing workload data of the analysis request using a plurality of learned functions (e.g., the synthesized learned functions). As described above, results from the machine learning ensemble 1566, in various embodiments, may include classification, a confidence metric, an inferred function, a regression function, an answer, a prediction, a recognized pattern, a rule, a recommendation, an evaluation, and/or another result. For example, in one embodiment, the machine learning ensemble 1566 provides a classification and a confidence metric for each instance of workload data input into the machine learning ensemble 1566 or the like. Workload data, in certain embodiments, may be substantially similar to test data, but the missing feature from the initialization data is not known and is to be solved for by the machine learning ensemble 1566. A classification, in certain embodiments, comprises a value for a missing feature in an instance of workload data, such as a prediction, an answer, or the like. For example, if the missing feature represents a question, the classification may represent a predicted answer, and the associated confidence metric may be an estimated strength or accuracy of the predicted answer. A classification, in certain embodiments, may comprise a binary value (e.g., yes, or no), a rating on a scale (e.g., four on a scale of one to five), or another data type for a feature. A confidence metric, in certain embodiments, may comprise a percentage, a ratio, a rating on a scale, or another indicator of accuracy, effectiveness, and/or confidence.

In the depicted embodiment, the machine learning ensemble 1566 includes an orchestration module. The orchestration module, in certain embodiments, is configured to direct workload data through the machine learning ensemble 1566 to produce a result, such as a classification, a confidence metric, an inferred function, a regression function, an answer, a prediction, a recognized pattern, a rule, a recommendation, an evaluation, and/or another result. For example, in one embodiment, the orchestration module uses evaluation metadata from the function evaluator module 1556 and/or the metadata database 1558, such as the synthesized metadata rule set, to determine how to direct workload data through the synthesized learned functions of the machine learning ensemble 1566. As described below, in certain embodiments, the synthesized metadata rule set comprises a set of rules or conditions from the evaluation metadata of the metadata database 1558 that indicate to the orchestration module which features, instances, or the like should be directed to which synthesized learned function.

For example, the evaluation metadata from the metadata database 1558 may indicate which learned functions were trained using which features and/or instances, how effective different learned functions were at making predictions based on different features and/or instances, or the like. The synthesizer module 1554 may use that evaluation metadata to determine rules for the synthesized metadata rule set, indicating which features, which instances, or the like the orchestration module should direct through which learned functions, in which order, or the like. The synthesized metadata rule set, in one embodiment, may comprise a decision tree or other data structure comprising rules which the orchestration module may follow to direct workload data through the synthesized learned functions of the machine learning ensemble 1566.

Further, embodiments may include a base module 1568, which may begin with the base module 1568 receiving the sensor data from the live event 1502. For example, the base module 1568 receives sensor data related to the event, such as the players within the event, the period within the event, the score of the event, and the current situation of the event, such as it is the first quarter of the New England Patriots vs. the New York Jets, with the Patriots having possession of the football at their 25-yard line and it is first down. Then it is determined if the base module 1568 received a request for a new machine learning ensemble 1566. For example, the wagering network 1514 may send a request for a new machine learning ensemble 1566, such as a daily request, weekly request, monthly request, quarterly request, yearly request, etc. If it is determined that the base module 1568 received a request for a new machine learning ensemble, then it initiates the machine learning module 1570. For example, if the base module 1568 receives a request for a new machine learning ensemble 1566, then the base module 1568 initiates the machine learning module 1570. If it is determined that the base module 1568 did not receive a request for a new machine learning ensemble 1566, then the base module 1568 determines a first play situation from the received sensor data. For example, the base module 1568 receives the time-stamped position information and determines a first play situation of the present competition, such as a current play situation. In various embodiments, the play situation is determined using, at least in part, time-stamped position information of each player in the subsets of players at the given time. For example, the process determines the play situation at a first time point which is a current time of competition while the competition is ongoing, and the time-stamped position information has been collected by the sensors 1504 at the present competition through the first time point. For example, the current play situation may be in the first quarter of the New England Patriots vs. the New York Jets, with the Patriots having possession of the football at their 25-yard line, and it is first down. The base module 1568 initiates the odds calculation module 1572 to determine the probability and wager odds of a first future event occurring at the present competition based on at least the first play situation and playing data associated with at least a subset of one or both of the first set of one or more participants and the second set of one or more participant. The base module 1568 provides the wager odds on the wagering app 1510. In various embodiments, the wager odds are transmitted to the wagering app 1510 through the wager network 1514 to be displayed on a mobile device 1508. In some embodiments, the wagering app 1510, a program that enables the user to place bets on individual plays in the live event 1502, streams audio and video from the live event 1502 and features the available wagers from the live event 1502 on the mobile device 1508. The wagering app 1510 allows users to interact with the wagering network 1514 to place bets and provide payment/receive funds based on wager outcomes.

Further, embodiments may include a machine learning module 1570, which may begin with the machine learning module 1570 being initiated by the base module 1568. Then the machine learning module 1570 receives a request for a new machine learning ensemble 1566. For example, the wagering network 1514 may send a request for a new machine learning ensemble 1566, such as a daily request, weekly request, monthly request, quarterly request, yearly request, etc. The machine learning module 1570 generates a plurality of learned functions based on the received training data. For example, the function generator module 1546 generates a plurality of learned functions based on the received training data from different machine learning classes. A learned function comprises a computer-readable code that accepts an input and provides a result. A learned function may comprise a compiled code, a script, text, a data structure, a file, a function, or the like. In some embodiments, a learned function may accept instances of one or more features as input and provide a result, such as classification, a confidence metric, an inferred function, a regression function, an answer, a prediction, a recognized pattern, a rule, a recommendation, an evaluation, or the like. In another embodiment, certain learned functions may accept instances of one or more features as input and provide a subset of the instances, a subset of the one or more features, or the like as an output. In a further embodiment, certain learned functions may receive the output or result of one or more other learned functions as input, such as a Bayes classifier, a Boltzmann machine, or the like. Then the machine learning module 1570 evaluates the plurality of generated learned functions. For example, the function evaluator module 1556 evaluates the plurality of generated learned functions to generate evaluation metadata. The function evaluator module 1556 is configured to evaluate learned functions using test data or the like. The function evaluator module 1556 may evaluate learned functions generated by the function generator module 1546, learned functions combined by the combiner module 1550, learned functions extended by the extender module 1552, combined extended learned functions, synthesized learned functions organized into the machine learning ensemble 1566 by the synthesizer module 1554, or the like. Test data for a learned function, in certain embodiments, comprises a different subset of the initialization data for the learned function than the function generator module 1546 used as training data. The function evaluator module 1556, in one embodiment, evaluates a learned function by inputting the test data into the learned function to produce a result, such as a classification, a confidence metric, an inferred function, a regression function, an answer, a prediction, a recognized pattern, a rule, a recommendation, an evaluation, or another result. The machine learning module 1570 combines learned functions based on the metadata from the evaluation. For example, the combiner module 1550 combines learned functions based on the metadata from the evaluation performed by the function evaluator module 1556. For example, the combiner module 1550 combines learned functions, forming sets, strings, groups, trees, or clusters of combined learned functions. In certain embodiments, the combiner module 1550 combines learned functions into a prescribed order, and different orders of learned functions may have different inputs, produce different results, or the like. The combiner module 1550 may combine learned functions in different combinations. For example, the combiner module 1550 may combine certain learned functions horizontally or in parallel, joined at the inputs and outputs or the like, and may combine certain learned functions vertically or in series, feeding the output of one into the input of another learned function. The combiner module 1550 may determine which learned functions to combine, how to combine learned functions, or the like based on evaluation metadata for the learned functions from the metadata database 1558, generated based on an evaluation of the learned functions using test data, as described below with regard to the function evaluator module 1556. The combiner module 1550 may request additional learned functions from the function generator module 1546 for combining with other learned functions. For example, the combiner module 1550 may request a new learned function with a particular input and/or output to combine with an existing learned function or the like. The machine learning module 1570 extends one or more learned functions by adding layers to one or more learned functions. For example, the extender module 1552 extends one or more learned functions by adding layers to the one or more learned functions, such as a probabilistic model layer or the like. In certain embodiments, the extender module 1552 extends combined learned functions based on the evaluation of the combined learned functions. For example, in certain embodiments, the extender module 1552 is configured to add one or more layers to a learned function. For example, the extender module 1552 may extend a learned function or combined learned function by adding a probabilistic model layer, such as a Bayesian belief network layer, a Bayes classifier layer, a Boltzmann layer, or the like. Certain classes of learned functions, such as probabilistic models, may be configured to receive either instances of one or more features as input or the output results of other learned functions, such as a classification and a confidence metric, an inferred function, a regression function, an answer, a prediction, a recognized pattern, a rule, a recommendation, an evaluation, or the like. The extender module 1552 may use these types of learned functions to extend other learned functions. The extender module 1552 may extend learned functions generated by the function generator module 1546 directly, may extend combined learned functions from the combiner module 1550, may extend other extended learned functions, may extend synthesized learned functions from the synthesizer module 1554, or the like. Then the machine learning module 1570 requests that the function generator module 1546 generate additional learned functions for the extender module to extend. For example, the extender module 1552 may request that the function generator module 1546 generate additional learned functions for the extender module 1552 to extend. For example, the function generator module 1546 may generate learned functions from multiple machine learning classes, models, or algorithms. For example, the function generator module 1546 may generate decision trees; decision forests; kernel classifiers and regression machines with a plurality of reproducing kernels; non-kernel regression and classification machines such as logistic, CART, multi-layer neural nets with various topologies; Bayesian-type classifiers such as Nave Bayes and Boltzmann machines; logistic regression; multinomial logistic regression; probit regression; AR; MA; ARMA; ARCH; GARCH; VAR; survival or duration analysis; MARS; radial basis functions; support vector machines; k-nearest neighbors; geospatial predictive modeling; and/or other classes of learned functions. The machine learning module 1570 evaluates the extended learned functions. For example, the function evaluator module 1556 evaluates the extended learned functions. For example, in one embodiment, the function evaluator module 1556 is configured to maintain evaluation metadata for an evaluated learned function in the metadata database 1558. The evaluation metadata, in certain embodiments, comprises log data generated by the function generator module 1546 while generating learned functions, the function evaluator module 1556 while evaluating learned functions, or the like. In one embodiment, the evaluation metadata includes indicators of one or more training data sets that the function generator module 1546 used to generate a learned function. The evaluation metadata, in another embodiment, includes indicators of one or more test data sets that the function evaluator module 1556 used to evaluate a learned function. In a further embodiment, the evaluation metadata includes indicators of one or more decisions made by and/or branches taken by a learned function during an evaluation by the function evaluator module 1556. The evaluation metadata, in another embodiment, includes the results determined by a learned function during an evaluation by the function evaluator module 1556. In one embodiment, the evaluation metadata may include evaluation metrics, learning metrics, effectiveness metrics, convergence metrics, or the like for a learned function based on an evaluation of the learned function. An evaluation metric, learning metrics, effectiveness metric, convergence metric, or the like may be based on a comparison of the results from a learned function to actual values from initialization data and may be represented by a correctness indicator for each evaluated instance, a percentage, a ratio, or the like. Different classes of learned functions in certain embodiments may have different types of evaluation metadata. The machine learning module 1570 synthesizes the selected learned functions into synthesized learned functions. For example, the synthesizer module 1554 synthesizes the selected learned functions into synthesized learned functions. For example, in certain embodiments, the synthesizer module 1554 is configured to organize a subset of learned functions into the machine learning ensemble 1566, as synthesized learned functions. In a further embodiment, the synthesizer module 1554 includes evaluation metadata from the metadata database 1558 of the function evaluator module 1556 in the machine learning ensemble 1566 as a synthesized metadata rule set, so that the machine learning ensemble 1566 includes synthesized learned functions and evaluation metadata, the synthesized metadata rule set, for the synthesized learned functions. The learned functions that the synthesizer module 1554 synthesizes or organizes into the synthesized learned functions of the machine learning ensemble 1566 may include learned functions directly from the function generator module 1546 combined learned functions from the combiner module 1550, extended learned functions from the extender module 1552, combined extended learned functions, or the like. In one embodiment, the function selector module 1560 selects the learned functions for the synthesizer module 1554 to include in the machine learning ensemble 1566. In certain embodiments, the synthesizer module 1554 organizes learned functions by preparing the learned functions and the associated evaluation metadata for processing workload data to reach a result. For example, as described below, the synthesizer module 1554 may organize and/or synthesize the synthesized learned functions, and the synthesized metadata rule set for the orchestration module is used to direct workload data through the synthesized learned functions to produce a result. Then the machine learning module 1570 evaluates the synthesized learned functions to generate a synthesized metadata rule set. For example, the function evaluator module 1556 evaluates the synthesized learned functions to generate a synthesized metadata rule set. Then the machine learning module 1570 organizes the synthesized learned functions and the synthesized metadata rule set into a machine learning ensemble 1566. For example, the synthesizer module 1554 organizes the synthesized learned functions and the synthesized metadata rule set into a machine learning ensemble 1566. For example, the machine learning ensemble 1566 may be used to respond to analysis requests, such as processing collected and coordinated data using machine learning and providing machine learning results, such as a classification, a confidence metric, an inferred function, a regression function, an answer, a prediction, a recognized pattern, a rule, a recommendation, or other results. The machine learning module 1570 stores the machine learning ensemble 1566. For example, the machine learning module 1570 may store the machine learning ensemble 1566 on the wagering network, within a database, etc. such as to provide machine learning results, such as a classification, a confidence metric, an inferred function, a regression function, an answer, a prediction, a recognized pattern, a rule, a recommendation, or other results. The machine learning module 1570 returns to the base module 1568.

Further, embodiments may include an odds calculation module 1572, which may begin with the odds calculation module 1572 being initiated by the base module 1568. In some embodiments, the odds calculation module 1572 may be continuously polling for the data from the live event 1502. In some embodiments, the odds calculation module 1572 may receive the data from the live event 1502. In some embodiments, the odds calculation module 1572 may store the results data, or the results of the last action, in the historical plays database 1518, which may contain historical data of all previous actions. The odds calculation module 1572 filters the historical plays database 1518 on the team and inning from the situational data. The odds calculation module 1572 selects the machine learning ensemble 1566. For example, the machine learning ensemble 1566 may be used to respond to analysis requests (e.g., processing collected and coordinated data using machine learning) and to provide machine learning results, such as a classification, a confidence metric, an inferred function, a regression function, an answer, a prediction, a recognized pattern, a rule, a recommendation, or other results. For example, if the machine learning ensemble 1566 is a regression function or regression analysis, such as a measure of the relation between the mean value of one variable and corresponding values of other variables, then the odds calculation module 1572 uses the selected variables or parameters to perform correlations that the machine learning ensemble 1566 has deemed highly correlated. Then if the correlation coefficients are above a predetermined threshold, the odds calculation module 1572 will be extracted and compared to the recommendations database 1574 and extracts the odds adjustment and then stores the odds adjustment to the adjustment database 1576 and then compares the adjustment database 1576 to the odds database 1520 to determine if any wager odds need to be altered, adjusted, etc. before being offered on the wagering app 1510. The odds calculation module 1572 selects the first parameter of the historical plays database 1518, for example, the event. Then the odds calculation module 1572 performs correlations on the data. For example, the historical plays database 1518 is filtered on the team, the players, the quarter, the down, and the distance to be gained. The first parameter is selected, which in this example is the event, which may either be a pass or a run, and the historical plays database 1518 is filtered on the event being a pass. Then, correlations are performed on the rest of the parameters, which are yards gained, temperature, decibel level, etc. Correlated data for the historical data involving the Patriots in the first quarter on first down with 10 yards to go and the play being a pass, which has a correlation coefficient of 0.81. The correlations are also performed with the same filters, and the next event, which is the play being a run that has a correlation coefficient of 0.79. Then the odds calculation module 1572 determines if the correlation coefficient is above a predetermined threshold, for example, 0.75, to determine if the data is highly correlated and deemed a relevant correlation. If the correlation is deemed highly relevant, the odds calculation module 1572 extracts the correlation coefficient from the data. For example, the two correlation coefficients of 0.81 for a pass and 0.79 for a run are extracted. If it is determined that the correlations are not highly relevant, then the odds calculation module 1572 determines if any parameters are remaining. Also, if the correlations were determined to be highly relevant and therefore extracted, it is also determined if any parameters are remaining to perform correlations on. If there are additional parameters to have correlations performed, then the odds calculation module 1572 selects the next parameter in the historical plays database 1518, and the process returns to performing correlations on the data. For example, the machine learning ensemble 1566 may have also identified other variables or parameters deemed to be highly important or have previously been shown to be highly correlated, and the next parameters are selected. Once there are no more remaining parameters to perform correlations on, the odds calculation module 1572 then determines the difference between each of the extracted correlations. For example, the correlation coefficient for a pass is 0.81, and the correlation coefficient for a run is 0.79. The difference between the two correlation coefficients (0.81−0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendations database 1528 to compare the two correlation coefficient based on statistical significance as opposed to the difference of the two correlation coefficients. Then the odds calculation module 1572 compares the difference between the two correlation coefficients, for example, 0.02, to the recommendations database 1574. The recommendations database 1574 contains various ranges of differences in correlations and the corresponding odds adjustment for those ranges. For example, the 0.02 difference of the two correlation coefficients falls into the range +0-2 difference in correlations which, according to the recommendations database, 1574 should have an odds adjustment of 5% increase. The odds calculation module 1572 then extracts the odds adjustment from the recommendations database 1574. The odds calculation module 1572 then stores the extracted odds adjustment in the adjustment database 1576. The odds calculation module 1572 compares the odds database 1520 to the adjustment database 1576. The odds calculation module 1572 then determines whether there is a match in any wager IDs in the odds database 1520 and the adjustment database 1576. For example, the odds database 1520 contains a list of all the current bet options for a user; for each bet option, the odds database 1520 contains a wager ID, event, time, inning, wager, and odds. The adjustment database 1576 contains the wager ID and the percentage, either as an increase or decrease, that the odds should be adjusted. If there is a match between the odds database 1520 and the adjustment database 1576, then the odds calculation module 1572 adjusts the odds in the odds database 1520 by the percentage increase or decrease in the adjustment database 1576 and the odds in the odds database 1520 are updated. For example, if the odds in the odds database 1520 are −105 and the matched wager ID in the adjustment database 1576 is a 5% increase, then the updated odds in the odds database 1520 should be −110. If there is a match, then the odds are adjusted based on the data stored in the adjustment database 1576, and the new data is stored in the odds database 1520 over the old entry. If there are no matches, or once the odds database 1520 has been adjusted, if there are matches, the odds calculation module 1572 returns to the base module 1568. In some embodiments, the odds calculation module 1572 may offer the odds database 1520 to the wagering app 1510, allowing users to place bets on the wagers stored in the odds database 1520. In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 1572. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1−b2/Sb1−b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 1572 may then extract an odds adjustment from the recommendations database 1574. The extracted odds adjustment is then stored in the adjustment database 1576. In some embodiments, the recommendations database 174 may be used in the odds calculation module 1572 to determine how the wager odds should be adjusted depending on the difference between the correlation coefficients of the correlated data points. The recommendations database 1574 may contain the difference in correlations and the odds adjustment. For example, if there is a correlation coefficient for a pass being thrown by the Patriots in the first quarter on first down of 0.81 and a correlation coefficient for a run being performed by the Patriots in the first quarter on first down of 0.79, the difference between the two would be +0.02 when compared to the recommendations database 1574 the odds adjustment would be a 5% increase for a Patriots pass or otherwise identified as wager 201 in the adjustment database 1576. In some embodiments, the difference in correlations may be the statistical significance of comparing the two correlation coefficients to determine how the odds should be adjusted. In some embodiments, the adjustment database 1576 may be used to adjust the wager odds of the odds database 1520 if it is determined that a wager should be adjusted. The adjustment database 1576 contains the wager ID, which is used to match with the odds database 1520 to adjust the odds of the correct wager.

Further, embodiments may include a recommendations database 1574, which may be used in the odds calculation module 1572 to determine how the wager odds should be adjusted depending on the difference between the correlation coefficients of the correlated data points. The recommendations database 1574 may contain the difference in correlations and the odds adjustment. For example, if there is a correlation coefficient for a pass being thrown by the Patriots in the first quarter on first down of 0.81 and a correlation coefficient for a run being performed by the Patriots in the first quarter on first down of 0.79, the difference between the two would be +0.02 when compared to the recommendations database 1574 the odds adjustment would be a 5% increase for a Patriots pass or otherwise identified as wager 201 in the adjustment database 1576. In some embodiments, the difference in correlations may be the statistical significance of comparing the two correlation coefficients to determine how the odds should be adjusted.

Further, embodiments may include an adjustment database 1576, which may be used to adjust the wager odds of the odds database 1520 if it is determined that a wager should be adjusted. The adjustment database 1576 contains the wager ID, which is used to match with the odds database 1520 to adjust the odds of the correct wager.

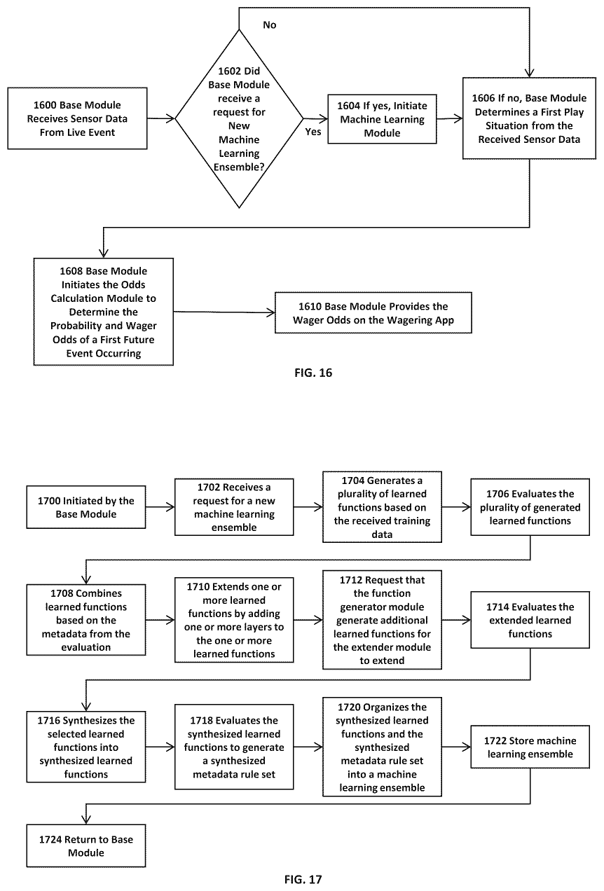

FIG. 16 illustrates the base module 1568. The process begins with the base module 1568 receives, at step 1600, the sensor data from the live event 1502. For example, the base module 1568 receives sensor data related to the event, such as the players within the event, the period within the event, the score of the event, and the current situation of the event, such as it is the first quarter of the New England Patriots vs. the New York Jets, with the Patriots having possession of the football at their 25-yard line and it is first down. Then it is determined if the base module 1568 received, at step 1602, a request for a new machine learning ensemble 1566. For example, the wagering network 1514 may send a request for a new machine learning ensemble 1566, such as a daily request, weekly request, monthly request, quarterly request, yearly request, etc. if it is determined that the base module 1568 received a request for a new machine learning ensemble then the base module initiates, at step 1604, the machine learning module 1570. For example, if the base module 1568 receives a request for a new machine learning ensemble 1566, then the base module 1568 initiates the machine learning module 1570. If it is determined that the base module 1568 did not receive a request for a new machine learning ensemble 1566, then the base module 1568 determines, at step 1606, a first play situation from the received sensor data. For example, the base module 1568 receives the time-stamped position information and determines a first play situation of the present competition, such as, a current play situation. In various embodiments, the play situation is determined using, at least in part, time-stamped position information of each player in the subsets of players at the given time. For example, the process determines the play situation at a first time point which is a current time of competition while the competition is ongoing, and the time-stamped position information has been collected by the sensors 1504 at the present competition through the first time point. For example, the current play situation may be in the first quarter of the New England Patriots vs. the New York Jets, with the Patriots having possession of the football at their 25-yard line, and it is first down. The base module 1568 initiates, at step 1608, the odds calculation module 1572 to determine the probability and wager odds of a first future event occurring at the present competition based on at least the first play situation and playing data associated with at least a subset of one or both of the first set of one or more participants and the second set of one or more participant. The base module 1568 provides, at step 1610, the wager odds on the wagering app 1510. In various embodiments, the wager odds are transmitted to the wagering app 1510 through the wager network 1514 to be displayed on a mobile device 1508. In some embodiments, the wagering app 1510, a program that enables the user to place bets on individual plays in the live event 1502, streams audio and video from the live event 1502 and features the available wagers from the live event 1502 on the mobile device 1508. The wagering app 1510 allows users to interact with the wagering network 1514 to place bets and provide payment/receive funds based on wager outcomes.

FIG. 17 illustrates the machine learning module 1570. The process begins with the machine learning module 1570 being initiated, at step 1700, by the base module 1568. Then the machine learning module 1570 receives, at step 1702, a request for a new machine learning ensemble 1566. For example, the wagering network 1514 may send a request for a new machine learning ensemble 1566, such as a daily request, weekly request, monthly request, quarterly request, yearly request, etc. The machine learning module 1570 generates, at step 1704, a plurality of learned functions based on the received training data. For example, the function generator module 1546 generates a plurality of learned functions based on the received training data from different machine learning classes. A learned function comprises a computer-readable code that accepts an input and provides a result. A learned function may comprise a compiled code, a script, text, a data structure, a file, a function, or the like. In some embodiments, a learned function may accept instances of one or more features as input and provide a result, such as a classification, a confidence metric, an inferred function, a regression function, an answer, a prediction, a recognized pattern, a rule, a recommendation, an evaluation, or the like. In another embodiment, certain learned functions may accept instances of one or more features as input and provide a subset of the instances, a subset of the one or more features, or the like as an output. In a further embodiment, certain learned functions may receive the output or result of one or more other learned functions as input, such as a Bayes classifier, a Boltzmann machine, or the like. Then the machine learning module 1570 evaluates, at step 1706, the plurality of generated learned functions. For example, the function evaluator module 1556 evaluates the plurality of generated learned functions to generate evaluation metadata. The function evaluator module 1556 is configured to evaluate learned functions using test data or the like. The function evaluator module 1556 may evaluate learned functions generated by the function generator module 1546, learned functions combined by the combiner module 1550, learned functions extended by the extender module 1552, combined extended learned functions, synthesized learned functions organized into the machine learning ensemble 1566 by the synthesizer module 1554, or the like. Test data for a learned function, in certain embodiments, comprises a different subset of the initialization data for the learned function than the function generator module 1546 used as training data. The function evaluator module 1556, in one embodiment, evaluates a learned function by inputting the test data into the learned function to produce a result, such as a classification, a confidence metric, an inferred function, a regression function, an answer, a prediction, a recognized pattern, a rule, a recommendation, an evaluation, or another result. The machine learning module 1570 combines, at step 1708, learned functions based on the metadata from the evaluation. For example, the combiner module 1550 combines learned functions based on the metadata from the evaluation performed by the function evaluator module 1556. For example, the combiner module 1550 combines learned functions, forming sets, strings, groups, trees, or clusters of combined learned functions. In certain embodiments, the combiner module 1550 combines learned functions into a prescribed order, and different orders of learned functions may have different inputs, produce different results, or the like. The combiner module 1550 may combine learned functions in different combinations. For example, the combiner module 1550 may combine certain learned functions horizontally or in parallel, joined at the inputs and outputs or the like, and may combine certain learned functions vertically or in series, feeding the output of one into the input of another learned function. The combiner module 1550 may determine which learned functions to combine, how to combine learned functions, or the like based on evaluation metadata for the learned functions from the metadata database 1558, generated based on an evaluation of the learned functions using test data, as described below with regard to the function evaluator module 1556. The combiner module 1550 may request additional learned functions from the function generator module 1546 for combining with other learned functions. For example, the combiner module 1550 may request a new learned function with a particular input and/or output to combine with an existing learned function or the like. The machine learning module 1570 extends, at step 1710, one or more learned functions by adding one or more layers to the one or more learned functions. For example, the extender module 1552 extends one or more learned functions by adding one or more layers to the one or more learned functions, such as a probabilistic model layer or the like. In certain embodiments, the extender module 1552 extends combined learned functions based on the evaluation of the combined learned functions. For example, in certain embodiments, the extender module 1552 is configured to add one or more layers to a learned function. For example, the extender module 1552 may extend a learned function or combined learned function by adding a probabilistic model layer, such as a Bayesian belief network layer, a Bayes classifier layer, a Boltzmann layer, or the like. Certain classes of learned functions, such as probabilistic models, may be configured to receive either instances of one or more features as input or the output results of other learned functions, such as a classification and a confidence metric, an inferred function, a regression function, an answer, a prediction, a recognized pattern, a rule, a recommendation, an evaluation, or the like. The extender module 1552 may use these types of learned functions to extend other learned functions. The extender module 1552 may extend learned functions generated by the function generator module 1546 directly, may extend combined learned functions from the combiner module 1550, may extend other extended learned functions, may extend synthesized learned functions from the synthesizer module 1554, or the like. Then the machine learning module 1570 requests, at step 1712, that the function generator module 1546 generate additional learned functions for the extender module to extend. For example, the extender module 1552 may request that the function generator module 1546 generate additional learned functions for the extender module 1552 to extend. For example, the function generator module 1546 may generate learned functions from multiple machine learning classes, models, or algorithms. For example, the function generator module 1546 may generate decision trees; decision forests; kernel classifiers and regression machines with a plurality of reproducing kernels; non-kernel regression and classification machines such as logistic, CART, multi-layer neural nets with various topologies; Bayesian-type classifiers such as Nave Bayes and Boltzmann machines; logistic regression; multinomial logistic regression; probit regression; AR; MA; ARMA; ARCH; GARCH; VAR; survival or duration analysis; MARS; radial basis functions; support vector machines; k-nearest neighbors; geospatial predictive modeling; and/or other classes of learned functions. The machine learning module 1570 evaluates, at step 1714, the extended learned functions. For example, the function evaluator module 1556 evaluates the extended learned functions. For example, in one embodiment, the function evaluator module 1556 is configured to maintain evaluation metadata for an evaluated learned function in the metadata database 1558. The evaluation metadata, in certain embodiments, comprises log data generated by the function generator module 1546 while generating learned functions, the function evaluator module 1556 while evaluating learned functions, or the like. In one embodiment, the evaluation metadata includes indicators of one or more training data sets that the function generator module 1546 used to generate a learned function. The evaluation metadata, in another embodiment, includes indicators of one or more test data sets that the function evaluator module 1556 used to evaluate a learned function. In a further embodiment, the evaluation metadata includes indicators of one or more decisions made by and/or branches taken by a learned function during an evaluation by the function evaluator module 1556. The evaluation metadata, in another embodiment, includes the results determined by a learned function during an evaluation by the function evaluator module 1556. In one embodiment, the evaluation metadata may include evaluation metrics, learning metrics, effectiveness metrics, convergence metrics, or the like for a learned function based on an evaluation of the learned function. An evaluation metric, learning metrics, effectiveness metric, convergence metric, or the like may be based on a comparison of the results from a learned function to actual values from initialization data and may be represented by a correctness indicator for each evaluated instance, a percentage, a ratio, or the like. Different classes of learned functions in certain embodiments may have different types of evaluation metadata. The machine learning module 1570 synthesizes, at step 1716, the selected learned functions into synthesized learned functions. For example, the synthesizer module 1554 synthesizes the selected learned functions into synthesized learned functions. For example, in certain embodiments, the synthesizer module 1554 is configured to organize a subset of learned functions into the machine learning ensemble 1566, as synthesized learned functions. In a further embodiment, the synthesizer module 1554 includes evaluation metadata from the metadata database 1558 of the function evaluator module 1556 in the machine learning ensemble 1566 as a synthesized metadata rule set, so that the machine learning ensemble 1566 includes synthesized learned functions and evaluation metadata, the synthesized metadata rule set, for the synthesized learned functions. The learned functions that the synthesizer module 1554 synthesizes or organizes into the synthesized learned functions of the machine learning ensemble 1566 may include learned functions directly from the function generator module 1546 combined learned functions from the combiner module 1550, extended learned functions from the extender module 1552, combined extended learned functions, or the like. In one embodiment, the function selector module 1560 selects the learned functions for the synthesizer module 1554 to include in the machine learning ensemble 1566. In certain embodiments, the synthesizer module 1554 organizes learned functions by preparing the learned functions and the associated evaluation metadata for processing workload data to reach a result. For example, as described below, the synthesizer module 1554 may organize and/or synthesize the synthesized learned functions and the synthesized metadata rule set for the orchestration module to direct workload data through the synthesized learned functions to produce a result. Then the machine learning module 1570 evaluates, at step 1718, the synthesized learned functions to generate a synthesized metadata rule set. For example, the function evaluator module 1556 evaluates the synthesized learned functions to generate a synthesized metadata rule set. Then the machine learning module 1570 organizes, at step 1720, the synthesized learned functions and the synthesized metadata rule set into a machine learning ensemble 1566. For example, the synthesizer module 1554 organizes the synthesized learned functions and the synthesized metadata rule set into a machine learning ensemble 1566. For example, the machine learning ensemble 1566 may be used to respond to analysis requests, such as processing collected and coordinated data using machine learning and to provide machine learning results, such as a classification, a confidence metric, an inferred function, a regression function, an answer, a prediction, a recognized pattern, a rule, a recommendation, or other results. The machine learning module 1570 stores, at step 1722, the machine learning ensemble 1566. For example, the machine learning module 1570 may store the machine learning ensemble 1566 on the wagering network, within a database, etc. such as to provide machine learning results, such as a classification, a confidence metric, an inferred function, a regression function, an answer, a prediction, a recognized pattern, a rule, a recommendation, or other results. The machine learning module 1570 returns, at step 1724, to the base module 1568.

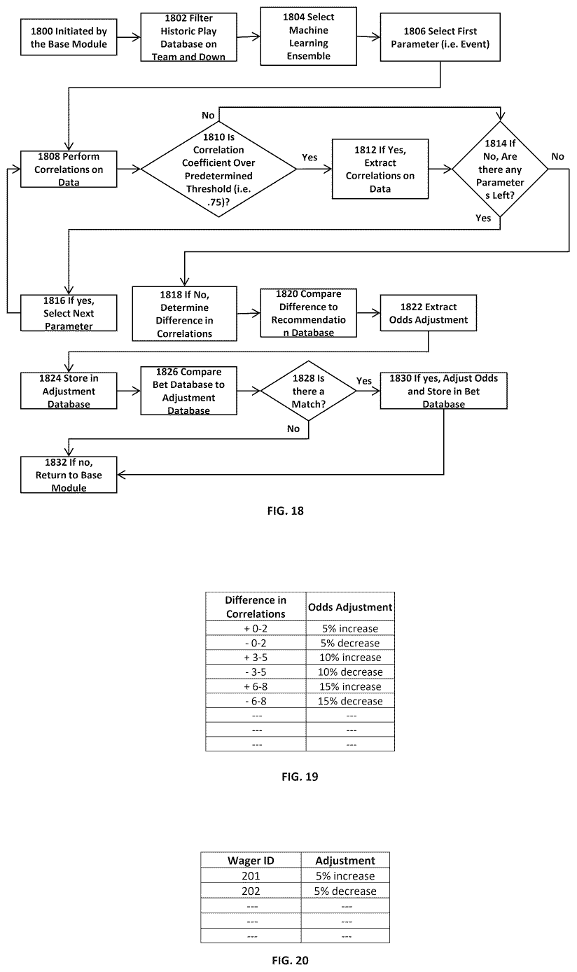

FIG. 18 illustrates the odds calculation module 1572. The process begins with the odds calculation module 1572 being initiated, at step 1800, by the base module 1568. In some embodiments, the odds calculation module 1572 may be continuously polling for the data from the live event 1502. In some embodiments, the odds calculation module 1572 may receive the data from the live event 1502. In some embodiments, the odds calculation module 1572 may store the results data, or the results of the last action, in the historical plays database 1518, which may contain historical data of all previous actions. The odds calculation module 1572 filters, at step 1802, the historical plays database 1518 on the team and inning from the situational data. The odds calculation module 1572 selects, at step 1804, the machine learning ensemble 1566. For example, the machine learning ensemble 1566 may be used to respond to analysis requests (e.g., processing collected and coordinated data using machine learning) and to provide machine learning results, such as a classification, a confidence metric, an inferred function, a regression function, an answer, a prediction, a recognized pattern, a rule, a recommendation, or other results. For example, if the machine learning ensemble 1566 is a regression function or regression analysis, such as a measure of the relation between the mean value of one variable and corresponding values of other variables, then the odds calculation module 1572 uses the selected variables or parameters to perform correlations that the machine learning ensemble 1566 has deemed highly correlated. Then if the correlation coefficients are above a predetermined threshold, the odds calculation module 1572 will be extracted and compared to the recommendations database 1574 and extracts the odds adjustment and then stores the odds adjustment to the adjustment database 1576 and then compares the adjustment database 1576 to the odds database 1520 to determine if any wager odds need to be altered, adjusted, etc. before being offered on the wagering app 1510. The odds calculation module 1572 selects, at step 1806, the first parameter of the historical plays database 1518, for example, the event. Then the odds calculation module 1572 performs, at step 1808, correlations on the data. For example, the historical plays database 1518 is filtered on the team, the players, the quarter, the down, and the distance to be gained. The first parameter is selected, which in this example is the event, which may either be a pass or a run, and the historical plays database 1518 is filtered on the event being a pass. Then, correlations are performed on the rest of the parameters, which are yards gained, temperature, decibel level, etc. Correlated data for the historical data involving the Patriots in the first quarter on first down with 10 yards to go and the play being a pass, which has a correlation coefficient of 0.81. The correlations are also performed with the same filters, and the next event is the play being a run with a correlation coefficient of 0.79. Then the odds calculation module 1572 determines, at step 1810, if the correlation coefficient is above a predetermined threshold, for example, 0.75, to determine if the data is highly correlated and deemed a relevant correlation. If the correlation is deemed highly relevant, then the odds calculation module 1572 extracts, at step 1812, the correlation coefficient from the data. For example, the two correlation coefficients of 0.81 for a pass and 0.79 for a run are extracted. If it is determined that the correlations are not highly relevant, then the odds calculation module 1572 determines, at step 1814, if any parameters are remaining. Also, if the correlations were determined to be highly relevant and therefore extracted, it is also determined if any parameters are remaining to perform correlations on. If there are additional parameters to have correlations performed, then the odds calculation module 1572 selects, at step 1816, the next parameter in the historical plays database 1518, and the process returns to performing correlations on the data. For example, the machine learning ensemble 1566 may have also identified other variables or parameters deemed to be highly important or have previously been shown to be highly correlated, and the next parameters are selected. Once there are no remaining parameters to perform correlations on, the odds calculation module 1572 then determines, at step 1818, the difference between each of the extracted correlations. For example, the correlation coefficient for a pass is 0.81, and the correlation coefficient for a run is 0.79. The difference between the two correlation coefficients (0.81−0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendations database 1528 to compare the two correlation coefficient based on statistical significance as opposed to the difference of the two correlation coefficients. Then the odds calculation module 1572 compares, at step 1820, the difference between the two correlation coefficients, for example, 0.02, to the recommendations database 1574. The recommendations database 1574 contains various ranges of differences in correlations and the corresponding odds adjustment for those ranges. For example, the 0.02 difference of the two correlation coefficients falls into the range +0-2 difference in correlations which, according to the recommendations database, 1574 should have an odds adjustment of 5% increase. The odds calculation module 1572 then extracts, at step 1822, the odds adjustment from the recommendations database 1574. The odds calculation module 1572 then stores, at step 1824, the extracted odds adjustment in the adjustment database 1576. The odds calculation module 1572 compares, at step 1826, the odds database 1520 to the adjustment database 1576. The odds calculation module 1572 then determines, at step 1828, whether there is a match in any of the wager IDs in the odds database 1520 and the adjustment database 1576. For example, the odds database 1520 contains a list of all the current bet options for a user; for each bet option, the odds database 1520 contains a wager ID, event, time, inning, wager, and odds. The adjustment database 1576 contains the wager ID and the percentage, either as an increase or decrease, that the odds should be adjusted. If it is determined there is a match between the odds database 1520 and the adjustment database 1576, then the odds calculation module 1572 adjust, at step 1830, the odds in the odds database 1520 by the percentage increase or decrease in the adjustment database 1576 and the odds in the odds database 1520 are updated. For example, if the odds in the odds database 1520 are −105 and the matched wager ID in the adjustment database 1576 is a 5% increase, then the updated odds in the odds database 1520 should be −110. If there is a match, then the odds are adjusted based on the data stored in the adjustment database 1576, and the new data is stored in the odds database 1520 over the old entry. If there are no matches, or, once the odds database 1520 has been adjusted if there are matches, the odds calculation module 1572 returns, at step 1832, to the base module 1568. In some embodiments, the odds calculation module 1572 may offer the odds database 1520 to the wagering app 1510, allowing users to place bets on the wagers stored in the odds database 1520. In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 1572. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1−b2/Sb1−b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 1572 may then extract an odds adjustment from the recommendations database 1574. The extracted odds adjustment is then stored in the adjustment database 1576. In some embodiments, the recommendations database 1574 may be used in the odds calculation module 1572 to determine how the wager odds should be adjusted depending on the difference between the correlation coefficients of the correlated data points. The recommendations database 1574 may contain the difference in correlations and the odds adjustment. For example, if there is a correlation coefficient for a pass being thrown by the Patriots in the first quarter on first down of 0.81 and a correlation coefficient for a run being performed by the Patriots in the first quarter on first down of 0.79, the difference between the two would be +0.02 when compared to the recommendations database 1574 the odds adjustment would be a 5% increase for a Patriots pass or otherwise identified as wager 201 in the adjustment database 1576. In some embodiments, the difference in correlations may be the statistical significance of comparing the two correlation coefficients to determine how the odds should be adjusted. In some embodiments, the adjustment database 1576 may be used to adjust the wager odds of the odds database 1520 if it is determined that a wager should be adjusted. The adjustment database 1576 contains the wager ID, which is used to match with the odds database 1520 to adjust the odds of the correct wager.

FIG. 19 illustrates the recommendations database 1574. The recommendations database 1574 may be used in the odds calculation module 1572 to determine how the wager odds should be adjusted depending on the difference between the correlation coefficients of the correlated data points. The recommendations database 1574 may contain the difference in correlations and the odds adjustment. For example, if there is a correlation coefficient for a pass being thrown by the Patriots in the first quarter on first down of 0.81 and a correlation coefficient for a run being performed by the Patriots in the first quarter on first down of 0.79, the difference between the two would be +0.02 when compared to the recommendations database 1574 the odds adjustment would be a 5% increase for a Patriots pass or otherwise identified as wager 201 in the adjustment database 1576. In some embodiments, the difference in correlations may be the statistical significance of comparing the two correlation coefficients to determine how the odds should be adjusted.

FIG. 20 illustrates the adjustment database 1576. The adjustment database 1576 may be used to adjust the wager odds of the odds database 1520 if it is determined that a wager should be adjusted. The adjustment database 1576 contains the wager ID, which is used to match with the odds database 1520 to adjust the odds of the correct wager.

In another embodiment, an artificial intelligence (AI) or machine learning (ML) parlay wager provider, generator, method, and system may be shown and described.

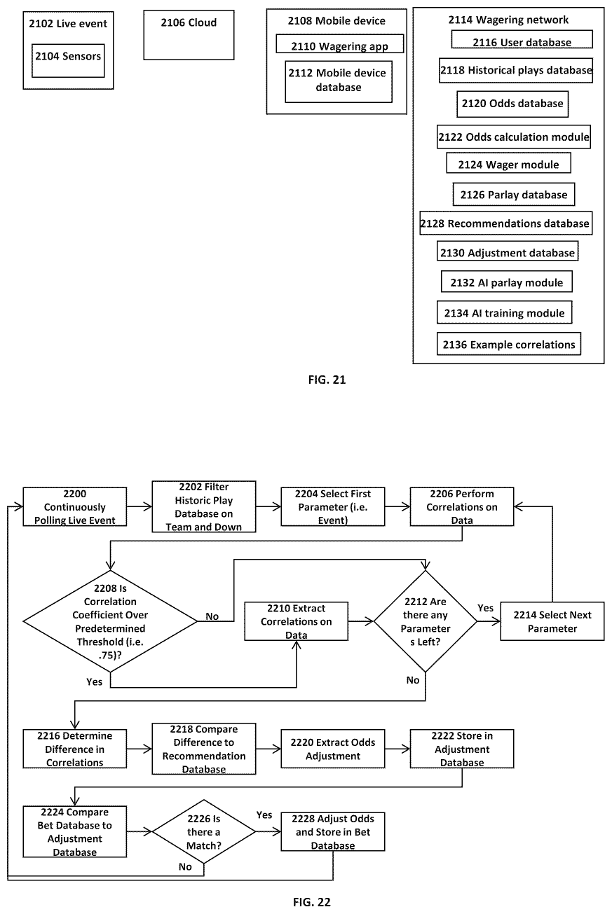

FIG. 21 is a system for parlay wager odds calculation. This system may include a live event 2102, for example, a sporting event such as a football, basketball, baseball, or hockey game, tennis match, golf tournament, eSports or digital game, etc. The live event 2102 may include some number of actions or plays upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 2102, such as the score of an American football game or the run line in a baseball game, or a series of actions in the live event 2102. Sportsbooks have several bets they can handle, which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers, which can be done at kiosks at the live event 2102 or at another location.

Further, embodiments may include a plurality of sensors 2104 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 2104 may include but are not limited to, tracking devices, such as RFID tags, GPS chips, or other such devices embedded on uniforms, in equipment, in the field of play, and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 2106 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 2106 may be communicatively coupled to a peer-to-peer wagering network 2114, which may perform real-time analysis on the type of play and the result of the play. The cloud 2106 may also be synchronized with game situational data such as the time of the game, the score, location on the field, weather conditions, and the like, which may affect the choice of play utilized. For example, in an exemplary embodiment, the cloud 2106 may not receive data gathered from the sensors 2104 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 2108 such as a computing device, laptop, smartphone, tablet, computer, smart speaker, or I/O devices. I/O devices may be present in the computing device. Input devices may include but are not limited to keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide-semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include but are not limited to video displays, graphical displays, speakers, headphones, inkjet printers, laser printers, or 3D printers. Devices may include but are not limited to a combination of multiple input or output devices such as Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs, including, but not limited to, Microsoft KINECT, SIRI for iPhone by Apple, Google Now, or Google Voice Search. Additional user devices have both input and output capabilities, including, but not limited to, haptic feedback devices, touchscreen displays, or multi-touch displays. Touchscreen, multi-touch displays, touchpads, touch mice, or other touch sensing devices may use different technologies to sense touch, including but not limited to capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 2108 could be an optional component and would be utilized in a situation where a paired wearable device employs the mobile device 2108 for additional memory or computing power or connection to the internet.

Further, embodiments may include a wagering software application or a wagering app 2110, which is a program that enables the user to place bets on individual plays in the live event 2102, streams audio and video from the live event 2102, and features the available wagers from the live event 2102 on the mobile device 2108. The wagering app 2110 allows users to interact with the wagering network 2114 to place bets and provide payment/receive funds based on wager outcomes.

Further, embodiments may include a mobile device database 2112 that may store some or all the user's data, the live event 2102, or the user's interaction with the wagering network 2114.

Further, embodiments may include the wagering network 2114, which may perform real-time analysis on the type of play and the result of a play or action. The wagering network 2114 (or the cloud 2106) may also be synchronized with game situational data, such as the time of the game, the score, location on the field, weather conditions, and the like, which may affect the choice of play utilized. For example, in an exemplary embodiment, the wagering network 2114 may not receive data gathered from the sensors 2104 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 2114 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 2116, which may contain data relevant to all users of the wagering network 2114 and may include, but is not limited to, a user ID, a device identifier, a paired device identifier, wagering history, or wallet information for the user. The user database 2116 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 2116 may contain betting lines and search queries. The user database 2116 may be searched based on a search criterion received from the user. Each betting line may include, but is not limited to, a plurality of betting attributes such as at least one of the live event 2102, a team, a player, an amount of wager, etc. The user database 2116 may include but is not limited to, information related to all the users involved in the live event 2102. In one exemplary embodiment, the user database 2116 may include information for generating a user authenticity report and a wagering verification report. Further, the user database 2116 may be used to store user statistics like, but not limited to, the retention period for a particular user, frequency of wagers placed by a particular user, the average amount of wager placed by each user, etc.

Further, embodiments may include a historical plays database 2118 that may contain play data for the type of sport being played in the live event 2102. For example, in American Football, for optimal odds calculation, the historical play data may include metadata about the historical plays, such as time, location, weather, previous plays, opponent, physiological data, etc.

Further, embodiments may utilize an odds database 2120—that contains the odds calculated by an odds calculation module 2122—to display the odds on the user's mobile device 2108 and take bets from the user through the mobile device wagering app 2110.

Further, embodiments may include the odds calculation module 2122, which utilizes historical play data to calculate odds for in-play wagers. For example, the odds calculation module 2122 may be continuously polling for the data from the live event 2102. The odds calculation module 2122 may receive the data from the live event 2102. The odds calculation module 2122 may store the results data, or the results of the last action, in the historical play database 2118, which may contain historical data of all previous actions. The odds calculation module 2122 filters the historical play database 2118 on the team and down from the situational data. The first parameter of the historical plays database 2118 is selected, for example, the event. Then the odds calculation module 2122 performs correlations on the data. For example, the historical action database 2130 is filtered on the team, the players, the quarter, the down, and the distance to be gained. The first parameter is selected, which in this example is the event, which may either be a pass or a run, and the historical action database 2130 is filtered on the event being a pass. Then, correlations are performed on the rest of the parameters, which are yards gained, temperature, decibel level, etc. In one embodiment, the parameter may be selected based on an unsupervised machine learning algorithm-created filter. For example, an unsupervised machine learning betting system may create a filter from examining historical play data. That filter may identify that decibel level is highly correlated to passing odds when the noise level exceeds 70 decibels in Arrowhead Stadium in Kansas City. In FIG. 27B, the graph shows the correlated data for the historical data involving the Patriots in the second quarter on second down with five yards to go and the action being a pass, which has a correlation coefficient of 0.81. The correlations are also performed with the same filters and the next event, which is the action being a run which is also shown in FIG. 27B and has a correlation coefficient of 0.79. It is determined if the correlation coefficient is above a predetermined threshold, for example, 0.75, in order to determine if the data is highly correlated and deemed a relevant correlation. If the correlation is deemed highly relevant, then the correlation coefficient is extracted from the date. For example, the two correlation coefficients of 0.81 for a pass and 0.79 for a run are both extracted. If it is determined that the correlations are not highly relevant, then then it is determined if any parameters are remaining. Also, if the correlations were determined to be highly relevant, it is also determined if any parameters are remaining to perform correlations on. If there are additional parameters to have correlations performed, then the odds calculation module 2122 selects the next parameter in the historic action database and returns to performing correlations on the data. Once there are no remaining parameters to perform correlations on, the odds calculation module 2122 determines the difference between each of the extracted correlations. For example, the correlation coefficient for a pass is 0.81, and the correlation coefficient for a run is 0.79. The difference between the two correlation coefficients (0.81−0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendations database to compare the two correlation coefficient based on statistical significance as opposed to the difference of the two correlation coefficients. The difference between the two correlation coefficients, 0.02, is then compared to the recommendations database 2128. The recommendations database 2128 contains various ranges of differences in correlations as well as the corresponding odds adjustment for those ranges. For example, the 0.02 difference of the two correlation coefficients falls into the range +0-2 difference in correlations which, according to the recommendations database 2128, should have an odds adjustment of 5% increase. The odds calculation module 2122 then extracts the odds adjustment from the recommendations database 2128. The extracted odds adjustment is stored in an adjustment database 2130. The odds calculation module 2122 compares the odds database 2120 to the adjustment database 2130. It is determined whether or not there is a match in any of the wager IDs in the odds database 2120 and the adjustment database. For example, the odds database 2120 contains a list of all the current bet options for a user. The odds database 2120 contains a wager ID, event, time, quarter, wager, and odds for each bet option. The adjustment database contains the wager ID and the percentage, either as an increase or decrease, that the odds should be adjusted. If there is a match between the odds database 2120 and the adjustment database 2130, then the odds in the odds database 2120 are adjusted by the percentage increase or decrease in the adjustment database 2130, and the odds in the odds database 2120 are updated. For example, if the odds in the odds database 2120 are −105 and the matched wager ID in the adjustment database 2130 is a 5% increase, then the updated odds in the odds database 2120 should be −110. If there is a match, then the odds are adjusted based on the data stored in the adjustment database 2130, and the new data is stored in the odds database 2120 over the old entry. If there are no matches, or once the odds database 2120 has been adjusted if there are matches, the odds calculation module 2122 offers the odds database 2120 to the wagering app 2110, allowing users to place bets on the wagers stored in the odds database 2120. In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 2122. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1−b2/Sb1−b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 2122 may then extract an odds adjustment from the recommendations database 2128. The extracted odds adjustment is then stored in the adjustment database. In some embodiments, the recommendations database 2128 may be used in the odds calculation module 2122 to determine how the wager odds should be adjusted depending on the difference between the correlation coefficients of the correlated data points. The recommendations database 2128 may contain the difference in correlations and the odds adjustment. For example, in FIG. 3B there is a correlation coefficient for a Patriots 2nd down pass of 0.81 and a correlation coefficient for a Patriots 2nd run of 0.79, the difference between the two would be +0.02 when compared to the recommendations database the odds adjustment would be a 5% increase for a Patriots pass or otherwise identified as wager 201 in the adjustment database. In some embodiments, the difference in correlations may be the statistical significance of comparing the two correlation coefficients in order to determine how the odds should be adjusted. In some embodiments, the adjustment database may be used to adjust the wager odds of the odds database 2120 if it is determined that a wager should be adjusted. The adjustment database 2130 contains the wager ID, which is used to match with the odds database 2120 to adjust the odds of the correct wager.

Further, embodiments may include a wager module 2124, which may determine the odds of each next possible event of the live event 2102. Then, the wager module 2124 may prompt the odds calculation module 2122 to calculate the odds of each outcome of those next possible events. The wager module 2124 may offer users to place a parlay wager, which is a wager on multiple outcomes, the odds of which may be more favorable than betting on each outcome separately.

Further, embodiments may include a parlay database 2126, which may contain the odds for the outcomes of possible future events.

Further, embodiments may include a recommendations database 2128 that may be used in the odds calculation module 2124 to determine how the wager odds should be adjusted depending on the difference between the correlation coefficients of the correlated data points. The recommendations database 2128 may contain the difference in correlations and the odds adjustment. For example, if there is a correlation coefficient for a Red Sox second inning with a runner on base with one out and a stolen base of 0.81 and a correlation coefficient for a Red Sox second inning with a runner on base with one out and the runner caught stealing of 0.79, the difference between the two would be +0.02 when compared to the recommendations database 2128 the odds adjustment would be a 5% increase for a Red Sox stolen base or otherwise identified as wager 201 in the adjustment database 2130. In some embodiments, the difference in correlations may be the statistical significance of comparing the two correlation coefficients in order to determine how the odds should be adjusted.

Further, embodiments may include an adjustment database 2130 that may be used to adjust the wager odds of the odds database 2120 if it is determined that a wager should be adjusted. The adjustment database 2130 contains the wager ID, which is used to match with the odds database 2120 to adjust the odds of the correct wager.

Further, embodiments may include an AI parlay module 2132, which may determine which parlay wagers to offer to a user. Which options are offered may be based on user behavior, the risk to the sportsbook, wagers needed to balance the sportsbook, profit of the sportsbook, user engagement, user retention, etc.

Further, embodiments may include an AI training module 2134, which may train the AI algorithm used in the AI parlay module 2132 based on which parlay options users end up wagering on.

Further, embodiments may include a weights database 2136 that stores weights for each parameter or metric used by the AI parlay module 2132 to determine a score for each parlay wager. These weights are altered over time by the AI training module 2134 as part of a machine learning process. If the AI parlay module 2132 uses a neural network algorithm, the weights database 2136 may include other data, such as biases, required for the algorithm. The weights database 2136 may also contain any other data required for any other AI or machine learning algorithm.

FIG. 22 illustrates the odds calculation module 2122. The process may begin with the odds calculation module 2124 continuously polling for the data from the live event 2102 at step 2200. In some embodiments, the odds calculation module 2124 may receive the data from the live event 2102. In some embodiments, the odds calculation module 2124 may store the results data, or the results of the last action, in the historical play database 2118, which may contain historical data of all previous actions. The odds calculation module 2124 filters, at step 2202, the historical play database 2118 on the live event 2102 status, such as team on offense, down and distance, position on the field, etc., from the situational data. The odds calculation module 2124 selects, at step 2204, the first parameter of the historical plays database 2118, for example, the event. Then the odds calculation module 2124 performs, at step 2206, correlations on the data. For example, the historical play database 2118 is filtered on the team, the players, the inning, and the number of outs. The first parameter is selected, which in this example is the event, which may be a stolen base, and the historical play database 2118 is filtered on the event being a stolen base. Then, correlations are performed on the rest of the parameters, which are how far away the baserunner is from first base, how far away is the first baseman from first base, and how far away is the second baseman from second base, etc. In an example of correlated data, the correlated data for the historical data involving the Red Sox in the second inning with one out recorded and the action being a stolen base, which has a correlation coefficient of 0.81. The correlations are also performed with the same filters, and the next event, which is the action being the runner is caught stealing, has a correlation coefficient of 0.79. Then the odds calculation module 2124 determines, at step 2208, if the correlation coefficient is above a predetermined threshold, for example, 0.75, in order to determine if the data is highly correlated and deemed a relevant correlation. If the correlation is deemed highly relevant, then the odds calculation module 2124 extracts, at step 2210, the correlation coefficient from the data. For example, the two correlation coefficients of 0.81 for a stolen base and 0.79 for a runner caught stealing are both extracted. If it is determined that the correlations are not highly relevant, then the odds calculation module 2124 determines, at step 2212, if any parameters are remaining. Also, if the correlations were determined to be highly relevant and therefore extracted, it is also determined if any parameters are remaining to perform correlations on. If there are additional parameters to have correlations performed, then the odds calculation module 2124 selects, at step 2214, the next parameter in the historical plays database 2118, and the process returns to performing correlations on the data. Once there are no remaining parameters to perform correlations on, the odds calculation module 2124 then determines, at step 2216, the difference between each of the extracted correlations. For example, the correlation coefficient for a stolen base is 0.81, and the correlation coefficient for a runner caught stealing is 0.79. The difference between the two correlation coefficients (0.81−0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendations database 2128 to compare the two correlation coefficient based on statistical significance as opposed to the difference of the two correlation coefficients. Then the odds calculation module compares, at step 2218, the difference between the two correlation coefficients, for example, 0.02, to the recommendations database 2128. The recommendations database 2128 contains various ranges of differences in correlations as well as the corresponding odds adjustment for those ranges. For example, the 0.02 difference of the two correlation coefficients falls into the range +0-2 difference in correlations which, according to the recommendations database 2128, should have an odds adjustment of 5% increase. The odds calculation module 2124 then extracts, at step 2220, the odds adjustment from the recommendations database 2128. The odds calculation module then stores, at step 2222, the extracted odds adjustment in the adjustment database 2130. The odds calculation module 2124 compares, at step 2224, the odds database 2120 to the adjustment database 2130. The odds calculation module 2124 then determines, at step 2226, whether or not there is a match in any of the wager IDs in the odds database 2120 and the adjustment database 2130. For example, the odds database 2120 contains a list of all the current bet options for a user. The odds database 2120 contains a wager ID, event, time, inning, wager, and odds for each bet option. The adjustment database 2130 contains the wager ID and the percentage, either as an increase or decrease, that the odds should be adjusted. If it is determined there is a match between the odds database 2120 and the adjustment database 2130, then the odds calculation module 2124 adjust, at step 2228, the odds in the odds database 2120 by the percentage increase or decrease in the adjustment database 2130 and the odds in the odds database 2120 are updated. For example, if the odds in the odds database 2120 are −105 and the matched wager ID in the adjustment database 2130 is a 5% increase, then the updated odds in the odds database 2120 should be −110. If there is a match, then the odds are adjusted based on the data stored in the adjustment database 2130, and the new data is stored in the odds database 2120 over the old entry. If there are no matches, or once the odds database 2120 has been adjusted if there are matches, the odds calculation module 2124 returns to step 2200. In some embodiments, the odds calculation module 2124 may offer the odds database 2120 to the wagering app 2110, allowing users to place bets on the wagers stored in the odds database 2120. In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 2124. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1−b2/Sb1−b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 2124 may then extract an odds adjustment from the recommendations database 2128. The extracted odds adjustment is then stored in the adjustment database 2130. In some embodiments, the recommendations database 2128 may be used in the odds calculation module 2124 to determine how the wager odds should be adjusted depending on the difference between the correlation coefficients of the correlated data points. The recommendations database 2128 may contain the difference in correlations and the odds adjustment. For example, if there is a correlation coefficient for a Red Sox second inning with a runner on base with one out and a stolen base of 0.81 and a correlation coefficient for a Red Sox second inning with a runner on base with one out and the runner caught stealing of 0.79, the difference between the two would be +0.02 when compared to the recommendations database 2128 the odds adjustment would be a 5% increase for a Red Sox stolen base or otherwise identified as wager 201 in the adjustment database 2130. In some embodiments, the difference in correlations may be the statistical significance of comparing the two correlation coefficients in order to determine how the odds should be adjusted. In some embodiments, the adjustment database 2130 may be used to adjust the wager odds of the odds database 2120 if it is determined that a wager should be adjusted. The adjustment database 2130 contains the wager ID, which is used to match with the odds database 2120 to adjust the odds of the correct wager. Odds from the odds database 2120 may be provided as starting indicators of odds movement on a betting exchange system.

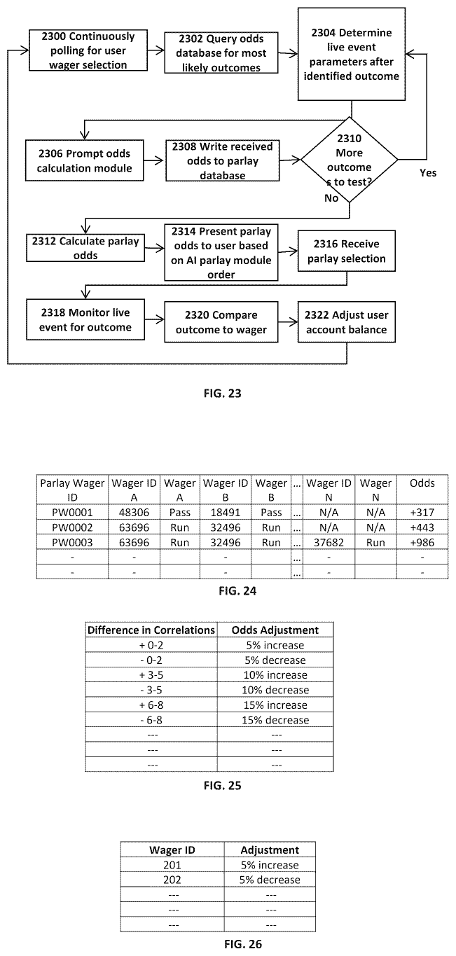

FIG. 23 illustrates the wager module 2124. The process begins with the wagering module 2124 continuously polling for a user wager selection at step 2300. When a user selects a wager, the odds database 2120 may be queried at step 2302 for the most likely outcomes of the wager. For example, a user may wager $10 at +150 odds that the Patriots will pass on 1st down and 10 from their 30-yard line. The odds database 2120 may indicate there is a 30% chance of an incomplete pass, a 10% chance of a short completed pass, a 10% chance of a run for no gain, a 10% chance of a short run, a 10% chance of a pass for 10-20 yards. In this example, the three most likely outcomes of the current play are examined, but more outcomes may be examined. The threshold for the number of outcomes to be examined may be static and defined by an administrator. It may also be based on the likelihood of the potential outcomes, for example, selecting all outcomes with a greater than 10% chance of being true. In other embodiments, the number of potential outcomes to examine may be dynamically determined by an algorithm. The parameters of the live event 2102 after the retrieved likely outcomes may be identified at step 304. The odds database 2120 may indicate that there is a 40% chance the next play will be 2nd down and 10 from the same 30-yard line, based on the combination of an incomplete pass probability (30%) and the run for no gain probability (10%), as both of those outcomes result in the same parameters of the live event 2102. It is also determined that there is a 20% chance the next play will be 2nd down and between 3 and 7, and a 10% chance it will be 1st and 10 between the 40-yard line and midfield. at step 2304. The odds calculation module 2122 may be prompted, at step 2306, to determine the odds that could be offered on one or more outcomes for the live event 2102 in the identified parameters. For example, the odds calculation module 2122 may calculate −150 odds the Patriots will pass on 2nd down and 10 from their 40-yard line. at step 2306. The odds calculated may be written to the parlay database 2126, at step 2308. Odds from the parlay database 2126 may be provided as starting indicators of odds movement on a betting exchange system. It may then be determined, at step 2310, if there are more outcomes to test. For example, the second and third most likely situations in the live event 2102. If more outcomes are to be tested, the process returns to step 2306. at step 2310. A parlay is a single bet that links together two or more individual wagers for a high payout. A two-wager parlay might pay 13/5 (+260), a three-wager parlay might pay 6/1 (+600), a four-wager parlay might pay 10/1(+1000), and so forth, with the payouts getting higher with more wagers or totals selected. Once the odds calculation module 2122 has calculated the odds on at least one outcome of the potential future state of the live event 2102, the odds of parlaying that wager with the original wager selected by the user may be calculated at step 2312. The wager module 2124 may present, at step 2314, one or more parlay wager options and odds to the user. For example, the user's current wager is for the Patriots to pass at +150. The odds of the Patriots passing on 2nd and 10 (the most likely future state of the live event 2102 with a 40% probability of occurring) are −150. Those two wagers may be combined into a single parlay with odds of +317. This combination of the two individual wager odds, plus the extra payout for a parlay. Sportsbooks may vary the amount of extra payout given on a parlay. In one embodiment, the amount of extra payout offered on a parlay may be customized to the user based on their likely response to the offer. In one embodiment, the odds of an outcome on the next play may be blended across multiple potential outcomes of the current play. For example, the odds for the Patriots to pass on the next play may be 60% if it is 2nd and 10, 37% if it is 2nd and 3-7, and 40% if it is 1st and 10. The odds of those situations being 40%, 20%, and 10%, respectively. The other 30% of possible next states of the game may have odds of a pass that are too difficult or not significant enough to calculate individually. These states may be given a general or default value for the likelihood of a pass, for example, the average percentage of times the Patriots pass overall, which in 2019 was about 58%. Then the total odds of the next play being a pass are 60%×40% plus 37%×20% plus 40%×10% plus 58%×30% which is equal to 52.8%. The combined odds of the current play resulting pass and the next play being a pass are 60%×52.8%, equal to 31.68% or about +214. Parlay wagers generally pay a premium over betting and winning the constituent wagers, so actual odds offered to the user may be adjusted up to, for example, +215 or +220 to make the parlay wager more enticing to users. This calculation may be used to calculate the odds for parlay wagers made from more than two wagers. The three odds of the same event happening could be blended and weighted based on the likelihood of each situation and the likelihood of a pass in that situation. For example, a parlay wager option may be that the three next plays are all passes or that over the next 4 downs, there will never be an interception. The wager module 2124 may use machine learning or AI to optimize profit, revenue, user engagement, new user recruitment, etc., by selecting which parlay options are shown to the user and how the odds of those parlay options are adjusted. The wager module 2124 may receive, at step 2316, a parley selection from the user. The wager module 2124 may monitor, at step 2318, the live event 2102 for the outcome of the events wagered on. This may require the wager module 2124 to continue to monitor multiple events until all events wagered on by one parlay wager are concluded or until at least one outcome would cause the user to lose the wager. The wager module 2124 may compare, at step 2320, the outcome of an event wagered on to the wager. For example, a wager is placed by a user that the next play would be a run. The outcome of the next play is a pass. Therefore the wager is lost. The wager module 2124 may adjust, at step 2322, the account balance of the user based on whether the wager was won or lost. The wager module 2124 may then return to step 300.

FIG. 24 provides the illustration of the parlay database 2126 that may contain parlay wagers and odds. Each parlay wager is made of two or more wagers. The details of these wagers may be stored in the parlay database 2126 or another database such as a wager database or bet database. The parlay database 2126 may contain wager IDs for these wagers such that they can be referenced if they are stored in a separate database.

FIG. 25 provides the illustration of the recommendations database 2128 that may be used in the odds calculation module 2124 to determine how the wager odds should be adjusted depending on the difference between the correlation coefficients of the correlated data points. The recommendations database 2128 may contain the difference in correlations and the odds adjustment. For example, if there is a correlation coefficient for a Red Sox second inning with a runner on base with one out and a stolen base of 0.81 and a correlation coefficient for a Red Sox second inning with a runner on base with one out and the runner caught stealing of 0.79, the difference between the two would be +0.02 when compared to the recommendations database 2128 the odds adjustment would be a 5% increase for a Red Sox stolen base or otherwise identified as wager 201 in the adjustment database 2130. In some embodiments, the difference in correlations may be the statistical significance of comparing the two correlation coefficients in order to determine how the odds should be adjusted.

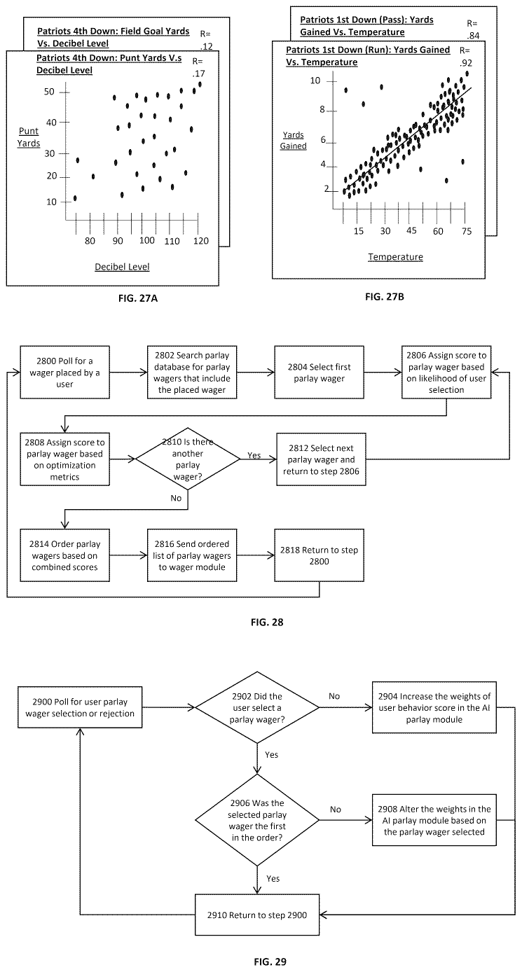

FIG. 26 provides the illustration of the adjustment database 2130 may be used to adjust the wager odds of the odds database 2120 if it is determined that a wager should be adjusted. The adjustment database 2130 contains the wager ID, which is used to match with the odds database 2120 to adjust the odds of the correct wager.

FIG. 27A provides the exemplary illustration of the correlated data for the historical data. In an exemplary embodiment the illustration may show data related to the patriots in the 4^{th} down. The exemplary illustration may be, for example, a graph showing punt yards on the y-axis and showing decibel level of the audience on the x axis. The illustration may further show a correlation level between the X and Y axis, for example an R value of 0.17.

FIG. 27B provides another illustration of the correlated data for the historical data. In an exemplary embodiment the illustration may show data related to a run after 1^{st} down. The exemplary illustration may be, for example, a graph showing yards gained on the Y-axis and outside temperature on the X-axis. The illustration may further show a correlation level between the X and Y axis, for example an R value of 0.92, and may also show a line of best fit.

FIG. 28 illustrates the functioning of the AI parlay module 2132. The process may begin with the AI parlay module 2132 polling, at step 2800, for a wager placed by a user. The AI parlay module 2132 may search, at step 2802, the parlay database for parlay wagers that include the wager placed by the user. The AI parlay module 2132 may also include wagers that are similar to the wager placed by the user or wagers that similar users have placed. Similar wagers may be wagers on the same team, with the same or close to the same odds, on the same play of the live event 2102, etc. Similar users may be users in the same demographic category such as age, location, ethnicity, etc., or may be users that the wagering user is connected to through the wagering app 2110 or other social media. The AI parlay module 2132 may select, at step 2804, the first parlay wager that includes the wager placed by the user. The AI parlay module 2132 may assign, at step 2806, a score to the selected parlay wager based on the likelihood that the user will accept the parlay wager. Likelihood may refer to the chance that the user will place a parlay wager. The likelihood that a user will place a parlay wager, or any wager, may be based on parameters such as the normal betting rate of the user, whether the user is on a winning or losing streak, the account balance of the user, the level of engagement of the user, etc. The AI parlay module 2132 may use data on the user stored in the user database to assign the score. The score may be based on user behavior parameters such as favorite team, wagering rate, parlay wagering rate, current win/lose ratio, win streak length, loss streak length, preferred risk or odds, etc. Likelihood score may also include, or be affected by, the expected wager amount. Some of these parameters may be self-reported such as favorite team. Each parameter may weight the final assigned score. These weights may be general or user-specific. For example, the Patriots may be the favorite team of a user. The user is watching a game where the Patriots are currently on offense and has wagered that they will pass the ball. One of the parlay options available is that not only will the Patriots pass, but that the Patriots will still have possession and pass again on the next play. The user may be more likely to take this parlay bet because they enjoy betting on their favorite team doing well. Therefore the score assigned to that parlay wager by the AI parlay module 2132 may be increased because the parlay wager is in favor of the Patriots. How much the score is increased may be based on the weight assigned to the parameter for a favorite team. For example, if the weight is 5, then the assigned score may be increased by 5 if the wager is in favor of the Patriots. Some parameters may have a non-binary value, such as a win/lose ratio, in which case the effect on the score is based on the parameter's weight and the value of the parameter. For example, the weight may be 2, and the current win/loss ratio may be 2/1, which may result in an assigned score increase of 2*2/1 or 4. For example, a user has placed a bet on the Patriots to win the current live event 102. A parlay wager in the parlay database 2126 contains this same wager, and another wager for the Patriots to be behind at half-time with odds of +450. The user is a Patriots fan and enjoys high odds bets. The weight for a favorite team is 5, and the weight for odds is 0.02. The likelihood score would be reduced by 5 since the other wager in the parlay bet is not in favor of the Patriots and increased by +450*0.02 or 9 because of the odds. Assuming no other parameters are included, the likelihood score for this parlay wager would be 4. The AI parlay module 2132 may assign, at step 2808, a score to the selected parlay wager based on one or more optimization metrics set by an administrator. Examples of optimization metrics include, but are not limited to, profit, revenue, user engagement, balanced wagers, minimized risk, user satisfaction, etc. Each metric may weight the final assigned score. These weights may be general or user-specific. For example, a sportsbook may determine too many users have placed a wager on the Patriots to beat the Eagles, and too few have wagered on the Eagles to win. This means that the sportsbook risks taking a loss if the Patriots win. Parlay wagers that include a wager for the Eagles to win may have a higher score than parlay wagers that do not include a wager for the Eagles to win, and both may have a higher score than parlay wagers that include a wager for the patriots to win. This may drive users to wager on the Eagles and to balance the book. How much the score is increased may be based on the weight assigned to the metric for balancing wagers. For example, if the weight is 5, the assigned score may be increased by 5 if the wager is for the Eagles to win and decreased by 5 if the wager is for the Patriots to win. Some metrics may have a non-binary value, such as profit, in which case the effect on the score is based on the parameter's weight and the value of the parameter. For example, the weight may be 20, and the projected profit on wager may be 3% of total wager revenue, in which case the score may be 200*0.03 or 6. For example, a user has placed a bet on the Patriots to win the current live event 2102. A parlay wager in the parlay database 2126 contains this same wager, and another wager for the Patriots to be behind at half-time with odds of +450. The sportsbook needs about $10,000 to be wagered against the patriots at half-time to balance the wager and doesn't want to open themselves up to high-odds bets. The weight for balance is 0.006, and the weight for odds is −0.01. The optimization score would be increased by 10,000*0.006 or 6 since the other wager in the parlay bet would help balance the sportsbook and decrease by +450*−0.01 or −4.5 because of the odds. Assuming no other parameters are included, the optimization score for this parlay wager would be 1.5. The AI parlay module 2132 may determine, at step 2810, if there is another parlay wager that includes the wager placed by the user. If there is another parlay wager, the AI parlay module 2132 may select, at step 2812, the next parlay wager and return to step 2806. If there are no other parlay wagers, the AI parlay module 2132 may order, at step 2814, the parlay wagers based on the combined scores for the likelihood of selection and optimized metrics. Combining the scores may be done by adding the scores together. A weight may be assigned to each score such that one score may have more influence over the total score than the other. For example, if the weight of the likelihood score is 0.6 and the likelihood score is 100, and the weight of the optimization score is 0.4, and the optimization score is 50, then the combined score would be 0.6*100+0.4*50, which is 80. The parlay wagers may be ordered from highest score to lowest score. The AI parlay module 2132 may send, at step 2816, the ordered list to the wager module 2124 so that the parlay wagers can be sent to the user in order. The AI parlay module 2132 may only send a portion of the ordered list. For example, the top 5 parlay wagers. The AI parlay module 2132 may return, at step 2818, to step 2800.

FIG. 29 illustrates the functioning of the AI training module 2134. The process may begin with the AI training module 2134 polling, at step 2900, for a parlay wager selection by a user or the rejection of all parlay options presented to that user. The AI training module 2134 may determine, at step 2902, if the user selected one of the parlay wager options presented to them. If the user rejected all parlay wager options, the AI training module 2134 may increase, at step 2904, the weight in the weights database 2136 of the user behavior score in calculating the total score in the AI parlay module 2132. This way, user behavior becomes a larger factor in which options are presented to the user until the user begins to select the parlay wager options presented. If the user selected a parlay wager option, the AI training module 2134 may determine, at step 2906, if the first option in the order was selected. This would correspond to the parlay option with the highest total score assigned by the AI parlay module 2132 for this user. If the first option was not the one selected, the AI training module 2134 may alter, at step 2908, the weights of the user behavior parameters weights database 2136. The alteration of these weights may be random or directed so that the selected option would achieve a higher score under the altered weight system. This way, options similar to the ones selected by the user would become the highest-scoring options. The AI training module 2134 may return, at step 2910, to step 2900.

In another embodiment, a current wager adjustor to select one or more common parameters may be shown and described.

FIG. 30 is a system for odds adjustment using artificial intelligence and machine learning. This system may comprise a live event 3002, such as a sporting event such as a football, basketball, baseball, or hockey game, tennis match, golf tournament, eSports, or digital game, etc. The live event 3002 may include some number of actions or plays upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 3002, such as the score of an American football game or the run line in a baseball game, or a series of actions in the live event 3002. Sportsbooks have several bets they can handle, limiting the number of wagers they can take on either side of a bet before moving the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer future bets on live events in the future. Sportsbooks need to offer payment processing services to cash out customers, which can be done at kiosks at the live event 3002 or at another location.

Further, embodiments may include a plurality of sensors 3004 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 3004 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball. Further, embodiments may include a cloud 3006 or a communication network that may be wired and/or wireless. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 3006 may be communicatively coupled to a peer-to-peer wagering network 3014, which may perform real-time analysis on the type of play and the result of the play. The cloud 3006 may also be synchronized with game situational data such as the time of the game, the score, location on the field, weather conditions, and the like, which may affect the choice of play utilized. For example, in an exemplary embodiment, the cloud 3006 may not receive data gathered from the sensors 3004 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 3008 such as a computing device, laptop, smartphone, tablet, computer, smart speaker, or I/O devices. I/O devices may be present in the computing device. Input devices may include but are not limited to keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide-semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include but are not limited to video displays, graphical displays, speakers, headphones, inkjet printers, laser printers, or 3D printers. Devices may include but are not limited to a combination of multiple input or output devices such as Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs, including, but not limited to, Microsoft KINECT, SIRI for iPhone by Apple, Google Now, or Google Voice Search. Additional user devices have both input and output capabilities, including, but not limited to, haptic feedback devices, touchscreen displays, or multi-touch displays. Touchscreen, multi-touch displays, touchpads, touch mice, or other touch sensing devices may use different technologies to sense touch, including but not limited to capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 3008 could be an optional component and would be utilized in a situation where a paired wearable device employs the mobile device 3008 for additional memory or computing power or connection to the internet.

Further, embodiments may include a wagering software application or a wagering app 3010, which is a program that enables the user to place bets on individual plays in the live event 3002, streams audio and video from the live event 3002, and features the available wagers from the live event 3002 on the mobile device 3008. The wagering app 3010 allows users to interact with the wagering network 3014 to place bets and provide payment/receive funds based on wager outcomes.

Further, embodiments may include a mobile device database 3012 that may store some or all the user's data, the live event 3002, or the user's interaction with the wagering network 3014.

Further, embodiments may include the wagering network 3014, which may perform real-time analysis on the type of play and the result of a play or action. The wagering network 3014 (or the cloud 3006) may also be synchronized with game situational data, such as the time of the game, the score, location on the field, weather conditions, and the like, which may affect the choice of play utilized. For example, in an exemplary embodiment, the wagering network 3014 may not receive data gathered from the sensors 3004 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 3014 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 3016, which may contain data relevant to all users of the wagering network 3014 and may include, but is not limited to, a user ID, a device identifier, a paired device identifier, wagering history, or wallet information for the user. The user database 3016 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 3016 may contain betting lines and search queries. The user database 3016 may be searched based on a search criterion received from the user. Each betting line may include, but is not limited to, a plurality of betting attributes such as at least one of the live event 3002, a team, a player, an amount of wager, etc. The user database 3016 may include but is not limited to information related to all the users involved in the live event 3002. In one exemplary embodiment, the user database 3016 may include information for generating a user authenticity report and a wagering verification report. Further, the user database 3016 may be used to store user statistics like, but not limited to, the retention period for a particular user, frequency of wagers placed by a particular user, the average amount of wager placed by each user, etc.

Further, embodiments may include a historical plays database 3018 that may contain play data for the type of sport being played in the live event 3002. For example, in American Football, for optimal odds calculation, the historical play data may include metadata about the historical plays, such as time, location, weather, previous plays, opponent, physiological data, etc.

Further, embodiments may utilize an odds database 3020—that contains the odds calculated by an odds calculation module 3022—to display the odds on the user's mobile device 3008 and take bets from the user through the mobile device wagering app 3010.

Further, embodiments may include an unsupervised learning module 3022. Embodiments of the unsupervised learning module 3022 may include multiple sub-modules, including a clustering module 3024, a semantic distance module 3026, a metadata mining module 3028, a report processing module 3030, a data characterization module 3032, a search results correlation module 3034, a SQL query processing module, an access frequency module 3038, and an external enrichment module 3040. Each of these modules is configured to perform at least one unsupervised learning technique.

Unsupervised learning techniques generally seek to summarize and explain key features of a data set. Non-limiting examples of unsupervised techniques include hidden Markov models, blind signal separation using feature extraction techniques for dimensionality reduction, and each of the techniques performed by the modules of the unsupervised learning module 3022 (cluster analysis, mining metadata from the data in the unstructured data set, identifying relationships in data of the unstructured data set based on one or more of analyzing process reports and analyzing process SQL queries, identifying relationships in data of the unstructured data set by identifying semantic distances between data in the unstructured data set, using statistical data to determine a relationship between data in the unstructured data set, identifying relationships in data of the unstructured data set based on analyzing the access frequency of data of the unstructured data set, querying external data sources to determine a relationship between data in the unstructured data set, and text search results correlation).

As mentioned, generally, the unsupervised learning module 3022 can determine relationships between data loaded by a load module into an unstructured data set. For example, the unsupervised learning module 3022 can connect data based on confidence intervals, confidence metrics, distances, or the like indicating the proximity measures and metrics inherent in the unstructured data set, such as schema and Entity Relationship Descriptions (ERD), integrity constraints, foreign key, and primary key relationships, parsing SQL queries, reports, spreadsheets, data warehouse information, or the like. For example, the unsupervised learning module 3022 may derive one or more relationships across heterogeneous data sets based on probabilistic relationships derived from artificial intelligence and machine learning, such as the unsupervised learning module 3022. The unsupervised learning module 3022 may determine, at a feature level or the like, the distance between data points based on one or more probabilistic relationships derived from artificial intelligence and machine learning, such as the unsupervised learning module 3022. In addition to identifying simple relationships between data elements, the unsupervised learning module 3022 may also determine a chain or tree comprising multiple relationships between different data elements.

In some embodiments, as part of one or more unstructured learning techniques, the unsupervised learning module 3022 may establish a confidence value, a confidence metric, a distance, or the like (collectively “confidence metric”) through clustering and/or other artificial intelligence and machine learning techniques (e.g., the unsupervised learning module 3022, the supervised learning module) that a certain field belongs to a feature, is associated, or related to other data, or the like.

In some unsupervised learning techniques, the unsupervised learning module 3022 may determine a confidence that data of an instance belongs together, is related, or the like. For example, the unsupervised learning module 3022 may determine that a player and an outcome with certain wager odds belong together, thus joining these instances or rows together and providing a confidence metric behind the join. The load module or the unsupervised learning module 3022 may store a confidence metric representing a likelihood that a field belongs to an instance and/or a different confidence value that the field belongs in a feature. The load module and/or the supervised learning module may use the confidence values, confidence metrics, or distances to determine an intersection between the row and the column, indicating where to put the field with confidence so that the field may be fed to and processed by the supervised learning module.

In this manner, the unsupervised learning module 3022 and/or the supervised learning module may eliminate a transformation step in data warehousing and replace the precision and deterministic behavior with an imprecise, probabilistic behavior (e.g., store the data in an unstructured or semi-structured manner). Maintaining data in an unstructured or semi-structured format, without transforming the data, may allow the load module and/or the supervised learning module to identify signals that a manual transformation would have otherwise eliminated, may eliminate the effort of performing the manual transformation, or the like. Thus, the unsupervised learning module 3022 and/or the supervised learning module may not only automate and make wager adjustments more efficient but may also make wager adjustments more effective due to the signal component that may have been erased through a manual transformation.

In some unsupervised learning techniques, the unsupervised module may make a first pass of the data to identify the first set of relationships, distances, and/or confidences that satisfy a simplicity threshold. For example, unique data, such as players, positions, teams, or the like, may be relatively easy to connect without exhaustive processing. The unsupervised learning module 3022, in a further embodiment, may make a second pass of data that is unable to be processed by the unsupervised learning module 3022 in the first pass (e.g., data that fails to satisfy the simplicity threshold is more difficult to connect, or the like).

The unsupervised learning module 3022 may perform an exhaustive analysis for the remaining data in the second pass, analyzing each potential connection or relationship between different data elements. For example, the unsupervised learning module 3022 may perform additional unsupervised learning techniques (e.g., cross product, a Cartesian joinder, or the like) for the remaining data in the second pass (e.g., analyzing each possible data connection or combination for the remaining data), thereby identifying probabilities or confidences of which connections or combinations are valid, should be maintained, or the like. In this manner, the unsupervised learning module 3022 may overcome computational complexity by approaching a logarithmic problem in a linear manner. In some embodiments, the unsupervised learning module 3022 and the supervised learning module, using the techniques described herein, may repeatedly, substantially continuously, and/or indefinitely process data over time, continuously refining the accuracy of connections and combinations.

Further, embodiments may include a clustering module 3024. The clustering module 3024 can be configured to perform one or more clustering analyses on the unstructured data loaded by the load module. Clustering involves grouping a set of objects so that objects in the same group (cluster) are more similar, in at least one sense, to each other than those in other clusters. Non-limiting examples of clustering algorithms include hierarchical clustering, k-means algorithm, kernel-based clustering algorithms, density-based clustering algorithms, spectral clustering algorithms. In one embodiment, the clustering module 3024 utilizes decision tree clustering with pseudo labels.

The clustering module 3024 may use focal points, clusters, or the like to determine relationships between, distances between, and/or confidences for data. By using focal points, clustering, or the like to break up large amounts of data, the unsupervised learning module 3022 may efficiently determine relationships, distances, and/or confidences for the data.

As mentioned, the unsupervised learning module 3022 may utilize multiple unsupervised learning techniques to assemble an organized data set. In one embodiment, the unsupervised learning module 3022 uses at least one clustering technique to assemble each organized data set. In other embodiments, some organized data sets may be assembled without using a clustering technique.

Further, embodiments may include a semantic distance module 3026. The semantic distance module 3026 is configured to identify the meaning in language and words using the unstructured data of the unstructured data set and use that meaning to identify relationships between data elements.

Further, embodiments may include a metadata mining module 3028. The metadata mining module 3028 is configured to data-mine declared metadata to identify relationships between metadata and data described by the metadata. For example, the metadata mining module 3028 may identify the table, row, and column names and draw relationships between them.

Further, embodiments may include a report processing module 3030. The report processing module 3030 is configured to analyze and/or read reports and other documents. The report processing module 3030 can identify associations and patterns in these documents that indicate how the data in the unstructured data set is organized. These associations and patterns can be used to identify relationships between data elements in the unstructured data set.

Further, embodiments may include a data characterization module 3032. The data characterization module 3032 is configured to use statistical data to ascertain the likelihood of similarities across a column/row family. For example, the data characterization module 3032 can calculate the maximum and minimum values in a column/row, the average column length, and the number of distinct values in a column. These statistics can assist the unsupervised learning module 3022 in identifying the likelihood that two or more columns/rows are related. For instance, two data sets with a maximum value of 10 and 10,000, respectively, may be less likely to be related than two data sets with identical maximum values.

Further, embodiments may include a search results correlation module 3034. The search results correlation module 3034 is configured to correlate data based on common text search results. These search results may include minor text and spelling variations for each word. Accordingly, the search results correlation module 3034 may identify words that may be a variant, abbreviation, misspelling, conjugation, or derivation of other words. Other unsupervised learning techniques may use these identifications.

Further, embodiments may include a SQL processing module 3036. The search results correlation module 3034 is configured to harvest queries in a live database, including SQL queries. These queries and the results of such queries can be utilized to determine or define a distance between relationships within a data set. Similarly, the unsupervised learning module 3022 or SQL processing module 3036 may harvest SQL statements or other data in real-time from a running database, database manager, or other data source. The SQL processing module 3036 may parse and/or analyze SQL queries to determine relationships. For example, a WHERE statement, a JOIN statement, or the like may relate to certain data features. In a further embodiment, the load module may use data definition metadata (e.g., primary keys, foreign keys, feature names, or the like) to determine relationships.

Further, embodiments may include an access frequency module 3038. The access frequency module 3038 is configured to identify correlations between data based on the frequency at which data is accessed, what data is accessed simultaneously, access count, time of day data is accessed, and the like. For example, the access frequency module 3038 can target highly accessed data first and use access patterns to determine possible relationships. More specifically, the access frequency module 3038 can poll a database system's buffer cache metrics for highly accessed database blocks and store that access pattern information in the data set to be used to identify relationships between the highly accessed data.

Further, embodiments may include an external enrichment module 3040. The external enrichment module 3040 is configured to access external sources if the confidence metric between features of a data set is below a threshold. Non-limiting examples of external sources include the Internet, an Internet search engine, an online encyclopedia or reference site, or the like. For example, if the geolocation of an event column is not related to other columns, it may be queried to an external source to establish relationships between the geolocation of an event and weather reports or forecasts.

While not an unsupervised learning technique, the unsupervised learning module 3022 can be configured to query the user (ask a human) for information lacking or for assistance in determining relationships between features of the unstructured data set.

In addition to the use of unsupervised learning techniques, the unsupervised learning module 3022 can be aided in determining relationships between data elements of the unstructured data set and assembling organized data sets by the supervised learning module. As mentioned, the organized data set(s) assembled by the unsupervised learning module 3022 can be evaluated by the supervised learning module. The unsupervised learning module 3022 can use these evaluations to identify which relationships are more likely and less likely. The unsupervised learning module 3022 can use that information to improve the accuracy of its processes.

Furthermore, in some embodiments, the unsupervised learning module 3022 may use a machine learning ensemble, such as predictive program code, as an input to unsupervised learning to determine probabilistic relationships between data points. The unsupervised learning module 3022 may use relevant influence factors from supervised learning (e.g., a artificial intelligence and machine learning ensemble or other predictive program code) to enhance unsupervised mining activities in defining the distance between data points in a data set. The unsupervised learning module 3022 may define the confidence that a data element is associated with a specific instance, a specific feature, or the like.

Further, embodiments may include a supervised learning module 3042. The supervised learning module 3042 is configured to generate one or more machine learning ensemble 3066s of learned functions based on the organized data set(s) assembled by the unsupervised learning module 3022. In the depicted embodiment, the supervised learning module 3042 includes a data receiver module 3044, a function generator module 3046, a machine learning compiler module 3048, a feature selector module 3062, a predictive correlation module 3064, and a machine learning ensemble 3066. The machine learning compiler module 3048 may include a combiner module 3050, an extender module 3052, a synthesizer module 3054, a function evaluator module 3056, a metadata database 3058, and a function selector module 3060. The machine learning ensemble 3066 may include an orchestration module, a synthesized metadata rule set, and synthesized learned functions.

Further, embodiments may include a data receiver module 3044 configured to receive data from the organized data set, including training data, test data, workload data, or the like, from the load module, or the unsupervised learning module 3022, either directly or indirectly. The data receiver module 3044, in various embodiments, may receive data over a local channel such as an API, a shared library, a hardware command interface, or the like; over a data network such as wired or wireless LAN, WAN, the Internet, a serial connection, a parallel connection, or the like. In certain embodiments, the data receiver module 3044 may receive data indirectly from a live event 3002, from the load module, the unsupervised learning module 3022, or the like, through an intermediate module that may pre-process, reformat, or otherwise prepare the data for the supervised learning module 3042. The data receiver module 3044 may support structured, unstructured, semi-structured, or the like.

One type of data that the data receiver module 3044 may receive, as part of a new ensemble request or the like, is initialization data. The supervised learning module 3042, in certain embodiments, may use initialization data to train and test learned functions from which the supervised learning module 3042 may build a machine learning ensemble 3066. Initialization data may comprise the trial data set, the organized data set, historical data, statistics, Big Data, customer data, marketing data, computer system logs, computer application logs, data networking logs, or other data that the wagering network 3014 provides to the data receiver module 3044 with which to build, initialize, train, and/or test a machine learning ensemble 3066.

As part of an analysis request or the like, another type of data that the data receiver module 3044 may receive is workload data. The supervised learning module 3042, in certain embodiments, may process workload data using a machine learning ensemble 3066 to obtain a result, such as a classification, a confidence metric, an inferred function, a regression function, an answer, a prediction, a recognized pattern, a rule, a recommendation, an evaluation, or the like. Workload data for a specific machine learning ensemble 3066, in one embodiment, has substantially the same format as the initialization data used to train and/or evaluate the machine learning ensemble 3066. For example, initialization data and/or workload data may include one or more features. As used herein, a feature may comprise a column, category, data type, attribute, characteristic, label, or other groupings of data. For example, in embodiments where initialization data and/or workload data is organized in a table format, a column of data may be a feature. Initialization data and/or workload data may include one or more instances of the associated features. In a table format, where columns of data are associated with features, a row of data is an instance.

In some embodiments, the data receiver module 3044 may maintain data stored on the wagering network 3014 (including the organized data set), such as initialization data and/or workload data, historical data, etc., where the function generator module 3046, the machine learning compiler module 3048, or the like may access the data. In certain embodiments, as described below, the function generator module 3046 and/or the machine learning compiler module 3048 may divide initialization data into subsets, using certain subsets of data as training data for generating and training learned functions and using certain subsets of data as test data for evaluating generated learned functions.

Further, embodiments may include a function generator module 3046 configured to generate a plurality of learned functions based on training data from the data receiver module 3044. A learned function comprises a computer-readable code that accepts an input and provides a result. A learned function may comprise a compiled code, a script, text, a data structure, a file, a function, or the like. In some embodiments, a learned function may accept instances of one or more features as input and provide a result, such as a classification, a confidence metric, an inferred function, a regression function, an answer, a prediction, a recognized pattern, a rule, a recommendation, an evaluation, or the like. In another embodiment, certain learned functions may accept instances of one or more features as input and provide a subset of the instances, a subset of the one or more features, or the like as an output. In a further embodiment, certain learned functions may receive the output or result of one or more other learned functions as input, such as a Bayes classifier, a Boltzmann machine, or the like.

The function generator module 3046 may generate learned functions from multiple artificial intelligence and artificial intelligence and machine learning classes, models, or algorithms. For example, the function generator module 3046 may generate decision trees; decision forests; kernel classifiers and regression machines with a plurality of reproducing kernels; non-kernel regression and classification machines such as logistic, CART, multi-layer neural nets with various topologies; Bayesian-type classifiers such as Naive Bayes and Boltzmann machines; logistic regression; multinomial logistic regression; probit regression; AR; MA; ARMA; ARCH; GARCH; VAR; survival or duration analysis; MARS; radial basis functions; support vector machines; k-nearest neighbors; geospatial predictive modeling; and/or other classes of learned functions.

In one embodiment, the function generator module 3046 generates learned functions pseudo-randomly, without regard to the effectiveness of the generated learned functions, without prior knowledge regarding the suitability of the generated learned functions for the associated training data or the like. For example, the function generator module 3046 may generate a total number of learned functions that is large enough that at least a subset of the generated learned functions are statistically likely to be effective. As used herein, pseudo-randomly indicates that the function generator module 3046 is configured to generate learned functions in an automated manner, without input or selection of learned functions, artificial intelligence and artificial intelligence and machine learning classes or models for the learned functions, or the like by a Data Scientist, expert, or other users.

The function generator module 3046 may generate as many learned functions as possible for a requested machine learning ensemble 3066, given one or more parameters or limitations. The wagering network 3014 may provide a parameter or limitation for learned function generation as part of a new ensemble request or the like, such as an amount of time; an allocation of system resources such as a number of processor nodes or cores, or an amount of volatile memory; a number of learned functions; runtime constraints on the requested ensemble such as an indicator of whether or not the requested ensemble should provide results in real-time; and/or another parameter or limitation from the wagering network 3014.

The number of learned functions that the function generator module 3046 may generate for building a machine learning ensemble 3066 may also be limited by capabilities of the system, such as the number of available processors or processor cores, a current load on the system, a price of remote processing resources over the data network, or other hardware capabilities of the system available to the function generator module 3046. The function generator module 3046 may balance the system's hardware capabilities with the time available for generating learned functions and building a machine learning ensemble 3066 to determine how many learned functions to generate for the machine learning ensemble 3066.

In a further embodiment, the function generator module 3046 may generate hundreds, thousands, or millions of learned functions, or more, for a machine learning ensemble 3066. By generating an unusually large number of learned functions from different classes without regard to the suitability or effectiveness of the generated learned functions for training data, in certain embodiments, the function generator module 3046 ensures that at least a subset of the generated learned functions, either individually or in combination, are useful, suitable, and/or effective for the training data without careful curation and fine-tuning by a Data Scientist or other expert.

Similarly, by generating learned functions from different artificial intelligence and machine learning classes without regard to the effectiveness or the suitability of the different artificial intelligence and machine learning classes for training data, the function generator module 3046, in certain embodiments, may generate learned functions that are useful, suitable, and/or effective for the training data due to the sheer number of learned functions generated from the different artificial intelligence and machine learning classes. This brute force, trial-and-error approach to generating learned functions, in certain embodiments, eliminates or minimizes the role of a Data Scientist or other expert in the generation of a machine learning ensemble 3066.

The function generator module 3046, in certain embodiments, divides initialization data from the data receiver module 3044 into various subsets of training data and may use different training data subsets, different combinations of multiple training data subsets, or the like to generate different learned functions. The function generator module 3046 may divide the initialization data into training data subsets by feature, instance, or both. For example, a training data subset may comprise a subset of features of initialization data, a subset of features of initialization data, a subset of both features and instances of initialization data, or the like. Varying the features and/or instances used to train different learned functions in certain embodiments may further increase the likelihood that at least a subset of the generated learned functions are useful, suitable, and/or effective. In a further embodiment, the function generator module 3046 ensures that the available initialization data is not used in its entirety as training data for any one learned function so that at least a portion of the initialization data is available for each learned function as test data.

In one embodiment, the function generator module 3046 may also generate additional learned functions in cooperation with the machine learning compiler module 3048. The function generator module 3046 may provide a learned function request interface, allowing the machine learning compiler module 3048 or another module, wagering network 3014, or the like to send a learned function request to the function generator module 3046 requesting that the function generator module 3046 generate one or more additional learned functions. In one embodiment, a learned function request may include one or more attributes for the requested one or more learned functions. For example, a learned function request, in various embodiments, may include a artificial intelligence and machine learning class for a requested learned function, one or more features for a requested learned function, instances from initialization data to use as training data for a requested learned function, runtime constraints on a requested learned function or the like. In another embodiment, a learned function request may identify initialization data, training data, or the like for one or more requested learned functions. The function generator module 3046 may generate one or more learned functions pseudo-randomly, as described above, based on the identified data.

Further, embodiments may include a machine learning compiler module 3048 configured to form a machine learning ensemble 3066 using learned functions from the function generator module 3046. As used herein, a machine learning ensemble 3066 comprises an organized set of a plurality of learned functions. Providing a classification, a confidence metric, an inferred function, a regression function, an answer, a prediction, a recognized pattern, a rule, a recommendation, or another result using a machine learning ensemble 3066, in certain embodiments, may be more accurate than using a single learned function.

In some embodiments, the machine learning compiler module 3048 may combine and/or extend learned functions to form new learned functions, request additional learned functions from the function generator module 3046, or the like for inclusion in a machine learning ensemble 3066. In one embodiment, the machine learning compiler module 3048 evaluates learned functions from the function generator module 3046 using test data to generate evaluation metadata. The machine learning compiler module 3048, in a further embodiment, may evaluate combined learned functions, extended learned functions, combined-extended learned functions, additional learned functions, or the like using test data to generate evaluation metadata.

The machine learning compiler module 3048, in certain embodiments, maintains evaluation metadata in a metadata database 3058. For example, the machine learning compiler module 3048 may select learned functions (e.g., learned functions from the function generator module 3046, combined learned functions, extended learned functions, learned functions from different artificial intelligence and machine learning classes, and/or combined-extended learned functions) for inclusion in a machine learning ensemble 3066 based on the evaluation metadata. In a further embodiment, the machine learning compiler module 3048 may synthesize the selected learned functions into a final, synthesized function or function set for a machine learning ensemble 3066 based on evaluation metadata. The machine learning compiler module 3048, in another embodiment, may include synthesized evaluation metadata in a machine learning ensemble 3066 for directing data through the machine learning ensemble 3066 or the like.

Further, embodiments may include a combiner module 3050. The combiner module 3050 combines learned functions, forming sets, strings, groups, trees, or clusters of combined learned functions. In certain embodiments, the combiner module 3050 combines learned functions into a prescribed order, and different orders of learned functions may have different inputs, produce different results, or the like. In addition, the combiner module 3050 may combine learned functions in different combinations. For example, the combiner module 3050 may combine certain learned functions horizontally or in parallel, joined at the inputs and outputs or the like, and may combine certain learned functions vertically or in series, feeding the output of one learned function into the input of another learned function.

The combiner module 3050 may determine which learned functions to combine, how to combine learned functions, or the like based on evaluation metadata for the learned functions from the metadata database 3058, generated based on an evaluation of the learned functions using test data, as described below with regard to the function evaluator module 3056. The combiner module 3050 may request additional learned functions from the function generator module 3046 for combining with other learned functions. For example, the combiner module 3050 may request a new learned function with a particular input and/or output to combine with an existing learned function or the like.

While the combining of learned functions may be informed by evaluation metadata for the learned functions, in certain embodiments, the combiner module 3050 combines a large number of learned functions pseudo-randomly, forming a large number of combined functions. For example, the combiner module 3050, in one embodiment, may determine each possible combination of generated learned functions, as many combinations of generated learned functions as possible given one or more limitations or constraints, a selected subset of combinations of generated learned functions, or the like, for evaluation by the function evaluator module 3056. In certain embodiments, by generating a large number of combined learned functions, the combiner module 3050 is statistically likely to form one or more combined learned functions that are useful and/or effective for the training data.

Further, embodiments may include an extender module 3052. The extender module 3052, in certain embodiments, is configured to add one or more layers to a learned function. For example, the extender module 3052 may extend a learned function or combined learned function by adding a probabilistic model layer, such as a Bayesian belief network layer, a Bayes classifier layer, a Boltzmann layer, or the like.

Certain classes of learned functions, such as probabilistic models, may be configured to receive either instance of one or more features as input or the output results of other learned functions, such as a classification and a confidence metric, an inferred function, a regression function, an answer, a prediction, a recognized pattern, a rule, a recommendation, an evaluation, or the like. The extender module 3052 may use these types of learned functions to extend other learned functions. For example, the extender module 3052 may extend learned functions generated by the function generator module 3046 directly, may extend combined learned functions from the combiner module 3050, may extend other extended learned functions, may extend synthesized learned functions from the synthesizer module 3054, or the like.

In one embodiment, the extender module 3052 determines which learned functions to extend, how to extend learned functions, or the like based on evaluation metadata from the metadata database 3058. The extender module 3052, in certain embodiments, may request one or more additional learned functions from the function generator module 3046 and/or one or more additional combined learned functions from the combiner module 3050 for the extender module 3052 to extend.

While the extending of learned functions may be informed by evaluation metadata for the learned functions, in certain embodiments, the extender module 3052 generates a large number of extended learned functions pseudo-randomly. For example, the extender module 3052, in one embodiment, may extend each possible learned function and/or combination of learned functions, may extend a selected subset of learned functions, may extend as many learned functions as possible given one or more limitations or constraints, or the like, for evaluation by the function evaluator module 3056. In certain embodiments, by generating a large number of extended learned functions, the extender module 3052 is statistically likely to form one or more extended learned functions and/or combined extended learned functions that are useful and/or effective for the training data.

Further, embodiments may include a synthesizer module 3054. For example, in certain embodiments, the synthesizer module 3054 is configured to organize a subset of learned functions into the machine learning ensemble 3066, as synthesized learned functions. In a further embodiment, the synthesizer module 3054 includes evaluation metadata from the metadata database 3058 of the function evaluator module 3056 in the machine learning ensemble 3066 as a synthesized metadata rule set, so that the machine learning ensemble 3066 includes synthesized learned functions and evaluation metadata, the synthesized metadata rule set, for the synthesized learned functions.

The learned functions that the synthesizer module 3054 synthesizes or organizes into the synthesized learned functions of the machine learning ensemble 3066 may include learned functions directly from the function generator module 3046 combined learned functions from the combiner module 3050, extended learned functions from the extender module 3052, combined extended learned functions, or the like. As described below, in one embodiment, the function selector module 3060 selects the learned functions for the synthesizer module 3054 to include in the machine learning ensemble 3066. In certain embodiments, the synthesizer module 3054 organizes learned functions by preparing the learned functions and the associated evaluation metadata for processing workload data to reach a result. For example, as described below, the synthesizer module 3054 may organize and/or synthesize the synthesized learned functions and the synthesized metadata rule set for the orchestration module to direct workload data through the synthesized learned functions to produce a result.

In one embodiment, the function evaluator module 3056 evaluates the synthesized learned functions that the synthesizer module 3054 organizes, and the synthesizer module 3054 synthesizes and/or organizes the synthesized metadata rule set based on evaluation metadata that the function evaluation module generates during the evaluation of the synthesized learned functions, from the metadata database 3058 or the like.

Further, embodiments may include a metadata database 3058 that provides evaluation metadata for learned functions to the feature selector module 3062, the predictive correlation module 3064, the combiner module 3050, the extender module 3052, and/or the synthesizer module 3054. The metadata database 3058 may provide an API, a shared library, one or more function calls, or the like providing access to evaluation metadata. The metadata database 3058, in various embodiments, may store or maintain evaluation metadata in a database format, as one or more flat files, as one or more lookup tables, as a sequential log or log file, or as one or more other data structures. In one embodiment, the metadata database 3058 may index evaluation metadata by learned function, by feature, by instance, by training data, by test data, by effectiveness, and/or by another category or attribute and may provide query access to the indexed evaluation metadata. The function evaluator module 3056 may update the metadata database 3058 in response to each evaluation of a learned function, adding evaluation metadata to the metadata database 3058 or the like.

Further, embodiments may include a function selector module 3060 that may use evaluation metadata from the metadata database 3058 to select learned functions for the combiner module 3050 to combine, for the extender module 3052 to extend, for the synthesizer module 3054 to include in the machine learning ensemble 3066, or the like. For example, in one embodiment, the function selector module 3060 may select learned functions based on evaluation metrics, learning metrics, effectiveness metrics, convergence metrics, or the like. In another embodiment, the function selector module 3060 may select learned functions for the combiner module 3050 to combine and/or for the extender module 3052 to extend based on training data features used to generate the learned functions or the like.

Further, embodiments may include a feature selector module 3062 that determines which features of initialization data to use in the machine learning ensemble 3066, and in the associated learned functions, and/or which features of the initialization data to exclude from the machine learning ensemble 3066, and from the associated learned functions. As described above, initialization data and training and test data derived from the initialization data may include features. Learned functions and the machine learning ensemble 3066s that they form are configured to receive and process instances of one or more features. Certain features may be more predictive than others, and the more features that the machine learning compiler module 3048 processes and includes in the generated machine learning ensemble 3066, the more processing overhead used by the machine learning compiler module 3048, and the more complex the generated machine learning ensemble 3066 becomes. Additionally, certain features may not contribute to the effectiveness or accuracy of the results from a machine learning ensemble 3066 but may simply add noise to the results.

The feature selector module 3062, in one embodiment, cooperates with the function generator module 3046 and the machine learning compiler module 3048 to evaluate the effectiveness of various features, based on evaluation metadata from the metadata database 3058. For example, the function generator module 3046 may generate a plurality of learned functions for various combinations of features, and the machine learning compiler module 3048 may evaluate the learned functions and generate evaluation metadata. Based on the evaluation metadata, the feature selector module 3062 may select a subset of features that are most accurate or effective, and the machine learning compiler module 3048 may use learned functions that utilize the selected features to build the machine learning ensemble 3066. The feature selector module 3062 may select features for use in the machine learning ensemble 3066 based on evaluation metadata for learned functions from the function generator module 3046, combined learned functions from the combiner module 3050, extended learned functions from the extender module 3052, combined extended functions, synthesized learned functions from the synthesizer module 3054, or the like.

In a further embodiment, the feature selector module 3062 may cooperate with the machine learning compiler module 3048 to build a plurality of different machine learning ensemble 3066 for the same initialization data or training data, each different machine learning ensemble 3066 utilizing different features of the initialization data or training data. The machine learning compiler module 3048 may evaluate each different machine learning ensemble 3066, using the function evaluator module 3056 described below, and the feature selector module 3062 may select the machine learning ensemble 3066 and the associated features which are most accurate or effective based on the evaluation metadata for the different machine learning ensemble 3066s. In certain embodiments, the machine learning compiler module 3048 may generate tens, hundreds, thousands, millions, or more different machine learning ensemble 3066s so that the feature selector module30may select an optimal set of features (e.g., the most accurate, most effective, or the like) with little or no input from a Data Scientist, expert, or other users in the selection process.

In one embodiment, the machine learning compiler module 3048 may generate a machine learning ensemble 3066 for each possible combination of features from which the feature selector module 3062 may select. In a further embodiment, the machine learning compiler module 3048 may begin generating machine learning ensemble 3066s with a minimal number of features and may iteratively increase the number of features used to generate machine learning ensemble 3066s until an increase in effectiveness or usefulness of the results of the generated machine learning ensemble 3066s fails to satisfy a feature effectiveness threshold. By increasing the number of features until the increases stop being effective, in certain embodiments, the machine learning compiler module 3048 may determine a minimum effective set of features for use in a machine learning ensemble 3066 so that generation and use of the machine learning ensemble 3066 is both effective and efficient. The feature effectiveness threshold may be predetermined or hardcoded, may be selected by a client 3004 as part of a new ensemble request or the like, may be based on one or more parameters or limitations, or the like.

During the iterative process, in certain embodiments, once the feature selector module 3062 determines that a feature is merely introducing noise, the machine learning compiler module 3048 excludes the feature from future iterations and from the machine learning ensemble 3066. For example, in one embodiment, a client 3004 may identify one or more features as required for the machine learning ensemble 3066 in a new ensemble request or the like. The feature selector module 3062 may include the required features in the machine learning ensemble 3066 and select one or more of the remaining optional features for inclusion in the machine learning ensemble 3066 with the required features.

In a further embodiment, based on evaluation metadata from the metadata database 3058, the feature selector module 3062 determines which features from initialization data and/or training data are adding noise, are not predictive, are the least effective, or the like, and excludes the features from the machine learning ensemble 3066. In other embodiments, the feature selector module 3062 may determine which features enhance the quality of results, increase effectiveness, or the like, and selects the features for the machine learning ensemble 3066.

In one embodiment, the feature selector module 3062 causes the machine learning compiler module 3048 to repeat generating, combining, extending, and/or evaluating learned functions while iterating through permutations of feature sets. At each iteration, the function evaluator module 3056 may determine the overall effectiveness of the learned functions in aggregate for the current iteration's selected combination of features. For example, once the feature selector module 3062 identifies a feature as noise introducing, the feature selector module 3062 may exclude the noisy feature, and the machine learning compiler module 3048 may generate a machine learning ensemble 3066 without the excluded feature. In one embodiment, the predictive correlation module 3064 determines one or more features, instances of features, or the like that correlate with higher confidence metrics (e.g., that are most effective in predicting results with high confidence). The predictive correlation module 3064 may cooperate with, be integrated with, or otherwise, work in concert with the feature selector module 3062 to determine one or more features, instances of features, or the like that correlate with higher confidence metrics. For example, as the feature selector module 3062 causes the machine learning compiler module 3048 to generate and evaluate learned functions with different sets of features, the predictive correlation module 3064 may determine which features and/or instances of features correlate with higher confidence metrics, are most effective, or the like based on metadata from the metadata database 3058.

Further, embodiments may include a predictive correlation module 3064 configured to harvest metadata regarding which features correlate to higher confidence metrics to determine which feature was predictive of which outcome or result or the like. In one embodiment, the predictive correlation module 3064 determines the relationship of a feature's predictive qualities for a specific outcome or result based on each instance of a particular feature. In other embodiments, the predictive correlation module 3064 may determine the relationship of a feature's predictive qualities based on a subset of instances of a particular feature. For example, the predictive correlation module 3064 may discover a correlation between one or more features and the confidence metric of a predicted result by attempting different combinations of features and subsets of instances within an individual feature's dataset and measuring an overall impact on predictive quality, accuracy, confidence, or the like. The predictive correlation module 3064 may determine predictive features at various granularities, such as per feature, per subset of features, per instance, or the like.

In one embodiment, the predictive correlation module 3064 determines one or more features with the greatest contribution to a predicted result or confidence metric as the machine learning compiler module 3048 forms the machine learning ensemble 3066, based on evaluation metadata from the metadata database 3058, or the like. For example, the machine learning compiler module 3048 may build one or more synthesized learned functions configured to provide one or more features with the greatest contribution as part of a result. In another embodiment, the predictive correlation module 3064 may determine one or more features with the greatest contribution to a predicted result or confidence metric dynamically at runtime as the machine learning ensemble 3066 determines the predicted result or confidence metric. In such embodiments, the predictive correlation module 3064 may be part of, integrated with, or in communication with the machine learning ensemble 3066. The predictive correlation module 3064 may cooperate with the machine learning ensemble 3066, such that the machine learning ensemble 3066 provides a listing of one or more features that provided the greatest contribution to a predicted result or confidence metric as part of a response to an analysis request.

In determining features that are predictive or that have the greatest contribution to a predicted result or confidence metric, the predictive correlation module 3064 may balance a frequency of the contribution of a feature and/or an impact of the contribution of the feature. For example, a certain feature or set of features may contribute to the predicted result or confidence metric frequently, for each instance or the like, but have a low impact. Another feature or set of features may contribute relatively infrequently but has a very high impact on the predicted result or confidence metric (e.g., provides at or near 100% confidence or the like). While the predictive correlation module 3064 is described herein as determining features that are predictive or that have the greatest contribution, in other embodiments, the predictive correlation module 3064 may determine one or more specific instances of a feature that are predictive, have the greatest contribution to a predicted result or confidence metric, or the like.

Further, embodiments may include machine learning ensemble 3066 that provides artificial intelligence and machine learning results for an analysis request by processing workload data of the analysis request using a plurality of learned functions (e.g., the synthesized learned functions). As described above, results from the machine learning ensemble 3066, in various embodiments, may include a classification, a confidence metric, an inferred function, a regression function, an answer, a prediction, a recognized pattern, a rule, a recommendation, an evaluation, and/or another result. For example, in one embodiment, the machine learning ensemble 3066 provides a classification and a confidence metric for each instance of workload data input into the machine learning ensemble 3066 or the like. Workload data, in certain embodiments, may be substantially similar to test data, but the missing feature from the initialization data is unknown and is to be solved for by the machine learning ensemble 3066. A classification, in certain embodiments, comprises a value for a missing feature in an instance of workload data, such as a prediction, an answer, or the like. For example, if the missing feature represents a question, the classification may represent a predicted answer, and the associated confidence metric may be an estimated strength or accuracy of the predicted answer. A classification, in certain embodiments, may comprise a binary value (e.g., yes, or no), a rating on a scale (e.g., 4 on a scale of 1 to 5), or another data type for a feature. A confidence metric, in certain embodiments, may comprise a percentage, a ratio, a rating on a scale, or another indicator of accuracy, effectiveness, and/or confidence.

In the depicted embodiment, the machine learning ensemble 3066 includes an orchestration module. The orchestration module, in certain embodiments, is configured to direct workload data through the machine learning ensemble 3066 to produce a result, such as a classification, a confidence metric, an inferred function, a regression function, an answer, a prediction, a recognized pattern, a rule, a recommendation, an evaluation, and/or another result. For example, in one embodiment, the orchestration module uses evaluation metadata from the function evaluator module 3056 and/or the metadata database 3058, such as the synthesized metadata rule set, to determine how to direct workload data through the synthesized learned functions of the machine learning ensemble 3066. As described below with regard to FIG. 37, in certain embodiments, the synthesized metadata rule set comprises a set of rules or conditions from the evaluation metadata of the metadata database 3058 that indicate to the orchestration module which features, instances or the like should be directed to which synthesized learned function.

For example, the evaluation metadata from the metadata database 3058 may indicate which learned functions were trained using which features and/or instances, how effective different learned functions were at making predictions based on different features and/or instances, or the like. The synthesizer module 3054 may use that evaluation metadata to determine rules for the synthesized metadata rule set, indicating which features, which instances or the like the orchestration module should direct through which learned functions, in which order, or the like. The synthesized metadata rule set, in one embodiment, may comprise a decision tree or other data structure comprising rules which the orchestration module may follow to direct workload data through the synthesized learned functions of the machine learning ensemble 3066.

Further, embodiments may include a base module 3068, which may begin with the base module 3068 receiving the sensor data from the live event 3002. For example, the base module 3068 receives sensor data related to the event, such as the players within the event, the period within the event, the score of the event, and the current situation of the event, such as it is the first quarter of the New England Patriots vs. the New York Jets, with the Patriots having possession of the football at their 25-yard line and it is first down. Then it is determined if the base module 3068 received a request for a new machine learning ensemble 3066. For example, the wagering network 3014 may send a request for a new machine learning ensemble 3066, such as a daily request, weekly request, monthly request, quarterly request, yearly request, etc. If it is determined that the base module 3068 received a request for a new artificial intelligence and machine learning ensemble, then it initiates the machine learning module 3070. For example, if the base module 3068 receives a request for a new machine learning ensemble 3066, then the base module 3068 initiates the machine learning module 3070. If it is determined that the base module 3068 did not receive a request for a new machine learning ensemble 3066, then the base module 3068 determines a first play situation from the received sensor data. For example, the base module 3068 receives the time-stamped position information and is used to determine a first play situation of the present competition, such as, a current play situation. In various embodiments, the play situation is determined using, at least in part, time-stamped position information of each player in the subsets of players at the given time. For example, the process determines the play situation at a first time point which is a current time of competition while the competition is ongoing, and the time-stamped position information has been collected by the sensors 3004 at the present competition through the first time point. For example, the current play situation may be in the first quarter of the New England Patriots vs. the New York Jets, with the Patriots having possession of the football at their 25-yard line, and it is first down. Then the base module 3068 initiates the parameter module 3072. For example, the parameter module 3072 may begin with the parameter module 3072 being initiated by the base module 3068. The parameter module 3072 is continuously polling for the sensor data from the live event 3002. In some embodiments, the base module 3068 may send the received sensor data to the parameter module 3072. The parameter module 3072 receives the sensor data from the live event 3002. In some embodiments, the base module 3068 may send the received sensor data to the parameter module 3072. Then the parameter module 3072 determines the first wager market. The parameter module 3072 filters the MLE database 3080 on the wagering market. Then the parameter module 3072 extracts the parameters from the MLE database 3080. The parameter module 3072 sends the extracted parameters to the odds calculation module 3074. Then the parameter module 3072 determines if there are more wager markets available. If it is determined that there are more wager markets available, the parameter module 3072 determines the next wager market, and the process returns to filtering the MILE database 3080 on the wagering market. If it is determined that there are no more wager markets available, then the parameter module 3072 returns to the base module 3068. The base module 3068 initiates the odds calculation module 3074 to determine the probability and wager odds of a first future event occurring at the present competition based on at least the first play situation and playing data associated with at least a subset of one or both of the first set of one or more participants and the second set of one or more participant. The base module 3068 provides the wager odds on the wagering app 3010. In various embodiments, the wager odds are transmitted to the wagering app 3010 through the wager network 3014 to be displayed on a mobile device 3008. In some embodiments, the wagering app 3010, a program that enables the user to place bets on individual plays in the live event 3002, streams audio and video from the live event 3002 and features the available wagers from the live event 3002 on the mobile device 3008. The wagering app 3010 allows users to interact with the wagering network 3014 to place bets and provide payment/receive funds based on wager outcomes.

Further, embodiments may include a machine learning module 3070, which may begin with the machine learning module 3070 being initiated by the base module 3068. Then the machine learning module 3070 receives a request for a new machine learning ensemble 3066. For example, the wagering network 3014 may send a request for a new machine learning ensemble 3066, such as a daily request, weekly request, monthly request, quarterly request, yearly request, etc. The machine learning module 3070 generates a plurality of learned functions based on the received training data. For example, the function generator module 3046 generates a plurality of learned functions based on the received training data from different artificial intelligence and machine learning classes. A learned function comprises a computer-readable code that accepts an input and provides a result. A learned function may comprise a compiled code, a script, text, a data structure, a file, a function, or the like. In some embodiments, a learned function may accept instances of one or more features as input and provide a result, such as a classification, a confidence metric, an inferred function, a regression function, an answer, a prediction, a recognized pattern, a rule, a recommendation, an evaluation, or the like. In another embodiment, certain learned functions may accept instances of one or more features as input and provide a subset of the instances, a subset of the one or more features, or the like as an output. In a further embodiment, certain learned functions may receive the output or result of one or more other learned functions as input, such as a Bayes classifier, a Boltzmann machine, or the like. Then the machine learning module 3070 evaluates the plurality of generated learned functions. For example, the function evaluator module 3056 evaluates the plurality of generated learned functions to generate evaluation metadata. The function evaluator module 3056 is configured to evaluate learned functions using test data or the like. The function evaluator module 3056 may evaluate learned functions generated by the function generator module 3046, learned functions combined by the combiner module 3050, learned functions extended by the extender module 3052, combined extended learned functions, synthesized learned functions organized into the machine learning ensemble 3066 by the synthesizer module 3054, or the like. Test data for a learned function, in certain embodiments, comprises a different subset of the initialization data for the learned function than the function generator module 3046 used as training data. The function evaluator module 3056, in one embodiment, evaluates a learned function by inputting the test data into the learned function to produce a result, such as a classification, a confidence metric, an inferred function, a regression function, an answer, a prediction, a recognized pattern, a rule, a recommendation, an evaluation, or another result. The machine learning module 3070 combines learned functions based on the metadata from the evaluation. For example, the combiner module 3050 combines learned functions based on the metadata from the evaluation performed by the function evaluator module 3056. For example, the combiner module 3050 combines learned functions, forming sets, strings, groups, trees, or clusters of combined learned functions. In certain embodiments, the combiner module 3050 combines learned functions into a prescribed order, and different orders of learned functions may have different inputs, produce different results, or the like. The combiner module 3050 may combine learned functions in different combinations. For example, the combiner module 3050 may combine certain learned functions horizontally or in parallel, joined at the inputs and outputs or the like, and may combine certain learned functions vertically or in series, feeding the output of one into the input of another learned function. The combiner module 3050 may determine which learned functions to combine, how to combine learned functions, or the like based on evaluation metadata for the learned functions from the metadata database 3058, generated based on an evaluation of the learned functions using test data, as described below with regard to the function evaluator module 3056. The combiner module 3050 may request additional learned functions from the function generator module 3046 for combining with other learned functions. For example, the combiner module 3050 may request a new learned function with a particular input and/or output to combine with an existing learned function or the like. The machine learning module 3070 extends one or more learned functions by adding one or more layers to the one or more learned functions. For example, the extender module 3052 extends one or more learned functions by adding one or more layers to the one or more learned functions, such as a probabilistic model layer or the like. In certain embodiments, the extender module 3052 extends combined learned functions based on the evaluation of the combined learned functions. For example, in certain embodiments, the extender module 3052 is configured to add one or more layers to a learned function. For example, the extender module 3052 may extend a learned function or combined learned function by adding a probabilistic model layer, such as a Bayesian belief network layer, a Bayes classifier layer, a Boltzmann layer, or the like. Certain classes of learned functions, such as probabilistic models, may be configured to receive either instances of one or more features as input or the output results of other learned functions, such as a classification and a confidence metric, an inferred function, a regression function, an answer, a prediction, a recognized pattern, a rule, a recommendation, an evaluation, or the like. The extender module 3052 may use these types of learned functions to extend other learned functions. The extender module 3052 may extend learned functions generated by the function generator module 3046 directly, may extend combined learned functions from the combiner module 3050, may extend other extended learned functions, may extend synthesized learned functions from the synthesizer module 3054, or the like. Then the machine learning module 3070 requests that the function generator module 3046 generate additional learned functions for the extender module to extend. For example, the extender module 3052 may request that the function generator module 3046 generate additional learned functions for the extender module 3052 to extend. For example, the function generator module 3046 may generate learned functions from multiple artificial intelligence and machine learning classes, models, or algorithms. For example, the function generator module 3046 may generate decision trees; decision forests; kernel classifiers and regression machines with a plurality of reproducing kernels; non-kernel regression and classification machines such as logistic, CART, multi-layer neural nets with various topologies; Bayesian-type classifiers such as Nave Bayes and Boltzmann machines; logistic regression; multinomial logistic regression; probit regression; AR; MA; ARMA; ARCH; GARCH; VAR; survival or duration analysis; MARS; radial basis functions; support vector machines; k-nearest neighbors; geospatial predictive modeling; and/or other classes of learned functions. The machine learning module 3070 evaluates the extended learned functions. For example, the function evaluator module 3056 evaluates the extended learned functions. For example, in one embodiment, the function evaluator module 3056 is configured to maintain evaluation metadata for an evaluated learned function in the metadata database 3058. The evaluation metadata, in certain embodiments, comprises log data generated by the function generator module 3046 while generating learned functions, the function evaluator module 3056 while evaluating learned functions, or the like. In one embodiment, the evaluation metadata includes indicators of one or more training data sets that the function generator module 3046 used to generate a learned function. The evaluation metadata, in another embodiment, includes indicators of one or more test data sets that the function evaluator module 3056 used to evaluate a learned function. In a further embodiment, the evaluation metadata includes indicators of one or more decisions made by and/or branches taken by a learned function during an evaluation by the function evaluator module 3056. The evaluation metadata, in another embodiment, includes the results determined by a learned function during an evaluation by the function evaluator module 3056. In one embodiment, the evaluation metadata may include evaluation metrics, learning metrics, effectiveness metrics, convergence metrics, or the like for a learned function based on an evaluation of the learned function. An evaluation metric, learning metrics, effectiveness metric, convergence metric, or the like may be based on a comparison of the results from a learned function to actual values from initialization data and may be represented by a correctness indicator for each evaluated instance, a percentage, a ratio, or the like. Different classes of learned functions in certain embodiments may have different types of evaluation metadata. The machine learning module 3070 synthesizes the selected learned functions into synthesized learned functions. For example, the synthesizer module 3054 synthesizes the selected learned functions into synthesized learned functions. For example, in certain embodiments, the synthesizer module 3054 is configured to organize a subset of learned functions into the machine learning ensemble 3066, as synthesized learned functions. In a further embodiment, the synthesizer module 3054 includes evaluation metadata from the metadata database 3058 of the function evaluator module 3056 in the machine learning ensemble 3066 as a synthesized metadata rule set, so that the machine learning ensemble 3066 includes synthesized learned functions and evaluation metadata, the synthesized metadata rule set, for the synthesized learned functions. The learned functions that the synthesizer module 3054 synthesizes or organizes into the synthesized learned functions of the machine learning ensemble 3066 may include learned functions directly from the function generator module 3046 combined learned functions from the combiner module 3050, extended learned functions from the extender module 3052, combined extended learned functions, or the like. In one embodiment, the function selector module 3060 selects the learned functions for the synthesizer module 3054 to include in the machine learning ensemble 3066. In certain embodiments, the synthesizer module 3054 organizes learned functions by preparing the learned functions and the associated evaluation metadata for processing workload data to reach a result. For example, as described below, the synthesizer module 3054 may organize and/or synthesize the synthesized learned functions and the synthesized metadata rule set for the orchestration module to direct workload data through the synthesized learned functions to produce a result. Then the machine learning module 3070 evaluates the synthesized learned functions to generate a synthesized metadata rule set. For example, the function evaluator module 3056 evaluates the synthesized learned functions to generate a synthesized metadata rule set. Then the machine learning module 3070 organizes the synthesized learned functions and the synthesized metadata rule set into a machine learning ensemble 3066. For example, the synthesizer module 3054 organizes the synthesized learned functions and the synthesized metadata rule set into a machine learning ensemble 3066. For example, the machine learning ensemble 3066 may be used to respond to analysis requests, such as processing collected and coordinated data using artificial intelligence and machine learning and to provide artificial intelligence and machine learning results, such as a classification, a confidence metric, an inferred function, a regression function, an answer, a prediction, a recognized pattern, a rule, a recommendation, or other results. The machine learning module 3070 stores the machine learning ensemble 3066 in the MILE database 3080. For example, the machine learning ensemble 3066 may be parameters that are deemed to be consistently highly correlated for a specific wager market, such as if the next play is a pass or run, and the parameters and the wagering market are stored in the MILE database 3080 for the odds calculation module 3074 to use to perform correlations on the filtered data in the historical plays database 3018. For example, the machine learning module 3070 may store the machine learning ensemble 3066 on the wagering network, within a database, etc. such as to provide artificial intelligence and machine learning results, such as a classification, a confidence metric, an inferred function, a regression function, an answer, a prediction, a recognized pattern, a rule, a recommendation, or other results. The machine learning module 3070 returns to the base module 3068.

Further, embodiments may include a parameter module 3072, which begins with the parameter module 3072 being initiated by the base module 3068. The parameter module 3072 is continuously polling for the sensor data from the live event 3002. In some embodiments, the base module 3068 may send the received sensor data to the parameter module 3072. The parameter module 3072 receives the sensor data from the live event 3002. In some embodiments, the base module 3068 may send the received sensor data to the parameter module 3072. Then the parameter module 3072 determines the first wager market. The parameter module 3072 filters the MILE database 3080 on the wagering market. Then the parameter module 3072 extracts the parameters from the MLE database 3080. The parameter module 3072 sends the extracted parameters to the odds calculation module 3074. Then the parameter module 3072 determines if there are more wager markets available. If it is determined that there are more wager markets available, the parameter module 3072 determines the next wager market, and the process returns to filtering the MLE database 3080 on the wagering market. If it is determined that there are no more wager markets available, then the parameter module 3072 returns to the base module 3068.

Further, embodiments may include an odds calculation module 3074, which begins with the odds calculation module 3074 being initiated by the base module 3068. In some embodiments, the odds calculation module 3074 may be continuously polling for the data from the live event 3002. In some embodiments, the odds calculation module 3074 may receive the data from the live event 3002. In some embodiments, the odds calculation module 3074 may store the results data, or the results of the last action, in the historical plays database 3018, which may contain historical data of all previous actions. The odds calculation module 3074 filters the historical plays database 3018 on the team and down with the remaining yards to go from the received situational data. For example, the historical plays database 3018 may be filtered on the received data, such as the players within the event, the period within the event, the score of the event, and the current situation of the event, such as it is the first quarter of the New England Patriots vs. the New York Jets, with the Patriots having possession of the football at their 25-yard line and it is first down. The odds calculation module 3074 receives the parameters from the parameter module 3072. For example, the odds calculation module 3074 receives the first parameter, such as the distance to gain, and the second parameter, such as the average distance gained, from the parameter module 3072 to allow the odds calculation module 3074 to perform correlations on the two parameters. In some embodiments, the odds calculation module 3074 may receive the machine learning ensemble 3066, which may contain the parameters, from the parameter module 3072 or the machine learning module 3070. For example, the machine learning ensemble 3066 may be used to respond to analysis requests (e.g., processing collected and coordinated data using artificial intelligence and machine learning) and to provide artificial intelligence and machine learning results, such as a classification, a confidence metric, an inferred function, a regression function, an answer, a prediction, a recognized pattern, a rule, a recommendation, or other results. For example, if the machine learning ensemble 3066 is a regression function or regression analysis, such as a measure of the relation between the mean value of one variable and corresponding values of other variables, then the odds calculation module 3074 uses the selected variables or parameters to perform correlations that the machine learning ensemble 3066 has deemed highly correlated. Then if the correlation coefficients are above a predetermined threshold, the odds calculation module 3074 will be extracted and compared to the recommendations database 3076 and extracts the odds adjustment and then stores the odds adjustment to the adjustment database 3078 and then compares the adjustment database 3078 to the odds database 3020 to determine if any wager odds need to be altered, adjusted, etc. before being offered on the wagering app 3010. Then the odds calculation module 3074 performs correlations on the data. For example, the historical plays database 3018 is filtered on the team, the players, the quarter, the down, and the event, which may be the next play to be a pass. The first parameter is selected, which in this example is the distance to be gained, and the historical plays database 3018 is filtered on the distance to be gained. Then, correlations are performed on the second parameter, which is average yards gained. Correlated data for the historical data involving the Patriots in the first quarter on first down with 10 yards to go and the play being a pass, which has a correlation coefficient of 0.81. The correlations are also performed with the same filters, and the next event is the play being a run with a correlation coefficient of 0.79. Then the odds calculation module 3074 determines if the correlation coefficient is above a predetermined threshold, for example, 0.75, to determine if the data is highly correlated enough to prompt an adjustment for the wager odds. If the correlation exceeds the predetermined threshold, the odds calculation module 3074 extracts the correlation coefficient from the data. For example, the two correlation coefficients of 0.81 for a pass and 0.79 for a run are extracted. If it is determined that the correlations do not exceed the predetermined threshold, then the odds calculation module 3074 determines if any parameters are remaining. Also, if the correlations were determined to be highly relevant and therefore extracted, it is also determined if any parameters are remaining to perform correlations on. In some embodiments, the odds calculation module 3074 may determine if there are more received parameters from the parameter module 3072 to perform correlations on. If there are additional parameters to have correlations performed, then the odds calculation module 3074 selects the next parameter in the historical plays database 3018, and the process returns to performing correlations on the data. For example, the parameter module 3072 may have also identified other variables or parameters deemed highly important or have previously been shown to be highly correlated, and the next parameters are selected. Once there are no more remaining parameters to perform correlations on, the odds calculation module 3074 then determines the difference between each of the extracted correlations. For example, the correlation coefficient for a pass is 0.81, and the correlation coefficient for a run is 0.79. The difference between the two correlation coefficients (0.81−0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendations database 3028 to compare the two correlation coefficient based on statistical significance as opposed to the difference of the two correlation coefficients. Then the odds calculation module 3074 compares the difference between the two correlation coefficients, for example, 0.02, to the recommendations database 3076. The recommendations database 3076 contains various ranges of differences in correlations and the corresponding odds adjustment for those ranges. For example, the 0.02 difference of the two correlation coefficients falls into the range +0-2 difference in correlations which, according to the recommendations database, 3076 should have an odds adjustment of 5% increase. The odds calculation module 3074 then extracts the odds adjustment from the recommendations database 3076. The odds calculation module 3074 then stores the extracted odds adjustment in the adjustment database 3078. The odds calculation module 3074 compares the odds database 3020 to the adjustment database 3078. The odds calculation module 3074 then determines whether or not there is a match in any of the wager IDs in the odds database 3020 and the adjustment database 3078. For example, the odds database 3020 contains a list of all the current bet options for a user; for each bet option, the odds database 3020 contains a wager ID, event, time, inning, wager, and odds. The adjustment database 3078 contains the wager ID and the percentage, either as an increase or decrease, that the odds should be adjusted. If there is a match between the odds database 3020 and the adjustment database 3078, then the odds calculation module 3074 adjusts the odds in the odds database 3020 by the percentage increase or decrease in the adjustment database 3078 and the odds in the odds database 3020 are updated. For example, if the odds in the odds database 3020 are −105 and the matched wager ID in the adjustment database 3078 is a 5% increase, then the updated odds in the odds database 3020 should be −110. If there is a match, the odds are adjusted based on the data stored in the adjustment database 3078, and the new data is stored in the odds database 3020 over the old entry. If there are no matches, or once the odds database 3020 has been adjusted, if there are matches, the odds calculation module 3074 returns to the base module 3068. In some embodiments, the odds calculation module 3074 may offer the odds database 3020 to the wagering app 3010, allowing users to place bets on the wagers stored in the odds database 3020. In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 3074. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1−b2/Sb1−b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 3074 may then extract an odds adjustment from the recommendations database 3076. The extracted odds adjustment is then stored in the adjustment database 3078. In some embodiments, the recommendations database 3076 may be used in the odds calculation module 3074 to determine how the wager odds should be adjusted depending on the difference between the correlation coefficients of the correlated data points. The recommendations database 3076 may contain the difference in correlations and the odds adjustment. For example, if there is a correlation coefficient for a pass being thrown by the Patriots in the first quarter on first down of 0.81 and a correlation coefficient for a run being performed by the Patriots in the first quarter on first down of 0.79, the difference between the two would be +0.02 when compared to the recommendations database 3076 the odds adjustment would be a 5% increase for a Patriots pass or otherwise identified as wager 201 in the adjustment database 3078. In some embodiments, the difference in correlations may be the statistical significance of comparing the two correlation coefficients to determine how the odds should be adjusted. In some embodiments, the adjustment database 3078 may be used to adjust the wager odds of the odds database 3020 if it is determined that a wager should be adjusted. The adjustment database 3078 contains the wager ID, which is used to match with the odds database 3020 to adjust the odds of the correct wager.

Further, embodiments may include a recommendations database 3076, which may be used in the odds calculation module 3074 to determine how the wager odds should be adjusted depending on the difference between the correlation coefficients of the correlated data points. The recommendations database 3076 may contain the difference in correlations and the odds adjustment. For example, if there is a correlation coefficient for a pass being thrown by the Patriots in the first quarter on first down of 0.81 and a correlation coefficient for a run being performed by the Patriots in the first quarter on first down of 0.79, the difference between the two would be +0.02 when compared to the recommendations database 3074 the odds adjustment would be a 5% increase for a Patriots pass or otherwise identified as wager 201 in the adjustment database 3078. In some embodiments, the difference in correlations may be the statistical significance of comparing the two correlation coefficients to determine how the odds should be adjusted.

Further, embodiments may include an adjustment database 3078, which may be used to adjust the wager odds of the odds database 3020 if it is determined that a wager should be adjusted. The adjustment database 3078 contains the wager ID, which is used to match with the odds database 3020 to adjust the odds of the correct wager.

Further, embodiments may include an MLE database 3080 or machine learning ensemble database, which may be created in the process described in the machine learning module 3070 in which the machine learning ensemble 3066 contains parameters for individual wager markets that have been deemed highly relevant and allows the odds calculation module 3074 to receive the parameters and perform correlations on the parameters with the historical plays database 3018 filtered on the situational sensor data received from the live event 3002 to determine if the wager odds should be adjusted based on if the correlation coefficients exceed a predetermined threshold. The database contains the event type, such as a football event, baseball event, basketball event, hockey event, etc., the wagering market such as if the next play is a run or a pass if the next pitch is strike or ball if the next basket is a three-pointer or two-pointer, the next goalscorer, the next play being over or under 5 yards gained, the next pass being complete or incomplete, the next play resulting in a first down or not, the wager odds for the next player to catch a pass, etc., the first parameter and the second parameter associated with the wagering market, for example, if the wagering market is the next play being a pass or a run then the parameters may be the distance to gain, and the average distance gained, if the wagering market is the next pitch being a strike or a ball then the parameters may be batting average and on-base percentage.

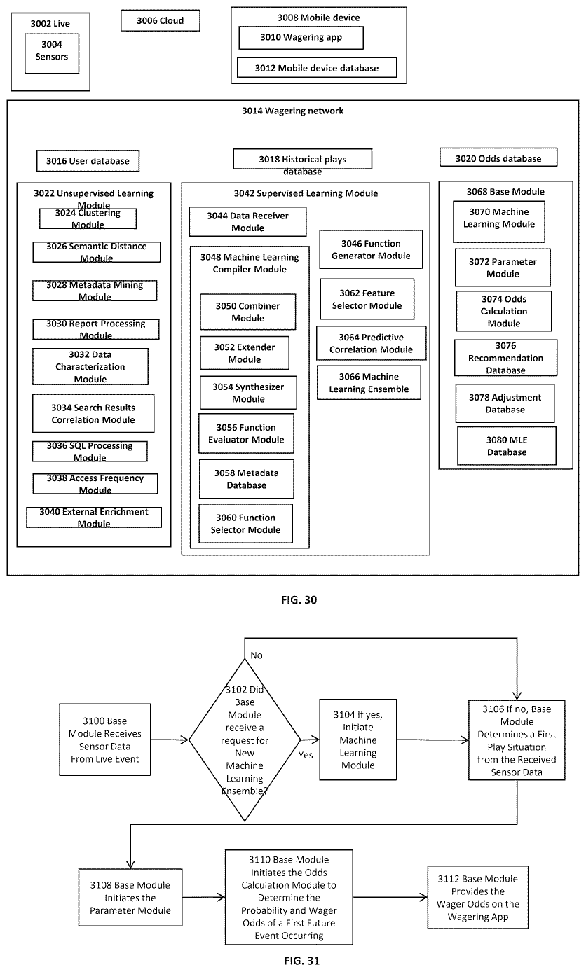

FIG. 31 illustrates the base module 3068. The process begins with the base module 3068 receives, at step 3100, the sensor data from the live event 3002. For example, the base module 3068 receives sensor data related to the event, such as the players within the event, the period within the event, the score of the event, and the current situation of the event, such as it is the first quarter of the New England Patriots vs. the New York Jets, with the Patriots having possession of the football at their 25-yard line and it is first down. Then it is determined if the base module 3068 received, at step 3102, a request for a new machine learning ensemble 3066. For example, the wagering network 3014 may send a request for a new machine learning ensemble 3066, such as a daily request, weekly request, monthly request, quarterly request, yearly request, etc. If it is determined that the base module 3068 received a request for a new artificial intelligence and machine learning ensemble, then the base module initiates, at step 3104, the machine learning module 3070. For example, if the base module 3068 receives a request for a new machine learning ensemble 3066, then the base module 3068 initiates the machine learning module 3070. If it is determined that the base module 3068 did not receive a request for a new machine learning ensemble 3066, then the base module 3068 determines, at step 3106, a first play situation from the received sensor data. For example, the base module 3068 receives the time-stamped position information and is used to determine a first play situation of the present competition, such as, a current play situation. In various embodiments, the play situation is determined using, at least in part, time-stamped position information of each player in the subsets of players at the given time. For example, the process determines the play situation at a first time point which is a current time of competition while the competition is ongoing, and the time-stamped position information has been collected by the sensors 3004 at the present competition through the first time point. For example, the current play situation may be in the first quarter of the New England Patriots vs. the New York Jets, with the Patriots having possession of the football at their 25-yard line, and it is first down. Then the base module 3068 initiates, at step 3108, the parameter module 3072. For example, the parameter module 3072 may begin with the parameter module 3072 being initiated by the base module 3068. The parameter module 3072 is continuously polling for the sensor data from the live event 3002. In some embodiments, the base module 3068 may send the received sensor data to the parameter module 3072. The parameter module 3072 receives the sensor data from the live event 3002. In some embodiments, the base module 3068 may send the received sensor data to the parameter module 3072. Then the parameter module 3072 determines the first wager market. The parameter module 3072 filters the MILE database 3080 on the wagering market. Then the parameter module 3072 extracts the parameters from the MILE database 3080. The parameter module 3072 sends the extracted parameters to the odds calculation module 3074. Then the parameter module 3072 determines if there are more wager markets available. If it is determined that there are more wager markets available, the parameter module 3072 determines the next wager market, and the process returns to filtering the MILE database 3080 on the wagering market. If it is determined that there are no more wager markets available, then the parameter module 3072 returns to the base module 3068. The base module 3068 initiates, at step 3110, the odds calculation module 3074 to determine the probability and wager odds of a first future event occurring at the present competition based on at least the first play situation and playing data associated with at least a subset of one or both of the first set of one or more participants and the second set of one or more participant. The base module 3068 provides, at step 3112, the wager odds on the wagering app 3010. In various embodiments, the wager odds are transmitted to the wagering app 3010 through the wager network 3014 to be displayed on a mobile device 3008. In some embodiments, the wagering app 3010, a program that enables the user to place bets on individual plays in the live event 3002, streams audio and video from the live event 3002 and features the available wagers from the live event 3002 on the mobile device 3008. The wagering app 3010 allows users to interact with the wagering network 3014 to place bets and provide payment/receive funds based on wager outcomes.

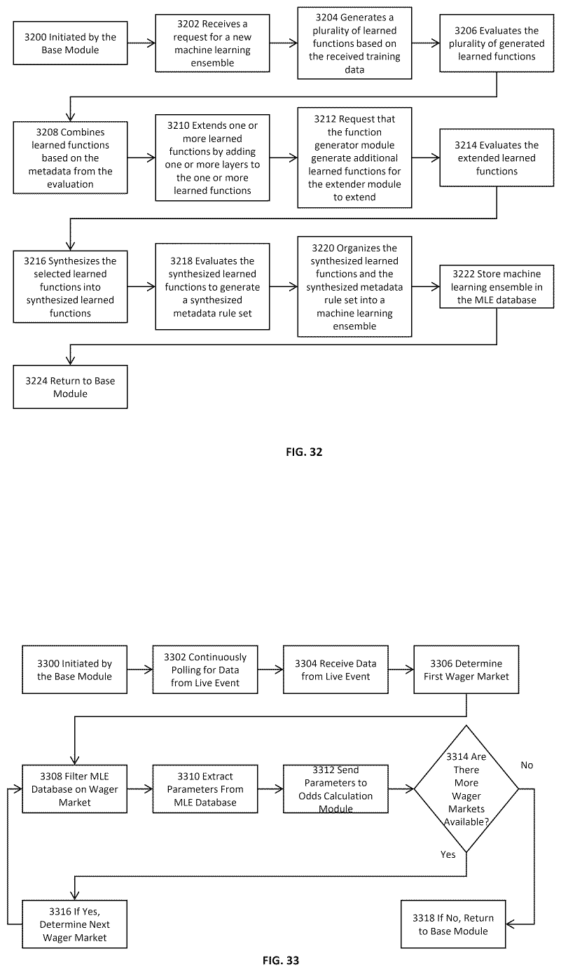

FIG. 32 illustrates the machine learning module 3070. The process begins with the machine learning module 3070 being initiated, at step 3200, by the base module 3068. Then the machine learning module 3070 receives, at step 3202, a request for a new machine learning ensemble 3066. For example, the wagering network 3014 may send a request for a new machine learning ensemble 3066, such as a daily request, weekly request, monthly request, quarterly request, yearly request, etc. The machine learning module 3070 generates, at step 3204, a plurality of learned functions based on the received training data. For example, the function generator module 3046 generates a plurality of learned functions based on the received training data from different artificial intelligence and machine learning classes. A learned function comprises a computer-readable code that accepts an input and provides a result. A learned function may comprise a compiled code, a script, text, a data structure, a file, a function, or the like. In some embodiments, a learned function may accept instances of one or more features as input and provide a result, such as a classification, a confidence metric, an inferred function, a regression function, an answer, a prediction, a recognized pattern, a rule, a recommendation, an evaluation, or the like. In another embodiment, certain learned functions may accept instances of one or more features as input and provide a subset of the instances, a subset of the one or more features, or the like as an output. In a further embodiment, certain learned functions may receive the output or result of one or more other learned functions as input, such as a Bayes classifier, a Boltzmann machine, or the like. Then the machine learning module 3070 evaluates, at step 3206, the plurality of generated learned functions. For example, the function evaluator module 3056 evaluates the plurality of generated learned functions to generate evaluation metadata. The function evaluator module 3056 is configured to evaluate learned functions using test data or the like. The function evaluator module 3056 may evaluate learned functions generated by the function generator module 3046, learned functions combined by the combiner module 3050, learned functions extended by the extender module 3052, combined extended learned functions, synthesized learned functions organized into the machine learning ensemble 3066 by the synthesizer module 3054, or the like. Test data for a learned function, in certain embodiments, comprises a different subset of the initialization data for the learned function than the function generator module 3046 used as training data. The function evaluator module 3056, in one embodiment, evaluates a learned function by inputting the test data into the learned function to produce a result, such as a classification, a confidence metric, an inferred function, a regression function, an answer, a prediction, a recognized pattern, a rule, a recommendation, an evaluation, or another result. The machine learning module 3070 combines, at step 3208, learned functions based on the metadata from the evaluation. For example, the combiner module 3050 combines learned functions based on the metadata from the evaluation performed by the function evaluator module 3056. For example, the combiner module 3050 combines learned functions, forming sets, strings, groups, trees, or clusters of combined learned functions. In certain embodiments, the combiner module 3050 combines learned functions into a prescribed order, and different orders of learned functions may have different inputs, produce different results, or the like. The combiner module 3050 may combine learned functions in different combinations. For example, the combiner module 3050 may combine certain learned functions horizontally or in parallel, joined at the inputs and outputs or the like, and may combine certain learned functions vertically or in series, feeding the output of one into the input of another learned function. The combiner module 3050 may determine which learned functions to combine, how to combine learned functions, or the like based on evaluation metadata for the learned functions from the metadata database 3058, generated based on an evaluation of the learned functions using test data, as described below with regard to the function evaluator module 3056. The combiner module 3050 may request additional learned functions from the function generator module 3046 for combining with other learned functions. For example, the combiner module 3050 may request a new learned function with a particular input and/or output to combine with an existing learned function or the like. The machine learning module 3070 extends, at step 3210, one or more learned functions by adding one or more layers to the one or more learned functions. For example, the extender module 3052 extends one or more learned functions by adding one or more layers to the one or more learned functions, such as a probabilistic model layer or the like. In certain embodiments, the extender module 3052 extends combined learned functions based on the evaluation of the combined learned functions. For example, in certain embodiments, the extender module 3052 is configured to add one or more layers to a learned function. For example, the extender module 3052 may extend a learned function or combined learned function by adding a probabilistic model layer, such as a Bayesian belief network layer, a Bayes classifier layer, a Boltzmann layer, or the like. Certain classes of learned functions, such as probabilistic models, may be configured to receive either instances of one or more features as input or the output results of other learned functions, such as a classification and a confidence metric, an inferred function, a regression function, an answer, a prediction, a recognized pattern, a rule, a recommendation, an evaluation, or the like. The extender module 3052 may use these types of learned functions to extend other learned functions. The extender module 3052 may extend learned functions generated by the function generator module 3046 directly, may extend combined learned functions from the combiner module 3050, may extend other extended learned functions, may extend synthesized learned functions from the synthesizer module 3054, or the like. Then the machine learning module 3070 requests, at step 3212, that the function generator module 3046 generate additional learned functions for the extender module to extend. For example, the extender module 3052 may request that the function generator module 3046 generate additional learned functions for the extender module 3052 to extend. For example, the function generator module 3046 may generate learned functions from multiple artificial intelligence and machine learning classes, models, or algorithms. For example, the function generator module 3046 may generate decision trees; decision forests; kernel classifiers and regression machines with a plurality of reproducing kernels; non-kernel regression and classification machines such as logistic, CART, multi-layer neural nets with various topologies; Bayesian-type classifiers such as Nave Bayes and Boltzmann machines; logistic regression; multinomial logistic regression; probit regression; AR; MA; ARMA; ARCH; GARCH; VAR; survival or duration analysis; MARS; radial basis functions; support vector machines; k-nearest neighbors; geospatial predictive modeling; and/or other classes of learned functions. The machine learning module 3070 evaluates, at step 3214, the extended learned functions. For example, the function evaluator module 3056 evaluates the extended learned functions. For example, in one embodiment, the function evaluator module 3056 is configured to maintain evaluation metadata for an evaluated learned function in the metadata database 3058. The evaluation metadata, in certain embodiments, comprises log data generated by the function generator module 3046 while generating learned functions, the function evaluator module 3056 while evaluating learned functions, or the like. In one embodiment, the evaluation metadata includes indicators of one or more training data sets that the function generator module 3046 used to generate a learned function. The evaluation metadata, in another embodiment, includes indicators of one or more test data sets that the function evaluator module 3056 used to evaluate a learned function. In a further embodiment, the evaluation metadata includes indicators of one or more decisions made by and/or branches taken by a learned function during an evaluation by the function evaluator module 3056. The evaluation metadata, in another embodiment, includes the results determined by a learned function during an evaluation by the function evaluator module 3056. In one embodiment, the evaluation metadata may include evaluation metrics, learning metrics, effectiveness metrics, convergence metrics, or the like for a learned function based on an evaluation of the learned function. An evaluation metric, learning metrics, effectiveness metric, convergence metric, or the like may be based on a comparison of the results from a learned function to actual values from initialization data and may be represented by a correctness indicator for each evaluated instance, a percentage, a ratio, or the like. Different classes of learned functions in certain embodiments may have different types of evaluation metadata. The machine learning module 3070 synthesizes, at step 3216, the selected learned functions into synthesized learned functions. For example, the synthesizer module 3054 synthesizes the selected learned functions into synthesized learned functions. For example, in certain embodiments, the synthesizer module 3054 is configured to organize a subset of learned functions into the machine learning ensemble 3066, as synthesized learned functions. In a further embodiment, the synthesizer module 3054 includes evaluation metadata from the metadata database 3058 of the function evaluator module 3056 in the machine learning ensemble 3066 as a synthesized metadata rule set, so that the machine learning ensemble 3066 includes synthesized learned functions and evaluation metadata, the synthesized metadata rule set, for the synthesized learned functions. The learned functions that the synthesizer module 3054 synthesizes or organizes into the synthesized learned functions of the machine learning ensemble 3066 may include learned functions directly from the function generator module 3046 combined learned functions from the combiner module 3050, extended learned functions from the extender module 3052, combined extended learned functions, or the like. In one embodiment, the function selector module 3060 selects the learned functions for the synthesizer module 3054 to include in the machine learning ensemble 3066. In certain embodiments, the synthesizer module 3054 organizes learned functions by preparing the learned functions and the associated evaluation metadata for processing workload data to reach a result. For example, as described below, the synthesizer module 3054 may organize and/or synthesize the synthesized learned functions and the synthesized metadata rule set for the orchestration module to direct workload data through the synthesized learned functions to produce a result. Then the machine learning module 3070 evaluates, at step 3218, the synthesized learned functions to generate a synthesized metadata rule set. For example, the function evaluator module 3056 evaluates the synthesized learned functions to generate a synthesized metadata rule set. Then the machine learning module 3070 organizes, at step 3220, the synthesized learned functions and the synthesized metadata rule set into a machine learning ensemble 3066. For example, the synthesizer module 3054 organizes the synthesized learned functions and the synthesized metadata rule set into a machine learning ensemble 3066. For example, the machine learning ensemble 3066 may be used to respond to analysis requests, such as processing collected and coordinated data using artificial intelligence and machine learning and to provide artificial intelligence and machine learning results, such as a classification, a confidence metric, an inferred function, a regression function, an answer, a prediction, a recognized pattern, a rule, a recommendation, or other results. The machine learning module 3070 stores, at step 3222, the machine learning ensemble 3066 in the MLE database 3080. For example, the machine learning ensemble 3066 may be parameters that are deemed to be consistently highly correlated for a specific wager market, such as if the next play is a pass or run, and the parameters and the wagering market are stored in the MILE database 3080 for the odds calculation module 3074 to use to perform correlations on the filtered data in the historical plays database 3018. For example, the machine learning module 3070 may store the machine learning ensemble 3066 on the wagering network, within a database, etc. such as to provide artificial intelligence and machine learning results, such as a classification, a confidence metric, an inferred function, a regression function, an answer, a prediction, a recognized pattern, a rule, a recommendation, or other results. The machine learning module 3070 returns, at step 3224, to the base module 3068.

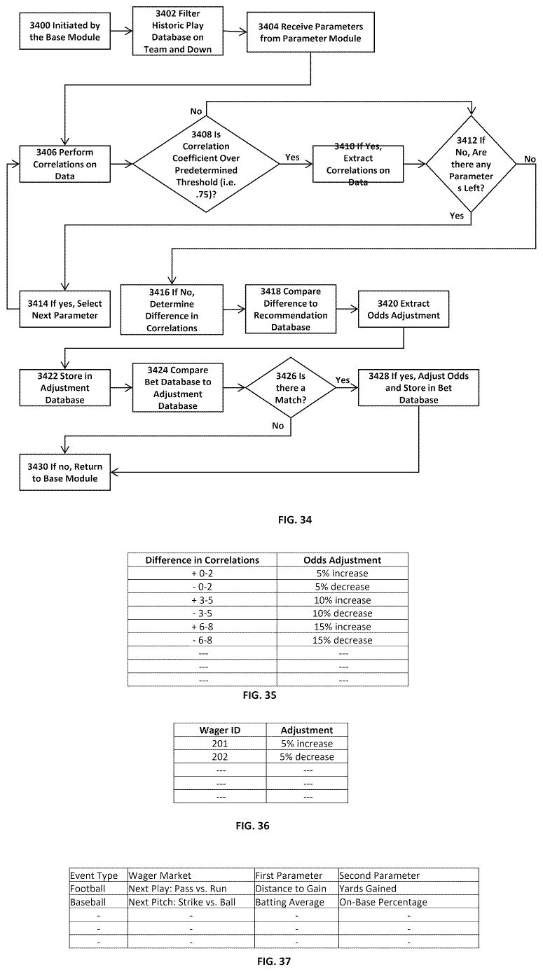

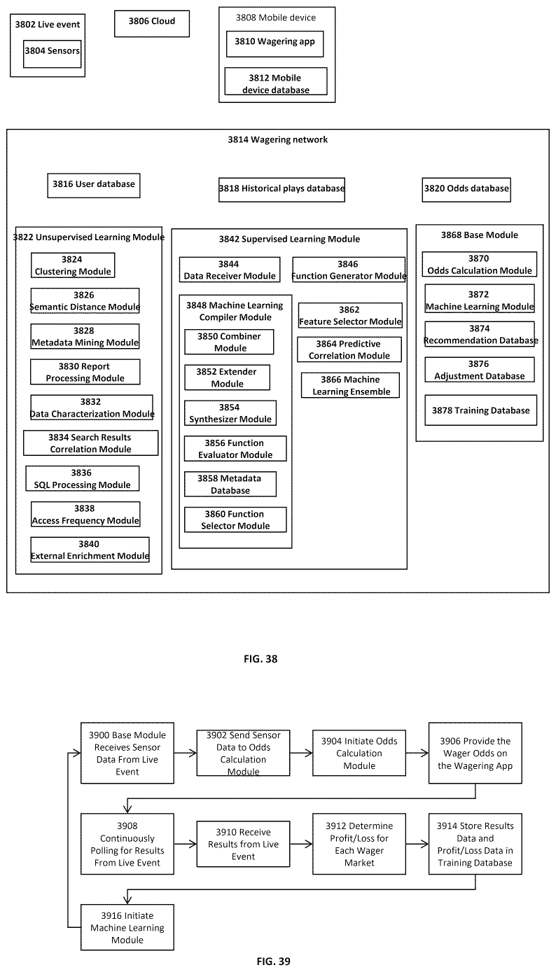

FIG. 33 illustrates the parameter module 3072. The process begins with the parameter module 3072 being initiated, at step 3300, by the base module 3068. The parameter module 3072 is continuously polling, at step 3302, for the sensor data from the live event 3002. For example, the parameter module 3072 is continuously polling for sensor data related to the event, such as the players within the event, the period within the event, the score of the event, and the current situation of the event, such as it is the first quarter of the New England Patriots vs. the New York Jets, with the Patriots having possession of the football at their 25-yard line and it is first down. In some embodiments, the base module 3068 may send the received sensor data to the parameter module 3072. The parameter module 3072 receives, at step 3304, the sensor data from the live event 3002. For example, the parameter module 3072 receives the sensor data related to the event, such as the players within the event, the period within the event, the score of the event, and the current situation of the event, such as it is the first quarter of the New England Patriots vs. the New York Jets, with the Patriots having possession of the football at their 25-yard line and it is first down. In some embodiments, the base module 3068 may send the received sensor data to the parameter module 3072. Then the parameter module 3072 determines, at step 3306, the first wager market. For example, the parameter module 3072 may determine the wagering market by the available wager markets that are offered on the wagering network, such as in a football, the next play being a pass or run, the next play being over or under 5 yards gained, the next pass being complete or incomplete, the next play resulting in a first down or not, the wager odds for the next player to catch a pass, etc. In some embodiments, the wager markets may be stored in a database to allow the parameter module to determine the wager markets. In some embodiments, the wager markets may be determined by the wager markets that have been previously or historically offered on the wagering network 3014 in similar event situations. The parameter module 3072 filters, at step 3308, the MLE database 3080 on the wagering market. For example, once the parameter module 3072 determines the wagering market, such as if the next play in a football event will be a pass or run, the parameter module 3072 filters the MLE database 3080 on the wagering market, for example, the next play in a football event will be a pass or run. Then the parameter module 3072 extracts, at step 3310, the parameters from the MLE database 3080. For example, the parameter module 3072 extracts the first and second parameters stored in the MLE database 3080 associated with the wagering market. For example, if the wagering market is the next play in a football event will be a pass or run, then the corresponding parameters may be the distance to gain, and the average distance gained. The MLE database 180 may store the event type, the wagering market, and the corresponding first and second parameters deemed highly correlated parameters from the process described in the machine learning module 3070 in which a machine learning ensemble 3066 is created. The machine learning ensemble 3066 may be parameters that are deemed to be consistently highly correlated for a specific wager market, such as if the next play is a pass or run, and the parameters and the wagering market are stored in the MLE database 3080 for the odds calculation module 3074 to use to perform correlations on the filtered data in the historical plays database 3018. For example, the machine learning module 3070 may store the machine learning ensemble 3066 on the wagering network, within a database, etc. such as to provide artificial intelligence and machine learning results, such as a classification, a confidence metric, an inferred function, a regression function, an answer, a prediction, a recognized pattern, a rule, a recommendation, or other results. The parameter module 3072 sends, at step 3312, the extracted parameters to the odds calculation module 3074. For example, the parameter module 3072 sends the first parameter, such as the distance to gain, and the second parameter, such as average distance gained, to the odds calculation module 3074 for the odds calculation module 3074 to perform correlations on the two parameters. Then the parameter module 3072 determines, at step 3314, if there are more wager markets available. For example, the parameter module 3072 may determine if there are additional wager markets available by the remaining wager markets that are offered on the wagering network 3014, such as in a football the next play being a pass or run, the next play being over or under 5 yards gained, the next pass being complete or incomplete, the next play resulting in a first down or not, the wager odds for the next player to catch a pass, etc. In some embodiments, the wager markets may be stored in a database to allow the parameter module to determine the wager markets. In some embodiments, the wager markets may be determined by the wager markets that have been previously or historically offered on the wagering network 3014 in similar event situations. If it is determined that there are more wager markets available, the parameter module 3072 determines, at step 3316, the next wager market is selected, and the process returns to filtering the MLE database 3080 on the wagering market. If it is determined that there are no more wager markets available, then the parameter module 3072 returns, at step 3318, to the base module 3068.

FIG. 34 illustrates the odds calculation module 3074. The process begins with the odds calculation module 3074 being initiated, at step 3400, by the base module 3068. In some embodiments, the odds calculation module 3074 may be continuously polling for the data from the live event 3002. In some embodiments, the odds calculation module 3074 may receive the data from the live event 3002. In some embodiments, the odds calculation module 3074 may store the results data, or the results of the last action, in the historical plays database 3018, which may contain historical data of all previous actions. The odds calculation module 3074 filters, at step 3402, the historical plays database 3018 on the team and down with the remaining yards to go from the received situational data. For example, the historical plays database 3018 may be filtered on the received data, such as the players within the event, the period within the event, the score of the event, and the current situation of the event, such as it is the first quarter of the New England Patriots vs. the New York Jets, with the Patriots having possession of the football at their 25-yard line and it is first down. The odds calculation module 3074 receives, at step 3404, the parameters from the parameter module 3072. For example, the odds calculation module 3074 receives the first parameter, such as the distance to gain, and the second parameter, such as the average distance gained, from the parameter module 3072 to allow the odds calculation module 3074 to perform correlations on the two parameters. In some embodiments, the odds calculation module 3074 may receive the machine learning ensemble 3066, which may contain the parameters, from the parameter module 3072 or the machine learning module 3070. For example, the machine learning ensemble 3066 may be used to respond to analysis requests (e.g., processing collected and coordinated data using artificial intelligence and machine learning) and to provide artificial intelligence and machine learning results, such as a classification, a confidence metric, an inferred function, a regression function, an answer, a prediction, a recognized pattern, a rule, a recommendation, or other results. For example, if the machine learning ensemble 3066 is a regression function or regression analysis, such as a measure of the relation between the mean value of one variable and corresponding values of other variables, then the odds calculation module 3074 uses the selected variables or parameters to perform correlations that the machine learning ensemble 3066 has deemed highly correlated. Then if the correlation coefficients are above a predetermined threshold, the odds calculation module 3074 will be extracted and compared to the recommendations database 3076 and extracts the odds adjustment and then stores the odds adjustment to the adjustment database 3078 and then compares the adjustment database 3078 to the odds database30to determine if any wager odds need to be altered, adjusted, etc. before being offered on the wagering app 3010. Then the odds calculation module 3074 performs, at step 3406, correlations on the data. For example, the historical plays database 3018 is filtered on the team, the players, the quarter, the down, and the event, which may be the next play to be a pass. The first parameter is selected, which in this example is the distance to be gained, and the historical plays database 3018 is filtered on the distance to be gained. Then, correlations are performed on the second parameter, which is average yards gained. Correlated data for the historical data involving the Patriots in the first quarter on first down with 10 yards to go and the play being a pass, which has a correlation coefficient of 0.81. The correlations are also performed with the same filters, and the next event, which is the play being a run with a correlation coefficient of 0.79. Then the odds calculation module 3074 determines, at step 3408, if the correlation coefficient is above a predetermined threshold, for example, 0.75, to determine if the data is highly correlated enough to prompt an adjustment for the wager odds. If the correlation exceeds the predetermined threshold, then the odds calculation module 3074 extracts, at step 3410, the correlation coefficient from the data. For example, the two correlation coefficients of 0.81 for a pass and 0.79 for a run are extracted. If it is determined that the correlations do not exceed the predetermined threshold, then the odds calculation module 3074 determines, at step 3412, if any parameters are remaining. Also, if the correlations were determined to be highly relevant and therefore extracted, it is also determined if any parameters are remaining to perform correlations on. In some embodiments, the odds calculation module 3074 may determine if there are more received parameters from the parameter module 3072 to perform correlations on. If there are additional parameters to have correlations performed, then the odds calculation module 3074 selects, at step 3414, the next parameter in the historical plays database 3018, and the process returns to performing correlations on the data. For example, the parameter module 3072 may have also identified other variables or parameters deemed highly important or have previously been shown to be highly correlated, and the next parameters are selected. Once there are no remaining parameters to perform correlations on, the odds calculation module 3074 then determines, at step 3416, the difference between each of the extracted correlations. For example, the correlation coefficient for a pass is 0.81, and the correlation coefficient for a run is 0.79. The difference between the two correlation coefficients (0.81−0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendations database 3028 to compare the two correlation coefficient based on statistical significance as opposed to the difference of the two correlation coefficients. Then the odds calculation module 3074 compares, at step 3418, the difference between the two correlation coefficients, for example, 0.02, to the recommendations database 3076. The recommendations database 3076 contains various ranges of differences in correlations and the corresponding odds adjustment for those ranges. For example, the 0.02 difference of the two correlation coefficients falls into the range +0-2 difference in correlations which, according to the recommendations database, 3076 should have an odds adjustment of 5% increase. The odds calculation module 3074 then extracts, at step 3420, the odds adjustment from the recommendations database 3076. The odds calculation module 3074 then stores, at step 3422, the extracted odds adjustment in the adjustment database 3078. The odds calculation module 3074 compares, at step 3424, the odds database 3020 to the adjustment database 3078. The odds calculation module 3074 then determines, at step 3426, whether or not there is a match in any of the wager IDs in the odds database 3020 and the adjustment database 3078. For example, the odds database 3020 contains a list of all the current bet options for a user; for each bet option, the odds database 3020 contains a wager ID, event, time, inning, wager, and odds. The adjustment database 3078 contains the wager ID and the percentage, either as an increase or decrease, that the odds should be adjusted. If it is determined there is a match between the odds database 3020 and the adjustment database 3078, then the odds calculation module 3074 adjust, at step 3428, the odds in the odds database 3020 by the percentage increase or decrease in the adjustment database 3078 and the odds in the odds database 3020 are updated. For example, if the odds in the odds database 3020 are −105 and the matched wager ID in the adjustment database 3078 is a 5% increase, then the updated odds in the odds database 3020 should be −110. If there is a match, the odds are adjusted based on the data stored in the adjustment database 3078 and the new data stored in the odds database 3020 over the old entry. If there are no matches, or, once the odds database 3020 has been adjusted if there are matches, the odds calculation module 3074 returns, at step 303430, to the base module 3068. In some embodiments, the odds calculation module 3074 may offer the odds database 3020 to the wagering app 3010, allowing users to place bets on the wagers stored in the odds database 3020. In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 3074. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1−b2/Sb1−b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 3074 may then extract an odds adjustment from the recommendations database 3076. The extracted odds adjustment is then stored in the adjustment database 3078. In some embodiments, the recommendations database 3076 may be used in the odds calculation module 3074 to determine how the wager odds should be adjusted depending on the difference between the correlation coefficients of the correlated data points. The recommendations database 3076 may contain the difference in correlations and the odds adjustment. For example, if there is a correlation coefficient for a pass being thrown by the Patriots in the first quarter on first down of 0.81 and a correlation coefficient for a run being performed by the Patriots in the first quarter on first down of 0.79, the difference between the two would be +0.02 when compared to the recommendations database 3076 the odds adjustment would be a 5% increase for a Patriots pass or otherwise identified as wager 201 in the adjustment database 3078. In some embodiments, the difference in correlations may be the statistical significance of comparing the two correlation coefficients to determine how the odds should be adjusted. In some embodiments, the adjustment database 3078 may be used to adjust the wager odds of the odds database 3020 if it is determined that a wager should be adjusted. The adjustment database 3078 contains the wager ID, which is used to match with the odds database 3020 to adjust the odds of the correct wager.

FIG. 35 illustrates the recommendations database 3076. The recommendations database 3076 may be used in the odds calculation module 3074 to determine how the wager odds should be adjusted depending on the difference between the correlation coefficients of the correlated data points. The recommendations database 3076 may contain the difference in correlations and the odds adjustment. For example, if there is a correlation coefficient for a pass being thrown by the Patriots in the first quarter on first down of 0.81 and a correlation coefficient for a run being performed by the Patriots in the first quarter on first down of 0.79, the difference between the two would be +0.02 when compared to the recommendations database 3076 the odds adjustment would be a 5% increase for a Patriots pass or otherwise identified as wager 201 in the adjustment database 3078. In some embodiments, the difference in correlations may be the statistical significance of comparing the two correlation coefficients to determine how the odds should be adjusted.

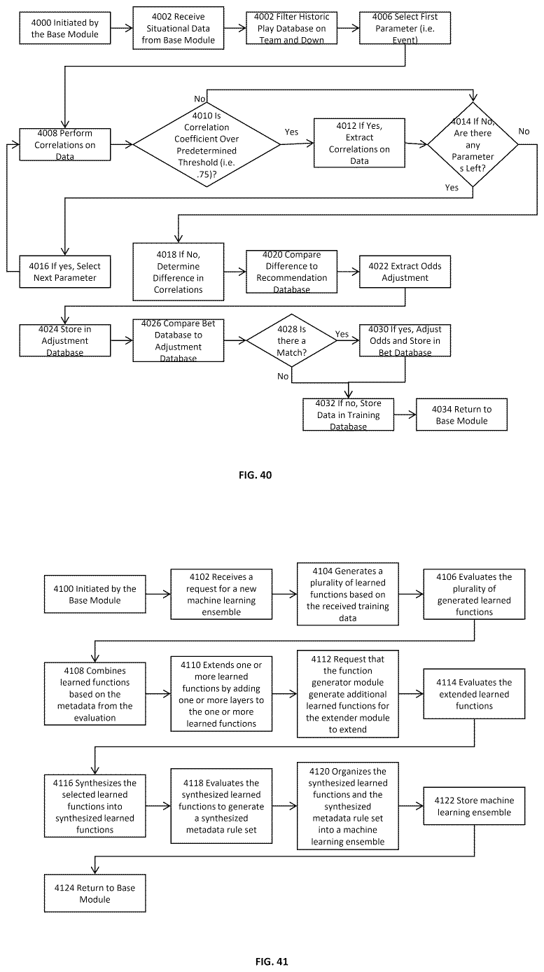

FIG. 36 illustrates the adjustment database 3078. The adjustment database 3078 may be used to adjust the wager odds of the odds database 3020 if it is determined that a wager should be adjusted. The adjustment database 3078 contains the wager ID, which is used to match with the odds database 3020 to adjust the odds of the correct wager.

FIG. 37 illustrates the MLE database 3080. The MLE database 3080 or machine learning ensemble database is created in the process described in the machine learning module 3070 in which the machine learning ensemble 3066 contains parameters for individual wager markets that have been deemed highly relevant and allows the odds calculation module 3074 to receive the parameters and perform correlations on the parameters with the historical plays database 3018 filtered on the situational sensor data received from the live event 3002 to determine if the wager odds should be adjusted based on if the correlation coefficients exceed a predetermined threshold. The database contains the event type, such as a football event, baseball event, basketball event, hockey event, etc., the wagering market such as if the next play is a run or a pass if the next pitch is strike or ball if the next basket is a three-pointer or two-pointer, the next goalscorer, the next play being over or under 5 yards gained, the next pass being complete or incomplete, the next play resulting in a first down or not, the wager odds for the next player to catch a pass, etc., the first parameter and the second parameter associated with the wagering market, for example, if the wagering market is the next play being a pass or a run then the parameters may be the distance to gain, and the average distance gained, if the wagering market is the next pitch being a strike or a ball then the parameters may be batting average and on-base percentage.

In another embodiment, machine learning training for an odds adjuster may be shown and described.

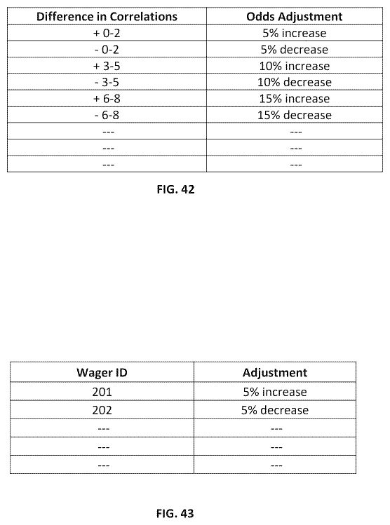

FIG. 38 is a method for machine learning training for an odds adjustor. This method comprises of This system may include a live event 3802, for example, a sporting event such as a football, basketball, baseball, or hockey game, tennis match, golf tournament, eSports, or digital game, etc. The live event 3802 may include some number of actions or plays upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 3802, such as the score of an American football game or the run line in a baseball game, or a series of actions in the live event 3802. Sportsbooks have several bets they can handle, limiting the number of wagers they can take on either side of a bet before moving the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer future bets on live events in the future. Sportsbooks need to offer payment processing services to cash out customers, which can be done at kiosks at the live event 3802 or at another location.

Further, embodiments may include a plurality of sensors 3804 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 3804 may include but are not limited to, tracking devices, such as RFID tags, GPS chips, or other such devices embedded on uniforms, in equipment, in the field of play and boundaries of the field of play, or on other markers in the field of play. In addition, imaging devices may also be used as tracking devices, such as player tracking, which provide statistical information through real-time X, Y positioning of players and X, Y, Z positioning of the ball.

Further, embodiments may include a cloud 3806 or a communication network that may be wired and/or wireless. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 3806 may be communicatively coupled to a peer-to-peer wagering network 3814, which may perform real-time analysis on the type of play and the result of the play. The cloud 3806 may also be synchronized with game situational data such as the time of the game, the score, location on the field, weather conditions, and the like, which may affect the choice of play utilized. For example, in an exemplary embodiment, the cloud 3806 may not receive data gathered from the sensors 3804 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 3808 such as a computing device, laptop, smartphone, tablet, computer, smart speaker, or I/O devices. I/O devices may be present in the computing device. Input devices may include but are not limited to keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide-semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include but are not limited to video displays, graphical displays, speakers, headphones, inkjet printers, laser printers, or 3D printers. Devices may include but are not limited to a combination of multiple input or output devices such as Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs, including, but not limited to, Microsoft KINECT, SIRI for iPhone by Apple, Google Now, or Google Voice Search. Additional user devices have both input and output capabilities, including, but not limited to, haptic feedback devices, touchscreen displays, or multi-touch displays. Touchscreen, multi-touch displays, touchpads, touch mice, or other touch sensing devices may use different technologies to sense touch, including but not limited to capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 3808 could be an optional component and would be utilized in a situation where a paired wearable device employs the mobile device 3808 for additional memory or computing power or connection to the internet.

Further, embodiments may include a wagering software application or a wagering app 3810, which is a program that enables the user to place bets on individual plays in the live event 3802, streams audio and video from the live event 3802, and features the available wagers from the live event 3802 on the mobile device 3808. The wagering app 3810 allows users to interact with the wagering network 3814 to place bets and provide payment/receive funds based on wager outcomes.

Further, embodiments may include a mobile device database 3812 that may store some or all the user's data, the live event 3802, or the user's interaction with the wagering network 3814.

Further, embodiments may include the wagering network 3814, which may perform real-time analysis on the type of play and the result of a play or action. The wagering network 3814 (or the cloud 3806) may also be synchronized with game situational data, such as the time of the game, the score, location on the field, weather conditions, and the like, which may affect the choice of play utilized. For example, in an exemplary embodiment, the wagering network 3814 may not receive data gathered from the sensors 3804 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 3814 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 3816, which may contain data relevant to all users of the wagering network 3814 and may include, but is not limited to, a user ID, a device identifier, a paired device identifier, wagering history, or wallet information for the user. The user database 3816 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 3816 may contain betting lines and search queries. The user database 3816 may be searched based on a search criterion received from the user. Each betting line may include, but is not limited to, a plurality of betting attributes such as at least one of the live event 3802, a team, a player, an amount of wager, etc. The user database 3816 may include but is not limited to information related to all the users involved in the live event 3802. In one exemplary embodiment, the user database 3816 may include information for generating a user authenticity report and a wagering verification report. Further, the user database 3816 may be used to store user statistics like, but not limited to, the retention period for a particular user, frequency of wagers placed by a particular user, the average amount of wager placed by each user, etc.

Further, embodiments may include a historical plays database 3818 that may contain play data for the type of sport being played in the live event 3802. For example, in American Football, for optimal odds calculation, the historical play data may include metadata about the historical plays, such as time, location, weather, previous plays, opponent, physiological data, etc. 3818. Further, embodiments may utilize an odds database 3820—that contains the odds calculated by an odds calculation module 3822—to display the odds on the user's mobile device 3808 and take bets from the user through the mobile device wagering app 3810.

Further, embodiments may include an unsupervised learning module 3822. Embodiments of the unsupervised learning module 3822 may include multiple sub-modules, including a clustering module 3824, a semantic distance module 3826, a metadata mining module 3828, a report processing module 3830, a data characterization module 3832, a search results correlation module 3834, a SQL query processing module, an access frequency module 3838, and an external enrichment module 3840. Each of these modules is configured to perform at least one unsupervised learning technique.

Unsupervised learning techniques generally seek to summarize and explain key features of a data set. Non-limiting examples of unsupervised techniques include hidden Markov models, blind signal separation using feature extraction techniques for dimensionality reduction, and each of the techniques performed by the modules of the unsupervised learning module 3822 (cluster analysis, mining metadata from the data in the unstructured data set, identifying relationships in data of the unstructured data set based on one or more of analyzing process reports and analyzing process SQL queries, identifying relationships in data of the unstructured data set by identifying semantic distances between data in the unstructured data set, using statistical data to determine a relationship between data in the unstructured data set, identifying relationships in data of the unstructured data set based on analyzing the access frequency of data of the unstructured data set, querying external data sources to determine a relationship between data in the unstructured data set, and text search results correlation).

As mentioned, generally, the unsupervised learning module 3822 can determine relationships between data loaded by a load module into an unstructured data set. For example, the unsupervised learning module 3822 can connect data based on confidence intervals, confidence metrics, distances, or the like indicating the proximity measures and metrics inherent in the unstructured data set, such as schema and Entity Relationship Descriptions (ERD), integrity constraints, foreign key, and primary key relationships, parsing SQL queries, reports, spreadsheets, data warehouse information, or the like. For example, the unsupervised learning module 3822 may derive one or more relationships across heterogeneous data sets based on probabilistic relationships derived from artificial intelligence and machine learning, such as the unsupervised learning module 3822. The unsupervised learning module 3822 may determine, at a feature level or the like, the distance between data points based on one or more probabilistic relationships derived from artificial intelligence and machine learning, such as the unsupervised learning module 3822. In addition to identifying simple relationships between data elements, the unsupervised learning module 3822 may also determine a chain or tree comprising multiple relationships between different data elements.

In some embodiments, as part of one or more unstructured learning techniques, the unsupervised learning module 3822 may establish a confidence value, a confidence metric, a distance, or the like (collectively “confidence metric”) through clustering and/or other artificial intelligence and machine learning techniques (e.g., the unsupervised learning module 3822, the supervised learning module) that a certain field belongs to a feature, is associated, or related to other data, or the like.

In some unsupervised learning techniques, the unsupervised learning module 3822 may determine a confidence that data of an instance belongs together, is related, or the like. For example, the unsupervised learning module 3822 may determine that a player and an outcome with certain wager odds belong together and thus join these instances or rows together and provide a confidence metric behind the join. The load module or the unsupervised learning module 3822 may store a confidence metric representing a likelihood that a field belongs to an instance and/or a different confidence value that the field belongs in a feature. The load module and/or the supervised learning module may use the confidence values, confidence metrics, or distances to determine an intersection between the row and the column, indicating where to put the field with confidence so that the field may be fed to and processed by the supervised learning module.

In this manner, the unsupervised learning module 3822 and/or the supervised learning module may eliminate a transformation step in data warehousing and replace the precision and deterministic behavior with an imprecise, probabilistic behavior (e.g., store the data in an unstructured or semi-structured manner). Maintaining data in an unstructured or semi-structured format, without transforming the data, may allow the load module and/or the supervised learning module to identify a signal that a manual transformation would have otherwise eliminated, which may eliminate the effort of performing the manual transformation, or the like. Thus, the unsupervised learning module 3822 and/or the supervised learning module may not only automate and make wager adjustments more efficient but may also make wager adjustments more effective due to the signal component that may have been erased through a manual transformation.

In some unsupervised learning techniques, the unsupervised module may make a first pass of the data to identify the first set of relationships, distances, and/or confidences that satisfy a simplicity threshold. For example, unique data, such as players, positions, teams, or the like, may be relatively easy to connect without exhaustive processing. The unsupervised learning module 3822, in a further embodiment, may make a second pass of data that is unable to be processed by the unsupervised learning module 3822 in the first pass (e.g., data that fails to satisfy the simplicity threshold is more difficult to connect, or the like).

The unsupervised learning module 3822 may perform an exhaustive analysis for the remaining data in the second pass, analyzing each potential connection or relationship between different data elements. For example, the unsupervised learning module 3822 may perform additional unsupervised learning techniques (e.g., cross product, a Cartesian joinder, or the like) for the remaining data in the second pass (e.g., analyzing each possible data connection or combination for the remaining data), thereby identifying probabilities or confidences of which connections or combinations are valid, should be maintained, or the like. In this manner, the unsupervised learning module 3822 may overcome computational complexity by approaching a logarithmic problem in a linear manner. In some embodiments, the unsupervised learning module 3822 and the supervised learning module, using the techniques described herein, may repeatedly, substantially continuously, and/or indefinitely process data over time, continuously refining the accuracy of connections and combinations.

Further, embodiments may include a clustering module 3824. The clustering module 3824 can be configured to perform one or more clustering analyses on the unstructured data loaded by the load module. Clustering involves grouping a set of objects so that objects in the same group (cluster) are more similar, in at least one sense, to each other than to those in other clusters. Non-limiting examples of clustering algorithms include hierarchical clustering, k-means algorithm, kernel-based clustering algorithms, density-based clustering algorithms, spectral clustering algorithms. In one embodiment, the clustering module 3824 utilizes decision tree clustering with pseudo labels.

The clustering module 3824 may use focal points, clusters, or the like to determine relationships between, distances between, and/or confidences for data. By using focal points, clustering, or the like to break up large amounts of data, the unsupervised learning module 3822 may efficiently determine relationships, distances, and/or confidences for the data.

As mentioned, the unsupervised learning module 3822 may utilize multiple unsupervised learning techniques to assemble an organized data set. In one embodiment, the unsupervised learning module 3822 uses at least one clustering technique to assemble each organized data set. In other embodiments, some organized data sets may be assembled without using a clustering technique.

Further, embodiments may include a semantic distance module 3826. The semantic distance module 3826 is configured to identify the meaning in language and words using the unstructured data of the unstructured data set and use that meaning to identify relationships between data elements.

Further, embodiments may include a metadata mining module 3828. The metadata mining module 3828 is configured to data-mine declared metadata to identify relationships between metadata and data described by the metadata. For example, the metadata mining module 3828 may identify the table, row, and column names and draw relationships between them.

Further, embodiments may include a report processing module 3830. The report processing module 3830 is configured to analyze and/or read reports and other documents. The report processing module 3830 can identify associations and patterns in these documents that indicate how the data in the unstructured data set is organized. These associations and patterns can be used to identify relationships between data elements in the unstructured data set.

Further, embodiments may include a data characterization module 3832. The data characterization module 3832 is configured to use statistical data to ascertain the likelihood of similarities across a column/row family. For example, the data characterization module 3832 can calculate the maximum and minimum values in a column/row, the average column length, and the number of distinct values in a column. These statistics can assist the unsupervised learning module 3822 in identifying the likelihood that two or more columns/rows are related. For instance, two data sets with a maximum value of 10 and 10,000, respectively, may be less likely to be related than two data sets with identical maximum values.

Further, embodiments may include a search results correlation module 3834. The search results correlation module 3834 is configured to correlate data based on common text search results. These search results may include minor text and spelling variations for each word. Accordingly, the search results correlation module 3834 may identify words that may be a variant, abbreviation, misspelling, conjugation, or derivation of other words. These identifications may be used by other unsupervised learning techniques.

Further, embodiments may include a SQL processing module 3836. The search results correlation module 3834 is configured to harvest queries in a live database, including SQL queries. These queries and the results of such queries can be utilized to determine or define a distance between relationships within a data set. Similarly, the unsupervised learning module 3822 or SQL processing module 3836 may harvest SQL statements or other data in real-time from a running database, database manager, or other data source. The SQL processing module 3836 may parse and/or analyze SQL queries to determine relationships. For example, a WHERE statement, a JOIN statement, or the like may relate to certain data features. In a further embodiment, the load module may use data definition metadata (e.g., primary keys, foreign keys, feature names, or the like) to determine relationships.

Further, embodiments may include an access frequency module 3838. The access frequency module 3838 is configured to identify correlations between data based on the frequency at which data is accessed, what data is accessed simultaneously, access count, time of day data is accessed, and the like. For example, the access frequency module 3838 can target highly accessed data first and use access patterns to determine possible relationships. More specifically, the access frequency module 3838 can poll a database system's buffer cache metrics for highly accessed database blocks and store that access pattern information in the data set to be used to identify relationships between the highly accessed data.

Further, embodiments may include an external enrichment module 3840. The external enrichment module 3840 is configured to access external sources if the confidence metric between features of a data set is below a threshold. Non-limiting examples of external sources include the Internet, an Internet search engine, an online encyclopedia or reference site, or the like. For example, if the geolocation of an event column is not related to other columns, it may be queried to an external source to establish relationships between the geolocation of an event and weather reports or forecasts.

While not an unsupervised learning technique, the unsupervised learning module 3822 can be configured to query the user (ask a human) for information lacking or for assistance in determining relationships between features of the unstructured data set.

In addition to the use of unsupervised learning techniques, the unsupervised learning module 3822 can be aided in determining relationships between data elements of the unstructured data set and in assembling organized data sets by the supervised learning module. As mentioned, the organized data set(s) assembled by the unsupervised learning module 3822 can be evaluated by the supervised learning module. The unsupervised learning module 3822 can use these evaluations to identify which relationships are more likely and less likely. The unsupervised learning module 3822 can use that information to improve the accuracy of its processes.

Furthermore, in some embodiments, the unsupervised learning module 3822 may use a machine learning ensemble, such as predictive program code, as an input to unsupervised learning to determine probabilistic relationships between data points. The unsupervised learning module 3822 may use relevant influence factors from supervised learning (e.g., a machine learning ensemble or other predictive program code) to enhance unsupervised mining activities in defining the distance between data points in a data set. The unsupervised learning module 3822 may define the confidence that a data element is associated with a specific instance, a specific feature, or the like.

Further, embodiments may include a supervised learning module 3842. The supervised learning module 3842 is configured to generate one or more machine learning ensemble 3866s of learned functions based on the organized data set(s) assembled by the unsupervised learning module 3822. In the depicted embodiment, the supervised learning module 3842 includes a data receiver module 3844, a function generator module 3846, a machine learning compiler module 3848, a feature selector module 3862, a predictive correlation module 3864, and a machine learning ensemble 3866. The machine learning compiler module 3848 may include a combiner module 3850, an extender module 3852, a synthesizer module 3854, a function evaluator module 3856, a metadata database 3858, and a function selector module 3860. The machine learning ensemble 3866 may include an orchestration module, a synthesized metadata rule set, and synthesized learned functions.

Further, embodiments may include a data receiver module 3844 configured to receive data from the organized data set, including training data, test data, workload data, or the like, from the load module, or the unsupervised learning module 3822, either directly or indirectly. The data receiver module 3844, in various embodiments, may receive data over a local channel such as an API, a shared library, a hardware command interface, or the like; over a data network such as wired or wireless LAN, WAN, the Internet, a serial connection, a parallel connection, or the like. In certain embodiments, the data receiver module 3844 may receive data indirectly from a live event 3802, from the load module, the unsupervised learning module 3822, or the like, through an intermediate module that may pre-process, reformat, or otherwise prepare the data for the supervised learning module 3842. The data receiver module 3844 may support structured data, unstructured data, semi-structured data, or the like.

One type of data that the data receiver module 3844 may receive, as part of a new ensemble request or the like, is initialization data. The supervised learning module 3842, in certain embodiments, may use initialization data to train and test learned functions from which the supervised learning module 3842 may build a machine learning ensemble 3866. Initialization data may comprise the trial data set, the organized data set, historical data, statistics, Big Data, customer data, marketing data, computer system logs, computer application logs, data networking logs, or other data that the wagering network 3814 provides to the data receiver module 3844 with which to build, initialize, train, and/or test a machine learning ensemble 3866.

Another type of data that the data receiver module 3844 may receive, as part of an analysis request or the like, is workload data. The supervised learning module 3842, in certain embodiments, may process workload data using a machine learning ensemble 3866 to obtain a result, such as a classification, a confidence metric, an inferred function, a regression function, an answer, a prediction, a recognized pattern, a rule, a recommendation, an evaluation, or the like. Workload data for a specific machine learning ensemble 3866, in one embodiment, has substantially the same format as the initialization data used to train and/or evaluate the machine learning ensemble 3866. For example, initialization data and/or workload data may include one or more features. As used herein, a feature may comprise a column, category, data type, attribute, characteristic, label, or another grouping of data. For example, in embodiments where initialization data and/or workload data that is organized in a table format, a column of data may be a feature. Initialization data and/or workload data may include one or more instances of the associated features. In a table format, where columns of data are associated with features, a row of data is an instance.

In some embodiments, the data receiver module 3844 may maintain data stored on the wagering network 3814 (including the organized data set), such as initialization data and/or workload data, historical data, etc., where the function generator module 3846, the machine learning compiler module 3848, or the like may access the data. In certain embodiments, as described below, the function generator module 3846 and/or the machine learning compiler module 3848 may divide initialization data into subsets, using certain subsets of data as training data for generating and training learned functions and using certain subsets of data as test data for evaluating generated learned functions.

Further, embodiments may include a function generator module 3846 configured to generate a plurality of learned functions based on training data from the data receiver module 3844. A learned function comprises a computer-readable code that accepts an input and provides a result. A learned function may comprise a compiled code, a script, text, a data structure, a file, a function, or the like. In some embodiments, a learned function may accept instances of one or more features as input and provide a result, such as a classification, a confidence metric, an inferred function, a regression function, an answer, a prediction, a recognized pattern, a rule, a recommendation, an evaluation, or the like. In another embodiment, certain learned functions may accept instances of one or more features as input and provide a subset of the instances, a subset of the one or more features, or the like as an output. In a further embodiment, certain learned functions may receive the output or result of one or more other learned functions as input, such as a Bayes classifier, a Boltzmann machine, or the like.

The function generator module 3846 may generate learned functions from multiple artificial intelligence and machine learning classes, models, or algorithms. For example, the function generator module 3846 may generate decision trees; decision forests; kernel classifiers and regression machines with a plurality of reproducing kernels; non-kernel regression and classification machines such as logistic, CART, multi-layer neural nets with various topologies; Bayesian-type classifiers such as Nave Bayes and Boltzmann machines; logistic regression; multinomial logistic regression; probit regression; AR; MA; ARMA; ARCH; GARCH; VAR; survival or duration analysis; MARS; radial basis functions; support vector machines; k-nearest neighbors; geospatial predictive modeling; and/or other classes of learned functions.

In one embodiment, the function generator module 3846 generates learned functions pseudo-randomly, without regard to the effectiveness of the generated learned functions, without prior knowledge regarding the suitability of the generated learned functions for the associated training data or the like. For example, the function generator module 3846 may generate a total number of learned functions that is large enough that at least a subset of the generated learned functions are statistically likely to be effective. As used herein, pseudo-randomly indicates that the function generator module 3846 is configured to generate learned functions in an automated manner, without input or selection of learned functions, artificial intelligence and machine learning classes or models for the learned functions, or the like by a Data Scientist, expert, or other users.

The function generator module 3846 may generate as many learned functions as possible for a requested machine learning ensemble 3866, given one or more parameters or limitations. The wagering network 3814 may provide a parameter or limitation for learned function generation as part of a new ensemble request or the like, such as an amount of time; an allocation of system resources such as a number of processor nodes or cores, or an amount of volatile memory; a number of learned functions; runtime constraints on the requested ensemble such as an indicator of whether or not the requested ensemble should provide results in real-time; and/or another parameter or limitation from the wagering network 3814.

The number of learned functions that the function generator module 3846 may generate for building a machine learning ensemble 3866 may also be limited by capabilities of the system, such as the number of available processors or processor cores, a current load on the system, a price of remote processing resources over the data network, or other hardware capabilities of the system available to the function generator module 3846. The function generator module 3846 may balance the system's hardware capabilities with the time available for generating learned functions and building a machine learning ensemble 3866 to determine how many learned functions to generate for the machine learning ensemble 3866.

In a further embodiment, the function generator module 3846 may generate hundreds, thousands, or millions of learned functions, or more, for a machine learning ensemble 3866. By generating an unusually large number of learned functions from different classes without regard to the suitability or effectiveness of the generated learned functions for training data, in certain embodiments, the function generator module 3846 ensures that at least a subset of the generated learned functions, either individually or in combination, are useful, suitable, and/or effective for the training data without careful curation and fine-tuning by a Data Scientist or other expert.

Similarly, by generating learned functions from different artificial intelligence and machine learning classes without regard to the effectiveness or the suitability of the different artificial intelligence and machine learning classes for training data, the function generator module 3846, in certain embodiments, may generate learned functions that are useful, suitable, and/or effective for the training data due to the sheer number of learned functions generated from the different artificial intelligence and machine learning classes. This brute force, trial-and-error approach to generating learned functions, in certain embodiments, eliminates or minimizes the role of a Data Scientist or other expert in the generation of a machine learning ensemble 3866.

The function generator module 3846, in certain embodiments, divides initialization data from the data receiver module 3844 into various subsets of training data and may use different training data subsets, different combinations of multiple training data subsets, or the like to generate different learned functions. The function generator module 3846 may divide the initialization data into training data subsets by feature, instance, or both. For example, a training data subset may comprise a subset of features of initialization data, a subset of features of initialization data, a subset of both features and instances of initialization data, or the like. Varying the features and/or instances used to train different learned functions in certain embodiments may further increase the likelihood that at least a subset of the generated learned functions are useful, suitable, and/or effective. In a further embodiment, the function generator module 3846 ensures that the available initialization data is not used in its entirety as training data for any one learned function so that at least a portion of the initialization data is available for each learned function as test data.

In one embodiment, the function generator module 3846 may also generate additional learned functions in cooperation with the machine learning compiler module 3848. The function generator module 3846 may provide a learned function request interface, allowing the machine learning compiler module 3848 or another module, wagering network 3814, or the like to send a learned function request to the function generator module 3846 requesting that the function generator module 3846 generate one or more additional learned functions. In one embodiment, a learned function request may include one or more attributes for the requested one or more learned functions. For example, a learned function request, in various embodiments, may include an artificial intelligence and machine learning class for a requested learned function, one or more features for a requested learned function, instances from initialization data to use as training data for a requested learned function, runtime constraints on a requested learned function or the like. In another embodiment, a learned function request may identify initialization data, training data, or the like for one or more requested learned functions, and the function generator module 3846 may generate the one or more learned functions pseudo-randomly, as described above, based on the identified data.

Further, embodiments may include a machine learning compiler module 3848 configured to form a machine learning ensemble 3866 using learned functions from the function generator module 3846. As used herein, a machine learning ensemble 3866 comprises an organized set of a plurality of learned functions. Providing a classification, a confidence metric, an inferred function, a regression function, an answer, a prediction, a recognized pattern, a rule, a recommendation, or another result using a machine learning ensemble 3866, in certain embodiments, may be more accurate than using a single learned function.

In some embodiments, the machine learning compiler module 3848 may combine and/or extend learned functions to form new learned functions, request additional learned functions from the function generator module 3846, or the like for inclusion in a machine learning ensemble 3866. In one embodiment, the machine learning compiler module 3848 evaluates learned functions from the function generator module 3846 using test data to generate evaluation metadata. The machine learning compiler module 3848, in a further embodiment, may evaluate combined learned functions, extended learned functions, combined-extended learned functions, additional learned functions, or the like using test data to generate evaluation metadata.

The machine learning compiler module 3848, in certain embodiments, maintains evaluation metadata in a metadata database 3858. The machine learning compiler module 3848 may select learned functions (e.g., learned functions from the function generator module 3846, combined learned functions, extended learned functions, learned functions from different artificial intelligence and machine learning classes, and/or combined-extended learned functions) for inclusion in a machine learning ensemble 3866 based on the evaluation metadata. In a further embodiment, the machine learning compiler module 3848 may synthesize the selected learned functions into a final, synthesized function or function set for a machine learning ensemble 3866 based on evaluation metadata. The machine learning compiler module 3848, in another embodiment, may include synthesized evaluation metadata in a machine learning ensemble 3866 for directing data through the machine learning ensemble 3866 or the like.

Further, embodiments may include a combiner module 3850. The combiner module 3850 combines learned functions, forming sets, strings, groups, trees, or clusters of combined learned functions. In certain embodiments, the combiner module 3850 combines learned functions into a prescribed order, and different orders of learned functions may have different inputs, produce different results, or the like. The combiner module 3850 may combine learned functions in different combinations. For example, the combiner module 3850 may combine certain learned functions horizontally or in parallel, joined at the inputs and outputs or the like, and may combine certain learned functions vertically or in series, feeding the output of one into the input of another learned function.

The combiner module 3850 may determine which learned functions to combine, how to combine learned functions, or the like based on evaluation metadata for the learned functions from the metadata database 3858, generated based on an evaluation of the learned functions using test data, as described below with regard to the function evaluator module 3856. The combiner module 3850 may request additional learned functions from the function generator module 3846 for combining with other learned functions. For example, the combiner module 3850 may request a new learned function with a particular input and/or output to combine with an existing learned function or the like.

While the combining of learned functions may be informed by evaluation metadata for the learned functions, in certain embodiments, the combiner module 3850 combines a large number of learned functions pseudo-randomly, forming a large number of combined functions. For example, the combiner module 3850, in one embodiment, may determine each possible combination of generated learned functions, as many combinations of generated learned functions as possible given one or more limitations or constraints, a selected subset of combinations of generated learned functions, or the like, for evaluation by the function evaluator module 3856. In certain embodiments, by generating a large number of combined learned functions, the combiner module 3850 is statistically likely to form one or more combined learned functions that are useful and/or effective for the training data.

Further, embodiments may include an extender module 3852. The extender module 3852, in certain embodiments, is configured to add one or more layers to a learned function. For example, the extender module 3852 may extend a learned function or combined learned function by adding a probabilistic model layer, such as a Bayesian belief network layer, a Bayes classifier layer, a Boltzmann layer, or the like.

Certain classes of learned functions, such as probabilistic models, may be configured to receive either instances of one or more features as input or the output results of other learned functions, such as a classification and a confidence metric, an inferred function, a regression function, an answer, a prediction, a recognized pattern, a rule, a recommendation, an evaluation, or the like. The extender module 3852 may use these types of learned functions to extend other learned functions. The extender module 3852 may extend learned functions generated by the function generator module 3846 directly, may extend combined learned functions from the combiner module 3850, may extend other extended learned functions, may extend synthesized learned functions from the synthesizer module 3854, or the like.

In one embodiment, the extender module 3852 determines which learned functions to extend, how to extend learned functions or the like based on evaluation metadata from the metadata database 3858. The extender module 3852, in certain embodiments, may request one or more additional learned functions from the function generator module 3846 and/or one or more additional combined learned functions from the combiner module 3850 for the extender module 3852 to extend.

While the extending of learned functions may be informed by evaluation metadata for the learned functions, in certain embodiments, the extender module 3852 generates a large number of extended learned functions pseudo-randomly. For example, the extender module 3852, in one embodiment, may extend each possible learned function and/or combination of learned functions, may extend a selected subset of learned functions, may extend as many learned functions as possible given one or more limitations or constraints, or the like, for evaluation by the function evaluator module 3856. In certain embodiments, by generating a large number of extended learned functions, the extender module 3852 is statistically likely to form one or more extended learned functions and/or combined extended learned functions that are useful and/or effective for the training data.

Further, embodiments may include a synthesizer module 3854. The synthesizer module 3854, in certain embodiments, is configured to organize a subset of learned functions into the machine learning ensemble 3866, as synthesized learned functions. In a further embodiment, the synthesizer module 3854 includes evaluation metadata from the metadata database 3858 of the function evaluator module 3856 in the machine learning ensemble 3866 as a synthesized metadata rule set, so that the machine learning ensemble 3866 includes synthesized learned functions and evaluation metadata, the synthesized metadata rule set, for the synthesized learned functions.

The learned functions that the synthesizer module 3854 synthesizes or organizes into the synthesized learned functions of the machine learning ensemble 3866 may include learned functions directly from the function generator module 3846 combined learned functions from the combiner module 3850, extended learned functions from the extender module 3852, combined extended learned functions, or the like. As described below, in one embodiment, the function selector module 3860 selects the learned functions for the synthesizer module 3854 to include in the machine learning ensemble 3866. In certain embodiments, the synthesizer module 3854 organizes learned functions by preparing the learned functions and the associated evaluation metadata for processing workload data to reach a result. For example, as described below, the synthesizer module 3854 may organize and/or synthesize the synthesized learned functions and the synthesized metadata rule set for the orchestration module to direct workload data through the synthesized learned functions to produce a result.

In one embodiment, the function evaluator module 3856 evaluates the synthesized learned functions that the synthesizer module 3854 organizes, and the synthesizer module 3854 synthesizes and/or organizes the synthesized metadata rule set based on evaluation metadata that the function evaluation module generates during the evaluation of the synthesized learned functions, from the metadata database 3858 or the like.

Further, embodiments may include a function evaluator module 3856. The function evaluator module 3856 is configured to evaluate learned functions using test data or the like. For example, the function evaluator module 3856 may evaluate learned functions generated by the function generator module 3846, learned functions combined by the combiner module 3850 described above, learned functions extended by the extender module 3852 described above, combined extended learned functions, synthesized learned functions organized into the machine learning ensemble 3866 by the synthesizer module 3854 described above, or the like.

Test data for a learned function, in certain embodiments, comprises a different subset of the initialization data for the learned function than the function generator module 3846 used as training data. The function evaluator module 3856, in one embodiment, evaluates a learned function by inputting the test data into the learned function to produce a result, such as a classification, a confidence metric, an inferred function, a regression function, an answer, a prediction, a recognized pattern, a rule, a recommendation, an evaluation, or another result.

Test data, in certain embodiments, comprises a subset of initialization data, with a feature associated with the requested result removed, so that the function evaluator module 3856 may compare the result from the learned function to the instances of the removed feature to determine the accuracy and/or effectiveness of the learned function for each test instance. For example, if a client 3804 has requested a machine learning ensemble 3866 to predict whether a customer will be a repeat customer and provided historical customer information as initialization data, the function evaluator module 3856 may input a test data set comprising one or more features of the initialization data other than whether the customer was a repeat customer into the learned function, and compare the resulting predictions to the initialization data to determine the accuracy and/or effectiveness of the learned function.

The function evaluator module 3856, in one embodiment, is configured to maintain evaluation metadata for an evaluated learned function in the metadata database 3858. The evaluation metadata, in certain embodiments, comprises log data generated by the function generator module 3846 while generating learned functions, the function evaluator module 3856 while evaluating learned functions, or the like.

In one embodiment, the evaluation metadata includes indicators of one or more training data sets that the function generator module 3846 used to generate a learned function. The evaluation metadata, in another embodiment, includes indicators of one or more test data sets that the function evaluator module 3856 used to evaluate a learned function. In a further embodiment, the evaluation metadata includes indicators of one or more decisions made by and/or branches taken by a learned function during an evaluation by the function evaluator module 3856. The evaluation metadata, in another embodiment, includes the results determined by a learned function during an evaluation by the function evaluator module 3856. In one embodiment, the evaluation metadata may include evaluation metrics, learning metrics, effectiveness metrics, convergence metrics, or the like for a learned function based on an evaluation of the learned function. An evaluation metric, learning metrics, effectiveness metric, convergence metric, or the like may be based on a comparison of the results from a learned function to actual values from initialization data and may be represented by a correctness indicator for each evaluated instance, a percentage, a ratio, or the like. Different classes of learned functions in certain embodiments may have different types of evaluation metadata.

Further, embodiments may include a metadata database 3858 that provides evaluation metadata for learned functions to the feature selector module 3862, the predictive correlation module 3864, the combiner module 3850, the extender module 3852, and/or the synthesizer module 3854. The metadata database 3858 may provide an API, a shared library, one or more function calls, or the like providing access to evaluation metadata. The metadata database 3858, in various embodiments, may store or maintain evaluation metadata in a database format, as one or more flat files, as one or more lookup tables, as a sequential log or log file, or as one or more other data structures. In one embodiment, the metadata database 3858 may index evaluation metadata by learned function, by feature, by instance, by training data, by test data, by effectiveness, and/or by another category or attribute and may provide query access to the indexed evaluation metadata. The function evaluator module 3856 may update the metadata database 3858 in response to each evaluation of a learned function, adding evaluation metadata to the metadata database 3858 or the like.

Further, embodiments may include a function selector module 3860 that may use evaluation metadata from the metadata database 3858 to select learned functions for the combiner module 3850 to combine, for the extender module 3852 to extend, for the synthesizer module 3854 to include in the machine learning ensemble 3866, or the like. For example, in one embodiment, the function selector module 3860 may select learned functions based on evaluation metrics, learning metrics, effectiveness metrics, convergence metrics, or the like. In another embodiment, the function selector module 3860 may select learned functions for the combiner module 3850 to combine and/or for the extender module 3852 to extend based on features of training data used to generate the learned functions or the like.

Further, embodiments may include a feature selector module 3862 that determines which features of initialization data to use in the machine learning ensemble 3866, and in the associated learned functions, and/or which features of the initialization data to exclude from the machine learning ensemble 3866, and from the associated learned functions. As described above, initialization data and the training data and test data derived from the initialization data may include one or more features. Learned functions and the machine learning ensemble 3866s that they form are configured to receive and process instances of one or more features. Certain features may be more predictive than others, and the more features that the machine learning compiler module 3848 processes and includes in the generated machine learning ensemble 3866, the more processing overhead used by the machine learning compiler module 3848, and the more complex the generated machine learning ensemble 3866 becomes. Additionally, certain features may not contribute to the effectiveness or accuracy of the results from a machine learning ensemble 3866 but may simply add noise to the results.

The feature selector module 3862, in one embodiment, cooperates with the function generator module 3846 and the machine learning compiler module 3848 to evaluate the effectiveness of various features, based on evaluation metadata from the metadata database 3858. For example, the function generator module 3846 may generate a plurality of learned functions for various combinations of features, and the machine learning compiler module 3848 may evaluate the learned functions and generate evaluation metadata. Based on the evaluation metadata, the feature selector module 3862 may select a subset of features that are most accurate or effective, and the machine learning compiler module 3848 may use learned functions that utilize the selected features to build the machine learning ensemble 3866. The feature selector module 3862 may select features for use in the machine learning ensemble 3866 based on evaluation metadata for learned functions from the function generator module 3846, combined learned functions from the combiner module 3850, extended learned functions from the extender module 3852, combined extended functions, synthesized learned functions from the synthesizer module 3854, or the like.

Further, embodiments may include a predictive correlation module 3864 configured to harvest metadata regarding which features correlate to higher confidence metrics, determine which feature was predictive of which outcome or result, or the like. In one embodiment, the predictive correlation module 3864 determines the relationship of a feature's predictive qualities for a specific outcome or result based on each instance of a particular feature. In other embodiments, the predictive correlation module 3864 may determine the relationship of a feature's predictive qualities based on a subset of instances of a particular feature. For example, the predictive correlation module 3864 may discover a correlation between one or more features and the confidence metric of a predicted result by attempting different combinations of features and subsets of instances within an individual feature's dataset and measuring an overall impact on predictive quality, accuracy, confidence, or the like. The predictive correlation module 3864 may determine predictive features at various granularities, such as per feature, per subset of features, per instance, or the like.

In one embodiment, the predictive correlation module 3864 determines one or more features with the greatest contribution to a predicted result or confidence metric as the machine learning compiler module 3848 forms the machine learning ensemble 3866, based on evaluation metadata from the metadata database 3858, or the like. For example, the machine learning compiler module 3848 may build one or more synthesized learned functions that are configured to provide one or more features with the greatest contribution as part of a result. In another embodiment, the predictive correlation module 3864 may determine one or more features with the greatest contribution to a predicted result or confidence metric dynamically at runtime as the machine learning ensemble 3866 determines the predicted result or confidence metric. In such embodiments, the predictive correlation module 3864 may be part of, integrated with, or in communication with the machine learning ensemble 3866. The predictive correlation module 3864 may cooperate with the machine learning ensemble 3866, such that the machine learning ensemble 3866 provides a listing of one or more features that provided the greatest contribution to a predicted result or confidence metric as part of a response to an analysis request.

In determining features that are predictive or that have the greatest contribution to a predicted result or confidence metric, the predictive correlation module 3864 may balance a frequency of the contribution of a feature and/or an impact of the contribution of the feature. For example, a certain feature or set of features may contribute to the predicted result or confidence metric frequently, for each instance or the like, but have a low impact. Another feature or set of features may contribute relatively infrequently but has a very high impact on the predicted result or confidence metric (e.g., provides at or near 100% confidence or the like). While the predictive correlation module 3864 is described herein as determining features that are predictive or that have the greatest contribution, in other embodiments, the predictive correlation module 3864 may determine one or more specific instances of a feature that are predictive, have the greatest contribution to a predicted result or confidence metric, or the like.

Further, embodiments may include machine learning ensemble 3866 that provides machine learning results for an analysis request by processing workload data of the analysis request using a plurality of learned functions (e.g., the synthesized learned functions). As described above, results from the machine learning ensemble 3866, in various embodiments, may include a classification, a confidence metric, an inferred function, a regression function, an answer, a prediction, a recognized pattern, a rule, a recommendation, an evaluation, and/or another result. For example, in one embodiment, the machine learning ensemble 3866 provides a classification and a confidence metric for each instance of workload data input into the machine learning ensemble 3866 or the like. Workload data, in certain embodiments, may be substantially similar to test data, but the missing feature from the initialization data is unknown and is to be solved for by the machine learning ensemble 3866. A classification, in certain embodiments, comprises a value for a missing feature in an instance of workload data, such as a prediction, an answer, or the like. For example, if the missing feature represents a question, the classification may represent a predicted answer, and the associated confidence metric may be an estimated strength or accuracy of the predicted answer. A classification, in certain embodiments, may comprise a binary value (e.g., yes, or no), a rating on a scale (e.g., 4 on a scale of 1 to 5), or another data type for a feature. A confidence metric, in certain embodiments, may comprise a percentage, a ratio, a rating on a scale, or another indicator of accuracy, effectiveness, and/or confidence.

In the depicted embodiment, the machine learning ensemble 3866 includes an orchestration module. The orchestration module, in certain embodiments, is configured to direct workload data through the machine learning ensemble 3866 to produce a result, such as a classification, a confidence metric, an inferred function, a regression function, an answer, a prediction, a recognized pattern, a rule, a recommendation, an evaluation, and/or another result. For example, in one embodiment, the orchestration module uses evaluation metadata from the function evaluator module 3856 and/or the metadata database 3858, such as the synthesized metadata rule set, to determine how to direct workload data through the synthesized learned functions of the machine learning ensemble 3866. As described below, in certain embodiments, the synthesized metadata rule set comprises a set of rules or conditions from the evaluation metadata of the metadata database 3858 that indicate to the orchestration module which features, instances, or the like should be directed to which synthesized learned function.

For example, the evaluation metadata from the metadata database 3858 may indicate which learned functions were trained using which features and/or instances, how effective different learned functions were at making predictions based on different features and/or instances, or the like. The synthesizer module 3854 may use that evaluation metadata to determine rules for the synthesized metadata rule set, indicating which features, which instances, or the like the orchestration module should direct through which learned functions, in which order, or the like. The synthesized metadata rule set, in one embodiment, may comprise a decision tree or other data structure comprising rules which the orchestration module may follow to direct workload data through the synthesized learned functions of the machine learning ensemble 3866.

Further, embodiments may include a base module 3868, which begins with the base module 3868 receiving the sensor data from the live event 3802. For example, the base module 3868 receives sensor data related to the event, such as the players within the event, the period within the event, the score of the event, and the current situation of the event, such as it is the first quarter of the New England Patriots vs. the New York Jets, with the Patriots having possession of the football at their 25-yard line and it is first down. Then the base module 3868 sends the sensor data or situational data to the odds calculation module 3870. For example, the base module 3868 sends the sensor data related to the event to the odds calculation module 3870, such as the players within the event, the period within the event, the score of the event, and the current situation of the event, such as it is the first quarter of the New England Patriots vs. the New York Jets, with the Patriots having possession of the football at their 25-yard line and it is first down. The base module 3868 initiates the odds calculation module 3870. Then the base module 3868 offers the wager odds stored in the odds database 3820 on the wagering app 3810. For example, the base module 3868 may offer various wager markets for the users of the wagering app 3810 to place wagers on, such as in the New England Patriots vs. the New York Jets with the Patriots having possession of the football at their 25-yard line and its first down the next play being a pass with the wager odds being −110. Then the base module 3868 is continuously polling for the results from the live event 3802. For example, the base module 3868 is continuously polling to receive the results from the previous play, such as a result in the New England Patriots vs. the New York Jets with the Patriots having possession of the football at their 25-yard line and its first down. In some embodiments, the base module 3868 may need to determine the results of the previous play by analyzing the new data received. For example, if the previous play in the New England Patriots vs. the New York Jets with the Patriots having possession of the football at their 25-yard line and it was first down, and the received sensor data is in the New England Patriots vs. the New York Jets with the Patriots having possession of the football at their 30-yard line and its second down and the quarterback has an additional 5 yards added to their passing stats and a wide receiver has an additional 5 yards added to their receiving stats, then the base module 3868 can determine that on first down the quarterback threw a 5-yard pass to the wide receiver. The base module 3868 receives the results from the live event 3802. For example, the base module 3868 receives the results from the previous play, such as a result in the New England Patriots vs. the New York Jets with the Patriots having possession of the football at their 25-yard line and its first down. In some embodiments, the base module 3868 may need to determine the results of the previous play by analyzing the new data received. For example, if the previous play in the New England Patriots vs. the New York Jets with the Patriots having possession of the football at their 25-yard line and it was first down, and the received sensor data is in the New England Patriots vs. the New York Jets with the Patriots having possession of the football at their 30-yard line and its second down and the quarterback has an additional 5 yards added to their passing stats and a wide receiver has an additional 5 yards added to their receiving stats, then the base module 3868 can determine that on first down the quarterback threw a 5-yard pass to the wide receiver. Then the base module 3868 determines the profit and/or loss for each wagering market. For example, the base module 3868 may determine if the placed wagers stored in the user database related to the previous play were either won or lost for each user. Then the base module 3868 may determine the total amount of money won and lost by the wagering network 3814 to determine if there was a profit or a loss for the wagering network 3814. For example, if there was $5,000 wagered on the next play to be a pass and $15,000 wagered on the next play to be run and the result of the play was a pass, the wagering network 3814 would collect the $15,000 from the loss wagers from the users (the ones that wagered the next play would be a run) and the wagering network 3814 would need to pay out $4,545.45 from the $5,000 won wagers from the users (the $5,000 wagered at −110 wagering odds which would result in a payout of $4,545.45) which in total would be $9,545.45 paid out to users who wagered on the next play being a pass. This example would result in a profit of $5,454.55 for the wagering network and the collected lost wagers ($15,000) minus the total paid out in won wagers ($9,545.45). The base module 3868 stores the results data and the profit and/or loss data for each wagering market in the training database 3878. For example, the base module 3868 would store all of the profit and loss data for each wagering market in the training database 3878, such as for the wagering market of the next play being a pass or run the profit of $5,454.55. This data would be stored to corresponding wager data and event data. For example, the teams, such as the New England Patriots vs. the New York Jets, the team with possession of the football, such as the New England Patriots, the quarter, such as the first quarter, the yard line, such as the 25-yard line, the down, such as first down, the wagering market, such as the next play being a pass or run, the wager odds, such as −110, the total amount wagered on a pass, such as $5,000, the total amount wagered on a run, such as $15,000, the profit or loss for the wager, such as a profit of $5,454.55, etc. The base module 3868 initiates the machine learning module 3872.

Further, embodiments may include an odds calculation module 3870, which begins with the odds calculation module 3870 being initiated by the base module 3868. In some embodiments, the odds calculation module 3870 may be continuously polling for the data from the live event 3802. In some embodiments, the odds calculation module 3870 may receive the data from the live event 3802. In some embodiments, the odds calculation module 3870 may store the results data, or the results of the last action, in the historical plays database 3818, which may contain historical data of all previous actions. The odds calculation module 3870 receives the situational data from the base module 3868. For example, the odds calculation module 3870 receives the sensor data related to the event from the base module 3868, such as the players within the event, the period within the event, the score of the event, and the current situation of the event, such as it is the first quarter of the New England Patriots vs. the New York Jets, with the Patriots having possession of the football at their 25-yard line and it is first down. The odds calculation module 3870 filters the historical plays database 3818 on the team and inning from the situational data. The odds calculation module 3870 selects the first parameter of the historical plays database 3818, for example, the event. In some embodiments, the odds calculation module 3870 may receive a machine learning ensemble 3866 that provides predetermined parameters to the odds calculation module 3870 to perform correlations. For example, the machine learning ensemble 3866 may be used to respond to analysis requests (e.g., processing collected and coordinated data using artificial intelligence and machine learning) and to provide artificial intelligence and machine learning results, such as a classification, a confidence metric, an inferred function, a regression function, an answer, a prediction, a recognized pattern, a rule, a recommendation, or other results. For example, if the machine learning ensemble 3866 is a regression function or regression analysis, such as a measure of the relation between the mean value of one variable and corresponding values of other variables, then the odds calculation module 3870 uses the selected variables or parameters to perform correlations that the machine learning ensemble 3866 has deemed highly correlated. Then if the correlation coefficients are above a predetermined threshold, the odds calculation module 3870 will be extracted and compared to the recommendations database 3874 and extracts the odds adjustment and then stores the odds adjustment to the adjustment database 3876 and then compares the adjustment database 3876 to the odds database 3820 to determine if any wager odds need to be altered, adjusted, etc. before being offered on the wagering app 3810. Then the odds calculation module 3870 performs correlations on the data. For example, the historical plays database 3818 is filtered on the team, the players, the quarter, the down, and the distance to be gained. The first parameter is selected, which in this example is the event, which may either be a pass or a run and the historical plays database 3818 is filtered on the event being a pass. Then, correlations are performed on the rest of the parameters, which are yards gained, temperature, decibel level, etc. Correlated data for the historical data involving the Patriots in the first quarter on first down with 10 yards to go and the play being a pass, which has a correlation coefficient of 0.81. The correlations are also performed with the same filters, and the next event is the play being a run with a correlation coefficient of 0.79. Then the odds calculation module 3870 determines if the correlation coefficient is above a predetermined threshold, for example, 0.75, to determine if the data is highly correlated and deemed a relevant correlation. If the correlation is deemed highly relevant, the odds calculation module 3870 extracts the correlation coefficient from the data. For example, the two correlation coefficients of 0.81 for a pass and 0.79 for a run are extracted. If it is determined that the correlations are not highly relevant, then the odds calculation module 3870 determines if any parameters are remaining. Also, if the correlations were determined to be highly relevant and therefore extracted, it is also determined if any parameters are remaining to perform correlations on. If there are additional parameters to have correlations performed, then the odds calculation module 3870 selects the next parameter in the historical plays database 3818, and the process returns to performing correlations on the data. For example, the machine learning ensemble 3866 may have also identified other variables or parameters deemed to be highly important or have previously been shown to be highly correlated, and the next parameters are selected. Once there are no remaining parameters to perform correlations on, the odds calculation module 3870 determines the difference between each of the extracted correlations. For example, the correlation coefficient for a pass is 0.81, and the correlation coefficient for a run is 0.79. The difference between the two correlation coefficients (0.81−0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendations database 3828 to compare the two correlation coefficient based on statistical significance as opposed to the difference of the two correlation coefficients. Then the odds calculation module 3870 compares the difference between the two correlation coefficients, for example, 0.02, to the recommendations database 3874. The recommendations database 3874 contains various ranges of differences in correlations and the corresponding odds adjustment for those ranges. For example, the 0.02 difference of the two correlation coefficients falls into the range +0-2 difference in correlations which, according to the recommendations database, 3874 should have an odds adjustment of 5% increase. The odds calculation module 3870 then extracts the odds adjustment from the recommendations database 3874. The odds calculation module 3870 then stores the extracted odds adjustment in the adjustment database 3876. The odds calculation module 3870 compares the odds database 3820 to the adjustment database 3876. The odds calculation module 3870 then determines whether or not there is a match in any of the wager IDs in the odds database 3820 and the adjustment database 3876. For example, the odds database 3820 contains a list of all the current bet options for a user which, for each bet option, the odds database 3820 contains a wager ID, event, time, inning, wager, and odds. The adjustment database 3876 contains the wager ID and the percentage, either as an increase or decrease, that the odds should be adjusted. If there is a match between the odds database 3820 and the adjustment database 3876, then the odds calculation module 3870 adjusts the odds in the odds database 3820 by the percentage increase or decrease in the adjustment database 3876 and the odds in the odds database 3820 are updated. For example, if the odds in the odds database 3820 are −105 and the matched wager ID in the adjustment database 3876 is a 5% increase, then the updated odds in the odds database 3820 should be −110. If there is a match, then the odds are adjusted based on the data stored in the adjustment database 3876, and the new data is stored in the odds database 3820 over the old entry. If there are no matches, or once the odds database 3820 has been adjusted if there are matches, the odds calculation module 3870 stores the data in the training database 3878. For example, the odds calculation module 3870 may store data in the training database 3878 such as the teams, such as the New England Patriots vs. the New York Jets, the team with possession of the football, such as the New England Patriots, the quarter, such as the first quarter, the yard line, such as the 25-yard line, the down, such as first down, the wagering market, such as the next play being a pass or run, the wager odds, such as—3810, the first parameter and second parameter in which correlations are performed on, such as the distance to be gained and the average distance gained, etc. Then odds calculation module 3870 returns to the base module 3868. In some embodiments, the odds calculation module 3870 may offer the odds database 3820 to the wagering app 3810, allowing users to place bets on the wagers stored in the odds database 3820. In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 170. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1−b2/Sb1−b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 3870 may then extract an odds adjustment from the recommendations database 3874. The extracted odds adjustment is then stored in the adjustment database 3876. In some embodiments, the recommendations database 3874 may be used in the odds calculation module 3870 to determine how the wager odds should be adjusted depending on the difference between the correlation coefficients of the correlated data points. The recommendations database 3874 may contain the difference in correlations and the odds adjustment. For example, if there is a correlation coefficient for a pass being thrown by the Patriots in the first quarter on first down of 0.81 and a correlation coefficient for a run being performed by the Patriots in the first quarter on first down of 0.79, the difference between the two would be +0.02 when compared to the recommendations database 3874 the odds adjustment would be a 5% increase for a Patriots pass or otherwise identified as wager 201 in the adjustment database 3876. In some embodiments, the difference in correlations may be the statistical significance of comparing the two correlation coefficients to determine how the odds should be adjusted. In some embodiments, the adjustment database 3876 may be used to adjust the wager odds of the odds database 3820 if it is determined that a wager should be adjusted. The adjustment database 3876 contains the wager ID, which is used to match with the odds database 3820 to adjust the odds of the correct wager.

Further, embodiments may include a machine learning module 3872, which begins with the machine learning module 3872 being initiated by the base module 3868. Then the machine learning module 3872 receives a request for a new machine learning ensemble 3866. For example, the wagering network 3814 may send a request for a new machine learning ensemble 3866, such as a daily request, weekly request, monthly request, quarterly request, yearly request, etc. The machine learning module 3872 generates a plurality of learned functions based on the received training data. For example, the received training data may be the data stored in the training database 3878, which may contain the teams, such as the New England Patriots vs. the New York Jets, the team with possession of the football, such as the New England Patriots, the quarter, such as the first quarter, the yard line, such as the 25-yard line, the down, such as first down, the wagering market, such as the next play being a pass or run, the wager odds, such as −110, the first parameter and second parameter in which correlations are performed on, such as the distance to be gained and the average distance gained, the correlation coefficients of the correlated parameters, etc. The training database 3878 allows the machine learning module 3872 to use the data to predict outcomes based on received inputs, such as the event data or situational data, to allow the creation of a machine learning ensemble 3866 that allows the odds calculation module 3870 to receive sensor data or situational data from a live event 3802 and determine which parameters should be used to perform correlations on and if the odds should be adjusted or not based if the correlation coefficient exceeds a predetermined threshold. For example, the function generator module 3846 generates a plurality of learned functions based on the received training data from different artificial intelligence and machine learning classes. A learned function comprises a computer-readable code that accepts an input and provides a result. A learned function may comprise a compiled code, a script, text, a data structure, a file, a function, or the like. In some embodiments, a learned function may accept instances of one or more features as input and provide a result, such as a classification, a confidence metric, an inferred function, a regression function, an answer, a prediction, a recognized pattern, a rule, a recommendation, an evaluation, or the like. In another embodiment, certain learned functions may accept instances of one or more features as input and provide a subset of the instances, a subset of the one or more features, or the like as an output. In a further embodiment, certain learned functions may receive the output or result of one or more other learned functions as input, such as a Bayes classifier, a Boltzmann machine, or the like. Then the machine learning module 3872 evaluates the plurality of generated learned functions. For example, the function evaluator module 3856 evaluates the plurality of generated learned functions to generate evaluation metadata. The function evaluator module 3856 is configured to evaluate learned functions using test data or the like. The function evaluator module 3856 may evaluate learned functions generated by the function generator module 3846, learned functions combined by the combiner module 3850, learned functions extended by the extender module 3852, combined extended learned functions, synthesized learned functions organized into the machine learning ensemble 3866 by the synthesizer module 3854, or the like. Test data for a learned function, in certain embodiments, comprises a different subset of the initialization data for the learned function than the function generator module 3846 used as training data. The function evaluator module 3856, in one embodiment, evaluates a learned function by inputting the test data into the learned function to produce a result, such as a classification, a confidence metric, an inferred function, a regression function, an answer, a prediction, a recognized pattern, a rule, a recommendation, an evaluation, or another result. The machine learning module 3872 combines learned functions based on the metadata from the evaluation. For example, the combiner module 3850 combines learned functions based on the metadata from the evaluation performed by the function evaluator module 3856. For example, the combiner module 3850 combines learned functions, forming sets, strings, groups, trees, or clusters of combined learned functions. In certain embodiments, the combiner module 3850 combines learned functions into a prescribed order, and different orders of learned functions may have different inputs, produce different results, or the like. The combiner module 3850 may combine learned functions in different combinations. For example, the combiner module 3850 may combine certain learned functions horizontally or in parallel, joined at the inputs and outputs or the like, and may combine certain learned functions vertically or in series, feeding the output of one into the input of another learned function. The combiner module 3850 may determine which learned functions to combine, how to combine learned functions, or the like based on evaluation metadata for the learned functions from the metadata database 3858, generated based on an evaluation of the learned functions using test data, as described below with regard to the function evaluator module 3856. The combiner module 3850 may request additional learned functions from the function generator module 3846 for combining with other learned functions. For example, the combiner module 3850 may request a new learned function with a particular input and/or output to combine with an existing learned function or the like. The machine learning module 3872 extends one or more learned functions by adding one or more layers to the one or more learned functions. For example, the extender module 3852 extends one or more learned functions by adding one or more layers to the one or more learned functions, such as a probabilistic model layer or the like. In certain embodiments, the extender module 3852 extends combined learned functions based on the evaluation of the combined learned functions. For example, in certain embodiments, the extender module 3852 is configured to add one or more layers to a learned function. For example, the extender module 3852 may extend a learned function or combined learned function by adding a probabilistic model layer, such as a Bayesian belief network layer, a Bayes classifier layer, a Boltzmann layer, or the like. Certain classes of learned functions, such as probabilistic models, may be configured to receive either instance of one or more features as input or the output results of other learned functions, such as a classification and a confidence metric, an inferred function, a regression function, an answer, a prediction, a recognized pattern, a rule, a recommendation, an evaluation, or the like. The extender module 3852 may use these types of learned functions to extend other learned functions. The extender module 3852 may extend learned functions generated by the function generator module 3846 directly, may extend combined learned functions from the combiner module 3850, may extend other extended learned functions, may extend synthesized learned functions from the synthesizer module 3854, or the like. Then the machine learning module 3872 requests that the function generator module 3846 generate additional learned functions for the extender module to extend. For example, the extender module 3852 may request that the function generator module 3846 generate additional learned functions for the extender module 3852 to extend. For example, the function generator module 3846 may generate learned functions from multiple artificial intelligence and machine learning classes, models, or algorithms. For example, the function generator module 3846 may generate decision trees; decision forests; kernel classifiers and regression machines with a plurality of reproducing kernels; non-kernel regression and classification machines such as logistic, CART, multi-layer neural nets with various topologies; Bayesian-type classifiers such as Nave Bayes and Boltzmann machines; logistic regression; multinomial logistic regression; probit regression; AR; MA; ARMA; ARCH; GARCH; VAR; survival or duration analysis; MARS; radial basis functions; support vector machines; k-nearest neighbors; geospatial predictive modeling; and/or other classes of learned functions. The machine learning module 3872 evaluates the extended learned functions. For example, the function evaluator module 3856 evaluates the extended learned functions. For example, in one embodiment, the function evaluator module 3856 is configured to maintain evaluation metadata for an evaluated learned function in the metadata database 3858. The evaluation metadata, in certain embodiments, comprises log data generated by the function generator module 3846 while generating learned functions, the function evaluator module 3856 while evaluating learned functions, or the like. In one embodiment, the evaluation metadata includes indicators of one or more training data sets that the function generator module 3846 used to generate a learned function. The evaluation metadata, in another embodiment, includes indicators of one or more test data sets that the function evaluator module 3856 used to evaluate a learned function. In a further embodiment, the evaluation metadata includes indicators of one or more decisions made by and/or branches taken by a learned function during an evaluation by the function evaluator module 3856. The evaluation metadata, in another embodiment, includes the results determined by a learned function during an evaluation by the function evaluator module 3856. In one embodiment, the evaluation metadata may include evaluation metrics, learning metrics, effectiveness metrics, convergence metrics, or the like for a learned function based on an evaluation of the learned function. An evaluation metric, learning metrics, effectiveness metric, convergence metric, or the like may be based on a comparison of the results from a learned function to actual values from initialization data and may be represented by a correctness indicator for each evaluated instance, a percentage, a ratio, or the like. Different classes of learned functions in certain embodiments may have different types of evaluation metadata. The machine learning module 3872 synthesizes the selected learned functions into synthesized learned functions. For example, the synthesizer module 3854 synthesizes the selected learned functions into synthesized learned functions. For example, in certain embodiments, the synthesizer module 3854 is configured to organize a subset of learned functions into the machine learning ensemble 3866, as synthesized learned functions. In a further embodiment, the synthesizer module 3854 includes evaluation metadata from the metadata database 3858 of the function evaluator module 3856 in the machine learning ensemble 3866 as a synthesized metadata rule set, so that the machine learning ensemble 3866 includes synthesized learned functions and evaluation metadata, the synthesized metadata rule set, for the synthesized learned functions. The learned functions that the synthesizer module 3854 synthesizes or organizes into the synthesized learned functions of the machine learning ensemble 3866 may include learned functions directly from the function generator module 3846 combined learned functions from the combiner module 3850, extended learned functions from the extender module 3852, combined extended learned functions, or the like. In one embodiment, the function selector module 3860 selects the learned functions for the synthesizer module 3854 to include in the machine learning ensemble 3866. In certain embodiments, the synthesizer module 3854 organizes learned functions by preparing the learned functions and the associated evaluation metadata for processing workload data to reach a result. For example, as described below, the synthesizer module 3854 may organize and/or synthesize the synthesized learned functions and the synthesized metadata rule set for the orchestration module to direct workload data through the synthesized learned functions to produce a result. Then the machine learning module 3872 evaluates the synthesized learned functions to generate a synthesized metadata rule set. For example, the function evaluator module 3856 evaluates the synthesized learned functions to generate a synthesized metadata rule set. Then the machine learning module 3872 organizes the synthesized learned functions and the synthesized metadata rule set into a machine learning ensemble 3866. For example, the synthesizer module 3854 organizes the synthesized learned functions and the synthesized metadata rule set into a machine learning ensemble 3866. For example, the machine learning ensemble 3866 may be used to respond to analysis requests, such as processing collected and coordinated data using artificial intelligence and machine learning and to provide artificial intelligence and machine learning results, such as a classification, a confidence metric, an inferred function, a regression function, an answer, a prediction, a recognized pattern, a rule, a recommendation, or other results. The machine learning module 3872 stores the machine learning ensemble 3866. For example, the machine learning module 3872 may store the machine learning ensemble 3866 on the wagering network, within a database, etc. such as to provide machine learning results, such as a classification, a confidence metric, an inferred function, a regression function, an answer, a prediction, a recognized pattern, a rule, a recommendation, or other results. The machine learning module 3872 returns to the base module 3868.

Further, embodiments may include a recommendations database 3874, which may be used in the odds calculation module 3872 to determine how the wager odds should be adjusted depending on the difference between the correlation coefficients of the correlated data points. The recommendations database 3874 may contain the difference in correlations and the odds adjustment. For example, if there is a correlation coefficient for a pass being thrown by the Patriots in the first quarter on first down of 0.81 and a correlation coefficient for a run being performed by the Patriots in the first quarter on first down of 0.79, the difference between the two would be +0.02 when compared to the recommendations database 3874 the odds adjustment would be a 5% increase for a Patriots pass or otherwise identified as wager 201 in the adjustment database 3876. In some embodiments, the difference in correlations may be the statistical significance of comparing the two correlation coefficients to determine how the odds should be adjusted.

Further, embodiments may include an adjustment database 3876, which may be used to adjust the wager odds of the odds database 3820 if it is determined that a wager should be adjusted. The adjustment database 3876 contains the wager ID, which is used to match with the odds database 3820 to adjust the odds of the correct wager.

Further, embodiments may include a training database 3878, which is created in the process described in the odds calculation module 3870 and the base module 3868. The training database 3878 may include historical data such as the sensor data or situational data, the data resulting from the odds calculation module 3870, the data resulting from a play within an event, and the resulting wager data, such as the teams, such as the New England Patriots vs. the New York Jets, the team with possession of the football, such as the New England Patriots, the quarter, such as the first quarter, the yard line, such as the 25-yard line, the down, such as first down, the wagering market, such as the next play being a pass or run, the wager odds, such as −110, the first parameter and second parameter in which correlations are performed on, such as the distance to be gained and the average distance gained, the correlation coefficient of the correlated parameters, etc. The training database 3878 allows the machine learning module 3872 to use the data to predict outcomes based on received inputs, such as the event data or situational data, to allow the creation of a machine learning ensemble 3866 that allows the odds calculation module 3870 to receive sensor data or situational data from a live event 3802 and determine which parameters should be used to perform correlations on and if the odds should be adjusted or not based if the correlation coefficient exceeds a predetermined threshold. In some embodiments, the odds calculation module 3870 may receive a machine learning ensemble 3866 that provides predetermined parameters to the odds calculation module 3870 to perform correlations on.

FIG. 39 illustrates the base module 3868. The process begins with the base module 3868 receives, at step 3900, the sensor data from the live event 3802. For example, the base module 3868 receives sensor data related to the event, such as the players within the event, the period within the event, the score of the event, and the current situation of the event, such as it is the first quarter of the New England Patriots vs. the New York Jets, with the Patriots having possession of the football at their 25-yard line and it is first down. Then the base module 3868 sends, at step 3902, the sensor or situational data to the odds calculation module 3870. For example, the base module 3868 sends the sensor data related to the event to the odds calculation module 3870, such as the players within the event, the period within the event, the score of the event, and the current situation of the event, such as it is the first quarter of the New England Patriots vs. the New York Jets, with the Patriots having possession of the football at their 25-yard line and it is first down. The base module 3868 initiates, at step 3904, the odds calculation module 3870. Then the base module 3868 offers, at step 3906, the wager odds stored in the odds database 3820 on the wagering app 3810. For example, the base module 3868 may offer various wager markets for the users of the wagering app 3810 to place wagers on, such as in the New England Patriots vs. the New York Jets with the Patriots having possession of the football at their 25-yard line and its first down the next play being a pass with the wager odds being −110. Then the base module 3868 is continuously polling, at step 3908, for the results from the live event 3802. For example, the base module 3868 is continuously polling to receive the results from the previous play, such as a result in the New England Patriots vs. the New York Jets with the Patriots having possession of the football at their 25-yard line and its first down. In some embodiments, the base module 3868 may need to determine the results of the previous play by analyzing the new data received. For example, if the previous play in the New England Patriots vs. the New York Jets with the Patriots having possession of the football at their 25-yard line and it was first down, and the received sensor data is in the New England Patriots vs. the New York Jets with the Patriots having possession of the football at their 30-yard line and its second down and the quarterback has an additional 5 yards added to their passing stats and a wide receiver has an additional 5 yards added to their receiving stats, then the base module 3868 can determine that on first down the quarterback threw a 5-yard pass to the wide receiver. The base module 3868 receives, at step 3910, the results from the live event 3802. For example, the base module 3868 receives the results from the previous play, such as a result in the New England Patriots vs. the New York Jets with the Patriots having possession of the football at their 25-yard line and its first down. In some embodiments, the base module 3868 may need to determine the results of the previous play by analyzing the new data received. For example, if the previous play in the New England Patriots vs. the New York Jets with the Patriots having possession of the football at their 25-yard line and it was first down, and the received sensor data is in the New England Patriots vs. the New York Jets with the Patriots having possession of the football at their 30-yard line and its second down and the quarterback has an additional 5 yards added to their passing stats and a wide receiver has an additional 5 yards added to their receiving stats, then the base module 3868 can determine that on first down the quarterback threw a 5-yard pass to the wide receiver. Then the base module 3868 determines, at step 3912, the profit and/or loss for each wagering market. For example, the base module 3868 may determine if the placed wagers stored in the user database related to the previous play were either won or lost for each user. Then the base module 3868 may determine the total amount of money won and lost by the wagering network 3814 to determine if there was a profit or a loss for the wagering network 3814. For example, if there was $5,000 wagered on the next play to be a pass and $15,000 wagered on the next play to be run and the result of the play was a pass, the wagering network 3814 would collect the $15,000 from the loss wagers from the users (the ones that wagered the next play would be a run) and the wagering network 3814 would need to pay out $4,545.45 from the $5,000 won wagers from the users (the $5,000 wagered at −110 wagering odds which would result in a payout of $4,545.45) which in total would be $9,545.45 paid out to users who wagered on the next play being a pass. This example would result in a profit of $5,454.55 for the wagering network; the collected lost wagers ($15,000) minus the total paid out in won wagers ($9,545.45). The base module 3868 stores, at step 3914, the results data and the profit and/or loss data for each wagering market in the training database 3878. For example, the base module 3868 would store all of the profit and loss data for each wagering market in the training database 3878, such as for the wagering market of the next play being a pass or run the profit of $5,454.55. This data would be stored to corresponding wager data and event data. For example, the teams, such as the New England Patriots vs. the New York Jets, the team with possession of the football, such as the New England Patriots, the quarter, such as the first quarter, the yard line, such as the 25-yard line, the down, such as first down, the wagering market, such as the next play being a pass or run, the wager odds, such as −110, the total amount wagered on a pass, such as $5,000, the total amount wagered on a run, such as $15,000, the profit or loss for the wager, such as a profit of $5,454.55, etc. The base module 3868 initiates, at step 3916, the machine learning module 3872.

FIG. 40 illustrates the odds calculation module 3870. The process begins with the odds calculation module 3870 being initiated, at step 4000, by the base module 3868. In some embodiments, the odds calculation module 3870 may be continuously polling for the data from the live event 3802. In some embodiments, the odds calculation module 3870 may receive the data from the live event 3802. In some embodiments, the odds calculation module 3870 may store the results data, or the results of the last action, in the historical plays database 3818, which may contain historical data of all previous actions. The odds calculation module 3870 receives, at step 4002, the situational data from the base module 3868. For example, the odds calculation module 3870 receives the sensor data related to the event from the base module 3868, such as the players within the event, the period within the event, the score of the event, and the current situation of the event, such as it is the first quarter of the New England Patriots vs. the New York Jets, with the Patriots having possession of the football at their 25-yard line and it is first down. The odds calculation module 3870 filters, at step 4004, the historical plays database 3818 on the team and inning from the situational data. The odds calculation module 3870 selects, at step 4006, the first parameter of the historical plays database 3818, for example, the event. In some embodiments, the odds calculation module 3870 may receive a machine learning ensemble 3866 that provides predetermined parameters to the odds calculation module 3870 to perform correlations on. For example, the machine learning ensemble 3866 may be used to respond to analysis requests (e.g., processing collected and coordinated data using artificial intelligence and machine learning) and to provide artificial intelligence and machine learning results, such as a classification, a confidence metric, an inferred function, a regression function, an answer, a prediction, a recognized pattern, a rule, a recommendation, or other results. For example, if the machine learning ensemble 3866 is a regression function or regression analysis, such as a measure of the relation between the mean value of one variable and corresponding values of other variables, then the odds calculation module 3870 uses the selected variables or parameters to perform correlations that the machine learning ensemble 3866 has deemed highly correlated. Then if the correlation coefficients are above a predetermined threshold, the odds calculation module 3870 will be extracted and compared to the recommendations database 3874 and extracts the odds adjustment and then stores the odds adjustment to the adjustment database 3876 and then compares the adjustment database 3876 to the odds database 3820 to determine if any wager odds need to be altered, adjusted, etc. before being offered on the wagering app 3810. Then the odds calculation module 3870 performs, at step 4008, correlations on the data. For example, the historical plays database 3818 is filtered on the team, the players, the quarter, the down, and the distance to be gained. The first parameter is selected, which in this example is the event, which may either be a pass or a run and the historical plays database 3818 is filtered on the event being a pass. Then, correlations are performed on the rest of the parameters, which are yards gained, temperature, decibel level, etc. Correlated data for the historical data involving the Patriots in the first quarter on first down with 10 yards to go and the play being a pass, which has a correlation coefficient of 0.81. The correlations are also performed with the same filters, and the next event is the play being a run with a correlation coefficient of 0.79. Then the odds calculation module 3870 determines, at step 4010, if the correlation coefficient is above a predetermined threshold, for example, 0.75, to determine if the data is highly correlated and deemed a relevant correlation. If the correlation is deemed highly relevant, then the odds calculation module 3870 extracts, at step 4012, the correlation coefficient from the data. For example, the two correlation coefficients of 0.81 for a pass and 0.79 for a run are extracted. If it is determined that the correlations are not highly relevant, then the odds calculation module 3870 determines, at step 4014, if any parameters are remaining. Also, if the correlations were determined to be highly relevant and therefore extracted, it is also determined if any parameters are remaining to perform correlations on. If there are additional parameters to have correlations performed, then the odds calculation module 3870 selects, at step 4016, the next parameter in the historical plays database 3818, and the process returns to performing correlations on the data. For example, the machine learning ensemble 3866 may have also identified other variables or parameters deemed to be highly important or have previously been shown to be highly correlated, and the next parameters are selected. Once there are no remaining parameters to perform correlations on, the odds calculation module 3870 then determines, at step 4018, the difference between each of the extracted correlations. For example, the correlation coefficient for a pass is 0.81, and the correlation coefficient for a run is 0.79. The difference between the two correlation coefficients (0.81−0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendations database 3828 to compare the two correlation coefficient based on statistical significance as opposed to the difference of the two correlation coefficients. Then the odds calculation module 3870 compares, at step 4020, the difference between the two correlation coefficients, for example, 0.02, to the recommendations database 3874. The recommendations database 3874 contains various ranges of differences in correlations and the corresponding odds adjustment for those ranges. For example, the 0.02 difference of the two correlation coefficients falls into the range +0-2 difference in correlations which, according to the recommendations database, 3874 should have an odds adjustment of 5% increase. The odds calculation module 3870 then extracts, at step 4022, the odds adjustment from the recommendations database 3874. The odds calculation module 3870 then stores, at step 4024, the extracted odds adjustment in the adjustment database 3876. The odds calculation module 3870 compares, at step 4026, the odds database 3820 to the adjustment database 3876. The odds calculation module 3870 then determines, at step 4028, whether or not there is a match in any of the wager IDs in the odds database 3820 and the adjustment database 3876. For example, the odds database 3820 contains a list of all the current bet options for a user which, for each bet option, the odds database 3820 contains a wager ID, event, time, inning, wager, and odds. The adjustment database 3876 contains the wager ID and the percentage, either as an increase or decrease, that the odds should be adjusted. If it is determined there is a match between the odds database 3820 and the adjustment database 3876, then the odds calculation module 3870 adjust, at step 4030, the odds in the odds database 3820 by the percentage increase or decrease in the adjustment database 3876 and the odds in the odds database 3820 are updated. For example, if the odds in the odds database 3820 are −105 and the matched wager ID in the adjustment database 3876 is a 5% increase, then the updated odds in the odds database 3820 should be −110. If there is a match, then the odds are adjusted based on the data stored in the adjustment database 3876, and the new data is stored in the odds database 3820 over the old entry. If there are no matches, or, once the odds database 3820 has been adjusted if there are matches, the odds calculation module 3870 stores, at step 4032, the data in the training database 3878. For example, the odds calculation module 3870 may store data in the training database 3878 such as the teams, such as the New England Patriots vs. the New York Jets, the team with possession of the football, such as the New England Patriots, the quarter, such as the first quarter, the yard line, such as the 25-yard line, the down, such as first down, the wagering market, such as the next play being a pass or run, the wager odds, such as −110, the first parameter and second parameter in which correlations are performed on, such as the distance to be gained and the average distance gained, etc. Then odds calculation module 3870 returns, at step 4034, to the base module 3868. In some embodiments, the odds calculation module 3870 may offer the odds database 3820 to the wagering app 3810, allowing users to place bets on the wagers stored in the odds database 3820. In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 3870. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1−b2/Sb1−b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 3870 may then extract an odds adjustment from the recommendations database 3874. The extracted odds adjustment is then stored in the adjustment database 3876. In some embodiments, the recommendations database 3874 may be used in the odds calculation module 3870 to determine how the wager odds should be adjusted depending on the difference between the correlation coefficients of the correlated data points. The recommendations database 3874 may contain the difference in correlations and the odds adjustment. For example, if there is a correlation coefficient for a pass being thrown by the Patriots in the first quarter on first down of 0.81 and a correlation coefficient for a run being performed by the Patriots in the first quarter on first down of 0.79, the difference between the two would be +0.02 when compared to the recommendations database 3874 the odds adjustment would be a 5% increase for a Patriots pass or otherwise identified as wager 201 in the adjustment database 3876. In some embodiments, the difference in correlations may be the statistical significance of comparing the two correlation coefficients to determine how the odds should be adjusted. In some embodiments, the adjustment database 3876 may be used to adjust the wager odds of the odds database 3820 if it is determined that a wager should be adjusted. The adjustment database 3876 contains the wager ID, which is used to match with the odds database 3820 to adjust the odds of the correct wager.

FIG. 41 illustrates the machine learning module 3872. The process begins with the machine learning module 3872 being initiated, at step 4100, by the base module 3868. Then the machine learning module 3872 receives, at step 4102, a request for a new machine learning ensemble 3866. For example, the wagering network 3814 may send a request for a new machine learning ensemble 3866, such as a daily request, weekly request, monthly request, quarterly request, yearly request, etc. The machine learning module 3872 generates, at step 4104, a plurality of learned functions based on the received training data. For example, the received training data may be the data stored in the training database 3878, which may contain the teams, such as the New England Patriots vs. the New York Jets, the team with possession of the football, such as the New England Patriots, the quarter, such as the first quarter, the yard line, such as the 25-yard line, the down, such as first down, the wagering market, such as the next play being a pass or run, the wager odds, such as −110, the first parameter and second parameter in which correlations are performed on, such as the distance to be gained and the average distance gained, the correlation coefficients of the correlated parameters, etc. The training database 3878 allows the machine learning module 3872 to use the data to predict outcomes based on received inputs, such as the event data or situational data, to allow the creation of a machine learning ensemble 3866 that allows the odds calculation module 3870 to receive sensor data or situational data from a live event 3802 and determine which parameters should be used to perform correlations on and if the odds should be adjusted or not based if the correlation coefficient exceeds a predetermined threshold. For example, the function generator module 3846 generates a plurality of learned functions based on the received training data from different artificial intelligence and machine learning classes. A learned function comprises a computer-readable code that accepts an input and provides a result. A learned function may comprise a compiled code, a script, text, a data structure, a file, a function, or the like. In some embodiments, a learned function may accept instances of one or more features as input and provide a result, such as a classification, a confidence metric, an inferred function, a regression function, an answer, a prediction, a recognized pattern, a rule, a recommendation, an evaluation, or the like. In another embodiment, certain learned functions may accept instances of one or more features as input and provide a subset of the instances, a subset of the one or more features, or the like as an output. In a further embodiment, certain learned functions may receive the output or result of one or more other learned functions as input, such as a Bayes classifier, a Boltzmann machine, or the like. Then the machine learning module 3872 evaluates, at step 4106, the plurality of generated learned functions. For example, the function evaluator module 3856 evaluates the plurality of generated learned functions to generate evaluation metadata. The function evaluator module 3856 is configured to evaluate learned functions using test data or the like. The function evaluator module 3856 may evaluate learned functions generated by the function generator module 3846, learned functions combined by the combiner module 3850, learned functions extended by the extender module 3852, combined extended learned functions, synthesized learned functions organized into the machine learning ensemble 3866 by the synthesizer module 3854, or the like. Test data for a learned function, in certain embodiments, comprises a different subset of the initialization data for the learned function than the function generator module 3846 used as training data. The function evaluator module 3856, in one embodiment, evaluates a learned function by inputting the test data into the learned function to produce a result, such as a classification, a confidence metric, an inferred function, a regression function, an answer, a prediction, a recognized pattern, a rule, a recommendation, an evaluation, or another result. The machine learning module 3872 combines, at step 4108, learned functions based on the metadata from the evaluation. For example, the combiner module 3850 combines learned functions based on the metadata from the evaluation performed by the function evaluator module 3856. For example, the combiner module 3850 combines learned functions, forming sets, strings, groups, trees, or clusters of combined learned functions. In certain embodiments, the combiner module 3850 combines learned functions into a prescribed order, and different orders of learned functions may have different inputs, produce different results, or the like. The combiner module 3850 may combine learned functions in different combinations. For example, the combiner module 3850 may combine certain learned functions horizontally or in parallel, joined at the inputs and outputs or the like, and may combine certain learned functions vertically or in series, feeding the output of one into the input of another learned function. The combiner module 3850 may determine which learned functions to combine, how to combine learned functions, or the like based on evaluation metadata for the learned functions from the metadata database 3858, generated based on an evaluation of the learned functions using test data, as described below with regard to the function evaluator module 3856. The combiner module 3850 may request additional learned functions from the function generator module 3846 for combining with other learned functions. For example, the combiner module 3850 may request a new learned function with a particular input and/or output to combine with an existing learned function or the like. The machine learning module 3872 extends, at step 4110, one or more learned functions by adding one or more layers to the one or more learned functions. For example, the extender module 3852 extends one or more learned functions by adding one or more layers to the one or more learned functions, such as a probabilistic model layer or the like. In certain embodiments, the extender module 3852 extends combined learned functions based on evaluating the combined learned functions. For example, in certain embodiments, the extender module 3852 is configured to add one or more layers to a learned function. For example, the extender module 3852 may extend a learned function or combined learned function by adding a probabilistic model layer, such as a Bayesian belief network layer, a Bayes classifier layer, a Boltzmann layer, or the like. Certain classes of learned functions, such as probabilistic models, may be configured to receive either instance of one or more features as input or the output results of other learned functions, such as a classification and a confidence metric, an inferred function, a regression function, an answer, a prediction, a recognized pattern, a rule, a recommendation, an evaluation, or the like. The extender module 3852 may use these types of learned functions to extend other learned functions. The extender module 3852 may extend learned functions generated by the function generator module 3846 directly, may extend combined learned functions from the combiner module 3850, may extend other extended learned functions, may extend synthesized learned functions from the synthesizer module 3854, or the like. Then the machine learning module 3872 requests, at step 4112, that the function generator module 3846 generate additional learned functions for the extender module to extend. For example, the extender module 3852 may request that the function generator module 3846 generate additional learned functions for the extender module 3852 to extend. For example, the function generator module 3846 may generate learned functions from multiple machine learning classes, models, or algorithms. For example, the function generator module 3846 may generate decision trees; decision forests; kernel classifiers and regression machines with a plurality of reproducing kernels; non-kernel regression and classification machines such as logistic, CART, multi-layer neural nets with various topologies; Bayesian-type classifiers such as Nave Bayes and Boltzmann machines; logistic regression; multinomial logistic regression; probit regression; AR; MA; ARMA; ARCH; GARCH; VAR; survival or duration analysis; MARS; radial basis functions; support vector machines; k-nearest neighbors; geospatial predictive modeling; and/or other classes of learned functions. The machine learning module 3872 evaluates, at step 4114, the extended learned functions. For example, the function evaluator module 3856 evaluates the extended learned functions. For example, in one embodiment, the function evaluator module 3856 is configured to maintain evaluation metadata for an evaluated learned function in the metadata database 3858. The evaluation metadata, in certain embodiments, comprises log data generated by the function generator module 3846 while generating learned functions, the function evaluator module 3856 while evaluating learned functions, or the like. In one embodiment, the evaluation metadata includes indicators of one or more training data sets that the function generator module 3846 used to generate a learned function. The evaluation metadata, in another embodiment, includes indicators of one or more test data sets that the function evaluator module 3856 used to evaluate a learned function. In a further embodiment, the evaluation metadata includes indicators of one or more decisions made by and/or branches taken by a learned function during an evaluation by the function evaluator module 3856. The evaluation metadata, in another embodiment, includes the results determined by a learned function during an evaluation by the function evaluator module 3856. In one embodiment, the evaluation metadata may include evaluation metrics, learning metrics, effectiveness metrics, convergence metrics, or the like for a learned function based on an evaluation of the learned function. An evaluation metric, learning metrics, effectiveness metric, convergence metric, or the like may be based on a comparison of the results from a learned function to actual values from initialization data and may be represented by a correctness indicator for each evaluated instance, a percentage, a ratio, or the like. Different classes of learned functions in certain embodiments may have different types of evaluation metadata. The machine learning module 3872 synthesizes, at step 4116, the selected learned functions into synthesized learned functions. For example, the synthesizer module 3854 synthesizes the selected learned functions into synthesized learned functions. For example, in certain embodiments, the synthesizer module 3854 is configured to organize a subset of learned functions into the machine learning ensemble 3866, as synthesized learned functions. In a further embodiment, the synthesizer module 3854 includes evaluation metadata from the metadata database 3858 of the function evaluator module 3856 in the machine learning ensemble 3866 as a synthesized metadata rule set, so that the machine learning ensemble 3866 includes synthesized learned functions and evaluation metadata, the synthesized metadata rule set, for the synthesized learned functions. The learned functions that the synthesizer module 3854 synthesizes or organizes into the synthesized learned functions of the machine learning ensemble 3866 may include learned functions directly from the function generator module 3846 combined learned functions from the combiner module 3850, extended learned functions from the extender module 3852, combined extended learned functions, or the like. In one embodiment, the function selector module 3860 selects the learned functions for the synthesizer module 3854 to include in the machine learning ensemble 3866. In certain embodiments, the synthesizer module 3854 organizes learned functions by preparing the learned functions and the associated evaluation metadata for processing workload data to reach a result. For example, as described below, the synthesizer module 3854 may organize and/or synthesize the synthesized learned functions and the synthesized metadata rule set for the orchestration module to direct workload data through the synthesized learned functions to produce a result. Then the machine learning module 3872 evaluates, at step 4118, the synthesized learned functions to generate a synthesized metadata rule set. For example, the function evaluator module 3856 evaluates the synthesized learned functions to generate a synthesized metadata rule set. Then the machine learning module 3872 organizes, at step 4120, the synthesized learned functions and the synthesized metadata rule set into a machine learning ensemble 3866. For example, the synthesizer module 3854 organizes the synthesized learned functions and the synthesized metadata rule set into a machine learning ensemble 3866. For example, the machine learning ensemble 3866 may be used to respond to analysis requests, such as processing collected and coordinated data using artificial intelligence and machine learning and to provide artificial intelligence and machine learning results, such as a classification, a confidence metric, an inferred function, a regression function, an answer, a prediction, a recognized pattern, a rule, a recommendation, or other results. The machine learning module 3872 stores, at step 4122, the machine learning ensemble 3866. For example, the machine learning module 3872 may store the machine learning ensemble 3866 on the wagering network, within a database, etc. such as to provide machine learning results, such as a classification, a confidence metric, an inferred function, a regression function, an answer, a prediction, a recognized pattern, a rule, a recommendation, or other results. The machine learning module 3872 returns, at step 4124, to the base module 3868.

FIG. 42 illustrates the recommendations database 3874. The recommendations database 3874 may be used in the odds calculation module 3872 to determine how the wager odds should be adjusted depending on the difference between the correlation coefficients of the correlated data points. The recommendations database 3874 may contain the difference in correlations and the odds adjustment. For example, if there is a correlation coefficient for a pass being thrown by the Patriots in the first quarter on first down of 0.81 and a correlation coefficient for a run being performed by the Patriots in the first quarter on first down of 0.79, the difference between the two would be +0.02 when compared to the recommendations database 3874 the odds adjustment would be a 5% increase for a Patriots pass or otherwise identified as wager 201 in the adjustment database 3876. In some embodiments, the difference in correlations may be the statistical significance of comparing the two correlation coefficients to determine how the odds should be adjusted.

FIG. 43 illustrates the adjustment database 3876. The adjustment database 3876 may be used to adjust the wager odds of the odds database 3820 if it is determined that a wager should be adjusted. The adjustment database 3876 contains the wager ID, which is used to match with the odds database 3820 to adjust the odds of the correct wager.

In another embodiment, an algorithm to adjust wagers may be shown and described.

FIG. 44 is a system for adjusting wager odds using an algorithm. This system may include a live event 4402, for example, a sporting event such as a football, basketball, baseball, or hockey game, tennis match, golf tournament, eSports or digital game, etc. The live event 4402 may include some number of actions or plays upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 4402, such as the score of an American football game or the run line in a baseball game, or a series of actions in the live event 4402. Sportsbooks have several bets they can handle, which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers, which can be done at kiosks at the live event 4402 or at another location.

Further, embodiments may include a plurality of sensors 4404 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 4404 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball. In some embodiments, telemetry data that an array of anchors may receive from one or more tracking devices which may include positional telemetry data. The positional telemetry data provides location data for a respective tracking device, which describes the location of the tracking device within a spatial region. In some embodiments, this positional telemetry data is provided as one or more Cartesian coordinates (e.g., an X coordinate, a Y coordinate, and/or Z a coordinate) that describe the position of each respective tracking device. However, any coordinate system (e.g., polar coordinates, etc.) that describes the position of each respective tracking device is used in alternative embodiments. The telemetry data that is received by the array of anchors from the one or more tracking devices includes kinetic telemetry data. The kinetic telemetry data provides data related to various kinematics of the respective tracking device. In some embodiments, this kinetic telemetry data is provided as a velocity of the respective tracking device, an acceleration of the respective tracking device, and/or a jerk of the respective tracking device. Further, in some embodiments, one or more of the above values is determined from an accelerometer of the respective tracking device and/or derived from the positional telemetry data of the respective tracking device. Further, in some embodiments, the telemetry data that is received by the array of anchors from the one or more tracking devices includes biometric telemetry data. The biometric telemetry data provides biometric information related to each subject associated with the respective tracking device. In some embodiments, this biometric information includes a heart rate of the subject, temperature, for example, a skin temperature, a temporal temperature, etc. In some embodiments, the array of anchors communicates the above-described telemetry data, for example, positional telemetry, kinetic telemetry, and/or biometric telemetry, to a telemetry parsing system. Accordingly, in some embodiments the telemetry parsing system communicates the telemetry data to a odds calculation module 4424. In some embodiments, an array of anchor devices may receive telemetry data from one or more tracking devices. In order to minimize error in receiving the telemetry from the one or more tracking devices, the array of anchor devices preferably includes at least three anchor devices. The inclusion of at least three anchor devices within the array of anchor devices allows for each ping, for example, telemetry data received from a respective tracking device, to be triangulated using the combined data from the at least three anchors that receive the respective ping.

Further, embodiments may include a cloud 4406 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 4406 may be communicatively coupled to a peer-to-peer wagering network 4414, which may perform real-time analysis on the type of play and the result of the play. The cloud 4406 may also be synchronized with game situational data such as the time of the game, the score, location on the field, weather conditions, and the like, which may affect the choice of play utilized. For example, in an exemplary embodiment, the cloud 4406 may not receive data gathered from the sensors 4404 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 4408 such as a computing device, laptop, smartphone, tablet, computer, smart speaker, or I/O devices. I/O devices may be present in the computing device. Input devices may include but are not limited to keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide-semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include but are not limited to video displays, graphical displays, speakers, headphones, inkjet printers, laser printers, or 3D printers. Devices may include but are not limited to a combination of multiple input or output devices such as Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs, including, but not limited to, Microsoft KINECT, SIRI for iPhone by Apple, Google Now, or Google Voice Search. Additional user devices have both input and output capabilities, including, but not limited to, haptic feedback devices, touchscreen displays, or multi-touch displays. Touchscreen, multi-touch displays, touchpads, touch mice, or other touch sensing devices may use different technologies to sense touch, including but not limited to capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 4408 could be an optional component and would be utilized in a situation where a paired wearable device employs the mobile device 4408 for additional memory or computing power or connection to the internet.

Further, embodiments may include a wagering software application or a wagering app 4410, which is a program that enables the user to place bets on individual plays in the live event 4402, streams audio and video from the live event 4402, and features the available wagers from the live event 4402 on the mobile device 4408. The wagering app 4410 allows users to interact with the wagering network 4414 to place bets and provide payment/receive funds based on wager outcomes.

Further, embodiments may include a mobile device database 4412 that may store some or all the user's data, the live event 4402, or the user's interaction with the wagering network 4414.

Further, embodiments may include the wagering network 4414, which may perform real-time analysis on the type of play and the result of a play or action. The wagering network 4414 (or the cloud 4406) may also be synchronized with game situational data, such as the time of the game, the score, location on the field, weather conditions, and the like, which may affect the choice of play utilized. For example, in an exemplary embodiment, the wagering network 4414 may not receive data gathered from the sensors 4404 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 4414 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 4416, which may contain data relevant to all users of the wagering network 4414 and may include, but is not limited to, a user ID, a device identifier, a paired device identifier, wagering history, or wallet information for the user. The user database 4416 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 4416 may contain betting lines and search queries. The user database 4416 may be searched based on a search criterion received from the user. Each betting line may include, but is not limited to, a plurality of betting attributes such as at least one of the live event 4402, a team, a player, an amount of wager, etc. The user database 4416 may include but is not limited to information related to all the users involved in the live event 4402. In one exemplary embodiment, the user database 4416 may include information for generating a user authenticity report and a wagering verification report. Further, the user database 4416 may be used to store user statistics like, but not limited to, the retention period for a particular user, frequency of wagers placed by a particular user, the average amount of wager placed by each user, etc.

Further, embodiments may include a historical plays database 4418 that may contain play data for the type of sport being played in the live event 4402. For example, in American Football, for optimal odds calculation, the historical play data may include metadata about the historical plays, such as time, location, weather, previous plays, opponent, physiological data, etc. Further, embodiments may utilize an odds database 4420—that contains the odds calculated by an odds calculation module 4422—to display the odds on the user's mobile device 4408 and take bets from the user through the mobile device wagering app 4410.

Further, embodiments may include a base module 4422, which receives the sensor data from the live event 4402. Then the base module 4422 determines a first play situation from the received sensor data. The base module 4422 determines the probability and wager odds of a first future event occurring at the present competition based on at least the first play situation and playing data associated with at least a subset of one or both of the first set of one or more participants and the second set of one or more participant. The base module 4422 provides the wager odds on the wagering app 4410.

Further, embodiments may include an odds calculation module 4424, which begins with being initiated by the base module 4422. In some embodiments, the odds calculation module 4424 may be continuously polling for the data from the live event 4402. In some embodiments, the odds calculation module 4424 may receive the data from the live event 4402. In some embodiments, the odds calculation module 4424 may store the results data, or the results of the last action, in the historical play database 4418, which may contain historical data of all previous actions. The odds calculation module 4424 filters the historical play database 4418 on the team and inning from the situational data. The odds calculation module 4424 determines the wagering market. For example, the event may have multiple wager markets, such as the next pitch being a strike or ball, the outcome of the next hit, which fielder may record the next out, where on the field the next hit will be located, etc. The odds calculation module 4424 selects the first algorithm stored in the algorithm database 4432. For example, the odds calculation module 4424 filters the algorithm database 4432 on the event type, such as baseball, and the wagering market, such as the next pitch to be a strike. Then the odds calculation module 4424 executes the algorithm stored in the algorithm database 4432. For example, the algorithm may use the data stored in the historical plays database 4418 to create another data point, such as combining multiple parameters to create a new parameter, performing calculations on multiple parameters to create a new parameter, etc. For example, the algorithm may calculate a batter's isolated power parameter, which uses the number of doubles, triples, home runs, and at-bats to create a new parameter for a batter using the formula (1×2B+2×3B+3×HR)/At-bats. This new parameter is used as a metric to determine the batter's power ability during an at-bat. For example, if the event is the Boston Red Sox vs. the New York Yankees, in the 1st inning, the batter is Rafael Devers, and the wager market is if the next hit be a home run, then the ISO algorithm will determine Rafael Devers ISO average. For example, if Rafael Devers hit 37 doubles, 1 triple, and 38 home runs in 591 at-bats, then the formula would be (1×37+2×1+3×38)/591 for an ISO average of 0.259. This average can be used as a parameter along with another parameter from the historical plays database 4418 to perform correlations in order to determine if the wager odds should be adjusted or not. In some embodiments, the historical plays database 4418 may be filtered on the batter's regular season statistics, career statistics, statistics against the current opponent, statistics against the current pitcher, statistics in the event location, etc. Then the odds calculation module 4424 performs correlations on the data based on the algorithm parameters. For example, the parameters for the algorithm may be the batter's ISO average and the total number of home runs. For example, the historical play database 4418 is filtered on the team, the players, the inning, and the number of outs. The first parameter is selected, which in this example is the batter's ISO average. Then, correlations are performed, with the other parameter being the total number of home runs the batter has hit. In an example of correlated data, the correlated data for the historical data involving the Boston Red Sox vs. the New York Yankees, in the 1st inning and the batter is Rafael Devers, and the wagering market is if the next hit will be a home run, which has a correlation coefficient of 0.81. The correlations are also performed with the same filters, and the next event, which is the action being the batter will not hit a home run, has a correlation coefficient of 0.79. Then the odds calculation module 4424 determines if the correlation coefficient is above a predetermined threshold, for example, 0.75, in order to determine if the data is highly correlated and deemed a relevant correlation. If the correlation is deemed highly relevant, the odds calculation module 4424 extracts the correlation coefficient from the data. For example, the two correlation coefficients of 0.81 for a home run and 0.79 for not a home run are both extracted. If it is determined that the correlations are not highly relevant, then the odds calculation module 4424 determines if any algorithms are remaining in the algorithm database 4432 with the same wager market, such as for the next hit to be a home run. Also, if the correlations were determined to be highly relevant and therefore extracted, it is also determined if any algorithms are remaining in the algorithm database 4432 with the same wager market. If it is determined that there are no more algorithms remaining for the wagering market, then the odds calculation module 4424 determines if any more wager markets are remaining, and the process continues to select the algorithm for the next wager market. If there are additional algorithms to have correlations performed, then the odds calculation module 4424 selects the next algorithm stored in the algorithm database 4432, and the process returns to performing correlations on the data. Once there are no more remaining algorithms to perform correlations on, the odds calculation module 4424 determines the difference between the extracted correlations. For example, the correlation coefficient for a home run is 0.81, and the correlation coefficient for the hit not being a home run is 0.79. The difference between the two correlation coefficients (0.81−0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendations database 4428 to compare the two correlation coefficient based on statistical significance as opposed to the difference of the two correlation coefficients. Then the odds calculation module compares the difference between the two correlation coefficients, for example, 0.02, to the recommendations database 4428. The recommendations database 4428 contains various ranges of differences in correlations as well as the corresponding odds adjustment for those ranges. For example, the 0.02 difference of the two correlation coefficients falls into the range +0-2 difference in correlations which, according to the recommendations database 4428, should have an odds adjustment of 5% increase. The odds calculation module 4424 then extracts the odds adjustment from the recommendations database 4428. The odds calculation module then stores the extracted odds adjustment in the adjustment database 4430. The odds calculation module 4424 compares the odds database 4420 to the adjustment database 4430. The odds calculation module 4424 then determines whether or not there is a match in any of the wager IDs in the odds database 4420 and the adjustment database 4430. For example, the odds database 4420 contains a list of all the current bet options for a user. The odds database 4420 contains a wager ID, event, time, inning, wager, and odds for each bet option. The adjustment database 4430 contains the wager ID and the percentage, either as an increase or decrease, that the odds should be adjusted. If it is determined there is a match between the odds database 4420 and the adjustment database 4430, then the odds calculation module 4424 adjusts the odds in the odds database 4420 by the percentage increase or decrease in the adjustment database 4430 and the odds in the odds database 4420 are updated. For example, if the odds in the odds database 4420 are −105 and the matched wager ID in the adjustment database 4430 is a 5% increase, then the updated odds in the odds database 4420 should be −110. If there is a match, then the odds are adjusted based on the data stored in the adjustment database 4430, and the new data is stored in the odds database 4420 over the old entry. If there are no matches, or once the odds database 4420 has been adjusted, if there are matches, the odds calculation module 4424 returns to the base module 4422. In some embodiments, the odds calculation module 4424 may offer the odds database 4420 to the wagering app 4410, allowing users to place bets on the wagers stored in the odds database 4420. In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 4424. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1−b2/Sb1−b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 4424 may then extract an odds adjustment from the recommendations database 4428. The extracted odds adjustment is then stored in the adjustment database 4430. In some embodiments, the recommendations database 4428 may be used in the odds calculation module 4424 to determine how the wager odds should be adjusted depending on the difference between the correlation coefficients of the correlated data points. The recommendations database 4428 may contain the difference in correlations and the odds adjustment. For example, if there is a correlation coefficient for a home run of 0.81 and a correlation coefficient for a not a home run of 0.79, the difference between the two would be +0.02 when compared to the recommendations database 4428 the odds adjustment would be a 5% increase for Rafael Devers to hit a home run or otherwise identified as wager 201 in the adjustment database 4430. In some embodiments, the difference in correlations may be the statistical significance of comparing the two correlation coefficients in order to determine how the odds should be adjusted. In some embodiments, the adjustment database 4430 may be used to adjust the wager odds of the odds database 4420 if it is determined that a wager should be adjusted. The adjustment database 4430 contains the wager ID, which is used to match with the odds database 4420 to adjust the odds of the correct wager.

Further, embodiments may include a tracking system 4426, which is associated with one or more tracking devices and anchors. The tracking system 4426 may include one or more processing units (CPUs), a peripherals interface, a memory controller, a network or other communications interface, a memory, for example, a random access memory, a user interface, the user interface including a display and an input, such as a keyboard, a keypad, a touch screen, etc., an input/output (I/O) subsystem, one or more communication busses for interconnecting the aforementioned components, and a power supply system for powering the aforementioned components. In some embodiments, the input is a touch-sensitive display, such as a touch-sensitive surface. In some embodiments, the user interface includes one or more soft keyboard embodiments. The soft keyboard embodiments may include standard (QWERTY) and/or non-standard configurations of symbols on the displayed icons. It should be appreciated that the tracking system 4426 is only one example of a system that may be used in engaging with various tracking devices and that the tracking system 4426 optionally has more or fewer components than described, optionally combines two or more components, or optionally has a different configuration or arrangement of the components. The various components described are implemented in hardware, software, firmware, or a combination thereof, including one or more signal processing and/or application-specific integrated circuits. Memory optionally includes high-speed random access memory, and optionally also includes non-volatile memory, such as one or more magnetic disk storage devices, flash memory devices, or other non-volatile solid-state memory devices. Access to memory by other tracking system components, such as CPU(s), is, optionally, controlled by a memory controller. Peripherals interface can be used to couple input and output peripherals of the tracking system 4426 to CPU(s) and memory. One or more processors run or execute various software programs and/or sets of instructions stored in memory to perform various functions for the tracking system 4426 and to process data. In some embodiments, peripherals interface, CPU(s), and memory controller are, optionally, implemented on a single chip. In some other embodiments, they are, optionally, implemented on separate chips. In some embodiments, power system optionally includes a power management system, one or more power sources (e.g., battery, alternating current (AC)), a recharging system, a power failure detection circuit, a power converter or inverter, a power status indicator (e.g., a light-emitting diode (LED), etc.) and any other components associated with the generation, management and distribution of power in portable devices. In some embodiments, the tracking system 4426 may include a tracking device manager module for facilitating management of one or more tracking devices, the tracking device manager module may include a tracking device identifier store for storing pertinent information related to each respective tracking device, including a tracking device identifier and a tracking device ping rate, and a tracking device grouping store for facilitating management of or more tracking device groups. The tracking device identifier store includes information related to each respective tracking device, including the tracking device identifier (ID) for each respective tracking device as well as a tracking device group to which the respective tracking device is associated. In some embodiments, a first tracking device group is associated with the left shoulder of each respective subject, and a second tracking device group is associated with a right shoulder of each respective subject. In some embodiments, a third tracking device group is associated with a first position, for example, first baseman, second baseman, shortstop, baserunner, pitcher, etc., of each respective subject, and a fourth tracking device group is associated with a second position. Grouping the tracking devices allows for a particular group to be designated with a particular ping rate, for example, a faster ping rate for baserunners. Grouping the tracking devices also allows for a particular group to be isolated from other tracking devices that are not associated with the respective group, which is useful in viewing representations of the telemetry data provided by the tracking devices of the group.

Further, embodiments may include a recommendations database 4428 that may be used in the odds calculation module 4424 to determine how the wager odds should be adjusted depending on the difference between the correlation coefficients of the correlated data points. The recommendations database 4428 may contain the difference in correlations and the odds adjustment. For example, if there is a correlation coefficient for a Red Sox second inning with a runner on base with one out and a stolen base of 0.81 and a correlation coefficient for a Red Sox second inning with a runner on base with one out and the runner caught stealing of 0.79, the difference between the two would be +0.02 when compared to the recommendations database 4428 the odds adjustment would be a 5% increase for a Red Sox stolen base or otherwise identified as wager 201 in the adjustment database 4430. In some embodiments, the difference in correlations may be the statistical significance of comparing the two correlation coefficients in order to determine how the odds should be adjusted.

Further, embodiments may include an adjustment database 4430 that may be used to adjust the wager odds of the odds database 4420 if it is determined that a wager should be adjusted. The adjustment database 4430 contains the wager ID, which is used to match with the odds database 4420 to adjust the odds of the correct wager.

Further, embodiments may include an algorithm database 4432 used by the odds calculation module 4424 to create another data point, such as combining multiple parameters to create a new parameter, performing calculations on multiple parameters to create a new parameter, etc. The database contains the event type, the wagering market, the algorithm, the data file containing the algorithm, and the parameters used to perform correlations in the odds calculation module 4424. For example, the algorithm may calculate a batter's isolated power parameter, which uses the number of doubles, triples, home runs, and at-bats to create a new parameter for a batter using the formula (1×2B+2×3B+3×HR)/At-bats. This new parameter is used as a metric to determine the batter's power ability during an at-bat. For example, if the event is the Boston Red Sox vs. the New York Yankees, in the 1st inning, the batter is Rafael Devers, and the wager market is if the next hit be a home run, then the ISO algorithm will determine Rafael Devers ISO average. For example, if Rafael Devers hit 37 doubles, 1 triple, and 38 home runs in 591 at-bats, then the formula would be (1×37+2×1+3×38)/591 for an ISO average of 0.259. This average can be used as a parameter along with another parameter from the historical plays database 4418 to perform correlations in order to determine if the wager odds should be adjusted or not. In some embodiments, the historical plays database 4418 may be filtered on the batter's regular season statistics, career statistics, statistics against the current opponent, statistics against the current pitcher, statistics in the event location, etc. In some embodiments, there may be more than two parameters to be correlated stored in the algorithm database 4432. For example, in the process described in the odds calculation module 4424, the parameters are required to exceed a predetermined threshold in order to adjust the odds, the algorithm database 4432 may store multiple parameters, such as 2, 3, 4, 5, etc. to ensure that the correlations will be high enough to exceed the predetermined threshold. For example, if the batter's ISO average and total home runs may not have a correlation coefficient to exceed the predetermined threshold, so a third parameter may be used to filter the historical plays database 4418 further to create a correlation coefficient that exceeds the predetermined threshold, such as total home runs hit in the first inning or total home runs hit in the first inning within the first five pitches to achieve a higher correlation coefficient to exceed the predetermined threshold to adjust the wager odds.

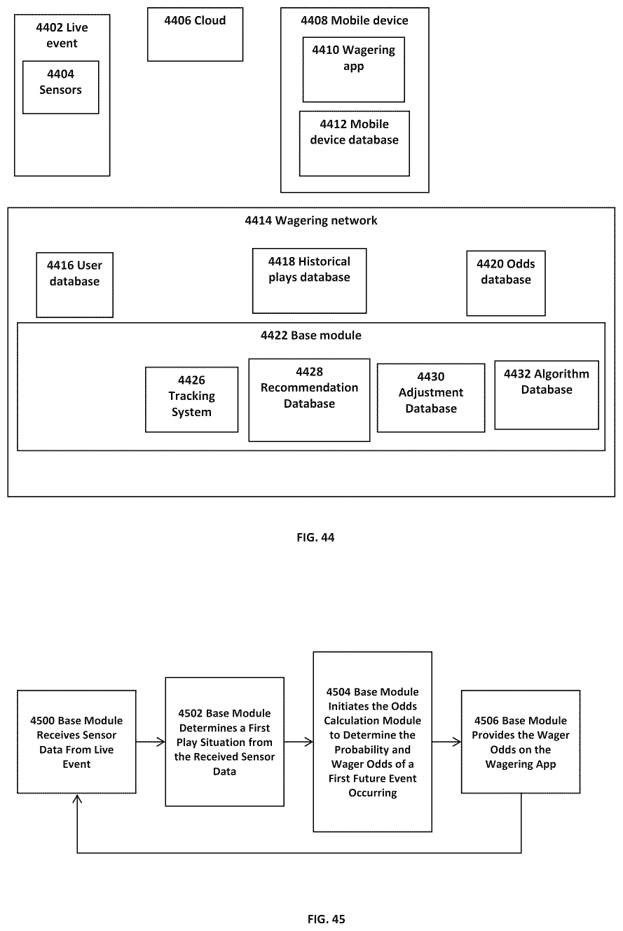

FIG. 45 Illustrates the base module 4422. the base module 4422 receives, at step 4500, the sensor data from the live event 4402. For example, the base module 4422 receives time-stamped position information of one or more participants of one or both of the first set of participant(s) and the second set of participant(s) in the present competition is received, the time-stamped position information captured by the sensors 4404 at a live event 4402 during the present competition. For example, the sensor data may be collected by a system including the tracking system 4426, the tracking devices, the anchor devices, etc. The time-stamped position information may include an XY- or XYZ-position of each participant of a first subset and a second subset of players with respect to a predefined space, for example, a game field, such as a football field, etc.

The first subset and the second subset can include any number of participants such as each subset including one participant, each subset including two or more participants, or each subset including all the participants of the first competitor and the second competitor, respectively, that are on the field during the first time point. Then the base module 4422 determines, at step 4502, a first play situation from the received sensor data. For example, the base module 4422 receives the time-stamped position information and is used to determine a first play situation of the present competition, such as a current play situation. In various embodiments, the play situation is determined using, at least in part, time-stamped position information of each player in the subsets of players at the given time. For example, the process determines the play situation at a first time point which is a current time of a competition while the competition is ongoing, and the time-stamped position information has been collected by the sensors 4404 at the present competition through the first time point.

In various embodiments, determining the play situation uses a set of parameters, including a current team, inning, outs recorded, baserunners, and defensive positions describing the play situation at the given time. In some embodiments, the data describing the play situation of the live event 4402 further includes motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 4404 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball. In some embodiments, telemetry data that an array of anchors may receive from one or more tracking devices which may include positional telemetry data. The positional telemetry data provides location data for a respective tracking device, which describes the location of the tracking device within a spatial region. In some embodiments, this positional telemetry data is provided as one or more Cartesian coordinates (e.g., an X coordinate, a Y coordinate, and/or Z a coordinate) that describe the position of each respective tracking device. However, any coordinate system (e.g., polar coordinates, etc.) that describes the position of each respective tracking device is used in alternative embodiments. The telemetry data that is received by the array of anchors from the one or more tracking devices includes kinetic telemetry data. The kinetic telemetry data provides data related to various kinematics of the respective tracking device. In some embodiments, this kinetic telemetry data is provided as a velocity of the respective tracking device, an acceleration of the respective tracking device, and/or a jerk of the respective tracking device. Further, in some embodiments, one or more of the above values is determined from an accelerometer of the respective tracking device and/or derived from the positional telemetry data of the respective tracking device. Further, in some embodiments, the telemetry data that is received by the array of anchors from the one or more tracking devices includes biometric telemetry data. The biometric telemetry data provides biometric information related to each subject associated with the respective tracking device. In some embodiments, this biometric information includes a heart rate of the subject, temperature, for example, a skin temperature, a temporal temperature, etc. In some embodiments, the array of anchors communicates the above-described telemetry data, for example, positional telemetry, kinetic telemetry, and/or biometric telemetry, to a telemetry parsing system. Accordingly, in some embodiments, the telemetry parsing system communicates the telemetry data to an odds calculation module 4422. In some embodiments, an array of anchor devices may receive telemetry data from one or more tracking devices. In order to minimize error in receiving the telemetry from the one or more tracking devices, the array of anchor devices preferably includes at least three anchor devices. The inclusion of at least three anchor devices within the array of anchor devices allows for each ping, for example, telemetry data received from a respective tracking device, to be triangulated using the combined data from the at least three anchors that receive the respective ping.

The position may be defined as an XY- or XYZ-coordinate for each player with respect to a predefined space, such as a field where the live event 4402 occurs, such as pitcher's location, catcher's location, baserunner's location, first base location, first baseman location, etc. The player configuration includes positions of the player with respect to each other, as well as with respect to the bases, pitcher's mound, home plate, foul lines, etc. Such positional data is used for recognizing patterns for deriving player configurations in play situations as well as for tracking next events, for example, a baserunner's lead, the position of the first baseman, second baseman, shortstop, etc.,

In various embodiments, determining a prediction of the probability of a first future event includes using historical playing data of one or more participants in one or both of the first set of participant(s) and the second set of participant(s). That is, the process determines a prediction of the probability of a first future event occurring at a live event 4402 based upon at least (i) the playing data, (ii) the play situation, and (iii) the historical playing data. Historical data refers to play-by-play data that specifies data describing play situations and next play events that have occurred after each play situation. The historical play-by-play data includes historical outcomes of next plays from given player configurations. For example, the historical play-by-play data includes a plurality of next play events that have occurred after a given play situation. For baseball, the given play situation includes the player's configuration in the field, a current inning, the number of outs recorded, the number of baserunners, the number of pitches thrown, the number of pitches called strikes, the number of pitches called balls, etc.

In some embodiments, such historical data also includes data collected so far during a live event 4402. In some embodiments, the historical data further includes play-by-play data recorded and published by a league, such as the MLB, NBA, NHL, NFL, etc.

In some embodiments, historical playing data is stored at historical plays database 818 for each participant of at least the first and second subset of participants in a plurality of historical games in the league. In some embodiments, the historical data is used to identify historical play situations corresponding to the play situation at the first time point and provide a prediction of the next event based on the historical play events that have occurred after similar play situations. In some embodiments, the historical playing data includes player telemetry data for each player of at least the first and second subset of players in the plurality of historical games in the league. In some embodiments, the historical playing data includes historical states for player configurations. The current play situation with the present player configuration is compared with the historical states for player configurations to predict the next event in the present game. In some embodiments, the historical states for each player configuration of the player configurations include player types included in the respective player configuration or a subset of the player types included in the respective player configuration. In some embodiments, the plurality of historical games spans a plurality of seasons over a plurality of years. The historical playing data may be for the same type of sport or competition involving the first and second competitors. The first and second competitors may have different team members compared with the current configuration of the team or may have some of the same team members. The base module 4422 initiates, at step 4504, the odds calculation module 4424 to determine the probability and wager odds of a first future event occurring at the present competition based on at least the first play situation and playing data associated with at least a subset of one or both of the first set of one or more participants and the second set of one or more participant. The base module 4422 provides, at step 4506, the wager odds on the wagering app 4410. In various embodiments, the wager odds are transmitted to the wagering app 4410 through the wager network 4414 to be displayed on a mobile device 4408. In some embodiments, the wagering app 4410, which is a program that enables the user to place bets on individual plays in the live event 4402, streams audio and video from the live event 4402, and features the available wagers from the live event 4402 on the mobile device 4408. The wagering app 4410 allows users to interact with the wagering network 4414 to place bets and provide payment/receive funds based on wager outcomes.

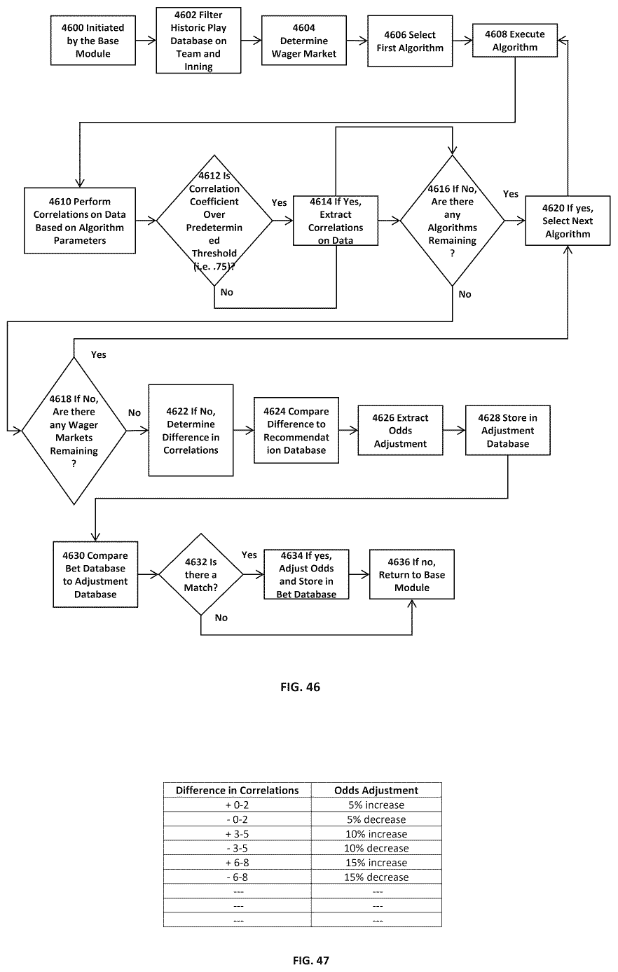

FIG. 46 illustrates the odds calculation module 4424. The odds calculation module 4424 being initiated, at step 4600, by the base module 4422. In some embodiments, the odds calculation module 4424 may be continuously polling for the data from the live event 4402. In some embodiments, the odds calculation module 4424 may receive the data from the live event 4402. In some embodiments, the odds calculation module 4424 may store the results data, or the results of the last action, in the historical play database 4418, which may contain historical data of all previous actions. The odds calculation module 4424 filters, at step 4602, the historical play database 4418 on the team and inning from the situational data. The odds calculation module 4424 determines, at step 4604, the wagering market. For example, the event may have multiple wager markets, such as the next pitch being a strike or ball, the outcome of the next hit, which fielder may record the next out, where on the field the next hit will be located, etc. The odds calculation module 4424 selects, at step 4606, the first algorithm stored in the algorithm database 4432. For example, the odds calculation module 4424 filters the algorithm database 4432 on the event type, such as baseball, and the wagering market, such as the next pitch to be a strike. Then the odds calculation module 4424 executes, at step 4608, the algorithm stored in the algorithm database 4432. For example, the algorithm may use the data stored in the historical plays database 4418 to create another data point, such as combining multiple parameters to create a new parameter, performing calculations on multiple parameters to create a new parameter, etc. For example, the algorithm may calculate a batter's isolated power parameter, which uses the number of doubles, triples, home runs, and at-bats to create a new parameter for a batter using the formula (1×2B+2×3B+3×HR)/At-bats. This new parameter is used as a metric to determine the batter's power ability during an at-bat. For example, if the event is the Boston Red Sox vs. the New York Yankees, in the 1st inning, the batter is Rafael Devers, and the wager market is if the next hit be a home run, then the ISO algorithm will determine Rafael Devers ISO average. For example, if Rafael Devers hit 37 doubles, 1 triple, and 38 home runs in 591 at-bats, then the formula would be (1×37+2×1+3×38)/591 for an ISO average of 0.259. This average can be used as a parameter along with another parameter from the historical plays database 4418 to perform correlations in order to determine if the wager odds should be adjusted or not. In some embodiments, the historical plays database 4418 may be filtered on the batter's regular season statistics, career statistics, statistics against the current opponent, statistics against the current pitcher, statistics in the event location, etc. In some embodiments, the algorithm may be created through a machine learning process or artificial intelligence process by using the data in the historical plays database 4418 to create new parameters and metrics that are correlated with the existing parameters stored in the historical plays database 4418 to determine which newly created parameters are highly correlated with existing parameters and storing the algorithms in the algorithm database 4432 which is an algorithm to create the new parameter as well as the highly correlated parameters for the odds calculation module 4424 to use. For example, a machine learning betting system is a system that incorporates machine learning into at least one step in the odds makings, market creation, user interface, algorithm creation, or personalization of a sports wagering platform. Machine learning leverages artificial intelligence to allow a computer algorithm to improve itself automatically over time without being explicitly programmed. Machine learning and AI are often discussed together, and the terms are sometimes used interchangeably, but they don't mean the same thing. An important distinction is that although all machine learning is AI, not all AI is machine learning. Machine learning algorithms can develop their framework for analyzing a data set through experience in using that data. Machine learning helps create models that can process and analyze large amounts of complex data to deliver accurate results. Machine learning uses models or mathematical representations of real-world processes. It achieves this through examining features, measurable properties, and parameters of a data set. It may utilize a feature vector, or a set of multiple numeric features, as a training input for prediction purposes. An algorithm takes a set of data known as “training data” as input. The learning algorithm finds patterns in the input data and trains the model for expected results (target). The output of the training process is the machine learning model. A model may then make a prediction when fed input data. The value that the machine learning model has to predict is called the target or label. When excessively large amounts of data are fed to a machine learning algorithm, it may experience overfitting, a situation in which the algorithm learns from noise and inaccurate data entries. Overfitting may result in data being labeled incorrectly or in predictions being inaccurate. An algorithm may experience underfitting when it fails to decipher the underlying trend in the input data set as it does not fit the data well enough.

A machine learning betting system will measure error once the model is trained. New data will be fed to the model, and the outcome will be checked and categorized into one of four types of results: true positive, true negative false positive, and false negative. A true positive result is when the model predicts a condition when the condition is present. A true negative result is when the model does not predict a condition when it is absent. A false-positive result is when the model predicts a condition when it is absent. A false negative is when the model does not predict a condition when it is absent. The sum of false positives and false negatives is the total error in the model. While an algorithm or hypothesis can fit well to a training set, it might fail when applied to another data set outside the training set. It must therefore be determined if the algorithm is fit for new data. Testing it with a set of new data is the way to judge this. Generalization refers to how well the model predicts outcomes for a new set of data. Noise must also be managed and data parameters tested. A machine learning betting system may go through several cycles of training, validation, and testing until the error in the model is brought within an acceptable range.

A machine learning betting system may use one or more types of machine learning. Supervised machine learning algorithms can use data that has already been analyzed, by a person or another algorithm, to classify new data. Analyzing a known training dataset allows a supervised machine learning algorithm to produce an inferred function to predict output values in the new data. As input data is fed into the model, it changes the weighting of characteristics until the model is fitted appropriately. This supervised learning is part of a process to ensure that the model avoids overfitting or underfitting called cross-validation. Supervised learning helps organizations solve various real-world problems at scale, such as classifying spam in a separate email folder.

Supervised machine learning algorithms are adept at dividing data into two categories, or binary classification, choosing between more than two types of answers, or multi-class classification, predicting continuous values, or regression modeling, or combining the predictions of multiple machine learning models to produce an accurate prediction, also known as ensembling. Some methods used in supervised learning include neural networks, naïve Bayes, linear regression, logistic regression, random forest, support vector machine (SVM), and more. A supervised machine learning betting system may be provided a dataset of historical sporting events, the odds of various outcomes of those sporting events, and the action waged on those outcomes, and use that data to predict the action on future outcomes by identifying similar historical outcomes. A machine learning betting system may utilize recommendation algorithms to learn user preferences are for teams, players, sports, wagers, etc.

Unsupervised machine learning analyzes and clusters data that has not been analyzed yet to discover hidden patterns or groupings within the data without the need for a human to define what the patterns or groupings should look like. The ability of unsupervised machine learning algorithms to discover similarities and differences in information makes it the ideal solution for exploratory data analysis, cross-selling strategies, customer segmentation, image, and pattern recognition. Most types of deep learning, including neural networks, are unsupervised algorithms.

Unsupervised machine learning may be utilized in dimensionality reduction or the process of reducing the number of random variables under consideration by identifying a set of principal variables. Unsupervised machine learning may split datasets into groups based on similarity, also known as clustering. It may also engage in anomaly detection by identifying unusual data points in a data set. It may also identify items in a data set that frequently occur together, also known as association mining. Principal component analysis and singular value decomposition are two methods of dimensionality reduction that may be employed. Other algorithms used in unsupervised learning include neural networks, k-means clustering, probabilistic clustering methods, and more.

A machine learning betting system may fall between a supervised machine learning algorithm and an unsupervised one. In these systems, an algorithm used training on a smaller labeled dataset to identify features and classify a larger, unlabeled dataset. These types of algorithms perform better when provided with labeled data sets. However, labeling can be time-consuming and expensive, which is where unsupervised learning can provide efficiency benefits. For example, a sportsbook may identify a cohort of users in a dataset who exhibit desirable behavior. A semi-supervised machine learning betting system may use that to identify other users in the cohort who are desirable.

Reinforcement learning is when data scientists teach a machine learning algorithm to complete a multi-step process with clearly defined rules. The algorithm is programmed to complete a task and is given positive and negative feedback or cues as it works out how to complete the task it has been given. The prescribed set of rules for accomplishing a distinct goal will allow the algorithm will learn and decide which steps to take along the way. This combination of rules along with positive and negative feedback would allow a reinforcement learning machine learning betting system to optimize the task over time. A machine learning betting system may utilize reinforcement learning to identify potential cheaters by recognizing a series of behaviors associated with undesirable player conduct, cheating, or fraud. Then the odds calculation module 4424 performs, at step 4610, correlations on the data based on the algorithm parameters. For example, the parameters for the algorithm may be the batter's ISO average and the total number of home runs. For example, the historical play database 4418 is filtered on the team, the players, the inning, and the number of outs. The first parameter is selected, which in this example is the batter's ISO average. Then, correlations are performed, with the other parameter being the total number of home runs the batter has hit. In an example of correlated data, the correlated data for the historical data involving the Boston Red Sox vs. the New York Yankees, in the 1st inning and the batter is Rafael Devers, and the wagering market is if the next hit will be a home run, which has a correlation coefficient of 0.81. The correlations are also performed with the same filters, and the next event, which is the action being the batter will not hit a home run, has a correlation coefficient of 0.79. Then the odds calculation module 4424 determines, at step 4612, if the correlation coefficient is above a predetermined threshold, for example, 0.75, in order to determine if the data is highly correlated and deemed a relevant correlation. If the correlation is deemed highly relevant, then the odds calculation module 4424 extracts, at step 4614, the correlation coefficient from the data. For example, the two correlation coefficients of 0.81 for a home run and 0.79 for not a home run are both extracted. If it is determined that the correlations are not highly relevant, then the odds calculation module 4424 determines, at step 4616, if any algorithms are remaining in the algorithm database 4432 with the same wager market, such as for the next hit to be a home run. Also, if the correlations were determined to be highly relevant and therefore extracted, it is also determined if any algorithms are remaining in the algorithm database 4432 with the same wager market. If it is determined that there are no more algorithms remaining for the wagering market, then the odds calculation module 4424 determines, at step 4618, if any more wager markets are remaining and the process continues to select the algorithm for the next wager market. If there are additional algorithms to have correlations performed, then the odds calculation module 4424 selects, at step 4620, the next algorithm stored in the algorithm database 4432, and the process returns to performing correlations on the data. Once there are no more remaining algorithms to perform correlations on, the odds calculation module 4424 then determines, at step 4622, the difference between each of the extracted correlations. For example, the correlation coefficient for a home run is 0.81, and the correlation coefficient for a not a home run is 0.79. The difference between the two correlation coefficients (0.81−0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendations database 4428 to compare the two correlation coefficient based on statistical significance as opposed to the difference of the two correlation coefficients. Then the odds calculation module compares, at step 4624, the difference between the two correlation coefficients, for example, 0.02, to the recommendations database 4428. The recommendations database 4428 contains various ranges of differences in correlations as well as the corresponding odds adjustment for those ranges. For example, the 0.02 difference of the two correlation coefficients falls into the range +0-2 difference in correlations which, according to the recommendations database 4428, should have an odds adjustment of 5% increase. The odds calculation module 4424 then extracts, at step 4626, the odds adjustment from the recommendations database 4428. The odds calculation module then stores, at step 4628, the extracted odds adjustment in the adjustment database 4430. The odds calculation module 4424 compares, at step 4630, the odds database 4420 to the adjustment database 4430. The odds calculation module 4424 then determines, at step 4632, whether or not there is a match in any of the wager IDs in the odds database 4420 and the adjustment database 4430. For example, the odds database 4420 contains a list of all the current bet options for a user. The odds database 4420 contains a wager ID, event, time, inning, wager, and odds for each bet option. The adjustment database 4430 contains the wager ID and the percentage, either as an increase or decrease, that the odds should be adjusted. If it is determined there is a match between the odds database 4420 and the adjustment database 4430, then the odds calculation module 4424 adjust, at step 4634, the odds in the odds database 4420 by the percentage increase or decrease in the adjustment database 4430 and the odds in the odds database 4420 are updated. For example, if the odds in the odds database 4420 are −105 and the matched wager ID in the adjustment database 4430 is a 5% increase, then the updated odds in the odds database 4420 should be −110. If there is a match, then the odds are adjusted based on the data stored in the adjustment database 4430, and the new data is stored in the odds database 4420 over the old entry. If there are no matches, or, once the odds database 4420 has been adjusted if there are matches, the odds calculation module 4424 returns, at step 4636, to the base module 4422. In some embodiments, the odds calculation module 4424 may offer the odds database 4420 to the wagering app 4410, allowing users to place bets on the wagers stored in the odds database 4420. In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 4424. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1−b2/Sb1−b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 4424 may then extract an odds adjustment from the recommendations database 4428. The extracted odds adjustment is then stored in the adjustment database 4430. In some embodiments, the recommendations database 4428 may be used in the odds calculation module 4424 to determine how the wager odds should be adjusted depending on the difference between the correlation coefficients of the correlated data points. The recommendations database 4428 may contain the difference in correlations and the odds adjustment. For example, if there is a correlation coefficient for a home run of 0.81 and a correlation coefficient for a not a home run of 0.79, the difference between the two would be +0.02 when compared to the recommendations database 4428 the odds adjustment would be a 5% increase for Rafael Devers to hit a home run or otherwise identified as wager 201 in the adjustment database 4430. In some embodiments, the difference in correlations may be the statistical significance of comparing the two correlation coefficients in order to determine how the odds should be adjusted. In some embodiments, the adjustment database 4430 may be used to adjust the wager odds of the odds database 4420 if it is determined that a wager should be adjusted. The adjustment database 4430 contains the wager ID, which is used to match with the odds database 4420 to adjust the odds of the correct wager.

FIG. 47 illustrates the recommendations database 4428. The recommendations database 4428 may be used in the odds calculation module 4424 to determine how the wager odds should be adjusted depending on the difference between the correlation coefficients of the correlated data points. The recommendations database 4428 may contain the difference in correlations and the odds adjustment. For example, if there is a correlation coefficient for a Red Sox second inning with a runner on base with one out and a stolen base of 0.81 and a correlation coefficient for a Red Sox second inning with a runner on base with one out and the runner caught stealing of 0.79, the difference between the two would be +0.02 when compared to the recommendations database 4428 the odds adjustment would be a 5% increase for a Red Sox stolen base or otherwise identified as wager 201 in the adjustment database 4430. In some embodiments, the difference in correlations may be the statistical significance of comparing the two correlation coefficients in order to determine how the odds should be adjusted.

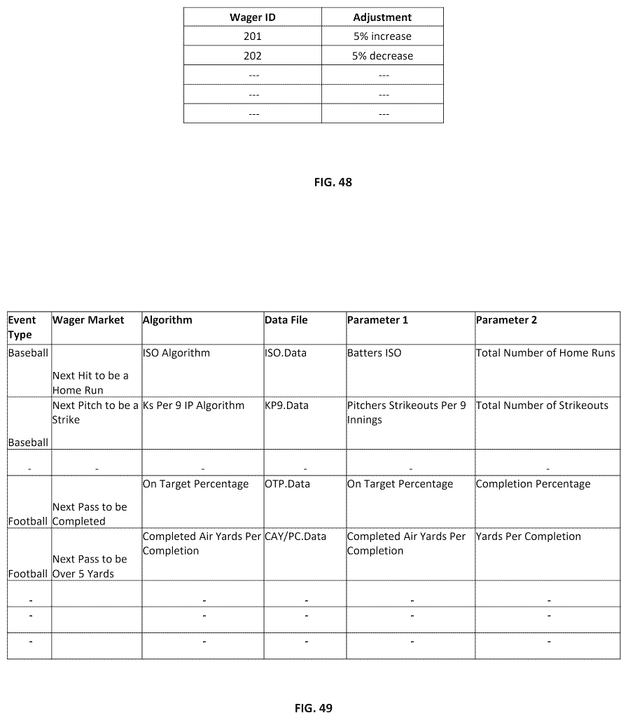

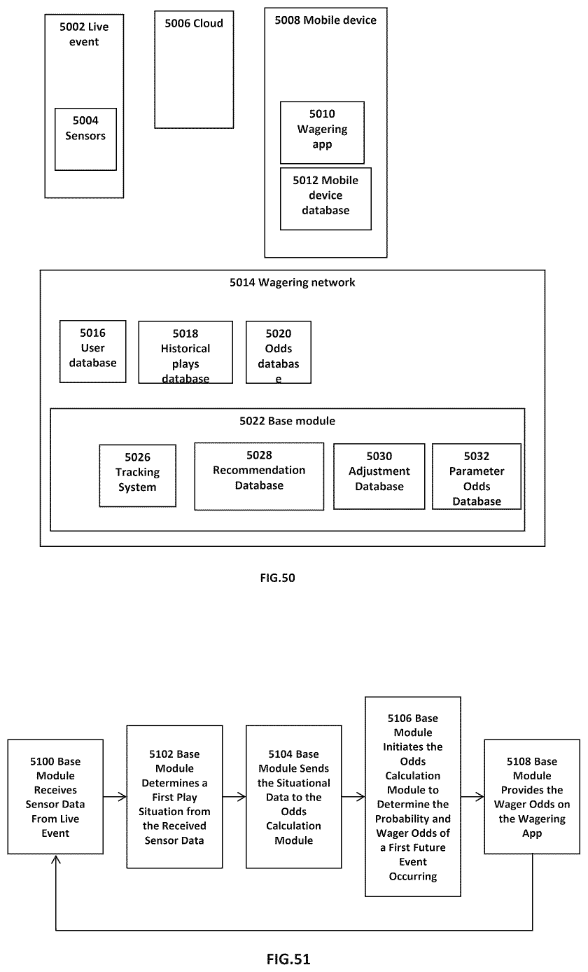

FIG. 48 illustrates the adjustment database 4430. The adjustment database 4430 may be used to adjust the wager odds of the odds database 4420 if it is determined that a wager should be adjusted. The adjustment database 4430 contains the wager ID, which is used to match with the odds database 4420 to adjust the odds of the correct wager.

FIG. 49 illustrates the algorithm database 4432. The database is used by the odds calculation module 4424 in order to create another data point, such as combining multiple parameters to create a new parameter, performing calculations on multiple parameters to create a new parameter, etc. The database contains the event type, the wagering market, the algorithm, the data file containing the algorithm, and the parameters used to perform correlations in the odds calculation module 4424. For example, the algorithm may calculate a batter's isolated power parameter, which uses the number of doubles, triples, home runs, and at-bats to create a new parameter for a batter using the formula (1×2B+2×3B+3×HR)/At-bats. This new parameter is used as a metric to determine the batter's power ability during an at-bat. For example, if the event is the Boston Red Sox vs. the New York Yankees, in the 1st inning, the batter is Rafael Devers, and the wager market is if the next hit be a home run, then the ISO algorithm will determine Rafael Devers ISO average. For example, if Rafael Devers hit 37 doubles, 1 triple, and 38 home runs in 591 at-bats, then the formula would be (1×37+2×1+3×38)/591 for an ISO average of 0.259. This average can be used as a parameter along with another parameter from the historical plays database 4418 to perform correlations in order to determine if the wager odds should be adjusted or not. In some embodiments, the historical plays database 4418 may be filtered on the batter's regular season statistics, career statistics, statistics against the current opponent, statistics against the current pitcher, statistics in the event location, etc. In some embodiments, there may be more than two parameters to be correlated stored in the algorithm database 4432. For example, in the process described in the odds calculation module 4424, the parameters are required to exceed a predetermined threshold in order to adjust the odds, the algorithm database 4432 may store multiple parameters, such as 2, 3, 4, 5, etc. to ensure that the correlations will be high enough to exceed the predetermined threshold. For example, if the batter's ISO average and total home runs may not have a correlation coefficient to exceed the predetermined threshold, so a third parameter may be used to filter the historical plays database 4418 further to create a correlation coefficient that exceeds the predetermined threshold, such as total home runs hit in the first inning or total home runs hit in the first inning within the first five pitches to achieve a higher correlation coefficient to exceed the predetermined threshold to adjust the wager odds.

In another embodiment, an adjustment parameter for a wager or wagers directly from a database may be shown and described.

FIG. 50 is a system for adjusting a wager directly from a database using a parameter. This system may include a live event 5002, for example, a sporting event such as a football, basketball, baseball, or hockey game, tennis match, golf tournament, eSports or digital game, etc. The live event 5002 may include some number of actions or plays upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 5002, such as the score of an American football game or the run line in a baseball game, or a series of actions in the live event 5002. Sportsbooks have several bets they can handle, which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers, which can be done at kiosks at the live event 5002 or at another location.

Further, embodiments may include a plurality of sensors 5004 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 5004 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball. In some embodiments, telemetry data that an array of anchors may receive from one or more tracking devices which may include positional telemetry data. The positional telemetry data provides location data for a respective tracking device, which describes the location of the tracking device within a spatial region. In some embodiments, this positional telemetry data is provided as one or more Cartesian coordinates (e.g., an X coordinate, a Y coordinate, and/or Z a coordinate) that describe the position of each respective tracking device. However, any coordinate system (e.g., polar coordinates, etc.) that describes the position of each respective tracking device is used in alternative embodiments. The telemetry data that is received by the array of anchors from the one or more tracking devices includes kinetic telemetry data. The kinetic telemetry data provides data related to various kinematics of the respective tracking device. In some embodiments, this kinetic telemetry data is provided as a velocity of the respective tracking device, an acceleration of the respective tracking device, and/or a jerk of the respective tracking device. Further, in some embodiments, one or more of the above values is determined from an accelerometer of the respective tracking device and/or derived from the positional telemetry data of the respective tracking device. Further, in some embodiments, the telemetry data that is received by the array of anchors from the one or more tracking devices includes biometric telemetry data. The biometric telemetry data provides biometric information related to each subject associated with the respective tracking device. In some embodiments, this biometric information includes a heart rate of the subject, temperature, for example, a skin temperature, a temporal temperature, etc. In some embodiments, the array of anchors communicates the above-described telemetry data, for example, positional telemetry, kinetic telemetry, and/or biometric telemetry, to a telemetry parsing system. Accordingly, in some embodiments, the telemetry parsing system communicates the telemetry data to an odds calculation module 5024. In some embodiments, an array of anchor devices may receive telemetry data from one or more tracking devices. In order to minimize error in receiving the telemetry from the one or more tracking devices, the array of anchor devices preferably includes at least three anchor devices. The inclusion of at least three anchor devices within the array of anchor devices allows for each ping, for example, telemetry data received from a respective tracking device, to be triangulated using the combined data from the at least three anchors that receive the respective ping.

Further, embodiments may include a cloud 5006 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 5006 may be communicatively coupled to a peer-to-peer wagering network 5014, which may perform real-time analysis on the type of play and the result of the play. The cloud 5006 may also be synchronized with game situational data such as the time of the game, the score, location on the field, weather conditions, and the like, which may affect the choice of play utilized. For example, in an exemplary embodiment, the cloud 5006 may not receive data gathered from the sensors 5004 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 5008 such as a computing device, laptop, smartphone, tablet, computer, smart speaker, or I/O devices. I/O devices may be present in the computing device. Input devices may include but are not limited to keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide-semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include but are not limited to video displays, graphical displays, speakers, headphones, inkjet printers, laser printers, or 3D printers. Devices may include but are not limited to a combination of multiple input or output devices such as Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs, including, but not limited to, Microsoft KINECT, SIRI for iPhone by Apple, Google Now, or Google Voice Search. Additional user devices have both input and output capabilities, including, but not limited to, haptic feedback devices, touchscreen displays, or multi-touch displays. Touchscreen, multi-touch displays, touchpads, touch mice, or other touch sensing devices may use different technologies to sense touch, including but not limited to capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 5008 could be an optional component and would be utilized in a situation where a paired wearable device employs the mobile device 5008 for additional memory or computing power or connection to the internet.

Further, embodiments may include a wagering software application or a wagering app 5010, which is a program that enables the user to place bets on individual plays in the live event 5002, streams audio and video from the live event 5002, and features the available wagers from the live event 5002 on the mobile device 5008. The wagering app 5010 allows users to interact with the wagering network 5014 to place bets and provide payment/receive funds based on wager outcomes.

Further, embodiments may include a mobile device database 5012 that may store some or all the user's data, the live event 5002, or the user's interaction with the wagering network 5014.

Further, embodiments may include the wagering network 5014, which may perform real-time analysis on the type of play and the result of a play or action. The wagering network 5014 (or the cloud 5006) may also be synchronized with game situational data, such as the time of the game, the score, location on the field, weather conditions, and the like, which may affect the choice of play utilized. For example, in an exemplary embodiment, the wagering network 5014 may not receive data gathered from the sensors 5004 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 5014 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 5016, which may contain data relevant to all users of the wagering network 5014 and may include, but is not limited to, a user ID, a device identifier, a paired device identifier, wagering history, or wallet information for the user. The user database 5016 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 5016 may contain betting lines and search queries. The user database 5016 may be searched based on a search criterion received from the user. Each betting line may include, but is not limited to, a plurality of betting attributes such as at least one of the live event 5002, a team, a player, an amount of wager, etc. The user database 5016 may include but is not limited to information related to all the users involved in the live event 5002. In one exemplary embodiment, the user database 5016 may include information for generating a user authenticity report and a wagering verification report. Further, the user database 5016 may be used to store user statistics like, but not limited to, the retention period for a particular user, frequency of wagers placed by a particular user, the average amount of wager placed by each user, etc.

Further, embodiments may include a historical plays database 5018 that may contain play data for the type of sport being played in the live event 5002. For example, in American Football, for optimal odds calculation, the historical play data may include metadata about the historical plays, such as time, location, weather, previous plays, opponent, physiological data, etc.

Further, embodiments may utilize an odds database 5020—that contains the odds calculated by an odds calculation module 5022—to display the odds on the user's mobile device 5008 and take bets from the user through the mobile device wagering app 5010.

Further, embodiments may include a base module 5022, which receives the sensor data from the live event 5002. Then the base module 5022 determines a first play situation from the received sensor data. The base module 5022 determines the probability and wager odds of a first future event occurring at the present competition based on at least the first play situation and playing data associated with at least a subset of one or both of the first set of one or more participants and the second set of one or more participant. The base module 5022 provides the wager odds on the wagering app 5010.

Further, embodiments may include an odds calculation module 5024 initiated by the base module 5022. In some embodiments, the odds calculation module 5024 may be continuously polling for the data from the live event 5002. In some embodiments, the odds calculation module 5024 may receive the data from the live event 5002. In some embodiments, the odds calculation module 5024 may store the results data, or the results of the last action, in the historical play database 5018, which may contain historical data of all previous actions. The odds calculation module 5024 receives the situational data of the live event 5002 from the base module 5022. For example, the situational data the odds calculation module 5024 may receive may be in the event of the New England Patriots vs. the New York Jets is in the second quarter, and the Patriots have possession of the football on second down with five yards to go on their 30-yard line. Then the odds calculation module 5024 determines the wagering market. For example, the event may have multiple wager markets, such as the next event being a pass or run, the outcome of the next event, such as a complete pass or incomplete pass or a run of five yards or more or a run of five yards or less, which receiver or running back may complete the next action, if the event will take place on the left or right side of the field, etc. The odds calculation module 5024 queries the parameter odds database 5032. For example, the odds calculation module 5024 sends a query to the parameter odds database 5032 to see if there is a match between the situational data and wager market data to determine if wager odds are already calculated for the current situation and wager market. For example, the query may be for the event of the New England Patriots vs. the New York Jets is in the second quarter and the Patriots have possession of the football on second down with five yards to go on their 30-yard line and the wagering market being the event being a pass. Then the odds calculation module 5024 determines if there is a match between the wagering market and the parameter odds database 5032. For example, if there are wager odds stored in the parameter odds database 5032 for the event being the New England Patriots vs. the New York Jets is in the second quarter. The Patriots have possession of the football on second down with five yards to go on their 30-yard line and the wagering market being the event being a pass, then the odds calculation module 5024 extracts the wager odds to be stored in the odds database 5020 to be offered to the users through the wagering app 5010. If it is determined that there is a match, the odds calculation module 5024 extracts the wager odds stored in the parameter odds database 5032. For example, the wager odds to be extracted for the event being the New England Patriots vs. the New York Jets is in the second quarter, and the Patriots have possession of the football on second down with five yards to go on their 30-yard line and the event being a pass may be −110. Then the odds calculation module 5024 stores the wager odds in the odds database 5020 to be offered on the wagering app 5010. For example, the extracted wager odds of −110 for the event being a pass are stored in the odds database 5020 to allow the users to wager on the event through the wagering app 5010. Then the odds calculation module 5024 determines if there is another wager market. For example, the event may have multiple wager markets, such as the next event being a pass or run, the outcome of the next event, such as a complete pass or incomplete pass or a run of five yards or more or a run of five yards or less, which receiver or running back may complete the next action, if the event will take place on the left or right side of the field, etc. If it is determined that there is another wager market, then the odds calculation module 5024 selects the next wager market, and the process returns to query the parameter odds database 5032. If it is determined that there is no match between the wagering market and the parameter odds database 5032, then odds calculation module 5024 filters the historical play database 5018 on the team and down from the situational data. The odds calculation module 5024 selects the first parameter of the historical plays database 5018, for example, the event. Then the odds calculation module 5024 performs correlations on the data. For example, the historical plays database 5018 is filtered on the team, the players, the quarter, the down, and the distance to be gained. The first parameter is selected, which in this example is the event, which may either be a pass or a run and the historical plays database 5018 is filtered on the event being a pass. Then, correlations are performed on the rest of the parameters, which are yards gained, temperature, decibel level, etc. For example, correlated data for the historical data involving the Patriots in the second quarter on second down with five yards to go and the action being a pass, which has a correlation coefficient of 0.81. The correlations are also performed with the same filters, and the next event, which is the action being a run and has a correlation coefficient of 0.79. It is determined if the correlation coefficient is above a predetermined threshold, for example, 0.75, in order to determine if the data is highly correlated and deemed a relevant correlation. If the correlation is deemed highly relevant, then the correlation coefficient is extracted from the data. For example, the two correlation coefficients of 0.81 for a pass and 0.79 for a run are both extracted. If it is determined that the correlations are not highly relevant, then then it is determined if any parameters are remaining. Then the odds calculation module 5024 determines, if the correlation coefficient is above a predetermined threshold, for example, 0.75, in order to determine if the data is highly correlated and deemed a relevant correlation. If the correlation is deemed highly relevant, then the odds calculation module 5024 extracts the correlation coefficient from the data. For example, the two correlation coefficients of 0.81 for a pass and 0.79 for a run are both extracted. If it is determined that the correlations are not highly relevant, then the odds calculation module 5024 determines if any parameters are remaining. Also, if the correlations were determined to be highly relevant and therefore extracted, it is also determined if any parameters are remaining to perform correlations on. If there are additional parameters to have correlations performed, then the odds calculation module 5024 selects the next parameter in the historical plays database 5018, and the process returns to performing correlations on the data. Once there are no remaining parameters to perform correlations on, the odds calculation module 5024 determines the difference between each of the extracted correlations. For example, the correlation coefficient for a pass is 0.81, and the correlation coefficient for a run is 0.79. The difference between the two correlation coefficients (0.81−0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendations database 5028 to compare the two correlation coefficient based on statistical significance as opposed to the difference of the two correlation coefficients. Then the odds calculation module compares the difference between the two correlation coefficients, for example, 0.02, to the recommendations database 5028. The recommendations database 5028 contains various ranges of differences in correlations as well as the corresponding odds adjustment for those ranges. For example, the 0.02 difference of the two correlation coefficients falls into the range +0-2 difference in correlations which, according to the recommendations database 5028, should have an odds adjustment of 5% increase. The odds calculation module 5024 then extracts the odds adjustment from the recommendations database 5028. The odds calculation module then stores the extracted odds adjustment in the adjustment database 5030. The odds calculation module 5024 compares the odds database 5020 to the adjustment database 5030. The odds calculation module 5024 then determines whether or not there is a match in any of the wager IDs in the odds database 5020 and the adjustment database 5030. For example, the odds database 5020 contains a list of all the current bet options for a user. The odds database 5020 contains a wager ID, event, time, inning, wager, and odds for each bet option. The adjustment database 5030 contains the wager ID and the percentage, either as an increase or decrease, that the odds should be adjusted. If it is determined there is a match between the odds database 5020 and the adjustment database 5030, then the odds calculation module 5024 adjusts the odds in the odds database 5020 by the percentage increase or decrease in the adjustment database 5030 and the odds in the odds database 5020 are updated. For example, if the odds in the odds database 5020 are −105 and the matched wager ID in the adjustment database 5030 is a 5% increase, then the updated odds in the odds database 5020 should be −110. If there is a match, then the odds are adjusted based on the data stored in the adjustment database 5030, and the new data is stored in the odds database 5020 over the old entry. If there are no matches, or once the odds database 5020 has been adjusted if there are matches, the odds calculation module 5024 stores all of the data in the parameter odds database. For example, the data may be the event, such as football, the team, such as the New England Patriots, the opponent, such as the New York Jets, the time period, such as the second quarter, the wagering market, such as the next play being a pass, the first parameter used in the correlations, such as the yards to be gained, the second parameter used in the correlations, such as average yards gained, and the resulting wager odds, such as −110. Then odds calculation module 5024 returns to the base module 5022. In some embodiments, the odds calculation module 5024 may offer the odds database 5020 to the wagering app 5010, allowing users to place bets on the wagers stored in the odds database 5020. In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 5024. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1−b2/Sb1−b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 5024 may then extract an odds adjustment from the recommendations database 5028. The extracted odds adjustment is then stored in the adjustment database 5030. In some embodiments, the recommendations database 5028 may be used in the odds calculation module 5024 to determine how the wager odds should be adjusted depending on the difference between the correlation coefficients of the correlated data points. The recommendations database 5028 may contain the difference in correlations and the odds adjustment. For example, if there is a correlation coefficient for the Patriots in the second quarter on second down with five yards to go and the action being a pass of 0.81 and a correlation coefficient for the Patriots in the second quarter on second down with five yards to go and the action being a run of 0.79, the difference between the two would be +0.02 when compared to the recommendations database 5028 the odds adjustment would be a 5% increase for a Patriots pass or otherwise identified as wager 201 in the adjustment database 5030. In some embodiments, the difference in correlations may be the statistical significance of comparing the two correlation coefficients in order to determine how the odds should be adjusted. In some embodiments, the adjustment database 5030 may be used to adjust the wager odds of the odds database 5020 if it is determined that a wager should be adjusted. The adjustment database 5030 contains the wager ID, which is used to match with the odds database 5020 to adjust the odds of the correct wager.

Further, embodiments may include a tracking system 5026, which is associated with one or more tracking devices and anchors. The tracking system 5026 may include one or more processing units (CPUs), a peripherals interface, a memory controller, a network or other communications interface, a memory, for example, a random access memory, a user interface, the user interface including a display and an input, such as a keyboard, a keypad, a touch screen, etc., an input/output (I/O) subsystem, one or more communication busses for interconnecting the aforementioned components, and a power supply system for powering the aforementioned components. In some embodiments, the input is a touch-sensitive display, such as a touch-sensitive surface. In some embodiments, the user interface includes one or more soft keyboard embodiments. The soft keyboard embodiments may include standard (QWERTY) and/or non-standard configurations of symbols on the displayed icons. It should be appreciated that the tracking system 5026 is only one example of a system that may be used in engaging with various tracking devices and that the tracking system 5026 optionally has more or fewer components than described, optionally combines two or more components, or optionally has a different configuration or arrangement of the components. The various components described are implemented in hardware, software, firmware, or a combination thereof, including one or more signal processing and/or application-specific integrated circuits. Memory optionally includes high-speed random access memory, and optionally also includes non-volatile memory, such as one or more magnetic disk storage devices, flash memory devices, or other non-volatile solid-state memory devices. Access to memory by other tracking system components, such as CPU(s), is, optionally, controlled by a memory controller. Peripherals interface can be used to couple input and output peripherals of the tracking system 5026 to CPU(s) and memory. One or more processors run or execute various software programs and/or sets of instructions stored in memory to perform various functions for the tracking system 5026 and to process data. In some embodiments, peripherals interface, CPU(s), and memory controller are, optionally, implemented on a single chip. In some other embodiments, they are, optionally, implemented on separate chips. In some embodiments, power system optionally includes a power management system, one or more power sources (e.g., battery, alternating current (AC)), a recharging system, a power failure detection circuit, a power converter or inverter, a power status indicator (e.g., a light-emitting diode (LED), etc.) and any other components associated with the generation, management and distribution of power in portable devices. In some embodiments, the tracking system 5026 may include a tracking device manager module for facilitating management of one or more tracking devices, the tracking device manager module may include a tracking device identifier store for storing pertinent information related to each respective tracking device, including a tracking device identifier and a tracking device ping rate, and a tracking device grouping store for facilitating management of or more tracking device groups. The tracking device identifier store includes information related to each respective tracking device, including the tracking device identifier (ID) for each respective tracking device as well as a tracking device group to which the respective tracking device is associated. In some embodiments, a first tracking device group is associated with the left shoulder of each respective subject, and a second tracking device group is associated with a right shoulder of each respective subject. In some embodiments, a third tracking device group is associated with a first position, for example, first baseman, second baseman, shortstop, baserunner, pitcher, etc., of each respective subject, and a fourth tracking device group is associated with a second position. Grouping the tracking devices allows for a particular group to be designated with a particular ping rate, for example, a faster ping rate for baserunners. Grouping the tracking devices also allows for a particular group to be isolated from other tracking devices that are not associated with the respective group, which is useful in viewing representations of the telemetry data provided by the tracking devices of the group.

Further, embodiments may include a recommendations database 5028 that may be used in the odds calculation module 5024 to determine how the wager odds should be adjusted depending on the difference between the correlation coefficients of the correlated data points. The recommendations database 5028 may contain the difference in correlations and the odds adjustment. For example, if there is a correlation coefficient for a Red Sox second inning with a runner on base with one out and a stolen base of 0.81 and a correlation coefficient for a Red Sox second inning with a runner on base with one out and the runner caught stealing of 0.79, the difference between the two would be +0.02 when compared to the recommendations database 5028 the odds adjustment would be a 5% increase for a Red Sox stolen base or otherwise identified as wager 201 in the adjustment database 5030. In some embodiments, the difference in correlations may be the statistical significance of comparing the two correlation coefficients in order to determine how the odds should be adjusted.

Further, embodiments may include an adjustment database 5030 that may be used to adjust the wager odds of the odds database 5020 if it is determined that a wager should be adjusted. The adjustment database 5030 contains the wager ID, which is used to match with the odds database 5020 to adjust the odds of the correct wager.

Further, embodiments may include a parameter odds database 5032. The database is created during the process described in the odds calculation module 5024, in which the data from the correlations performed is stored along with the associated wager odds to be used for future similar situations within an event so that the wager odds may be directly extracted from the database. For example, the database may contain the event, such as football, the team, such as the New England Patriots, the opponent, such as the New York Jets, the time period, such as the second quarter, the wagering market, such as the next play being a pass, the first parameter used in the correlations, such as the yards to be gained, the second parameter used in the correlations, such as average yards gained, and the resulting wager odds, such as −110. In some embodiments, the data may contain the current yard line, the down, the yards to go, etc.

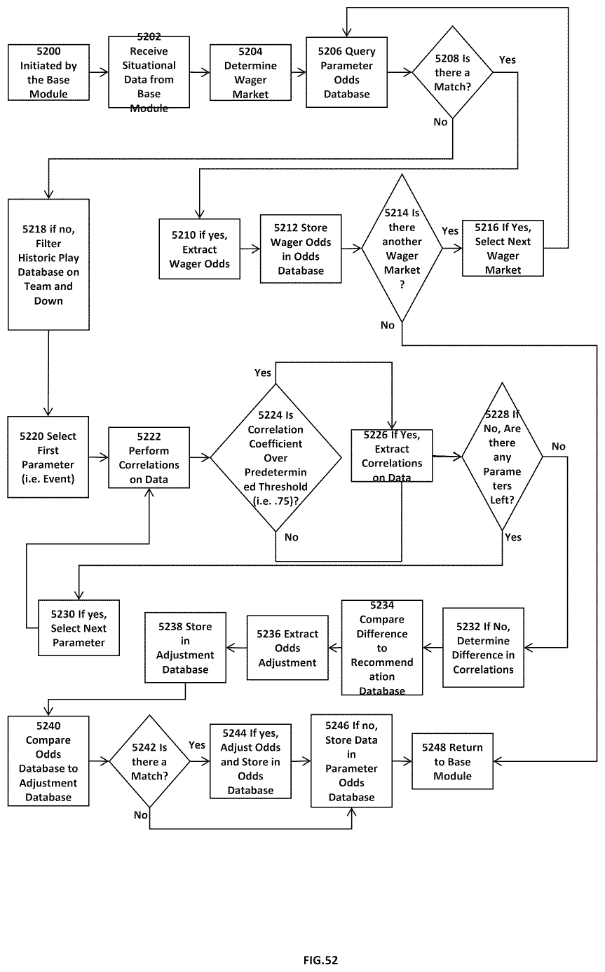

FIG. 51 illustrates the base module 5022. The base module 5022 receives, at step 5100, the sensor data from the live event 5002. For example, the base module 5022 receives time-stamped position information of one or more participants of one or both of the first set of participant(s) and the second set of participant(s) in the present competition is received, the time-stamped position information captured by the sensors 5004 at a live event 5002 during the present competition. For example, the sensor data may be collected by a system including the tracking system 5026, the tracking devices, the anchor devices, etc. The time-stamped position information may include an XY- or XYZ-position of each participant of a first subset and a second subset of players with respect to a predefined space, for example, a game field, such as a football field, etc.

The first subset and the second subset can include any number of participants such as each subset including one participant, each subset including two or more participants, or each subset including all the participants of the first competitor and the second competitor, respectively, that are on the field during the first time point. Then the base module 5022 determines, at step 5102, a first play situation from the received sensor data. For example, the base module 5022 receives the time-stamped position information and is used to determine a first play situation of the present competition, such as a current play situation. In various embodiments, the play situation is determined using, at least in part, time-stamped position information of each player in the subsets of players at the given time. For example, the process determines the play situation at a first time point which is a current time of a competition while the competition is ongoing, and the time-stamped position information has been collected by the sensors 5004 at the present competition through the first time point.

In various embodiments, determining the play situation uses a set of parameters, including a current team, inning, outs recorded, baserunners, and defensive positions describing the play situation at the given time. In some embodiments, the data describing the play situation of the live sports event further includes motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 5004 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball. In some embodiments, telemetry data that an array of anchors may receive from one or more tracking devices which may include positional telemetry data. The positional telemetry data provides location data for a respective tracking device, which describes the location of the tracking device within a spatial region. In some embodiments, this positional telemetry data is provided as one or more Cartesian coordinates (e.g., an X coordinate, a Y coordinate, and/or Z a coordinate) that describe the position of each respective tracking device. However, any coordinate system (e.g., polar coordinates, etc.) that describes the position of each respective tracking device is used in alternative embodiments. The telemetry data that is received by the array of anchors from the one or more tracking devices includes kinetic telemetry data. The kinetic telemetry data provides data related to various kinematics of the respective tracking device. In some embodiments, this kinetic telemetry data is provided as a velocity of the respective tracking device, an acceleration of the respective tracking device, and/or a jerk of the respective tracking device. Further, in some embodiments, one or more of the above values is determined from an accelerometer of the respective tracking device and/or derived from the positional telemetry data of the respective tracking device. Further, in some embodiments, the telemetry data that is received by the array of anchors from the one or more tracking devices includes biometric telemetry data. The biometric telemetry data provides biometric information related to each subject associated with the respective tracking device. In some embodiments, this biometric information includes a heart rate of the subject, temperature, for example, a skin temperature, a temporal temperature, etc. In some embodiments, the array of anchors communicates the above-described telemetry data, for example, positional telemetry, kinetic telemetry, and/or biometric telemetry, to a telemetry parsing system. Accordingly, in some embodiments, the telemetry parsing system communicates the telemetry data to an odds calculation module 5022. In some embodiments, an array of anchor devices may receive telemetry data from one or more tracking devices. In order to minimize error in receiving the telemetry from the one or more tracking devices, the array of anchor devices preferably includes at least three anchor devices. The inclusion of at least three anchor devices within the array of anchor devices allows for each ping, for example, telemetry data received from a respective tracking device, to be triangulated using the combined data from the at least three anchors that receive the respective ping.

The position may be defined as an XY- or XYZ-coordinate for each player with respect to a predefined space, such as a field where the sporting event occurs, such as pitcher's location, catcher's location, baserunner's location, first base location, first baseman location, etc. The player configuration includes positions of the player with respect to each other, as well as with respect to the bases, pitcher's mound, home plate, foul lines, etc. Such positional data is used for recognizing patterns for deriving player configurations in play situations as well as for tracking next events, for example, a baserunner's lead, the position of the first baseman, second baseman, shortstop, etc.,

In various embodiments, determining a prediction of the probability of a first future event includes using historical playing data of one or more participants in one or both of the first set of participant(s) and the second set of participant(s). That is, the process determines a prediction of the probability of a first future event occurring at a live sports event based upon at least (i) the playing data, (ii) the play situation, and (iii) the historical playing data. Historical data refers to play-by-play data that specifies data describing play situations and next play events that have occurred after each play situation. The historical play-by-play data includes historical outcomes of next plays from given player configurations. For example, the historical play-by-play data includes a plurality of next play events that have occurred after a given play situation. For baseball, the given play situation includes the player's configuration in the field, a current inning, a number of outs recorded, a number of baserunners, a number of pitches thrown, a number of pitches called strikes, a number of pitches called balls, etc.

In some embodiments, such historical data also includes data collected so far during a live sports event. In some embodiments, the historical data further includes play-by-play data recorded and published by a league, such as the MLB, NBA, NHL, NFL, etc.

In some embodiments, historical playing data is stored at historical plays database 5018 for each participant of at least the first and second subset of participants in a plurality of historical games in the league. In some embodiments, the historical data is used to identify historical play situations corresponding to the play situation at the first time point and provide a prediction of the next event based on the historical play events that have occurred after similar play situations. In some embodiments, the historical playing data includes player telemetry data for each player of at least the first and second subset of players in the plurality of historical games in the league. In some embodiments, the historical playing data includes historical states for player configurations. The current play situation with the present player configuration is compared with the historical states for player configurations to determine a prediction of the next event in the present game. In some embodiments, the historical states for each player configuration of the player configurations include player types included in the respective player configuration or a subset of the player types included in the respective player configuration. In some embodiments, the plurality of historical games spans a plurality of seasons over a plurality of years. The historical playing data may be for the same type of sport or competition involving the first and second competitors. The first and second competitors may have different team members compared with the current configuration of the team or may have some of the same team members. Then the base module 5022 sends, at step 5104, the situational data of the live event 5002 to the odds calculation module 5024. The base module 5022 initiates, at step 5106, the odds calculation module 5024 to determine the probability and wager odds of a first future event occurring at the present competition based on at least the first play situation and playing data associated with at least a subset of one or both of the first set of one or more participants and the second set of one or more participant. The base module 5022 provides, at step 5108, the wager odds on the wagering app 5010. In various embodiments, the wager odds are transmitted to the wagering app 5010 through the wager network 5014 to be displayed on a mobile device 5008. In some embodiments, the wagering app 5010, which is a program that enables the user to place bets on individual plays in the live event 5002, streams audio and video from the live event 5002, and features the available wagers from the live event 5002 on the mobile device 5008. The wagering app 5010 allows users to interact with the wagering network 5014 to place bets and provide payment/receive funds based on wager outcomes.

FIG. 52 illustrates the odds calculation module 5024. The odds calculation module 5024 is initiated, at step 5200, by the base module 5022. In some embodiments, the odds calculation module 5024 may be continuously polling for the data from the live event 5002. In some embodiments, the odds calculation module 5024 may receive the data from the live event 5002. In some embodiments, the odds calculation module 5024 may store the results data, or the results of the last action, in the historical play database 5018, which may contain historical data of all previous actions. The odds calculation module 5024 receives, at step 5202, the situational data of the live event 5002 from the base module 5022. For example, the situational data the odds calculation module 5024 may receive may be in the event of the New England Patriots vs. the New York Jets is in the second quarter, and the Patriots have possession of the football on second down with five yards to go on their 30-yard line. Then the odds calculation module 5024 determines, at step 5204, the wagering market. For example, the event may have multiple wager markets, such as the next event being a pass or run, the outcome of the next event, such as a complete pass or incomplete pass or a run of five yards or more or a run of five yards or less, which receiver or running back may complete the next action, if the event will take place on the left or right side of the field, etc. The odds calculation module 5024 queries, at step 5206, the parameter odds database 5032. For example, the odds calculation module 5024 sends a query to the parameter odds database 5032 to see if there is a match between the situational data and wager market data to determine if wager odds are already calculated for the current situation and wager market. For example, the query may be for the event of the New England Patriots vs. the New York Jets is in the second quarter and the Patriots have possession of the football on second down with five yards to go on their 30-yard line and the wagering market being the event being a pass. Then the odds calculation module 5024 determines, at step 5208, if there is a match between the wagering market and the parameter odds database 5032. For example, if there are wager odds stored in the parameter odds database 5032 for the event being the New England Patriots vs. the New York Jets is in the second quarter. The Patriots have possession of the football on second down with five yards to go on their 30-yard line and the wagering market being the event being a pass, then the odds calculation module 5024 extracts the wager odds to be stored in the odds database 5020 to be offered to the users through the wagering app 5010. If it is determined that there are a match, the odds calculation module 5024 extracts, at step 5210, the wager odds stored in the parameter odds database 5032. For example, the wager odds to be extracted for the event being the New England Patriots vs. the New York Jets is in the second quarter, and the Patriots have possession of the football on second down with five yards to go on their 30-yard line and the event being a pass may be −110. Then the odds calculation module 5024 stores, at step 5212, the wager odds in the odds database 5020 to be offered on the wagering app 5010. For example, the extracted wager odds of −110 for the event being a pass are stored in the odds database 5020 to allow the users to wager on the event through the wagering app 5010. Then the odds calculation module 5024 determines, at step 5214, if there is another wager market. For example, the event may have multiple wager markets, such as the next event being a pass or run, the outcome of the next event, such as a complete pass or incomplete pass or a run of five yards or more or a run of five yards or less, which receiver or running back may complete the next action, if the event will take place on the left or right side of the field, etc. If it is determined that there is another wager market, then the odds calculation module 5024 selects, at step 5216, the next wager market, and the process returns to query the parameter odds database 5032. If it is determined that there is no match between the wagering market and the parameter odds database 5032, then odds calculation module 5024 filters, at step 5218, the historical play database 5018 on the team and down from the situational data. The odds calculation module 5024 selects, at step 5220, the first parameter of the historical plays database 5018, for example, the event. Then the odds calculation module 5024 performs, at step 5222, correlations on the data. For example, the historical plays database 5018 is filtered on the team, the players, the quarter, the down, and the distance to be gained. The first parameter is selected, which in this example is the event, which may either be a pass or a run and the historical plays database 5018 is filtered on the event being a pass. Then, correlations are performed on the rest of the parameters, which are yards gained, temperature, decibel level, etc. For example, correlated data for the historical data involving the Patriots in the second quarter on second down with five yards to go and the action being a pass, which has a correlation coefficient of 0.81. The correlations are also performed with the same filters, and the next event, which is the action being a run and has a correlation coefficient of 0.79. It is determined if the correlation coefficient is above a predetermined threshold, for example, 0.75, in order to determine if the data is highly correlated and deemed a relevant correlation. If the correlation is deemed highly relevant, then the correlation coefficient is extracted from the data. For example, the two correlation coefficients of 0.81 for a pass and 0.79 for a run are both extracted. If it is determined that the correlations are not highly relevant, then then it is determined if any parameters are remaining. Then the odds calculation module 5024 determines, at step 5224, if the correlation coefficient is above a predetermined threshold, for example, 0.75, in order to determine if the data is highly correlated and deemed a relevant correlation. If the correlation is deemed highly relevant, then the odds calculation module 5024 extracts, at step 5226, the correlation coefficient from the data. For example, the two correlation coefficients of 0.81 for a pass and 0.79 for a run are both extracted. If it is determined that the correlations are not highly relevant, then the odds calculation module 5024 determines, at step 5228, if any parameters are remaining. Also, if the correlations were determined to be highly relevant and therefore extracted, it is also determined if any parameters are remaining to perform correlations on. If there are additional parameters to have correlations performed, then the odds calculation module 5024 selects, at step 5230, the next parameter in the historical plays database 5018, and the process returns to performing correlations on the data. Once there are no remaining parameters to perform correlations on, the odds calculation module 5024 then determines, at step 5232, the difference between each of the extracted correlations. For example, the correlation coefficient for a pass is 0.81, and the correlation coefficient for a run is 0.79. The difference between the two correlation coefficients (0.81−0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendations database 5028 to compare the two correlation coefficient based on statistical significance as opposed to the difference of the two correlation coefficients. Then the odds calculation module compares, at step 5234, the difference between the two correlation coefficients, for example, 0.02, to the recommendations database 5028. The recommendations database 5028 contains various ranges of differences in correlations as well as the corresponding odds adjustment for those ranges. For example, the 0.02 difference of the two correlation coefficients falls into the range +0-2 difference in correlations which, according to the recommendations database 5028, should have an odds adjustment of 5% increase. The odds calculation module 5024 then extracts, at step 5236, the odds adjustment from the recommendations database 5028. The odds calculation module then stores, at step 5238, the extracted odds adjustment in the adjustment database 5030. The odds calculation module 5024 compares, at step 5240, the odds database 5020 to the adjustment database 5030. The odds calculation module 5024 then determines, at step 5242, whether or not there is a match in any of the wager IDs in the odds database 5020 and the adjustment database 5030. For example, the odds database 5020 contains a list of all the current bet options for a user. The odds database 5020 contains a wager ID, event, time, inning, wager, and odds for each bet option. The adjustment database 5030 contains the wager ID and the percentage, either as an increase or decrease, that the odds should be adjusted. If it is determined there is a match between the odds database 5020 and the adjustment database 5030, then the odds calculation module 5024 adjust, at step 5244, the odds in the odds database 5020 by the percentage increase or decrease in the adjustment database 5030 and the odds in the odds database 5020 are updated. For example, if the odds in the odds database 5020 are −105 and the matched wager ID in the adjustment database 5030 is a 5% increase, then the updated odds in the odds database 5020 should be −110. If there is a match, then the odds are adjusted based on the data stored in the adjustment database 5030, and the new data is stored in the odds database 5020 over the old entry. If there are no matches, or, once the odds database 5020 has been adjusted if there are matches, the odds calculation module 5024 stores, at step 5246, all of the data in the parameter odds database. For example, the data may be the event, such as football, the team, such as the New England Patriots, the opponent, such as the New York Jets, the time period, such as the second quarter, the wagering market, such as the next play being a pass, the first parameter used in the correlations, such as the yards to be gained, the second parameter used in the correlations, such as average yards gained, and the resulting wager odds, such as −110. Then odds calculation module 5024 returns, at step 5248, to the base module 5022. In some embodiments, the odds calculation module 5024 may offer the odds database 5020 to the wagering app 5010, allowing users to place bets on the wagers stored in the odds database 5020. In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 5024. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1-b2/Sb1-b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 5024 may then extract an odds adjustment from the recommendations database 5028. The extracted odds adjustment is then stored in the adjustment database 5030. In some embodiments, the recommendations database 5028 may be used in the odds calculation module 5024 to determine how the wager odds should be adjusted depending on the difference between the correlation coefficients of the correlated data points. The recommendations database 5028 may contain the difference in correlations and the odds adjustment. For example, if there is a correlation coefficient for the Patriots in the second quarter on second down with five yards to go and the action being a pass of 0.81 and a correlation coefficient for the Patriots in the second quarter on second down with five yards to go and the action being a run of 0.79, the difference between the two would be +0.02 when compared to the recommendations database 5028 the odds adjustment would be a 5% increase for a Patriots pass or otherwise identified as wager 201 in the adjustment database 5030. In some embodiments, the difference in correlations may be the statistical significance of comparing the two correlation coefficients in order to determine how the odds should be adjusted. In some embodiments, the adjustment database 5030 may be used to adjust the wager odds of the odds database 5020 if it is determined that a wager should be adjusted. The adjustment database 5030 contains the wager ID, which is used to match with the odds database 5020 to adjust the odds of the correct wager.

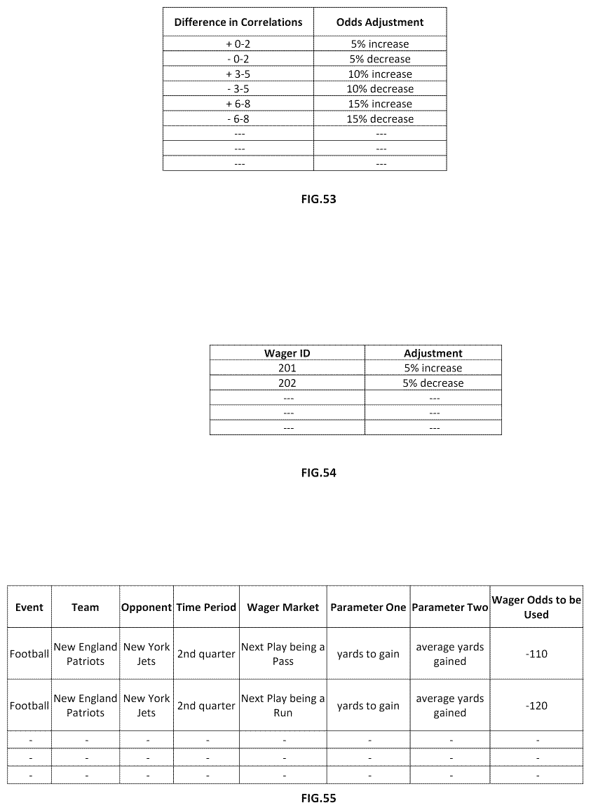

FIG. 53 illustrates the recommendations database 5028. The recommendations database 5028 may be used in the odds calculation module 5024 to determine how the wager odds should be adjusted depending on the difference between the correlation coefficients of the correlated data points. The recommendations database 5028 may contain the difference in correlations and the odds adjustment. For example, if there is a correlation coefficient for a Red Sox second inning with a runner on base with one out and a stolen base of 0.81 and a correlation coefficient for a Red Sox second inning with a runner on base with one out and the runner caught stealing of 0.79, the difference between the two would be +0.02 when compared to the recommendations database 5028 the odds adjustment would be a 5% increase for a Red Sox stolen base or otherwise identified as wager 201 in the adjustment database 5030. In some embodiments, the difference in correlations may be the statistical significance of comparing the two correlation coefficients in order to determine how the odds should be adjusted.

FIG. 54 illustrates the adjustment database 5030. The adjustment database 5030 may be used to adjust the wager odds of the odds database 5020 if it is determined that a wager should be adjusted. The adjustment database 5030 contains the wager ID, which is used to match with the odds database 5020 to adjust the odds of the correct wager.

FIG. 55 illustrates the parameter odds database 5032. The database is created during the process described in the odds calculation module 5024, in which the data from the correlations performed is stored along with the associated wager odds to be used for future similar situations within an event so that the wager odds may be directly extracted from the database. For example, the database may contain the event, such as football, the team, such as the New England Patriots, the opponent, such as the New York Jets, the time period, such as the second quarter, the wagering market, such as the next play being a pass, the first parameter used in the correlations, such as the yards to be gained, the second parameter used in the correlations, such as average yards gained, and the resulting wager odds, such as −110. In some embodiments, the data may contain the current yard line, the down, the yards to go, etc.

1. A method comprising:
filtering, by machine learning, a historic database to match a current wager available on a gaming device;
selecting, by machine learning, a common parameter within historic data in the historic database;
determining, by machine learning, when there is correlated data;
extracting, by machine learning, data points from the correlated data;
comparing, by machine learning, the extracted data points to one or more thresholds;
adjusting, by machine learning, the current wager on the gaming device; and
outputting the current wager on the gaming device.
